(19) United States
(12) Patent Application Publication
(10) Pub. No.: US 2024/0385811 A1
(43) Pub. Date: Nov. 21, 2024

(54) METHOD AND APPARATUS FOR CONSTRUCTING COMPOSITE FUNCTION BLOCK, COMPOSITE FUNCTION BLOCK, AND STORAGE MEDIUM

(71) Applicant: ELEMENT SOFTWARE CO., LTD., Jinan (CN)

(72) Inventors: Yi YOUNG, Jinan (CN); Chunxiao QU, Jinan (CN)

(73) Assignee: ELEMENT SOFTWARE CO., LTD., Jinan (CN)

(21) Appl. No.: 18/696,651

(22) PCT Filed: Oct. 14, 2022
(86) PCT No.: PCT/CN2022/125382

§ 371 Date: Mar. 28, 2024

(30) Foreign Application Priority Data
Sep. 28, 2021 (CN) 202111142660.X

(51) Int. Cl. G06F 8/34

(52) U.S. Cl. CPC G06F 8/34

(57) ABSTRACT

A method and apparatus for constructing a composite function block, a composite function block, and a storage medium are provided. The method applies to a function block library and includes: selecting at least one composite paradigm from a plurality of composite paradigms; acquiring an arrangement operation for at least two function blocks of the plurality of function blocks to obtain a computation sequence; based on the computation sequence, performing a concatenation operation to determine a joining relationship between the at least two function blocks; and based on an interface of each function block of the at least two function blocks and the joining relationship between the at least two function blocks, encapsulating the at least two function blocks into a composite function block and generating an interface corresponding to the composite function block.

### CROSS-REFERENCE TO RELATED APPLICATION

The present application claims priority of the Chinese Patent Application No. 202111142660.X, filed on Sep. 28 2021, the entire disclosure of which is incorporated herein by reference as part of the present application.

### TECHNICAL FIELD

Embodiments of the present disclosure relate to a method for constructing a composite function block by nested use of composite paradigms, an apparatus for constructing a composite function block, a composite function block, and a non-transient computer-readable storage medium.

### BACKGROUND

For a software design, there may be two basic design ideas: modularization and abstraction. The modularization may make software easy to design, easy to understand, and easy to maintain. The abstraction may make a code more reusable. There is no uniform method for implementing the modularization and abstraction of the software design, and specific methods need to be selected according to different applications.

### SUMMARY

At least one embodiment of the present disclosure provides a method for constructing a composite function block by nested use of composite paradigms, applied to a function block library comprising a plurality of function blocks, the method includes: selecting at least one composite paradigm from a plurality of composite paradigms; acquiring an arrangement operation for at least two function blocks of the plurality of function blocks to obtain a computation sequence; based on the computation sequence, performing a concatenation operation to determine a joining relationship between the at least two function blocks; and based on an interface of each function block of the at least two function blocks and the joining relationship between the at least two function blocks, encapsulating the at least two function blocks into a composite function block and generating an interface corresponding to the composite function block. Each function block of the plurality of function blocks includes at least one input data item and at least one output data item that correspond to an interface corresponding to the function block, and the at least one input data item and the at least one output data item exist in a form of storage in the function block; and the concatenation operation includes joining at least part of input data items and/or at least part of output data items of the at least two function blocks.

At least one embodiment of the present disclosure provides a composite function block obtained by the method according to any embodiment of the present disclosure, the composite function block includes one or more function blocks, the one or more function blocks are joined by a data transfer joining line and/or an auxiliary merging joining line.

At least one embodiment of the present disclosure provides an apparatus for constructing a composite function block, the apparatus includes a memory configured to non-transiently store computer-readable instructions, and a processor configured to run the computer-readable instructions, the computer-readable instructions upon being run by the processor, implementing the method according to any embodiment of the present disclosure.

At least one embodiment of the present disclosure provides a non-transient computer-readable storage medium, the non-transient computer-readable storage medium stores computer-readable instructions, the computer-readable instructions upon being executed by a processor, implement the method according to any embodiment of the present disclosure.

### BRIEF DESCRIPTION OF DRAWINGS

In order to illustrate the technical solutions of the embodiments of the present disclosure more clearly, the drawings of the embodiments are briefly introduced below. Apparently, the drawings described below only relate to some embodiments of the present disclosure, rather than limiting the present disclosure.

FIG. 1 is a schematic diagram of a method for constructing a composite function block provided in some embodiments of the present disclosure;

FIG. 2A is a schematic diagram illustrating graphical representations of two computations provided in some embodiments of the present disclosure;

FIG. 2B is a schematic diagram of compositing the two computations illustrated in FIG. 2A;

FIG. 2C is a schematic diagram illustrating a graphical representation of a new computation obtained by compositing the two computations illustrated in FIG. 2A;

FIG. 2D is a schematic diagram illustrating a graphical representation of an interface of a new computation obtained by compositing the two computations illustrated in FIG. 2A;

FIG. 3A is a schematic diagram illustrating a graphical representation of a data item provided in some embodiments of the present disclosure;

FIG. 3B is a schematic diagram illustrating a graphical representation of a data item of an integer type provided in some embodiments of the present disclosure;

FIG. 3 (1) A to 3 (1) F are structural diagrams illustrating storage hierarchies of interfaces of function blocks provided in some embodiments of the present disclosure;

FIG. 4A is a schematic diagram illustrating a graphical representation of an interface of a basic function block provided in some embodiments of the present disclosure;

FIG. 4B is a structural diagram illustrating a storage hierarchy of an interface of a basic function block provided in some embodiments of the present disclosure;

FIG. 4C is a schematic diagram illustrating a graphical representation of an interface of an addition function block provided in some embodiments of the present disclosure;

FIG. 4D (1) is a structural diagram illustrating a storage hierarchy of an interface of an addition function block provided in some embodiments of the present disclosure;

FIG. 4D (2) is a structural diagram illustrating another storage hierarchy of an interface of an addition function block provided in some embodiments of the present disclosure;

FIG. 4E is a schematic diagram illustrating a graphical representation of a basic function block representing a relational expression provided in some embodiments of the present disclosure;

FIG. 4F is a schematic diagram illustrating a graphical representation of a specific example of a basic function block representing a relational expression provided in some embodiments of the present disclosure;

FIG. 4G is a structural diagram illustrating a storage hierarchy of an interface of a basic function block representing a relational expression provided in some embodiments of the present disclosure;

FIG. 4H is a schematic diagram illustrating a graphical representation of a basic function block representing a logical expression provided in some embodiments of the present disclosure;

FIG. 4I is a schematic diagram illustrating a graphical representation of a specific example of a basic function block representing a logical AND expression provided in some embodiments of the present disclosure;

FIG. 4J is a structural diagram illustrating a storage hierarchy of an interface of a basic function block representing a logical AND expression provided in some embodiments of the present disclosure:

FIG. 4K is a schematic diagram illustrating a graphical representation of a basic function block representing an arithmetical expression provided in some embodiments of the present disclosure;

FIG. 4L is a schematic diagram illustrating a graphical representation of a basic function block representing an addition expression provided in some embodiments of the present disclosure;

FIG. 4M is a structural diagram illustrating a storage hierarchy of an interface of a basic function block representing an addition expression provided in some embodiments of the present disclosure;

FIG. 4N is a structural diagram illustrating another storage hierarchy of the interface of the basic function block representing the addition expression provided in some embodiments of the present disclosure;

FIG. 4O is a schematic diagram illustrating a graphical representation of a basic function block representing an assignment expression provided in some embodiments of the present disclosure;

FIG. 4P is a schematic diagram illustrating a graphical representation of a specific example of a basic function block representing an assignment expression provided in some embodiments of the present disclosure;

FIG. 4Q is a structural diagram illustrating a storage hierarchy of the interface of the basic function block representing the assignment expression provided in some embodiments of the present disclosure;

FIG. 4R is a schematic diagram illustrating a graphical representation of a basic function block representing a getname function provided in some embodiments of the present disclosure;

FIG. 4S is a structural diagram illustrating a storage hierarchy of the interface of the basic function block representing the getname function provided in some embodiments of the present disclosure;

FIG. 5A is a schematic diagram of an output-output transfer line provided in an embodiment of the present disclosure;

FIG. 5B is a schematic diagram of an output-input transfer line provided in an embodiment of the present disclosure;

FIG. 5C is a schematic diagram of another output-input transfer line provided in an embodiment of the present disclosure;

FIG. 5D is a schematic diagram of further another output-input transfer line provided in an embodiment of the present disclosure;

FIG. 5E is a schematic diagram of an auxiliary merging joining line provided in an embodiment of the present disclosure;

FIG. 6 is a schematic diagram of a composite function block provided in some embodiments of the present disclosure;

FIG. 7A is a schematic diagram of a method for compositing function blocks based on a sequential composite paradigm provided in some embodiments of the present disclosure;

FIG. 7B is a schematic diagram illustrating graphical representations of at least two function blocks provided in some embodiments of the present disclosure;

FIG. 7C is a schematic diagram illustrating a graphical representation of a constant data item provided in some embodiments of the present disclosure;

FIG. 7D is a schematic diagram illustrating graphical representations of two function blocks provided in some embodiments of the present disclosure;

FIG. 8A is a schematic diagram illustrating a graphical representation of a computation sequence provided in some embodiments of the present disclosure;

FIG. 8B is a schematic diagram illustrating a graphical representation of the constant data item illustrated in FIG. 8A;

FIG. 8C is a schematic diagram illustrating a graphical representation of the computation sequence illustrated in FIG. 8A after joining by a line;

FIG. 8D is a schematic diagram illustrating a graphical representation of an interface corresponding to a composite function block determined based on a line joining relationship illustrated in FIG. 8C;

FIG. 8E is a structural diagram illustrating a storage hierarchy of the interface illustrated in FIG. 8D;

FIG. 9A is a schematic diagram of a composite function block having an if structure provided in some embodiments of the present disclosure;

FIG. 9B is a schematic diagram of a method for compositing function blocks based on an if composite paradigm provided in some embodiments of the present disclosure;

FIG. 9C is a schematic diagram illustrating a graphical representation of a composite function block having an if structure provided in some embodiments of the present disclosure;

FIG. 9D is a schematic diagram illustrating a graphical representation after joining data items in the composite function block in FIG. 9C by a line;

FIG. 9E is a schematic diagram of a composite function block having a conditional structure provided in some embodiments of the present disclosure;

FIG. 9F is a schematic diagram illustrating a graphical representation of an interface corresponding to the composite function block having the if structure illustrated in FIG. 9E;

FIG. 10A is a schematic diagram of a composite function block having a for structure provided in some embodiments of the present disclosure;

FIG. 10B is a schematic diagram of a method for compositing function blocks based on a for composite paradigm provided in some embodiments of the present disclosure;

FIG. 10C is a schematic diagram illustrating a graphical representation of a composite function block having a for structure provided in some embodiments of the present disclosure;

FIG. 10D is a schematic diagram illustrating a graphical representation of a computation sequence illustrated in FIG. 10C after joining by a line;

FIG. 10E is a schematic diagram illustrating another graphical representation of the computation sequence illustrated in FIG. 10C after joining by a line;

FIG. 10F is a schematic diagram illustrating further another graphical representation of the computation sequence illustrated in FIG. 10C after joining by a line;

FIG. 10G is a schematic diagram illustrating a graphical representation of an interface corresponding to the composite function block having the for structure illustrated in FIG. 10F;

FIG. 10H is a structural diagram illustrating a storage hierarchy of an interface of a function block including a data item of an array type;

FIG. 10I is a structural diagram illustrating a storage hierarchy when expanding the data item of the array type at a first layer;

FIG. 10J is a structural diagram illustrating a storage hierarchy when expanding the data item of the array type at a second layer;

FIG. 11A is a schematic diagram of a computation function provided in some embodiments of the present disclosure;

FIG. 11B is a schematic diagram illustrating a graphical representation of another composite function block having a for structure provided in some embodiments of the present disclosure;

FIG. 11C is another schematic diagram of a computation function provided in some embodiments of the present disclosure;

FIG. 11D is a schematic diagram illustrating a graphical representation of a computation sequence illustrated in FIG. 11B after joining by a line;

FIG. 11E is a schematic diagram illustrating another graphical representation of the computation sequence illustrated in FIG. 11C after joining by a line;

FIG. 11F is a schematic diagram illustrating a graphical representation of an interface corresponding to the composite function block having the for structure illustrated in FIG. 11E;

FIG. 12A is a schematic diagram of a composite function block having a while structure provided in some embodiments of the present disclosure;

FIG. 12B is a schematic diagram of a method for compositing function blocks based on a while composite paradigm provided in some embodiments of the present disclosure;

FIG. 13 illustrates an apparatus for constructing a composite function block provided in some embodiments of the present disclosure;

FIG. 14 is a schematic diagram of a non-transient computer-readable storage medium provided in at least one embodiment of the present disclosure;

FIG. 15A is a schematic diagram of a plurality of function blocks for compositing provided in some embodiments of the present disclosure;

FIG. 15B is a schematic diagram of performing a line joining operation on the plurality of function blocks illustrated in FIG. 15A;

FIG. 15C is a schematic diagram of an interface of a large function block generated based on compositing of the plurality of function blocks illustrated in FIG. 15A; and

FIG. 15D is a schematic diagram of a large function block generated based on compositing of the plurality of function blocks illustrated in FIG. 15A.

### DETAILED DESCRIPTION

In order to make objects, technical details and advantages of the embodiments of the present disclosure apparent, the technical solutions of the embodiments are described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by those of ordinary skill in the art to which the present disclosure belongs. The terms “first”, “second”, and the like, which are used in the description and the claims of the present disclosure, are not intended to indicate any sequence, amount or importance, but used to distinguish various components. Similarly, the terms “a”, “an”, “the”, or the like are not intended to indicate a limitation of quantity, but indicate that there is at least one. The terms, such as “comprise/comprising”, “include/including”, or the like are intended to specify that the elements or the objects stated before these terms encompass the elements or the objects and equivalents thereof listed after these terms, but not preclude other elements or objects. The terms, such as “connect/connecting/connected”, “couple/coupling/coupled”, or the like, are not limited to a physical connection or mechanical connection, but may include an electrical connection/coupling, directly or indirectly. The terms, “on”, “under”, “left”, “right”, or the like are only used to indicate relative position relationship, and when the position of the object which is described is changed, the relative position relationship may be changed accordingly.

In order to keep the following description of embodiments of the present disclosure clear and concise, the present disclosure omits detailed descriptions of some well-known functions and well-known components.

An algorithm is a composite system with an algorithm closure formed by a finite number of basic structural units and a finite number of composition rules. Any algorithm may be derived from a finite number of composition rules by repeatedly using basic structural units. The modularization software design method is a method that can improve the software development efficiency and maintenance efficiency. On the one hand, a software structure cannot be 100% modularized, and there are still a lot of development behaviors for non-modular statement layers. On the other hand, existing software applications are not separated from the algorithm, and consequently, although the algorithm used by different software is the same in essence, it cannot be shared because variables used in the algorithm have different names.

Statements in a high-level language are all included in a function structure which includes a data area and a computation area. The data area includes an input parameter to the function. Variables (including an output variable and an intermediate variable) used in statements and an external variable of the function to be used by the function are defined within the function. The computation area is composed of statements. The statement type includes: a compound statement (a statement may include a statement therein: if, for, while), a function (call) statement, and a basic statement (statements for realizing addition (+), subtraction (−), multiplication (*), division (/), assignment, logic computation, and the like, namely other statements for realizing language defined computations than a variable defining statement, a compound statement, and a function statement).

A basic statement in the high-level language is regarded as a computation unit that includes input and output portions of computation. The high-level language complies a small computation unit to a large computation unit with statements. When the high-level language organizes a function, it is necessary to first determine the data area and name each storage of the data area (i.e., define a variable name), and a statement cites the variable name of the data area to represent a computation on data in the data area. Therefore, the high-level language organizes a computation by describing a relationship between each statement and the storage of the data area rather than describing an interactive relationship between statements, and there is no direct relationship between the statements. In other words, the software modularization mentioned in the prior art actually is to encapsulate a plurality of statements for realizing a particular functionality into a software module, that is, a way of organizing a large computation by firstly defining data and then representing a relationship between a small computation and the data, which is not an organization way of modularization in essence. The main reason why modularization cannot be realized completely is an implementation way of a function structure including statements and a data area in the high-level language.

At least one embodiment of the present disclosure provides a method for constructing a composite function block by nested use of composite paradigms, an apparatus for constructing a composite function block, a composite function block, and a non-transient computer-readable storage medium. The method for constructing a composite function block by nested use of composite paradigms is applied to a function block library that includes a plurality of function blocks. The method includes: selecting at least one composite paradigm from a plurality of composite paradigms; acquiring an arrangement operation for at least two function blocks of the plurality of function blocks to obtain a computation sequence: based on the computation sequence, performing a concatenation operation to determine a joining relationship between the at least two function blocks; and based on an interface of each function block of the at least two function blocks and the joining relationship between the at least two function blocks, encapsulating the at least two function blocks into a composite function block and generating an interface corresponding to the composite function block. Each function block of the plurality of function blocks includes at least one input data item and at least one output data item that correspond to an interface corresponding to the function block, and the at least one input data item and the at least one output data item exist in a form of storage in the function block; and the concatenation operation includes joining at least part of input data items and/or at least part of output data items of the at least two function blocks.

The method for constructing a composite function block provided in the present disclosure solves the problems of incomplete modularization and abstraction of software arisen due to the use of an existing high-level language. In the method for constructing a composite function block provided in the present disclosure, by organizing a computational interactive relationship between small function blocks to form a large composite function block, 100% modularization of a software structure can be realized. Only logic implementation needs to be considered in the compositing process, and no development behavior for a non-modular statement layer is required. Meanwhile, the abstraction of an algorithm is also realized and the problems of incomplete modularization and abstraction of software arisen due to the use of the existing high-level language is solved.

In this method, instead of describing a relationship between a statement and data, a relationship between function blocks is described and the data item is attached to the function block in the form of storage such that the description of the relationship between computations may be transformed into that of a relationship between input-output storages. Association between function blocks is established by line joining, thereby constructing an algorithm program for realizing a particular functionality, i.e., a composite function block. The modularization is realized fundamentally. Because each function block has its own storage and does not require a variable to be defined and each variable has no actual meaning, high abstraction and standardization and high portability of the algorithm are realized in essence. Because the variable has no actual meaning, the code wall between different industries is broken.

In an embodiment of the present disclosure, a basic computation (such as an assignment expression, a conditional expression, an arithmetical expression, or a logical expression) of the high-level language is subdivided according to a type of the computed data, and each subdivided basic statement is attached with an input-output storage matching the type of the data thereof. For example, an addition statement is subdivided into adding values of two storages of an integer type together for outputting to another storage of the integer type, adding values of two storages of a floating-point type together for outputting to another storage of the floating-point type, and the like. All the basic statements are subjected to similar processing, and then a plurality of basic computations on data items of a plurality of basic data types may be obtained. For example, in some embodiments, the number of the basic computations may be 67 and the number of the basic data types may be 10. The present disclosure is not limited thereto, and the number of the basic computations and the number of the basic data types may be determined according to actual situations. Attaching storage to a function block allows the description of a relationship between the function blocks may be transformed into that of a relationship between input-output storages of the function blocks, thus realizing modularization.

In the present disclosure, if a function block (a basic function block and a composite function block) is regarded as a chip and a type storage (an input data item and an output data item) is regarded as a pin of the chip (with a type), in the method provided in the present disclosure, the compositing operation of function blocks is turned into an operation of connecting pins similar to a hardware design. Thus, a visualized design of a function block may be realized. A visualized operation does not involve naming a storage, and therefore, the visualized representation of a function block (i.e., computation) is abstract. A visualized organizational logic similar to hardware enables an abstract computation to be more understandable.

FIG. 1 is a schematic diagram of a method for constructing a composite function block provided in some embodiments of the present disclosure.

For example, a function block library includes a plurality of function blocks. For example, the plurality of function blocks include a plurality of basic function blocks and a plurality of composite function blocks. The plurality of basic function blocks represent the minimum unit composing any composite function block. In other words, in the present disclosure, the basic function block is the minimum function block that cannot be further split. Storages (i.e., data items) are attached to the plurality of basic function blocks, and then the plurality of basic function blocks and/or the plurality of composite function blocks are composited to obtain a new composite function block. In the function block library, all the composite function blocks are each composed of these minimum basic function blocks. Any composite function block may be finally split into a plurality of basic function blocks. For example, for any composite function block A, the composite function block A is composed of one composite function block B and one basic function block C1, and the composite function block B is composed of two basic function blocks C2 and C3. In other words, in effect, the composite function block A is composed of three basic function blocks (i.e., the basic function blocks C1, C2, and C3).

For example, each of the plurality of composite function blocks is composed of at least one basic function block and/or at least one composite function block.

As illustrated in FIG. 1, the method for constructing a composite function block includes the following steps S10 to step S13.

Step S10: selecting at least one composite paradigm from a plurality of composite paradigms.

Step S11: acquiring an arrangement operation for at least two function blocks of the plurality of function blocks to obtain a computation sequence.

Step S12: based on the computation sequence, performing a concatenation operation to determine a joining relationship between the at least two function blocks.

Step S13: based on an interface of each function block of the at least two function blocks and the joining relationship between the at least two function blocks, encapsulating the at least two function blocks into a composite function block and generating an interface corresponding to the composite function block.

The method for constructing a composite function block provided in the present disclosure has the following characteristics:
1, the visualized operation is supported, which is intuitional, convenient, and easy to learn.
2, the algorithm is separated from the application, and a common unified algorithm representation space is formed, which lays a theoretical foundation for 100% algorithm sharing among all industries.
3, by standardized normative production, for example, by the visualized operation, python code is generated.
4, high abstraction of the composite function block can be realized with high portability.
5, there is no need for writing any statement, and a symbolic language (e.g., an extensible markup language (XML)) is automatically formed in constructing the composite function block.

For example, each function block of the plurality of function blocks includes at least one input data item and at least one output data item that correspond to an interface corresponding to the function block, and the at least one input data item and the at least one output data item exist in a form of storage in the function block. In other words, the input data item and the output data item have data types, and there is no need to designate a variable name. That is, a variable name does not need to be designated for the at least one input data item and the at least one output data item.

For example, in step S11, the arrangement operation may represent information such as an arrangement sequence and arrangement positions of the at least two function blocks. The arrangement operation may be determined based on a computing functionality of the composite function block needing to be obtained by compositing.

For example, in step S12, the concatenation operation includes joining at least part of input data items and/or at least part of output data items of the at least two function blocks.

In the process of acquiring the concatenation operation of the at least two function blocks, the joining relationship between the at least two function blocks may be determined.

The composite function block is obtained by concatenating and compositing a plurality of function blocks, and a joining way of the plurality of function blocks determines the computing functionality of the constructed composite function block. In other words, an input-output data item (i.e., an input-output parameter) of the composite function block may be generated by the input data items and the output data items of the plurality of function blocks and the joining relationship between the input data items and the output data items of the plurality of function blocks. Based on this principle, the formation process of a large function block (i.e., the composite function block) from small function blocks is realized. This principle may be called as a compositing formation principle.

For example, a basic composition way of a computation (i.e., the function block) is as follows: if a data type attribute of an output data item of one computation and a data type attribute (which will be described subsequently) of an input data item of another computation meet a type matching rule (which will be described subsequently), the two data items (i.e., storages) may be joined by a line to form a composition of two computations. The input-output data item of the new computation (the composite function block) formed by composition may be generated based on the input-output data items of the two computations and the joining relationship of the two computations.

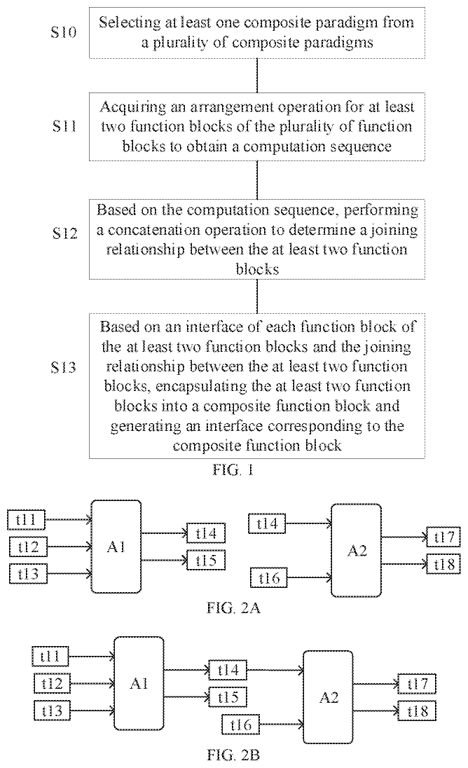

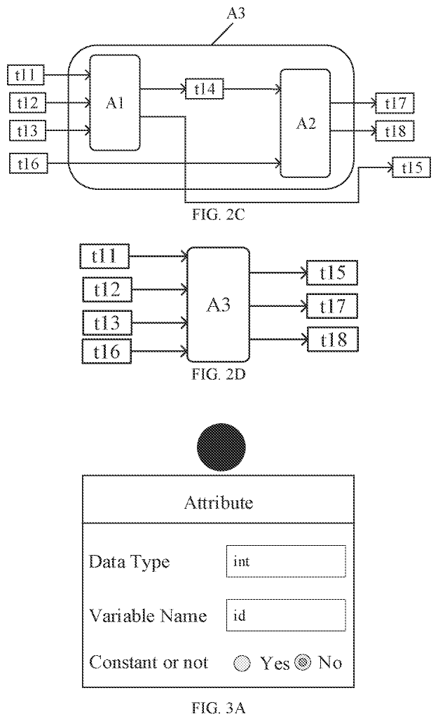

For example, as illustrated in FIG. 2A, computation A1 includes three input data items t11, t12, and t3, and two output data items t14 and t15, and computation A2 includes two input data items t14 and t16, and two output data items t17 and t18. For example, the data type attribute of the output data item t14 of the computation A1 matches the data type attribute of the input data item t14 of the computation A2 (e.g., the data type attribute of the output data item t14 of the computation A1 is identical to the data type attribute of the input data item t14 of the computation A2). Thus, as illustrated in FIG. 2B, the output data item t14 of the computation A1 and the input data item t14 of the computation A2 may be joined by a line, thereby obtaining the new computation A3 formed by composition illustrated in FIG. 2C. For example, as illustrated in FIG. 2C, the new computation A3 may include the computation A1 and the computation A2. Within the new computation A3, the output data item t14 of the computation A1 and the input data item t14 of the computation A2 may be joined to each other by a line, and the input-output data item of the new computation A3 may be generated based on the input-output data items of the computation A1 and the computation A2 and the joining relationship of the computation A1 and the computation A2. As illustrated in FIG. 2D, the computation A3 includes four input data items t11, t12, t13, and t16, and three output data items t15, t17, and 118, and the output data item t14 of the computation A1 and the input data item t14 of the computation A2 are internally joined by a line. Thus, the output data item t14 of the computation A1 and the input data item t14 of the computation A2 are not used as the input-output data item of the computation A3.

For example, in some embodiments, in step S11, the concatenation operation is performed in the following order of steps: compositing the at least two function blocks according to at least one composite paradigm of the plurality of composite paradigms; and joining at least part of input data items and/or at least part of output data items of the at least two function blocks after compositing.

For example, in some other embodiments, in step S11, the concatenation operation is performed in the following order of steps: joining at least part of input data items and/or at least part of output data items of the at least two function blocks; and according to at least one composite paradigm of the plurality of composite paradigms, compositing the at least two function blocks after joining data items.

Based on the at least two function blocks, the computation sequence corresponding to the at least two function blocks may be obtained.

In the embodiments of the present disclosure, the compositing process of function blocks is a circular recursion process. According to the definite and unique line joining rule and in accordance with the type matching rule, composite paradigms for compositing a plurality of function blocks are selected, and by nested use of the composite paradigms, a composite function of various functionalities is finally formed. For example, function blocks are generated in a circular recursion manner, and a data type is a portion of a function block and is also generated in the circular recursion manner.

In the present disclosure, a joining rule of a composition rule for compositing a plurality of function block is as follows: an output data item or a data sub-item of a function block is joined to other input or output data items or data sub-items of the same algorithm type in a one-to-many manner.

For example, in the method provided in the embodiments of the present disclosure, operation ways (i.e., the composite paradigms) on the function block includes 4 ways, i.e., the plurality of composite paradigms include 4 composite paradigms. The operation way on storages follows a data transfer line joining rule which must be followed in the processes of organizing function blocks in the 4 composite paradigms, and all joining lines start from output data items. In the organization process of a function block, in consideration of technical and practical aspects, a practical line joining rule is added. The data transfer line joining rule includes a data transfer joining line. The data transfer joining line is a directed line segment that starts from one data item and ends at another data item. The practical line joining rule includes an auxiliary merging joining line which is an undirected line segment and joins two data items at two ends thereof. The data transfer joining line includes an output-to-output data transfer joining line (also called an output-output joining line for short) and an output-to-input data transfer joining line (also called an output-input joining line for short). The output-output joining line is used for joining at least two output data items, and the output-input joining line is used for joining at least one input data item and at least one output data item. The auxiliary merging joining line represents a line of joining a plurality of input data items. The significance of the auxiliary merging joining line is that input data item storages with the auxiliary merging joining line are externally joined to a same output item by the data transfer joining lines.

The plurality of composite paradigms and line joining rules (the data transfer line joining rule and the practical line joining rule) are together applied to function blocks, thereby realizing construction of a large function block from small function blocks. Four operation ways (i.e., four composite paradigms: a sequential composite paradigm, a conditional composite paradigm (if composite paradigm), a looping composite paradigm (for composite paradigm), and a while looping composite paradigm (while composite paradigm)) on the function block and two operation ways (i.e., data transfer line joining and auxiliary merging line joining) on the storage can be repeatedly nested on the basis of the composition rule to act on the basic function blocks and the constructed composite function blocks. Thus, more composite function blocks can be generated. Function blocks constructed by the composition rule are all called composite function blocks, each represented using symbol PF. The basic function blocks and the composite function blocks all belong to a function block library set.

The composition of functions may be implemented by a graphic operation coupled with a particular language storage data (taking XML for example in the present disclosure), allowing a user to perform visualized operations using graphics, which is simple, convenient, and easy to understand. The composition of functions may also be implemented separately by the XML.

For example, the plurality of composite paradigms include the sequential composite paradigm, the conditional composite paradigm (the if composite paradigm), the looping composite paradigm (the for composite paradigm), and the while looping composite paradigm (the while composite paradigm). These composite paradigms may realize the process of compositing small function blocks into a large function block. The if composite paradigm refers to compositing a true function block and a false function block into a composite function block and forming an input data item and an output data item of the composite function block. The while composite paradigm and the for composite paradigm refer to compositing a conditional function block and a loop body function block (e.g., the loop body function block may be run for a plurality of times) to form a composite function block and forming an input data item and an output data item of the composite function block. The sequential composite paradigm refers to compositing a plurality of function blocks of which a performing order is determined into a composite function block and forming an input data item and an output data item of the composite function block. For example, the frameworks of the sequential composite paradigm, the if composite paradigm, the while composite paradigm, and the for composite paradigm are fixed.

It needs to be noted that the sequential composite paradigm, the if composite paradigm, and the while composite paradigm are basic paradigms, and the for composite paradigm is an additional composite paradigm, so as to facilitate compositing of function blocks.

For example, in step S13, when the at least one composite paradigm is the sequential composite paradigm, the composite function block obtained by composition is a composite function block having a sequential structure. When the at least one composite paradigm is the conditional composite paradigm, the composite function block obtained by composition is a composite function block having a conditional structure (if structure). When the at least one composite paradigm is the looping composite paradigm, the composite function block obtained by composition is a composite function block having a loop structure (for structure). When the at least one composite paradigm is the while looping composite paradigm, the composite function block obtained by composition is a composite function block having a while loop structure (while structure).

For example, in some embodiments, the method provided in the embodiments of the present disclosure further includes: storing the composite function block in the function block library as a function block to expand the function block library. The composite function block obtained by compositing the function blocks in the function block library may be used as a function block to generate a new composite function block. In other words, in the embodiments of the present disclosure, a plurality of function blocks are organized into a corresponding composite function, and then the composite function block obtained by composition may be used for organization of other composite function block to form a new composite function block. The new composite function block may be applied to organization of a composite function block of next layer again. By sequential organization and nesting layer by layer, a composite function block with a corresponding functionality may be finally realized. Thus, the final software design may be realized.

Each composite paradigm includes three portions: a paradigm composition area, a large function interface area, and a relationship area of a large function interface type and a small function interface type. The data types of data items of an interface of a large function are a subset of a set formed by the data types of all data items in the paradigm composition area and/or data types obtained by breaking apart and recompositing the data types of all the data items in the paradigm composition area. The data type/interface does not exist independently and does not need to be designed independently, and is generated by the composite paradigm to achieve the integration of storage and computation. The paradigm composition area further includes a small function block area and a compositing action area. The small function block area is formed by an interface of at least one function block selected by the user from the function block library, and the compositing action area records a concatenation action by the user on function blocks in the small function block area. The large function interface area is automatically generated after the completion of the composite paradigm in the paradigm composition area and includes an input portion and an output portion. The data items of the input portion are a subset of a set formed by all input data items in the small function block area and/or data items obtained by breaking apart and recompositing all the input data items in the small function block area, and the data items of the output portion are a subset of a set formed by all output data items in the small function block area and/or data items obtained by breaking apart and recompositing all the output data items in the small function block area. The large function interface areas generated by all the composite paradigms follow a same function interface specification. The relationship area of the large function interface type and the small function interface type records a data item relationship between function interfaces of the large function interface area and the small function block area generated by the composite paradigm. The relationship area of the large function interface type and the small function interface type is also automatically generated after the completion of the composite paradigm in the paradigm composition area.

When programming an algorithm in the prior art, the entire algorithm is designed generally from the top down. Firstly, an interface portion of the algorithm is designed and each data item is defined with a variable name, algorithm statements are then written within the algorithm. A statement cites the defined variable to represent a computation on the variable. During writing, a reference relationship between an algorithm process and an algorithm interface is confirmed repeatedly. In the writing process of the algorithm, generally, a local variable in the algorithm is generated simultaneously, and relationships between an algorithm statement and the local variable and between the local variable and the interface defining variable are confirmed repeatedly during writing. The whole process is completely operated manually. The process of designing an algorithm from the top down in the present disclosure involves manually selecting a composite paradigm, selecting a storage-computation integrated function block, and concatenating and joining function blocks by a line. At the same time of completing an algorithm logic, a function interface and a relationship between the function interface and a data item of an internal function block are generated automatically with no need to manually write and confirm a local variable, an interface variable, and a relationship between each variable and the algorithm.

For example, each function block of a plurality of function blocks has a corresponding computing functionality. The method provided in the embodiments of the present disclosure further includes: determining the computing functionality of the composite function block based on the computing functionalities and the joining relationship of the at least two function blocks.

For example, each basic function block of the plurality of basic function blocks has a corresponding computing functionality, and the computing functionality of each of the plurality of composite function blocks is determined based on the computing functionality and the joining relationship of the at least one basic function block and/or the at least one composite function block. That is, in the present disclosure, the computing functionality of each of the plurality of composite function blocks may be determined based on the computing functionalities and the joining relationship of a plurality of function blocks forming the composite function block. In other words, in the present disclosure, a relationship between the input (the input portion of the interface of the composite function block) and the output (the output portion of the interface of the composite function block) of the formed composite algorithm (composite function block) may be obtained according to known algorithms (the computing functionalities of at least two function blocks) and an interacting relationship between the known algorithms (the joining relationship of the at least two function blocks). It needs to be noted that a plurality of function blocks in the same computation sequence may be joined differently to express different computing functionalities.

For example, in the embodiments of the present disclosure, the process of compositing a composite function block having a corresponding computing functionality includes: according to a requirement of the corresponding computing functionality, determining function blocks and a composite paradigm required for realizing the corresponding computing functionality, and then selecting a plurality of function blocks required from the functional block library, where the plurality of function blocks may include basic function blocks, or may include composite function blocks. Then, based on the corresponding computing functionality and the composite paradigm, the performing order, the arrangement positions, and the like of the selected plurality of function blocks may be determined, i.e., the plurality of function blocks are composited to obtain a computation sequence corresponding to the plurality of function blocks. Subsequently, a concatenation and line joining operation is performed on the computation sequence to obtain an intermediate composite function block. Whether the intermediate composite function block realizes the corresponding computing functionality is judged, and in response to the intermediate composite function block realizing the corresponding computing functionality, the intermediate composite function block is regarded as a composite function block corresponding to the corresponding computing functionality. In response to that the intermediate composite function block cannot realize the corresponding computing functionality, function blocks are continuously selected from the function block library until the intermediate composite function block obtained by composition can realize the corresponding computing functionality, and the intermediate composite function block is regarded as a composite function block to be designed with a functionality. Thus, the composite function block for realizing the computing functionality is obtained. The composite function block may be stored in the function block library for subsequent compositing. Repeated in this way, there may be an increasing number of function blocks for realizing particular algorithm functionalities. When the function blocks included among the function blocks to be composited exist in the function block library, the corresponding function blocks can be directly used for compositing.

For example, each function block (the basic function block and the composite function block) of the plurality of function blocks may be presented in form of graphic, the graphic may present the function block for the user simply, conveniently, and intuitively. At the background of a computer, the graphic corresponds to a symbolic language. In other words, in the present disclosure, each function block may a have two-dimensional representation, i.e., two formalized forms: graphic and corresponding symbolic language, thereby enriching the representation of the function block, and the visualized operation may be realized based on the graphic representation. Both of the two representations can represent the syntax and the programming process of a function block independently and completely. The user can perform a visualized operation by a graphic corresponding to a function block, which is simple, convenient, and easy to understand. Alternatively, the user may also edit a symbolic language corresponding to a function block, thereby realizing an operation on the function block.

For example, in the present disclosure, each data item (input data item and output data item) may also have two representations: graphic and symbolic language.

For example, in some embodiments, the symbolic language includes the extensible markup language (XML) and JavaScript Object Notation (JSON). The following description of the present disclosure is made by taking for example that each function block is described by XML and JSON, but the present disclosure includes but is not limited thereto.

Moreover, in the embodiments of the present disclosure, the function block and/or each storage (the input data item and the output data item, etc,) of the function block may be named (applied with names), and this behavior may be referred to as specifying. These names are not involved in the organization behavior of the function block and are merely used as annotations, thereby improving the readability of the function block and the input data item and the output data item thereof. If the composite function block obtained by composition is compiled into a high-level language, some names will become variable names. If the composite function block obtained by composition is compiled into a machine code, these names are not used. Moreover, the symbolic representation of the composite function block is used for storing a result of a visualized design and provides an input for a compiler. The user may not need to operate the symbolic representation of a composite language.

For example, for each function block of the plurality of function blocks, the interface corresponding to the function block includes an input portion and an output portion; the input portion of the interface corresponding to the function block corresponds to at least one input data item of the function block, and the output portion of the interface corresponding to the function block corresponds to at least one output data item of the function block. In other words, in the embodiments of the present disclosure, each function block corresponds to one interface, and the interface includes an input portion that corresponds to at least one input data item and an output portion that corresponds to at least one output data item. In some embodiments, the input data items in the input portion of each interface may be composited into an input data item of a composite data type, and the output data items in the output portion of each interface may be composited into an output data item of the composite data type.

For example, each of the at least one input data item and the at least one output data item include a data type attribute, a data class attribute, a storage type attribute, a value attribute, a physical address attribute, a relative address attribute, a name attribute, and the like.

It needs to be noted that in the present disclosure, the input data item and the output data item may be collectively called a data item. According to a location of the data item, the data item may be an input data item or an output data item. For example, if one data item is located in the input portion of an interface corresponding to a function block, the data item is the input data item; and if one data item is located in the output portion of the interface corresponding to the function block, the data item is the output data item. For example, in the present disclosure, the data items have a storage functionality.

For example, the name attribute (id attribute) is used for annotating a data item corresponding to the name attribute and is not involved in the concatenation operation on a function block to which the data item corresponding to the name attribute belongs. The technical solution provided in the present disclosure may realize an abstract algorithm design. That is, the compositing process of function blocks provided in the present disclosure does not involve a variable name and is an abstract algorithm representation and design, which is a common algorithm representation and design way for all different applications. Thus, algorithm sharing between different applications is realized. The embodying of an application lies in the id attribute of a data item. A value of the id attribute may be an application name, thereby facilitating describing an algorithm in the concept of the application, but the id attribute is not involved in the design and running of the algorithm and just serves as an annotation. If the extensible markup language corresponding to each function block needs to be compiled as a traditional high-level language, the name attribute is compiled as a variable name in the high-level language. The relative address of the data item is automatically processed by the algorithm.

For example, the physical address attribute (name attribute) is used for representing the physical address of the data item when an algorithm (an algorithm determined based on a function block) actually runs.

For example, the relative address attribute is used for representing a sequentially encoded value of a data item and may be automatically computed by the algorithm. In the XML representation of the data item, the relative address attribute may not be embodied.

For example, the data class attribute includes a basic data type, a composite data type, a pointer type, and a generic type. The composite data type includes a basic composite data type, an Exclusive OR type, an array type, and the like. The pointer type includes a generic pointer type and a non-generic pointer type. A data item of the pointer type does not have a data item with specific pointing, i.e., the pointing of the data item of the pointer type is null. A data item of the non-generic pointer type has a data item with specific pointing. The data type attribute refers to a type of a data item, and the storage type attribute includes a virtual storage and a real storage. For example, in some embodiments, in an XML architecture, the storage type attribute may be represented as memory. When memory is 1, it represents the real storage. When memory is 0, it represents the virtual storage. Memory is 1 by default; and memory may be decided by the concatenation action. For example, in some embodiments, in graphics, if the storage type attribute of a data item is the real storage, the circle representing the data item is a solid circle; and if the storage type attribute of the data item is the virtual storage, the circle representing the data item is a hollow circle. It needs to be noted that in graphics, the present disclosure is not limited to representing a data item using a circle, and a data item may also be represented using a rectangle, a rhombus, and the like. In the description of the present disclosure, the embodiments of the present disclosure are described by taking for example that a data item is represented using a circle in graphics.

It needs to be noted that in the following description, for ease of description, if the data class attribute of a data item is the composite data type, the data item may be referred to as a composite data item; if the data class attribute of a data item is the basic data type, the data item may be referred to as a basic data item; if the data class attribute of a data item is the pointer type, the data item may be referred to as a pointer data item; and if the data class attribute of a data item is the generic type, the data item may be referred to as a generic data item.

For example, for a data item whose data class attribute is the composite data type (the data item may be an input data item or an output data item), the data item of the composite data type includes a plurality of data items whose data class attribute is the basic data type, or includes a plurality of data items whose data class attribute is the composite data type, or includes a plurality of data items whose data class attribute is the pointer type, or includes a plurality of data items whose data class attribute is the generic type, or data class attributes of data items included in the data item of the composite data type are at least two of the following data class attributes: the basic data type, the composite data type, the pointer type, and the generic type. In other words, the data item of the composite data type is formed by compositing data items of one or more basic data types and/or data items of one or more composite data types or data items of one or more pointer types and/or data items of one or more generic types.

For example, structure formats of a data item whose data class attribute is the basic data type, a data item whose data class attribute is the composite data type, a data item whose data class attribute is the pointer type, and a data item whose data class attribute is the generic type are identical and normative. A structure of the data item whose data class attribute is the composite data type is a nested structure, and structure formats of data items of each layer of the nested structure are identical.

For example, the basic data type includes but is not limited to a byte data type (byte), a short integer type (short), an integer type (int), a long integer type (long), a single-precision floating-point type (float), a double-precision floating-point type (double), a boolean type (boolean), a character type (char), a string type (string). It needs to be noted that the basic data type is not limited to the above data types. The basic data types of the high-level language may be selected, or only bits (0 and 1) may be selected, and so on. For convenience, the basic data types corresponding to the high-level language may be selected. It needs to be noted that the basic data type may further include a constant type, and a data item of the constant type has a specific constant value.

In addition to the basic data types, there also exist the pointer type (ref) and the generic type (*). A data item of the pointer type represents a physical address of a storage in actual running. A data item of the generic type represents an uncertain data type, which may represent any data type.

The representation of the data item storage may be in a plurality of forms, such as XML, JSON, or any format of a particular rule, and specific representations are as follows:

For example, the XML representation of a particular data item (an input data item or an output data item) may be as illustrated below: <type id=“ ” name=“ ” value=“ ” typeclass=“ ” typevalue=“ ” typeid=“ ”memory=“ ”/>.

In the above representation, id represents an annotation name (i.e., a specific name) of the data item, which indicates the meaning of the data item in a data structure corresponding to the data item, may be specifically named by the user, and is not involved in the organization and computation of a function block; name is used for representing the physical address of the data item during actual running of an algorithm (the algorithm determined based on the function block), and a relative location of the data item is determined by an XML structure; value represents the value attribute of the data item, and the value of a data item of the composite data type is determined jointly by the values of data items within the data item of the composite data type; typeclass represents the data class attribute of the data item; typevalue represents the data type attribute, namely an actual data type of the data item, e.g., the basic data type such as int and char, or the composite data type such as int2; typeid represents a user defined data type name. In other words, in the present disclosure, the user may define some data types. In some embodiments, typeid and typevalue may be identical. Memory represents a storage type of the data item; when the value of memory is 0, it represents that the data item is the virtual storage; and when the value of memory is 1, it represents that the data item is the real storage. For example, typeclass may be represented using a numeral; when typeclass is 0, it represents the basic data type; when typeclass is 1, it represents the basic composite data type; when typeclass is 2, it represents that the data structure is of the array type; when typeclass is 3, it represents the Exclusive OR type; when typeclass is 4, it represents the pointer type ref; and when typeclass is 5, it represents the generic type. It needs to be noted that the basic composite data type, the array type, and the Exclusive OR type are all composite data types. A data item of the basic composite data type may be composed of data items of the basic data type, the pointer type, and the generic type. For example, a data item int2 is obtained by compositing two data items of the int type, and the type of the data item int2 is the basic composite data type. For example, a data item charref is obtained by compositing a data item of the char type and a data item of a pointer type, and the type of the data item charref is the basic composite data type. The pointer type ref and the generic type are neither the basic data type nor the composite data type.

Only id, typeid, and the value of a data item of the basic data type may be set by the user. Therefore, only the three attributes (i.e., id, typeid, and value of a data item of the basic data type) are provided for setting a related graphic representation, allowing the user to modify or set the above three attributes in the graphic representation.

For example, the XML architectures of data items of some basic data types are illustrated below:

```
  <type id=“” name=“” value=“” typeclass=“0” typevalue=“byte” typeid=“byte”/>
  <type id=“” name=“” value=“” typeclass=“0” typevalue=“short” typeid=“short” />
  <type id=“” name=“” value=“” typeclass=“0” typevalue=“int” typeid=“int” />
  <type id=“” name=“” value=“” typeclass=“0” typevalue=“long” typeid=“long” />
  <type id=“” name=“” value=“” typeclass=“0” typevalue=“float” typeid=“float”/>
  <type id=“” name=“” value=“” typeclass=“0” typevalue=“double” typeid=“double”
/>
  <type id=“” name=“” value=“” typeclass=“0” typevalue=“boolean”
typeid=“boolean”/>
  <type id=“” name=“” value=“” typeclass=“0” typevalue=“char” typeid=“char”/>
  <type id=“” name=“” value=“” typeclass=“0” typevalue=“string” typeid=“string”/>
  For example, the XML architectures of data items of the pointer type and the
generic type are illustrated below:
  <type id=“” name=“” value=“” typeclass=“4” typevalue=“ref” typeid=“ref”/>
  <type id=“” name=“” value=“” typeclass=“5” typevalue=“*” typeid=“*”/>
```

For example, if a data item of the pointer type points to a data item, typevalue of the data item of the pointer type is symbol “&” coupled with the data type of a data item to which the data item of the pointer type points. For example, for a pointer pointing to a data item of the int 2 type, typevalue of the pointer data item is &int2. If a data item of the pointer type does not point to any data item, the data item of the pointer type is a data item of the generic pointer type, and the internal structure of the data item of the generic pointer type is null and does not include any other data description. If the data type of a data item is the pointer type and the data item points to other data items, the data item of the pointer type is a data item of the non-generic pointer type, and the data item of the non-generic pointer type includes the description of other data items therein, where the other data items may be of the basic data type, the basic composite data type, the array type, and the Exclusive OR type. For example, if a data item that a particular data item of the pointer type points to is a data item of the integer type, the data item of the pointer type is a data item of the non-generic pointer type, and the XML description of the data item of the non-generic pointer type is as follows:

<type id=“” name=“” value=“” typeclass=“4” typevalue=“&int” typeid=“ref”>
<type id=“” name=“” value=“” typeclass=“0” typevalue=“int” typeid=“int”/>
</type>

For example, data items of the basic data type, the pointer type, and the generic type may be composited into a data item of the composite data type. The data item of the composite data type may be further composited with another data item (a data item of the composite data type, a data item of the basic data type, a data item of the pointer type, or a data item of the generic type) to obtain a new data item of the composite data type. For example, in the embodiments of the present disclosure, a data item of the basic data type has a basic data structure, and a data item of the composite data type has a composite data structure. In other words, the data structure of the data item of the composite data type is referred to as the composite data structure, and the data structure of the data item of the basic data type is referred to as the basic data structure. A data item of the generic pointer type and a data item of the generic type (i.e., its data class attribute is the generic type) have a data structure consistent with the basic data structure, and a data type of the non-generic pointer type has a data structure consistent with the composite data structure.

The JSON representation of a data item is illustrated as follows:

```
{
  “id”:“”,
  “name”:“”,
  “value”:“”,
  “typeclass”:“”,
  “typevalue”:“”,
  “typeid”:“”,
  “memory”:“”
}
```

The attribute represented by label is identical to the XML format. For example, in the JSON representation, “name” is used for representing the physical address attribute of the data item when an algorithm (an algorithm determined based on a function block) actually runs. The relative address attribute of the data item in the data structure corresponding to the data item may be automatically computed by the algorithm and may not be embodied in the JSON representation of the data item.

Other format representations of a data item with particular rules are, for example, as follows:
<“ ”,“ ”,“ ”,“ ”,“ ”,“ ”,“ ”/>

It is specified that 7 attribute values in angle brackets < > are arranged in sequence, representing corresponding values of id, name, value, typeclass, typevalue, typeid, and memory in XML in sequence.

The format representations of the data item and all new concepts appearing thereafter have a plurality of representations. The XML representation is used in the present embodiment, but the present disclosure is not limited thereto.

If a data item is of the non-generic pointer type, i.e., typeclass=4 and other data items are included therein, an expanding action may be performed on the data item. The expanding action has no influence on the data type attribute and the data class attribute of the data item and the data item included therein. If a data item included in a pointer data item is also a data item of the composite data type (the basic composite data type, the Exclusive OR type, the array type) or the non-generic pointer type, the expanding action may be continuously applied to the data item included therein until the type of the data item meets the type matching rule or the data item is of the basic data type, the generic pointer type, or the generic type.

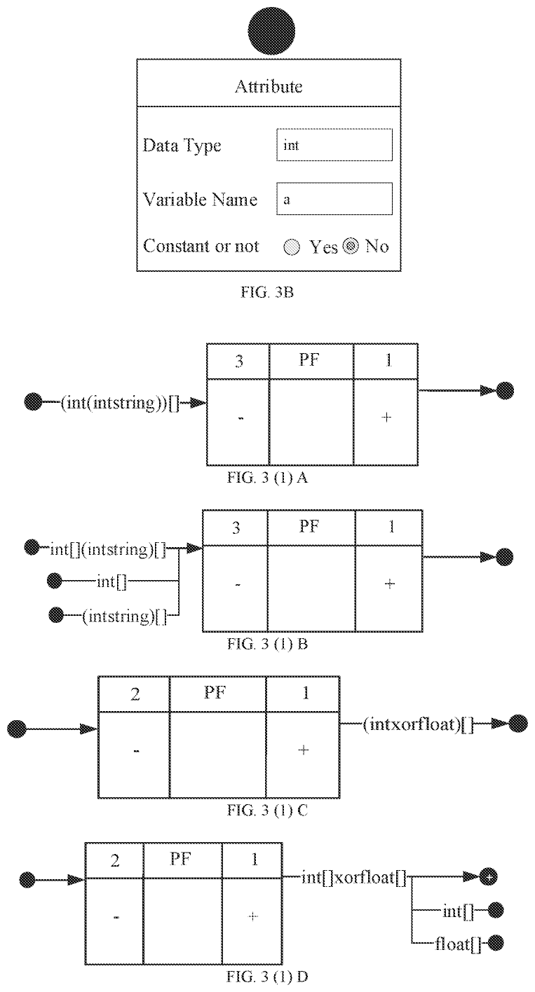

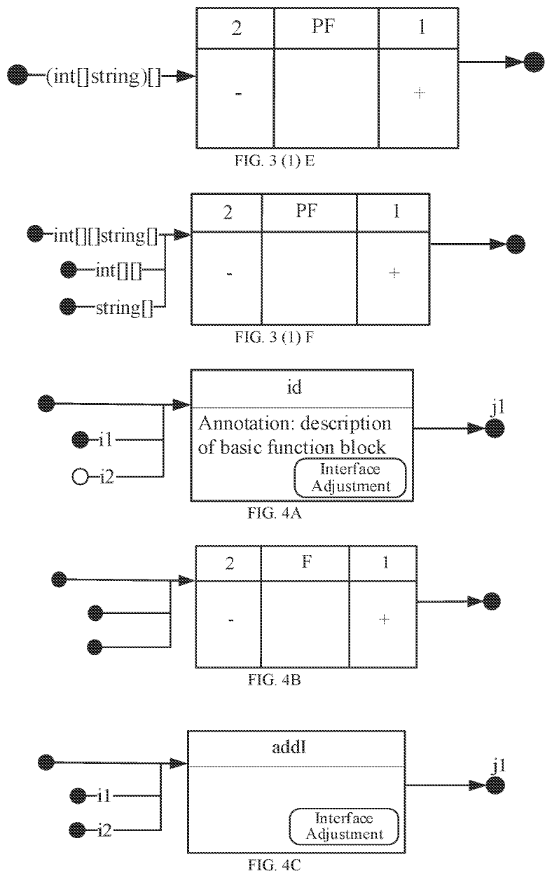

FIG. 3A is a schematic diagram illustrating a graphic representation of a data item provided in some embodiments of the present disclosure; and FIG. 3B is a schematic diagram illustrating a graphic representation of a data item of an integer type provided in some embodiments of the present disclosure.

For example, FIG. 3A illustrates the graphic representation of a data item id. As illustrated in FIG. 3A, a solid circle may represent a data item of the basic data type, namely a storage. The variable name id represents the annotation name of the data item. The attribute of the data item may include the data type attribute, whether it is a constant or not (the value of the constant data is a determined value and cannot be modified in subsequent operation; and if it is a constant, a constant value attribute exists), and the like.

For example, in some examples, FIG. 3B illustrates the graphic representation of data item a of the int type, and the XML architecture representation of the data item a is as follows:
<type id=“a” name=“ ” value=“ ” typeclass=“0”typevalue=“int” typeid=“int”/>

The JSON representation of the data item a is as follows:

```
{
  “id”:“a”,
  “name”:“”,
  “value”:“”,
  “typeclass”:“0”,
  “typevalue”:“int”,
  “typeid”:“int”,
  “memory”:“”
}
```

For example, the XML architecture representation of the constant data item a is as follows:
<type id=“a” name=“ ” value=“1” typeclass=“0”typevalue=“int” typeid=“int”/>

where value=1, representing that the value of the constant data item a is 1.

For example, in the graphic representation, a non-constant data item may be represented by using a blue solid circle, and a constant data item may be represented by using a yellow solid circle.

Other representation of the constant data item a may be as follows:
<“a”,“ ”,“1”,“0”,“int”,“int”,“ ”/>

For example, two data items of the int type are IdName1 and IdName2. The data items of the int type are composited to obtain a composite data item int2, and the XML architecture representation of the composited data item int2 is as follows (it needs to be noted that, a data item of the int2 type only exists in a basic function block):

```
  <type id=“int2” name=“” value=“” typeclass=“1” typevalue=“int2” typeid=“int2”>
  <type id=“IdName1” name=“” value=“” typeclass=“0” typevalue=“int”
typeid=“int”/>
  <type id=“IdName2” name=“” value= “” typeclass=“0” typevalue=“int”
typeid=“int”/>
  </type>
```

For example, input-output data items formed according to a composition rule in the compositing process of function blocks are of the composite data type in addition to the basic data type, the pointer type, and the generic type. Data item of the composite data type (i.e., composite data item) is an ordered set of the input-output data items in the interface of the composite function block, and can be expanded in the composite function block to the data items of the basic data type, the generic pointer type, and the generic type.

For example, the composite data item is a data item (input data item and output data item) formed according to the composition rule in the compositing process of function blocks. The composite data item may represent an ordered set of input data items and an ordered set of output data items in the interface of the composite function block.

For example, in some examples, the XML e representation of a data item of the composite data type (i.e., a composite data item) is as follows:

```
  <type id=“(int2)int” name=“” value=“” typeclass=“1” typevalue=“(int2)int”
typeid=“(int2)int”>
  <type id=“int2” name=“” value=“” typeclass=“1” typevalue=“int2” typeid=“int2”>
  <type id=“11” name=“” value=“” typeclass=“0” typevalue=“int” typeid=“int” />
  <type id=“12” name=“” value=“” typeclass=“0” typevalue=“int” typeid=“int” />
  </type>
  <type id=“21” name=“” value=“” typeclass=“0” typevalue=“int” typeid=“int” />
  </type>
```

For example, the nested structure of the composite data item is capable of representing a relative location of the composite data item in the data structure. A generation rule for a relative location of a data item includes: in the data structure at a same layer, the value of the relative location is encoded from 0 and progressive increases in the order of integers. For example, in the above XML, for data item (int2)int of the composite data type, data item int2 and data item 21 are two data items in the data structure at the same layer of data item (int2)int. Data item int2 of which the data type attribute is int2 is a first data item in the data structure of composite data item (int2)int, and therefore, the value of the relative location of data item int2 is 0. Data item 21 is a second data item in the data structure of composite data item (int2)int, and therefore, the value of the relative location of data item 21 is 1. For data item int2, data item 11 is a first data item of data item int2, and a value of the relative location of data 11 is 0. Data item 12 is a second data item of data item int2, and the value of the relative location of data item 12 is 1, and so on. An encoding rule for the relative location of the data structure of each layer is identical. A relative location does not need to be described using an attribute symbol, is determined by the structure of a data item, and may be automatically computed and acquired by an algorithm according to a relative location encoding rule.

For example, positioning of a data item includes: for positioning of data item x, starting from the outermost layer of the composite data structure of the composite data item in which the data item resides, and expressing using a value of a relative location coupled with “.” along the path of data item x in the composite data structure. For example, in the above XML, the positioning of data item 12 starts from data item (int2)int of the outermost layer, and traversal is performed along a path from data item (int2)int to data item int2 and a value of a relative location is used, thereby obtaining that a relative path of data item 12 in the data structure is 0.0.1, where the first 0 in the relative path 0.0.1 represents the value of the relative location of data item (int2)int, the second 0 in the relative path 0.0.1 represents the value of the relative location of data item int2, and 1 in the relative path 0.0.1 represents the value of the relative location of data item 12. Similarly, a relative path of data item int2 is 0.1; and a relative path of data item (int2)int is 0. It needs to be noted that because data item 11 and data item 12 are data items at a same layer, the value of the relative location of data item 11 is not included in the relative path of data item 12.

For example, the representation of the value of typevalue in a composite data item may be omitted. When the typevalue attribute is used, a naming rule for typevalue (i.e., a type label) in a data item of the basic composite data type includes: for a data item of the composite data structure in a basic function block, the typevalue of the data item is composed of the basic data type, the pointer type, and the generic type included within the data item. The representation of the typevalue of the data item is: (basic data type, pointer type, generic type)+quantity. For example, the input portion of the interface of an addition function block of the int type is composed of two input data items of the int type, i.e., the data type attribute of the composite data item obtained by composition is represented as int2. For example, the XML representation of the input portion is as follows:

<type id=“” name=“” value=“” typeclass=“1” typevalue=“int2” typeid=“int2”>
<type id=“” name=“” value=“” typeclass=“0” typevalue=“int” typeid=“int” />
“type id=“” name=“” value=“” typeclass=“0” typevalue=“int” typeid=“int” />
</type>

For example, the naming rule for typevalue in a data item of the basic composite data type further includes: for a data item of the composite data structure in a composite function block, the typevalue of the data item is composed of the composite data type or the basic data type or the pointer type or the generic type included within the data item. The representation of the typevalue of the data item is: basic data type/pointer type/generic type 1+(composite data type 1)+ . . . , where ( ) represents the composite data type.

For example, the XML representation of data item T of the composite data structure is as follows:

<type id=“” name=“” value=“” typeclass=“” typevalue=“T” typeid=“”>
<type id=“” name=“” value=“” typeclass=“” typevalue=“t1” typeid=“” />
<type id=“” name=“” value=“” typeclass=“” typevalue=“2” typeid=“” /> ......
<type id=“” name=“” value=“” typeclass=“” typevalue=“tn” typeid=“” />
</type>

As illustrated in the above XML, assuming that data item T of the basic composite data structure is composed of data type attributes t1, t2, . . . , tn, the actual data type attribute of data item T is t1t2 . . . tn. For 1≤k≤n, if tk is the composite data type or the non-generic pointer type, in naming of the actual data type attribute of data item T, tk is replaced by the data type attribute of an internal data item thereof and bracketed, and sequential recursion is performed according to this rule until the data item is a data item of the basic data type, the generic pointer type, or the generic type.

For example, the XML representation of the input portion of the interface corresponding to a composite function block representing function (a>b)&&c is as follows:

```
  <type id=“” name=“” value=“” typeclass=“1” typevalue=“(int2)(boolean2)”
typeid=“(int2)(boolean2)”>
  <type id=“” name=“” value=“” typeclass=“1” typevalue=“int2” typeid=“int2”>
  <type id=“” name=“” value=“” typeclass=“0” typevalue=“int” typeid=“int” />
  <type id=“” name=“” value=“” typeclass=“0” typevalue=“int” typeid=“int” />
  </type>
  <type id=“” name=“” value=“” typeclass=“1” typevalue=“boolean2”
typeid=“boolean2”>
  <type id=“” name=“” value=“” typeclass=“0” typevalue=“boolean”
typeid=“boolean” />
  <type id=“”# name=“” value=“” typeclass=“0” typevalue=“boolean”
typeid=“boolean” />
  </type>
  </type>
```

With reference to the above XML, the composite function block includes a basic function block of a relational expression and a basic function block of a logical expression. The representation of the typevalue of data item (int2)(boolean2) of the composite data type corresponding to the input portion is (int2)(boolean2). Data item (int2)(boolean2) is composed of two data items int2 and boolean2 of the composite data type, where data item int 2 is composed of two data items of the basic data type (int) and data item boolean2 is composed of two data items of the basic data type (boolean). It needs to be noted that if one data item boolean of data item boolean2 is not extracted as the input portion of the interface after the line joining processing, data item boolean2 is broken apart, and a data item, not extracted as the input portion of the interface, of data item boolean2 is not embodied at the interface, and a data item, extracted as the input portion of the interface, of data item boolean2 is composited with data item int2 to obtain the input portion. In this case, the representation of the typevalue of the data item of the composite data type corresponding to the input portion is (int2)boolean.

For example, the concatenation operation further includes a data expanding rule, a type matching rule, and a line joining requirement rule, which corresponds to a data item expanding action and a line joining action (i.e., line joining operation). That is, based on the data item expanding rule, the expanding action may be performed on a data item, and based on the type matching rule and/or the line joining requirement rule, the line joining action may be performed on data items. If the data class attribute of a data item is the basic composite data type, i.e., typeclass=1, the expanding action may be performed on the data item. The expanding action has no influence on the data type attributes and the data class attributes of the data item and the data items included therein. If a data item included in a composite data item is also a data item of the composite data type (the basic composite data type, the Exclusive OR type, the array type) or the non-generic pointer type, the expanding action may be continuously applied to the data item included therein until the type of the data item meets the type matching rule or the data item is of the basic data type, the generic pointer type, or the generic type.

It is assumed that data item d is composed of n data items d1, d2, . . . , dn, and the data classes of n data items are tc1, tc2, . . . , tcn, and the types of the n data items are t1, t2, . . . , tn, where n>1, and the data item d is a data item of the basic composite data type. It is assumed that data item s is composed of m data items s1, s2, . . . , sm, and the data classes of m data items are tcf1, tcf2, . . . , tcfm, and the types of the n data items are tf1, tf2, . . . , tfm, where m>1. The data item d and the data item s are then composited in the Exclusive OR manner to form a composite data item of the Exclusive OR type. The typeclass of the composite data item of the Exclusive OR type is 3. The typevalue of the composite data item of the Exclusive OR type is formed by joining the typevalue of the data item d and the typevalue of the data item s using symbol xor. The composite data item of the Exclusive OR type internally includes the data item d and the data item s, and the XML description corresponding to the composite data item of the Exclusive OR type is as follows:

```
  <type id=“” name=“” value=“” typeclass=“3” typevalue=“t1t2...tnxortfltf2...tfm”
typeid=“”>
  <type id=“d” name=“” value=“” typeclass=“1” typevalue=“t1t2...tn” typeid=“”>
  <type id=“” name=“” value=“” typeclass=“tc1” typevalue=“t1” typeid=“”/>
  <type id=“” name=“” value=“” typeclass=“tc2” typevalue=“t2” typeid=“”/>
    ......
  <type id=“” name=“” value=“” typeclass=“ton” typevalue=“tn” typeid=“”/>
  </type>
  <type id=“s” name=“” value=“” typeclass=“1” typevalue=“tfltf2 ... tfm” typeid=“”>
  <type id=“” name=“” value=“” typeclass=“tcf1” typevalue=“tf1” typeid=“”/>
  <type id=“” name=“” value=“” typeclass=“tcf2” typevalue=“tf2” typeid=“”/>
    ......
  <type id=“” name=“” value=“” typeclass=“tcfm” typevalue=“tfm” typeid=“”>
  </type>
  </type>
```

The data item d and the data item s in the composite data item of the Exclusive OR type may be of the basic data type, the basic composite data type, the Exclusive OR type, the array type, the pointer type, the generic type, or the like. It needs to be noted that a data item of the Exclusive OR type has an Exclusive OR structure. The value of the typevalue of the data item of the Exclusive OR type may be omitted from the representation and may be automatically computed by an algorithm.

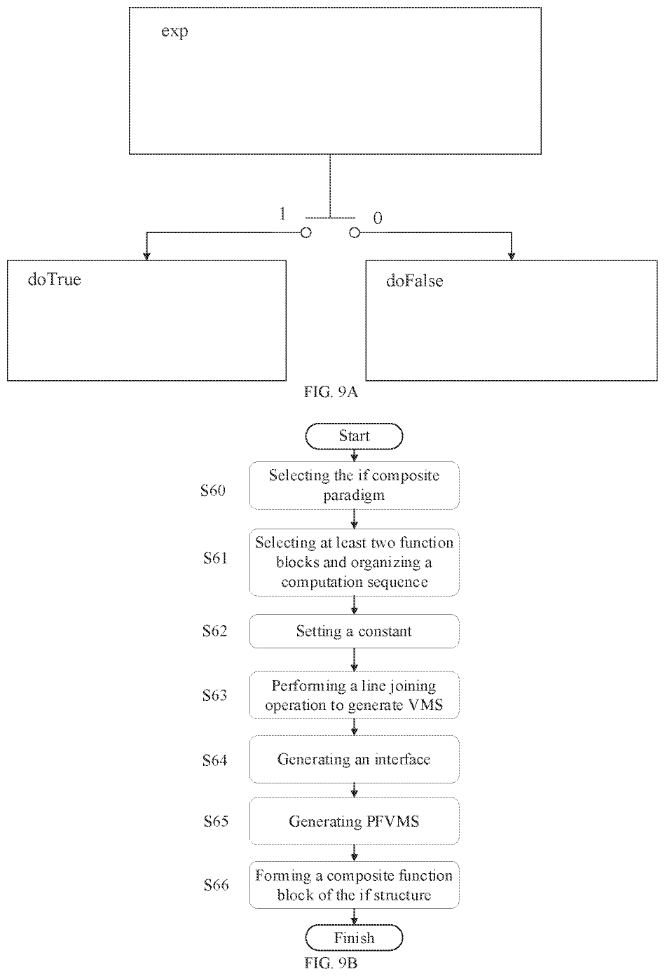

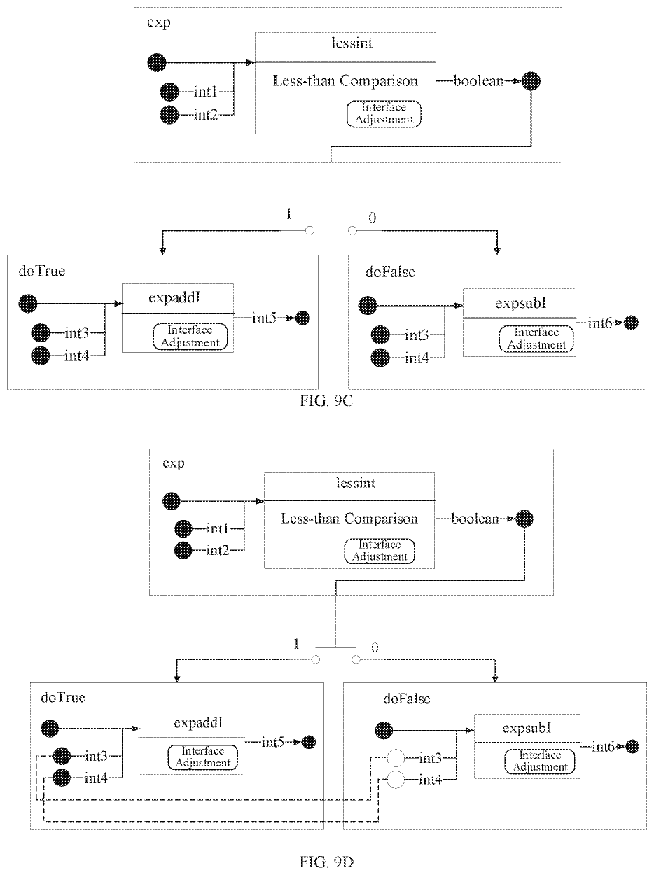

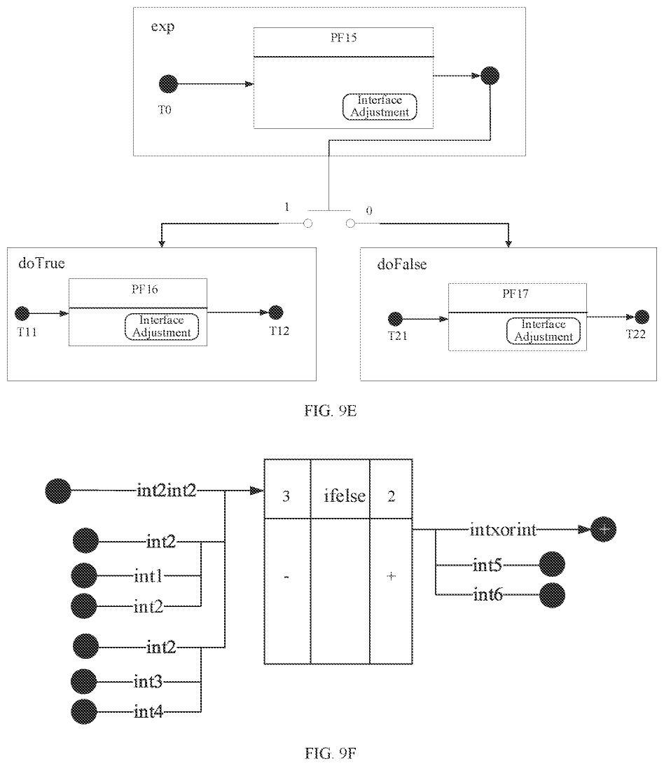

The graphical representation of a composite data item of the Exclusive OR type may be a solid circle (e.g., blue) with symbol ‘+’ therein (e.g., as illustrated in FIG. 9F). For example, a composite data item of the Exclusive OR type is formed by data item T1 and data item T2 in the Exclusive OR way, and the XML representation of the composite data item of the Exclusive OR type is as follows:

<type id=“” name=“” value=“” typeclass=“3” typevalue=“T1xorT2” typeid=“”>
<type id=“” name=“” value=“” typeclass=“” typevalue=“T1” typeid=“” />
<type id=“” name=“” value=“” typeclass=“” typevalue=“T2” typeid=“” />
</type>

The JSON representation of the composite data item of the Exclusive OR type is as follows:

```
{
“id”: “”,
“name”: “”.
“value”: “”,
“typeclass”: “3”,
“typevalue”: “T1xorT2”,
“typeid”: “”,
“memory”: “”,
“children”: [{
“id”: “”,
“name”: “”,
“value”: “”,
“typeclass”: “”,
“typevalue”: “T1”,
“typeid”: “”,
“memory”: “”
  }, {
“id”: “”,
“name”: “”,
“value”: “#
“typeclass”: “”,
“typevalue”: “T2”,
“typeid”: “”,
“memory”: “”
  }]
}
```

For a composite data item of the Exclusive OR type, i.e., typeclass=3, the expanding action may be performed on the composite data item of the Exclusive OR type. The expanding action has no influence on the data type attributes and the data class attributes of the composite data item of the Exclusive OR type and the data items included therein. If a data item included in a composite data item of the Exclusive OR type is also a data item of the composite data type (the basic composite data type, the Exclusive OR type, the array type) or the non-generic pointer type, the expanding action may be continuously applied to the data item included therein until the type of the data item meets the type matching rule or the data item is of the basic data type, the generic pointer type, or the generic type.

For example, array data item a is a data item internally including n data items of T type, where n may be any constant, or may be a variable, and T type may be the basic data type, the basic composite data type, the Exclusive OR type, the array type, the pointer type, or the generic type. To provide a simplified representation of the n data items of T type, it is sufficient to give a description of only one data item. The data type attribute of array data item a is T[ ], and the data class attribute is 2. The XML representation of the array data item of T[ ] type is as follows:

```
  <type id=“a” name=“” value=“” typeclass=“2” typevalue=“T[ ]” typeid=“”>
  <type id=“” name=“” value=“” typeclass=“0, 1, 2, 3, 4 or 5” typevalue=“T”
typeid=“”/>
  </type>
```

The value of the typevalue of a data item of the array type may be omitted from the representation and may be automatically computed by an algorithm.

The expanding action is allowed to be performed on an array data item of the composite data type, and the expanding action has influence on the data type attributes and the data class attributes of the array data item and the data items included therein. The operation process of the expanding action is as follows: if an array data item included in an expanded data item is also an array data item of the composite data type, the expanding action may be continuously applied to the array data item of the composite data type included therein until the type of the data item meets the type matching rule or the data item is an array of the basic data type or an array of the pointer type or an array of the generic type.

Assuming that there is array data item T[ ], the data class attribute of array data item T[ ] is 2 and the data type attribute of array data item T[ ] is T[ ]. If T is the composite data type and array data item T[ ] internally includes a composite data item of which the type is T and that internally includes k data items, with the data type attributes of the k data items being t1, t2, . . . , tk, the data class attribute of T may be 1 or 3 (except for the basic data type) and the data type attribute of T is t1t2 . . . tk. The expanding action is performed on array data item T[ ]. N-ization is performed on the k data items to form k array data items t1[ ], t2[ ], . . . , tk[ ]. The data class attribute of each array data item of the k array data items is 2. Meanwhile, following a composition rule of data types, array data item T[ ] turns into composite data item D formed by compositing t1[ ], t2[ ], . . . , tk[ ], i.e., N-ization of T[ ] is canceled. The data class attribute of composite data D is identical to the data class attribute (which may be 1 or 3) of array data item T, and the data type attribute of the composite data item D is t1[ ]t2[ ] . . . tk[ ]. If there is the composite data type among t1, t2, . . . , and tk, the expanding action may be continuously and recursively applied to the array of the composite data type, and the expanding operation is terminated until the following two conditions are met: first, the data item at this time is an array of a basic type and cannot be expanded; second, when the line joining operation requirement of the user is met, the expanding operation may be chosen not to be performed. An array logic equivalent transformation rule is represented as follows: array data item T[ ] may be represented as composite data item D formed by compositing t1[ ], t2[ ], . . . , tk[ ].

Assuming that there is array data item T[ ], the data class attribute of array data item T[ ] is 2 and the data type attribute of array data item T[ ] is T[ ]. If T is an array of the composite data type, i.e., T itself is an array that internally includes m data items t1, t2, . . . , tm, the data type attribute of T is (t1t2 . . . tm)[ ], the data class attribute of T is 2, and the data type attribute of array data item T[ ] is ((t1t2 . . . tm)[ ])[ ]. When performing the expanding action on array data item T[ ], T needs to be expanded first. That is, data item (t1t2 . . . tm)[ ] is expanded first by the expanding action as described above. Thus, (t1t2 . . . tm)[ ] is expanded into t1[ ]t2[ ] . . . tm[ ]. At this time, the data type attribute of array data item T[ ] is (t1[ ]t2[ ] . . . tm[ ])[ ] and the data class attribute thereof is 2. If there is also an array of the composite data type among t1, t2, . . . , and tm, the array of the composite data type among t1, t2, . . . , and tm is expanded first, and then the expanding action is performed on an array of an upper layer.

For example, for an array logic equivalent rule, the specific operation is represented as follows: an expanding rule for an array structure is that for a function block in which a data item of the array type resides, a logic equivalent expanding operation may be performed on the data item of the array type, and the operation may be performed according to the following description: assuming that an output data item of the current layer of the function block is a data item of the array type, the data class attribute of the data item of the array type is 2 and the data type attribute is ((t1t2)t3)[ ]. The data item of the array type is an array of the composite data type and internally includes data item D1 of the composite data type (of which the data type attribute is t1t2) and data item D2 of the basic data type (of which the data type attribute is t3). The composite data type is ((t1t2)t3) and the data class attribute is 1. When expanding the data item of the array type, data items D1 and D2 included in the data item are logically N-ized into the array form of each data item, thereby forming two array data items of which the data type attributes are (t1t2)[ ] and t3[ ], with the data type attribute of the array data item being 2. Meanwhile, an N-ization canceling operation is performed on original data item T[ ], and according to a generation rule for typevalue, a data item having the data type attribute of (t1t2)[ ]t3[ ] and the data class attribute of 1 is generated. For the expanded array data item having the data type attribute of (t1t2)[ ], whether to continue expanding may be selected according to the willingness of the user. For a data item of which the data type attribute is t3[ ], because it is an array of the basic data type and does not meet an expanding condition, the data item of which the data type attribute is t3[ ] cannot be expanded continuously. For an input data item, a reference may be made to the above related description on an output data item. After an array data item is expanded, the expanded array data items may be merged according to reverse actions of the above steps till a first level of data items.

FIG. 3 (1) A to 3 (1) F are structural diagrams illustrating storage hierarchies of interfaces of function blocks provided in some embodiments of the present disclosure. FIG. 3 (1) A illustrates a function block with an array data item of the basic composite data type. FIG. 3 (1) A is a structural diagram illustrating a storage hierarchy of the interface of the function block when not expanded. FIG. 3 (1) B illustrates a form after the expanding action is performed on the array data item. FIG. 3 (1) B is a structural diagram illustrating a storage hierarchy of the interface of the function block when expanded to a second layer. FIG. 3 (1) A illustrates a form after merging of the array data item in FIG. 3 (1) B. FIG. 3 (1) C illustrates a function block with an array data item of the Exclusive OR composite data type. FIG. 3 (1) D illustrates a form after the expanding action is performed on the array data item. FIG. 3 (1) C illustrates a form after merging of the array data item in FIG. 3 (1) D. FIG. 3 (1) E illustrates a function block internally including a data item of the array type. FIG. 3 (1) F illustrates a form after the expanding action is performed on the array. FIG. 3 (1) E illustrates a form after merging of the array in FIG. 3 (1) F. It needs to be noted that the specific meaning of each portion in the structural diagrams of the storage hierarchies illustrated in FIG. 3 (1) A to 3 (1) F.

For example, the XML representation of a data item of the array type having the data type attribute of ((t1t2)t3)[ ] is as follows:

```
  <type id=“” name=“” value=“” typeclass=“2” typevalue=“(t1+2)(3)[ ]” typeid=“”>
  <type id=“” name=“” value=“” typeclass=“1” typevalue=“((t1t2)t3)” typeid=“”>
  <type id=“” name=“” value=“” typeclass=“1” typevalue=“t1t2” typeid=“”>
  <type id=“” name=“” value=“” typeclass=“0, 1, 2, 3, 4 or 5” typevalue=“t1”
typeid=“” />
  <type id=“” name=“” value=“” typeclass=“0, 1, 2, 3, 4 or 5” typevalue=“t2”
typeid=“” />
  </type>
  <type id=“” name=“” value=“” typeclass=“0, 1, 2, 3, 4 or 5” typevalue=“t3”
typeid=“” />
  </type>
  </type>
```

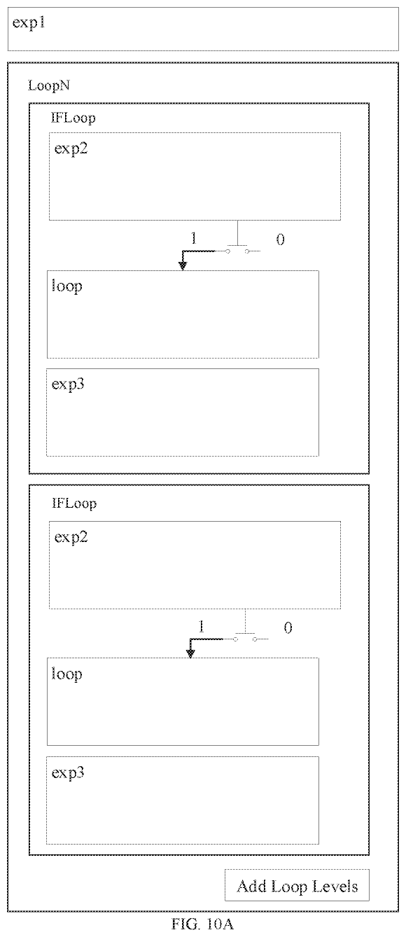

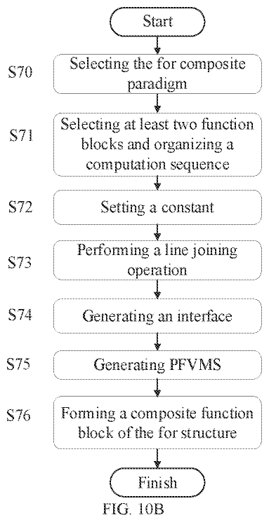

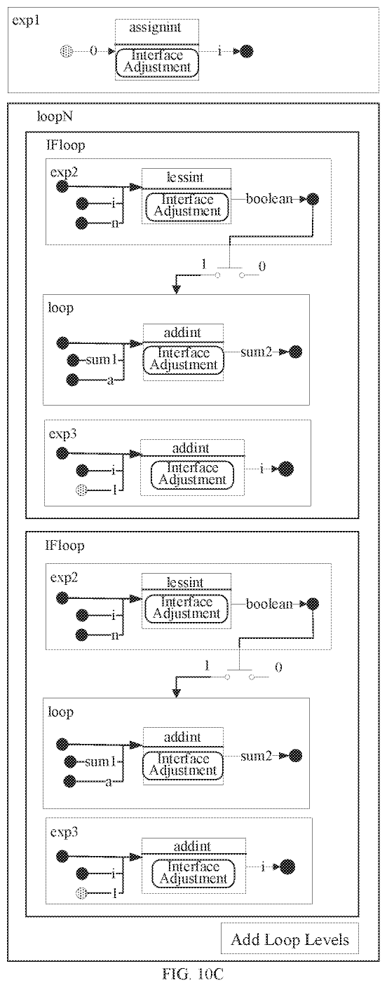

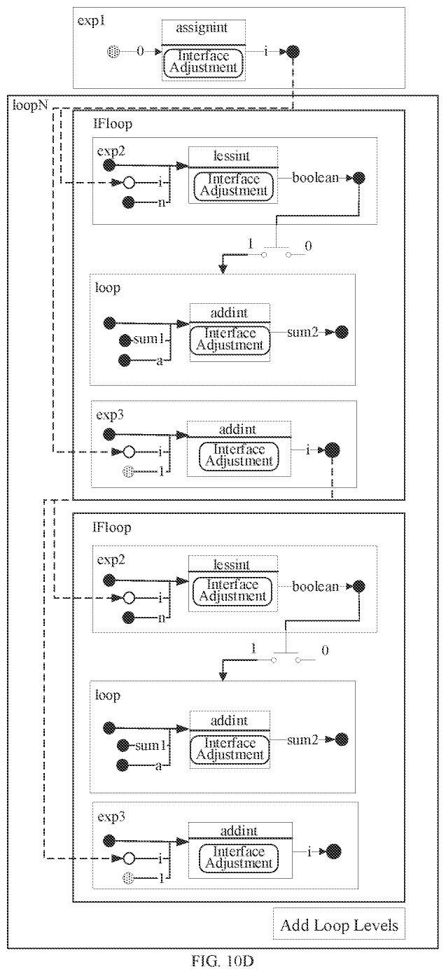

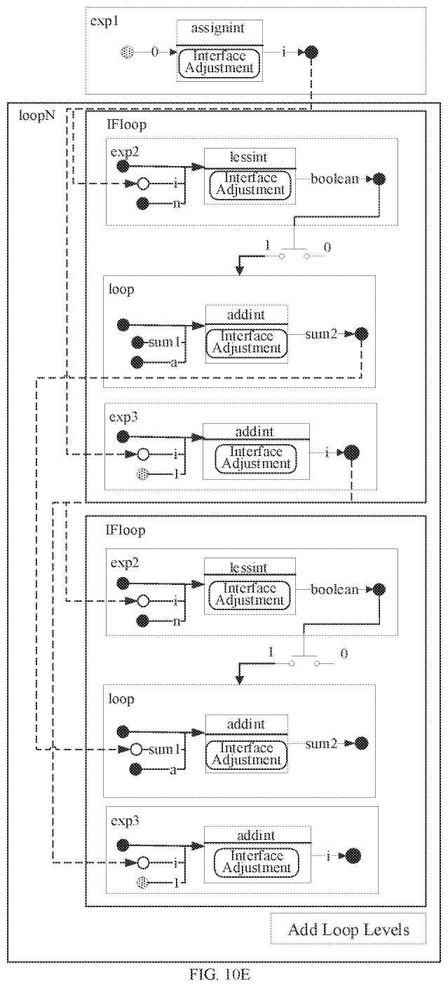

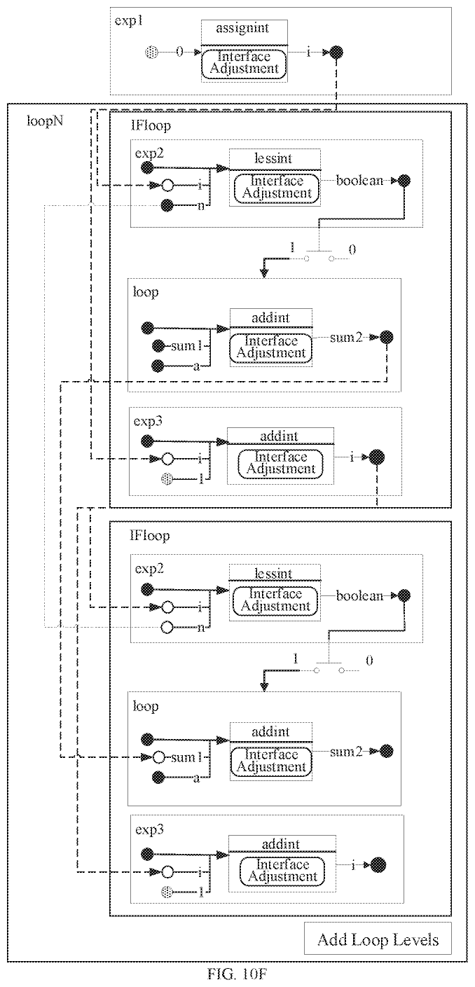

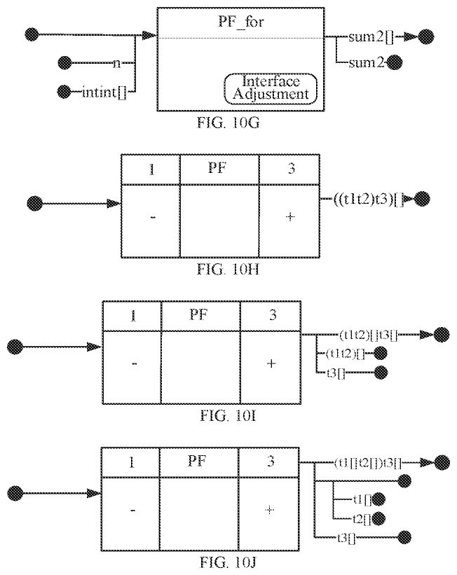

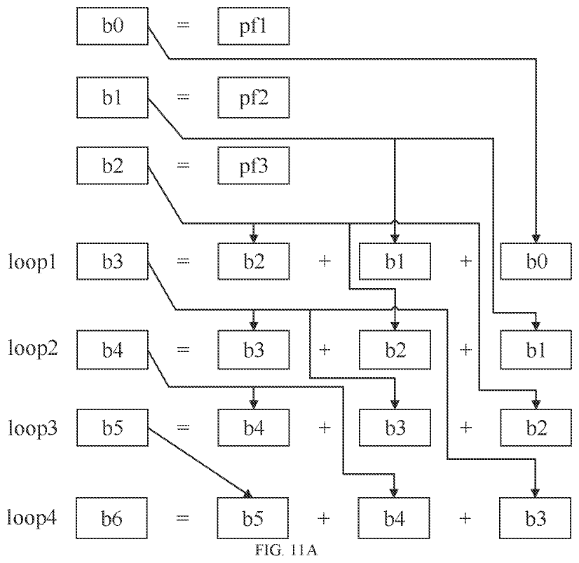

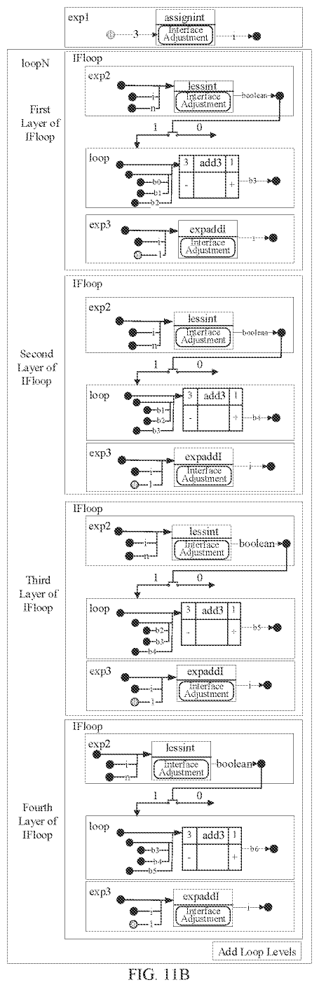

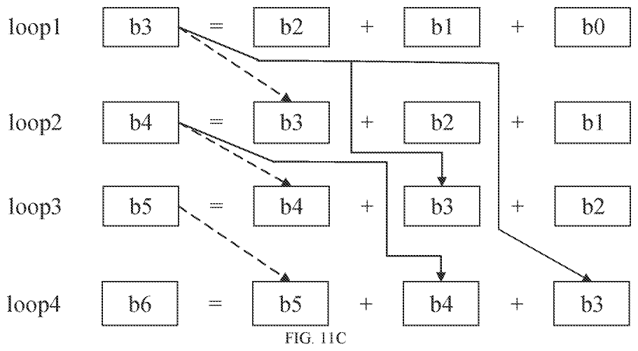

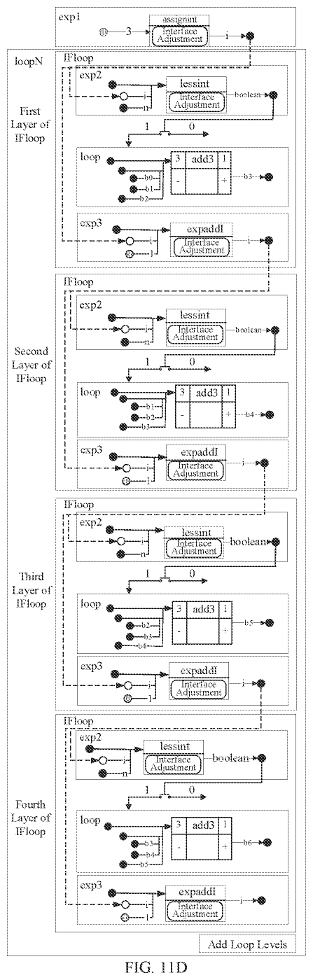

FIG. 10H illustrates a structural diagram illustrating a storage hierarchy of an interface of a function block including the data item of the array type; FIG. 10I is a structural diagram illustrating a storage hierarchy when expanding the data item of the array type at a first layer; and FIG. 10J is a structural diagram illustrating a storage hierarchy when expanding the data item of the array type at a second layer.

As illustrated in FIG. 10H, in the rectangular box, the input portion of the function block PF has one layer in total, and the first layer of the input portion is currently displayed. The output portion of the function block PF has three layers in total, and a first layer of the output portion is currently displayed. As illustrated in FIG. 10I, the operation of expanding the output data item of the function block at the first layer is as follows: an internal type of the first layer of the output data item is logically modified to (t1t2)[ ]t3[ ], and the XML representation is as follows:

```
  <type id=“” name=“” value=“” typeclass=“1” typevalue=“(t1+2)[3][ ])” typeid=“”>
  <type id=“” name=“” value=“” typeclass=“2” typevalue=“(t1t2)[ ]” typeid=“”>
  <type id=“” name=“” value=“” typeclass=“1” typevalue=“t1t2” typeid=“”>
  <type id=“” name=“” value=“” typeclass=“0, 1, 2, 3, 4 or 5” typevalue=“t1”
typeid=“” />
  <type id=“” name=“” value=“” typeclass=“0, 1, 2, 3, 4 or 5” typevalue=“t2”
typeid=“” />
  </type>
  </type>
  <type id=“” name=“” value=“” typeclass=“2” typevalue=“t3[ ]” typeid=“”>
  <type id=“” name=“” value=“” typeclass=“0, 1, 2, 3, 4 or 5” typevalue=“t3”
typeid=“”>
  </type>
  </type>
```

For example, as illustrated in FIG. 10I, in the rectangular box, the input portion of the function block PF is currently displayed till the first layer, and the output portion of the function block PF is currently displayed till the second layer.

As illustrated in FIG. 10J, the operation of expanding the output data item of the function block at the second layer is as follows: an internal type of the second layer of the output data item is logically modified to t1[ ]t2[ ]t3[ ], and the XML representation is as follows:

```
  <type id=“” name=“” value=“” typeclass=“1” typevalue=“((t1[ ]t2[ ])t3[ ])”
typeid=“”>
  <type id=“” name=“ value=“ typeclass=“1” typevalue=“t1[ ]+2[ ]” typeid=“”>
  <type id=“” name=“” value=“” typeclass=“2” typevalue=“t1[ ]” typeid=“”>
  <type id=“” name=“” value=“” typeclass=“0, 1, 2, 3, 4 or 5” typevalue=“t1”
typeid=“”>
  </type>
  <type id=“” name=“” value=“” typeclass=“2” typevalue=“t2[ ]” typeid=“”>
  <type id=“” name=“” value=“” typeclass=“0, 1, 2, 3, 4 or S” typevalue=“12”
typeid=“”>
  </type>
  <type id=“” name=“” value=“” typeclass=“2” typevalue=“t3[ ]” typeid=“”>
  <type id=“” name=“” value=“” typeclass=“0, 1, 2, 3, 4 or 5” typevalue=“13”
typeid=“”>
  </type>
  </type>
```

For example, as illustrated in FIG. 10J, in the rectangular box, the input portion of the function block PF is currently displayed till the first layer, and the output portion of the function block PF is currently displayed till the third layer.

For example, various expressions of a high-level programming language are transformed into basic function blocks (in the XML architecture, a basic function block may be expressed as F and a composite function block may be expressed as PF), and the basic function blocks may be subdivided according to basic data types. Thus, 134 basic function blocks may be formed. In the present disclosure, with a finite number (i.e., 134) of basic function blocks, data items of different data types are attached to the basic function blocks. Thus, when compositing, only joining (line) between algorithms needs to be considered and no storage design is needed. It needs to be noted that the data type of a data item of a basic function block is the basic data type or the basic composite data type or the generic pointer type or the generic type.

It needs to be noted that for basic function blocks, different basic function blocks may be identified with name (not value). For example, a basic function block having a name value of 0 may be defined as expaddI (which will be described below; expaddI represents an addition function block of the int type), a basic function block having a name value of 1 may be defined as expsubI (which will be described below; expsubI represents a subtraction function block of the int type), and so on, as long as they are different in name value from other function blocks in the function block library. In XML corresponding to each function block, the value of name in F/PF a relative address of the function block in the function block library, which is globally unique.

For example, a basic function block is a minimum function block used in the method of compositing function blocks. There may be multiple choices for the basic function block. A basic function block may be constructed by selecting an instruction set of a hardware system, or a basic function block may be constructed based on a basic statement of a high-level language. The embodiments of the present disclosure are described based on basic statement blocks of the high-level language. The basic function blocks include but are not limited to the following 6 categories: a basic function block representing a relational expression, a basic function block representing a logical expression, a basic function block representing an arithmetical expression, a basic function block representing an assignment expression, a basic function block representing a data type conversion functionality, and a paradigm basic function block. The paradigm basic function block includes a basic function block for performing an operation on a pointer. The paradigm basic function block includes basic function block getname for acquiring an address of a data item. In other words, the plurality of basic function blocks in the function block library include the basic function block representing the relational expression, the basic function block representing the logical expression, the basic function block representing the arithmetical expression, the basic function block representing the assignment expression, the basic function block representing the data type conversion functionality, and getname. It needs to be noted that, the basic function blocks, the basic types, and the like include but are not limited to the above specific cases.

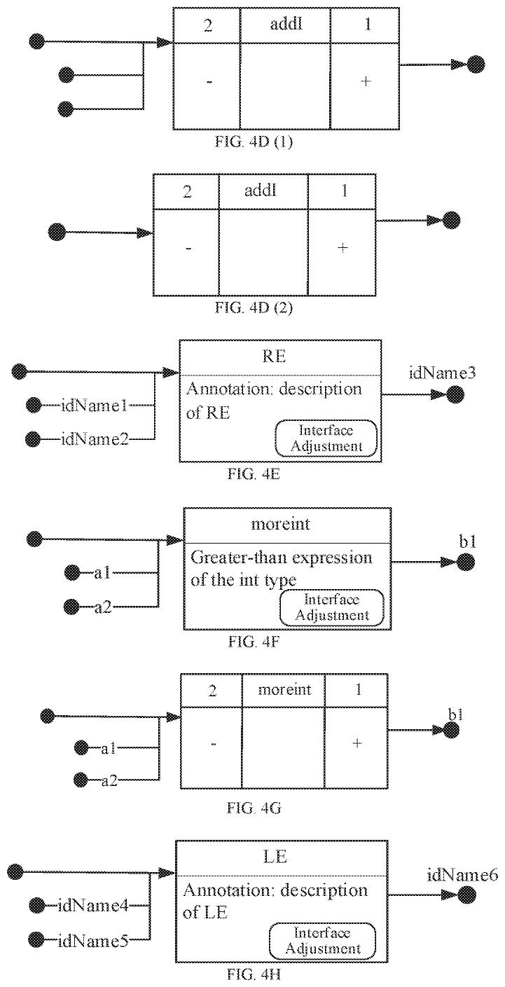

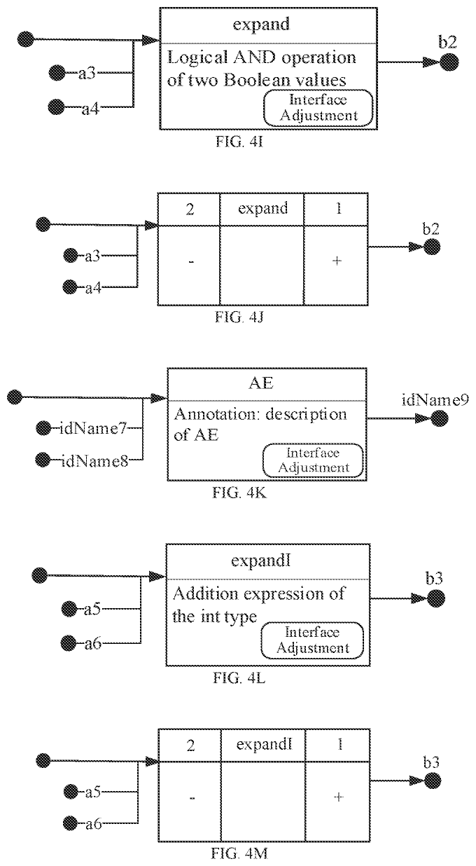

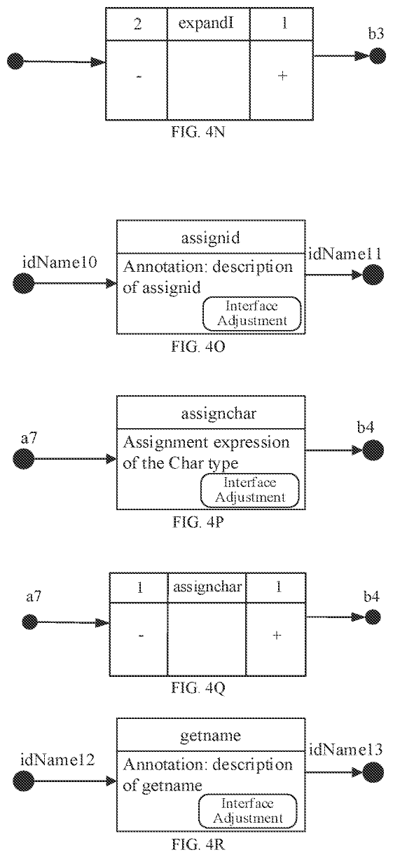

FIG. 4A is a schematic diagram illustrating a graphical representation of an interface of a basic function block provided in some embodiments of the present disclosure; and FIG. 4B is a structural diagram illustrating a storage hierarchy of an interface of a basic function block provided in some embodiments of the present disclosure.

For example, a basic function block may be represented graphically and in XML.

For example, the representation of a basic function block exits in the form of an interface. FIG. 4A illustrates a graphical representation of an interface of a basic function block. As illustrated in FIG. 4A, id represents the name of the basic function block, which is defined by the user. The arrowed line on the left of the rectangular box representing basic function block id represents an input pin of the basic function block. The solid circle (representing the real storage) and the hollow circle (representing the virtual storage) corresponding to the input pin represent input data items of the basic function block; i1 represents input data item i1 of the basic function block, i2 represents input data item i2 of the basic function block, and so on. All the input data items of the input portion of the interface of the basic function block are encoded sequentially, and the encoding rule is 0, 1, 2, 3 . . . ; in other words, for example, i1 may be 0 and i2 may be 1. The arrowed line on the right of the rectangular box representing basic function block id represents an output pin of the basic function block. The solid circle or hollow circle corresponding to the output pin represents an output data item of the basic function block; and j1 represents output data item j1 of the basic function block. All the output data items of the output portion of the interface of the basic function block are encoded sequentially, and the encoding rule is 0, 1, 2, 3 . . . ; in other words, for example, j1 may be 0. The related description of basic function block id may be annotated in the rectangular box of basic function block id. For example, an annotation may be provided to indicate a functionality that the basic function block may realize, etc. An interface adjustment button is further set in the rectangular box of basic function block id. In the process of organizing the basic function block, the interface adjustment button may be clicked on as needed to show the structural diagram of the storage hierarchy of the interface of the basic function block, as illustrated in FIG. 4B.

In the graphical representation of the structural diagram of the storage hierarchy, data items are illustrated in a tree-like nested structure, allowing the user to view the overall structure of the data items more intuitively. The user may select a particular data item, e.g., click on operation buttons “+” and “−” in the structural diagram of the storage hierarchy corresponding to function block F illustrated in FIG. 4B to expand and merge a data item in the interface corresponding to the function block F. The numeral on the left of the id “F” of the function block F in the structural diagram of the storage hierarchy is a total number of levels of an input data item in the interface corresponding to the function block F, and the numeral on the right is a total number of levels of an output data item in the interface corresponding to the function block F.

As illustrated in FIG. 4B, in the rectangular box, the first lattice of the first row represents levels of the input portion (level represents a maximum value of nested levels of the composite type of an input data item corresponding to the input portion), the second lattice of the first row represents the id identifier of basic function block F, and the third lattice of the first row represents levels of the output portion (level represents a maximum value of nested levels of the composite type of an output data item corresponding to the output portion).

The first lattice and the third lattice of the second row represent a level decreasing button and increasing button. By clicking on the decreasing button and the increasing button, the merging or expanding operation may be performed on the selected data item. If the selected data item does not include a data sub-item, i.e., the selected data item is an array of the basic data type, the generic pointer type, or the basic data type, the selected data item cannot be expanded. If the selected data item has been merged, the merging operation on the selected data item does not work.

For example, in the graphical representation of basic function block id, both of the data items of the input portion and the output portion of the interface of the basic function block id are illustrated till the second level. If the total number of levels of the input portion or the output portion is 1, it is only displayed till the first level.

FIG. 4C is a schematic diagram illustrating a graphical representation of an interface of an addition function block provided in some embodiments of the present disclosure; FIG. 4D (1) is a structural diagram illustrating a storage hierarchy of an interface of an addition function block provided in some embodiments of the present disclosure; and FIG. 4D (2) is a structural diagram illustrating another storage hierarchy of an interface of an addition function block provided in some embodiments of the present disclosure.

For example, the XML architecture of the interface of addition function block addI is represented as:

```
  <type id=“” name=“” value=“” typeclass=“1” typevalue=“int2” typeid=“”>-----
level1
  <type id=“1” name=“” value=“” typeclass=“0” typevalue=“int” typeid=“” />-----
level2
  <type id=“2” name=“” value=“” typeclass=“0” typevalue=“int” typeid=“” />-----
level2
  </type>
```

For example, taking the input portion of the interface corresponding to addition function block addI for example, the input portion includes 2 levels: level1 and level2. The data type of the input data item corresponding to level1 is int2, representing a data item of the composite data type; and the data types of the input data items corresponding to level2 are int and int, representing two data items of the basic data type. As illustrated in FIG. 4D (1), in the structural diagram of a current storage hierarchy, the input portion is currently expanded at the second level. Thus, the input portion of the interface illustrates two input data items (int and int), and the output portion is currently expanded at the first level. When the first sign ‘−’ of the second row in the structural diagram illustrated in FIG. 4D (1) is clicked on, it represents reducing the levels of the input portion by one level to obtain the structural diagram illustrated in FIG. 4D (2). In the structural diagram of the current storage hierarchy illustrated in FIG. 4D (2), the input portion is current expanded at the first level. At this time, the input portion of the interface merely shows one input data item (int2). The structural diagram of the current storage hierarchy illustrated in FIG. 4D (1) is the structural diagram of the default storage hierarchy.

For example, the JSON representation of the addition function block addI is as follows:

```
{
  “id”:“”,
  “name”:“”,
  “value”:“”,
  “typeclass”:“1”,
  “typevalue”:“int2”.
  “typeid”: “int2”,
  “memory”:“”,
  “children”:[
    {
      “id”:“1”,
      “name”:“”,
      “value”:“”,
      “typeclass”:“0”,
      “typevalue”:“int”,
      “typeid”:“int”,
      “memory:“”
    },
    {
      “id”:“2”,
      “name”:“”,
      “value”:“”,
      “typeclass”:“0”,
      “typevalue”:“int”,
      “typeid”:“int”,
      “memory”:“”
    }
  ]
}
```

where children is the subordinate data item of int2 data item.

For example, the XML architecture of the interface of a basic function block is represented as:

```
  <F id=“” name=“”>
    <in>
      <type id=“” name=“” value=“” typeclass=“”typevalue=“T”
typeid=“”/>
    </in>
    <out>
      <type id=“” name=“” value=“” typeclass=“”typevalue=“T”
typeid=“”/>
    </out>
  </F>
```

As illustrated above, basic function block F has three attributes: id, name, and value, where id represents the name of the basic function block, which is defined by the user; name represents a global address of the basic function block in the function block library, which is defined by a computer according to a rule; the global address is sequentially numbered from 0; name is a numeral; and the function block library is a set of all function blocks (including basic function blocks and composite function blocks); and value represents an operation symbol of a basic function block, e.g., “+” or “−”. The interface of basic function block F includes two portions. A portion between <in> and </in> represents the input portion, and a portion between <out> and </out> represents the output portion. An input data item of the input portion and an output data item of the output portion are storages attached to the basic function block, and the storages are carriers for carrying data. T in <in> and <fin> as well as <out> and </out> represents the data type of a data item, which may be the basic data type, the composite data type, the pointer type, or the generic type.

It needs to be noted that in the process of constructing a composite function block, the name of any function block (including the basic function block and the composite function block) remains unchanged.

The JSON representation of the interface of a basic function block is as follows:

```
{
  “type”:“F”,
  “id”:“”,
  “name”:“”,
  “in”:{
    “id”:“”,
    “name”:“”,
    “value”:“”,
    “typeclass”:“”,
    “typevalue”:“T”,
    “typeid”:“T”,
    “memory”:“”
  },
  “out”:{
    “id”:“”,
    “name”:“”,
    “value”:“”,
    “typeclass”:“”,
    “typevalue”:“T”,
    “typeid”:“T”
    “memory”:“”
  }
}
```

For example, a third representation of the interface of the basic function block is as follows:

```
<“F”,“”,“”,“”>
  <“”,“”,“”,“”,“”,“”,“” />
  <“”,“”,“”,“”,“”,“”,“” />
</>
```

where regarding <“F”,“ ”,“ ”,“ ” >, F represents a basic function block of the function block, and three values following it represent attribute values of id, name, and value of the function block in sequence; the first <“ ”,“ ”,“ ”,“ ”,“ ”,“ ”,“ ”/> represents the input portion of the function block and is in a format identical to that of a data item; and the second <“ ”,“ ”,“ ”,“ ”,“ ”,“ ”,“ ”/> represents the output portion of the function block.

Various basic function blocks are simply introduced below.

For example, a relational expression is used for realizing a relational operation. The relational operation includes being equal (=), being greater than (>), being less than (<), being greater than or equal to (>=), being less than or equal to (<=), and being not equal (!=). The relational operation is an operation directed to data items of seven basic data types: int, float, double, long, char, byte, and short. Each input to a relational expression is a binary data item (i.e., two input data items), and an output of the relational expression is a data item of unitary boolean type (i.e., an output data item). The following Table 1 shows various relational expressions.

TABLE 1

| | Operation | | | | | |
|---|---|---|---|---|---|---|
| | | > | < | >= | <= | |
| | == | greater | less | greater than | less than or | != |
| Type | equal | than | than | or equal to | equal to | not equal |
| int | equint | moreint | lessint | mequint | lequint | nequint |
| float | equfloat | morefloat | lessfloat | mequfloat | lequfloat | nequfloat |
| double | equdouble | moredouble | lessdouble | mequdouble | lequdouble | nequdouble |
| long | equlong | morelong | lesslong | mequlong | lequlong | nequlong |
| char | equC | moreC | leqC | mequC | leqC | nequC |
| byte | equbyte | morebyte | lessbyte | mequbyte | leqbyte | nequbyte |
| short | equshort | moreshort | lessshort | mequshort | leqshort | nequshort |

Besides, an embodiment of the present disclosure further includes two basic function blocks related to a pointer, i.e., equalref for judging whether data items of the pointer type are equal, and isnull for judging whether a data item of the pointer type is null. isnull includes an input data item and an output data item, where the data type attribute of the input data item is ref, and the data type attribute of the output data item is boolean.

FIG. 4E is a schematic diagram illustrating a graphical representation of a basic function block representing a relational expression provided in some embodiments of the present disclosure.

For example, as illustrated in FIG. 4E, the name of the basic function block representing the relational expression is RE. The basic function block RE representing the relational expression has two input data items: idName1 and idName2. The basic function block RE representing the relational expression has one output data item idName3, and the output data item idName3 is a data item of the boolean type. The XML architecture of the basic function block RE representing the relational expression is represented as:

```
  <F id=“RE” name=“”>
    <in>
      <type id=““ name=““ value=““ typeclass=“1” typevalue=“T2” typeid=“”>
      <type id=“idName1” name=“” value=“” typeclass=“0 or 4” typevalue=“T”
typeid=“”/>
      <type id=“idName2” name=“” value=“” typeclass=“0 or 4” typevalue=“T”
typeid=“”/>
      </type>
    </in>
    <out>
      <type id=“idName3” name=“” value=“” typeclass=“0”
typevalue=“boolean” typeid=“”/>
    </out>
  </F>
```

where the data type attributes of the two input data items idName1 and idName2 are represented as T. T may be any one of int, float, double, long, char, byte, and short, the data type attribute of the output data item idName3 is boolean. For example, in some examples, T is int, i.e., the data types of input data items idName1 and idName2 are the integer type. In this case, the data type T2 of a composite data item formed by compositing the two input data items idName1 and idName2 is int2. When the basic function block representing the relational expression is encapsulated to form an interface, the two input data items idName1 and idName2 may be composited into a composite data item. The composite data item is encapsulated into the input portion of the interface corresponding to the basic function block representing the relational expression, and the output data item idName3 is encapsulated into the output portion of the interface corresponding to the basic function block representing the relational expression.

For example, with reference to the XML architecture of the above basic function block RE representing the relational expression, the relative address of input data item idName1 is 0, i.e., the relative address of the input data item idName1 in a composite data item formed by compositing input data items idName1 and idName2 is 0; the relative address of input data item idName2 is 1, i.e., the relative address of the input data item idName2 in the composite data item formed by compositing input data items idName1 and idName2 is 1, and so on. The relative address of the composite data item formed by compositing the input data items idName1 and idName2 is 0, i.e., the relative address of the composite data item formed by compositing the input data items idName1 and idName2 in the input portion of the interface corresponding to the basic function block RE representing the relational expression is 0. It needs to be noted that the relative address attribute of a data item is not represented using name, but is implied by the data structure of the data item and automatically computer by an algorithm.

The JSON representation of the basic function block RE representing the relational expression illustrated in FIG. 4E is as follows:

```
{
  “type”:“F”,
  “id”:“RE”,
  “name”:“”,
  “in”:{
    “id”:“”,
    “name”:“”,
    “value”:“”,
    “typeclass”:“1”,
    “typevalue”:“T2”,
    “typeid”:“”,
    “memory”: ““
    “children”:[
      {
        “id”: “idName1”,
        “name”:“”,
        “value”:“”,
        “typeclass”:“0 or 4”,
        “typevalue”:“T”,
        “typeid”:“”,
        “memory”:“”
      },
      {
        “id”:“idName2”,
        “name”:“”,
        “value”:“”,
        “typeclass”:“0 or 4”,
        “typevalue”:“T”,
        “typeid”:“”
        “memory”:“”
      }
    ]
  },
  “out”:{
    “id”:“idName3”,
    “name”:“”,
    “value”:“”,
    “typeclass”:“0”,
    “typevalue”:“boolean”.
    “typeid”:“”,
    “memory”:“”
  }
}
```

FIG. 4F is a schematic diagram illustrating a graphical representation of a specific example of a basic function block representing a relational expression provided in some embodiments of the present disclosure; and FIG. 4G is a structural diagram illustrating a storage hierarchy of an interface of a basic function block representing a relational expression provided in some embodiments of the present disclosure.

For example, in one embodiment, FIG. 4F illustrates the graphical representation of a basic function block representing the relational expression of the int type, and FIG. 4G is the structural diagram illustrating the storage hierarchy of the interface of the basic function block representing the relational expression of the int type. For example, the relational expression of the int type is a greater-than expression form of the int type. The representations of other data types are similar thereto. As illustrated in FIG. 4F, the name of the basic function block representing the relational expression of the int type is moreint. The basic function block moreint representing the relational expression of the int type includes two input data items a1 and a2 and one output data item b1. Both of the data type attributes of the input data items a1 and a2 are the int type, and the data type attribute of the output data item b1 is the boolean type. The XML architecture of the basic function block moreint is represented as:

<F id=“moreint” name=“” >
<in>
<type id=“” name=“” value=“” typeclass=“1” typevalue=“int2” typeid=“”>
<type id=“a1” name=“” value=“” typeclass=“0” typevalue=“int” typeid=“” />
<type id=“a2” name=“” value=“” typeclass=“0” typevalue=“int” typeid=“” />
</type>
</in>
<out>>
<type id=“b1” name=“” value=“” typeclass=“0” typevalue=“boolean” typeid=“” />
</out>
</F>

For example, as illustrated in the above XML, the input portion of the interface corresponding to the basic function block moreint includes two levels: a first level (i.e., int2) and a second level (i.e., int and int). The output portion of the interface corresponding to the basic function block moreint includes one level (i.e., boolean). Thus, as illustrated in FIG. 4G, in the structural diagram of the storage hierarchy of the interface of the basic function block moreint, the total number of levels of the input portion is 2 and the total number of levels of the output portion is 1. The input portion currently displays 2 levels and the output portion currently displays 1 level. In this case, the input portion shows two input data items a1 and a2, and the output portion shows one output data item b1.

For example, a logical expression is used for realizing a logical operation that includes the following three operations: && logical AND (expand), ∥ logical OR (expor), and ! logical NOT (expnot). Logical AND and logical OR are dyadic logical operations, and logical NOT is a monadic logical operation.

An input to the monadic logical operation is a data item, and the data type of the data item must be the boolean type. An input to the dyadic logical operation is a composite data item formed by compositing two data items of the boolean type. Each of an output of the monadic logical operation and an output of the dyadic logical operation is a data item of the boolean type.

FIG. 4H is a schematic diagram illustrating a graphical representation of a basic function block representing a logical expression provided in some embodiments of the present disclosure.

For example, as illustrated in FIG. 4H, the name of the basic function block representing the logical expression is LE. The basic function block LE representing the logical expression has two input data items: idName4 and idName5. The basic function block LE representing the logical expression has one output data item idName6. The two input data items idName4 and idName5 and the output data item idName6 are all data items of the boolean type. For example, the XML architecture of the basic function block LE representing the logical expression is represented as:

```
  <F id=“LE” name=“”>
  <in>
  <type id=“” name=“” value=“” typeclass=“1” typevalue=“boolean2” typeid=“”>
  <type id=“idName4” name=“” value=“” typeclass=“0” typevalue=“boolean”
typeid=“”/>
  <type id=“idName5” name=“” value=“” typeclass=“0” typevalue=“boolean”
typeid=“”/>
  </type>
  </in>
  <out>
  <type id=“idName6” name=“” value=“” typeclass=“0” typevalue=“boolean”
typeid=“”/>
  </out>
  </F>
```

where the data type attributes of the two input data items idName4 and idName5 are boolean, the data type attribute of a composite data item formed by compositing the two input data items idName4 and idName5 is boolean2, and the data type attribute of the output data item idName6 is boolean. When the basic function block representing the logical expression is encapsulated into an interface, the two input data items idName4 and idName5 may be composited into a composite data item. The composite data item is encapsulated into the input portion of the interface corresponding to the basic function block representing the logical expression, and the output data item idName6 is encapsulated into the output portion of the interface corresponding to the basic function block representing the logical expression.

FIG. 4I is a schematic diagram illustrating a graphical representation of a specific example of a basic function block representing a logical AND expression provided in some embodiments of the present disclosure; and FIG. 4J is a structural diagram illustrating a storage hierarchy of an interface of a basic function block representing a logical AND expression provided in some embodiments of the present disclosure.

For example, in an embodiment, FIG. 4I illustrates the graphical representation of a basic function block representing the logical AND expression of two data items of the Boolean type, and FIG. 4J is the structural diagram illustrating the storage hierarchy of the interface of the basic function block representing the logical AND expression. As illustrated in FIG. 4I, the name of the basic function block representing the logical AND expression is expand. The basic function block expand representing the logical AND expression includes two input data items a3 and a4 and one output data item b2. The data type attributes of the input data items a3 and a4 and the output data item b2 are the boolean type. The XML architecture of the basic function block expand representing the logical AND expression is represented as:

<F id=“expand” name=“” >
<in>
<type id=“” name=“” value=“” typeclass=“1” typevalue=“boolean2” typeid=“”>
<type id=“a3” name=“” value=“” typeclass=“0” typevalue=“boolean” typeid=“” />
<type id=“a4” name=“” value=“” typeclass=“0” typevalue=“boolean” typeid=“” />
</type>
</in>
<out>>
<type id=“b2” name=“” value=“” typeclass=“0” typevalue=“boolean” typeid=“” />
</out>
</F>

For example, as illustrated in the above XML, the input portion of the interface corresponding to the basic function block expand includes two levels: a first level (i.e., boolean2) and a second level (i.e., boolean and boolean). The output portion of the interface corresponding to the basic function block expand includes one level (i.e., boolean). Thus, as illustrated in FIG. 4J, in the structural diagram of the storage hierarchy of the interface of the basic function block expand, the total number of levels of the input portion is 2 and the total number of levels of the output portion is 1. The input portion currently displays 2 levels and the output portion currently displays 1 level. In this case, the input portion shows two input data items a3 and a4, and the output portion shows one output data item b2.

For example, an arithmetical expression is used for realizing an arithmetical operation that includes the following 5 operations: addition (+), subtraction (−), multiplication (*), division (/), and complementation (%). The 5 arithmetical operations are all dyadic operations. The arithmetical operations are operations directed to data items of the basic data types (i.e., int, float, double, long, byte, and short). The following Table 2 shows various arithmetical expressions.

TABLE 2

| | Operation | | | | |
|---|---|---|---|---|---|
| | | − | * | | |
| | + | sub- | multi- | / | % |
| Type | addition | traction | plication | division | complementation |
| int | expaddI | expsubI | expmulI | expdivI | expmodI |
| float | expaddF | expsubF | expmulF | expdivF | expmodF |
| double | expaddD | expsubD | expmulD | expdivD | expmodD |
| long | expaddL | expsubL | expmulL | expdivL | expmodL |
| byte | expaddB | expsubB | expmulB | expdivB | expmodB |
| short | expaddS | expsubS | expmulS | expdivS | expmodS |

FIG. 4K is a schematic diagram illustrating a graphical representation of a basic function block representing an arithmetical expression provided in some embodiments of the present disclosure.

For example, as illustrated in FIG. 4K, the name of the basic function block representing the arithmetical expression is AE. The basic function block AE representing the arithmetical expression has two input data items: idName7 and idName8. The basic function block AE representing the arithmetical expression has one output data item idName9. The data type attributes of the two input data items idName7 and idName8 and the output data item idName9 are identical. The XML architecture of the basic function block AE representing the arithmetical expression is represented as:

<F id=“AE” name=“”>
<in>>
<type id=“” name=“” value=“” typeclass=“1”typevalue=“T2” typeid=“”>
<type id=“idName7” name=“” value=“” typeclass=“0”typevalue=“T” typeid=“”/>
<type id=“idName8” name=“” value=“” typeclass=“0”typevalue=“T” typeid=“”/>
</type>
</in>
<out>
<type id=“idName9” name=“” value=“” typeclass=“0”typevalue=“T” typeid=“”/>
</out>
</F>

where the data type attributes of the two input data items idName7 and idName8 are both represented as T. T may be any one of int, float, double, long, byte, and short, the data type attribute of the output data item idName9 is also represented as T. For example, in some examples, T is int, i.e., the data type attributes of input data items idName7 and idName8 and output data item idName9 are the int type. In this case, the data type attribute T2 of a composite data item formed by compositing the two input data items idName7 and idName8 is int2. When the basic function block AE representing the arithmetical expression is encapsulated into an interface, the two input data items idName7 and idName8 may be composited into a composite data item. The composite data item is encapsulated into the input portion of the interface corresponding to the basic function block AE representing the arithmetical expression, and the output data item idName9 is encapsulated into the output portion of the interface corresponding to the basic function block AE representing the arithmetical expression.

FIG. 4L is a schematic diagram illustrating a graphical representation of a basic function block representing an addition expression provided in some embodiments of the present disclosure; FIG. 4M is a structural diagram illustrating a storage hierarchy of an interface of a basic function block representing an addition expression provided in some embodiments of the present disclosure; and FIG. 4N is a structural diagram illustrating another storage hierarchy of the interface of the basic function block representing the addition expression provided in some embodiments of the present disclosure.

For example, in an embodiment, the arithmetical expression includes an addition expression. FIG. 4L illustrates the graphical representation of a basic function block representing the addition expression of the int type, and FIG. 4M and FIG. 4N illustrate the storage hierarchy of the interface of the basic function block representing the addition expression of the int type. The arithmetical expressions of other data types are similar thereto. As illustrated in FIG. 4L, the name of the basic function block representing the addition expression is expaddI. The basic function block expaddI representing the addition expression includes two input data items a5 and a6 and one output data item b3. The data type attributes of the input data items a5 and a6 and the output data item b3 are the int type.

For example, the XML architecture of the basic function block expaddI representing the addition expression is represented as:

<Fid=“expaddI” name=“” >
<in>
<type id=“” name=“” value=“” typeclass=“1” typevalue=“int2” typeid=“”>
<type id=“a5” name=“” value=“” typeclass=“0” typevalue=“int” typeid=“” />
<type id=“a” name=“” value=“” typeclass=“0” typevalue=“int” typeid=“” />
</type>
</in>
<out>
<type id=“b3” name=“” value=“” typeclass=“0” typevalue=“int” typeid=“” />
</out>
</F>

For example, as illustrated in the above XML, the input portion of the interface corresponding to the basic function block expaddI includes two levels: a first level (i.e., int2) and a second level (i.e., int and int). The output portion of the interface corresponding to the basic function block expaddI includes one level (i.e., int). Thus, as illustrated in FIG. 4M and FIG. 4N, in the structural diagram of the storage hierarchy of the interface of the basic function block expaddI, the total number of levels of the input portion is 2 and the total number of levels of the output portion is 1. As illustrated in FIG. 4M, the input portion currently displays 2 (default value) levels and the output portion currently displays 1 level. In this case, the input portion shows two input data items a5 and a6 (int and int), and the output portion shows one output data item b3. As illustrated in FIG. 4N, the input portion currently displays 1 level and the output portion currently displays 1 level. In this case, the input portion shows one input data item (int2), and the output portion shows one output data item b3. It needs to be noted that the input portion and the output portion illustrated in FIG. 4L corresponding to the storage hierarchy illustrated in FIG. 4M.

For example, an assignment expression is used for realizing an assignment operation and has one input data item and one output data item, and the data type attribute of the input data item and the data type attribute of the output data item must be consistent and be the basic data type. The assignment operation represents assigning the value of the input data item to the value of the output data item.

An assignment algorithm is directed to 10 basic data types and has corresponding assignment basic function blocks. The following Table 3 shows various assignment expressions.

TABLE 3

| | Type | | | | | | | | | |
|---|---|---|---|---|---|---|---|---|---|---|
| Operation | int | long | float | double | char | byte | short | boolean | string | ref |
| Assignment | assign- | assign | assign | assign- | assign | assign- | assign- | assign- | assign | assign- |
| Function | int | long | float | double | char | byte | short | boolean | string | ref |

FIG. 4O is a schematic diagram illustrating a graphical representation of a basic function block representing an assignment expression provided in some embodiments of the present disclosure.

For example, as illustrated in FIG. 4O, the name of the basic function block representing the assignment expression is assignid. The basic function block assignid representing the assignment expression has one input data item idName10 and one output data item idName11. The data type attribute of the input data item idName10 and the data type attribute of the output data item idName11 are identical. The XML architecture of the basic function block assignid representing the assignment expression is represented as:

```
  <F id=“” name=“”>
  <in>
  <type id=“idName10” name=“” value=“”typeclass=“0 or 4”typevalue=“T”
typeid=“” />
  </in>
  <out>
  <type id=“idName11” name=“” value=“” typeclass=“0 or 4”typevalue=“T”
typeid=“”/>
  </out>
  </F>
```

where the data type attributes of the input data item idName10 and the output data item idName11 are both represented as T. T may be any one of 10 basic data types. When the basic function block representing the assignment expression is encapsulated into an interface, the input data item idName10 is encapsulated into the input portion of the interface corresponding to the basic function block representing the assignment expression, and the output data item idName11 is encapsulated into the output portion of the interface corresponding to the basic function block representing the assignment expression.

FIG. 4P is a schematic diagram illustrating a graphical representation of a specific example of a basic function block representing an assignment expression provided in some embodiments of the present disclosure; and FIG. 4Q is a structural diagram illustrating a storage hierarchy of the interface of the basic function block representing the assignment expression provided in some embodiments of the present disclosure.

For example, in an embodiment, FIG. 4P illustrates the graphical representation of a basic function block representing the assignment expression of the Char type, and FIG. 4Q illustrates the storage hierarchy of the interface of the basic function block representing the assignment expression of the Char type. The expression forms of other data types are similar thereto. As illustrated in FIG. 4P, the name of the basic function block representing the assignment expression of the Char type is assignchar. The basic function block assignchar representing the assignment expression of the Char type includes one input data item a7 and one output data item b4. The data type attributes of the input data item a7 and the output data item b4 are the Char type. The XML architecture of the basic function block assignchar is represented as:

<F id=“assignchar” name=“”>
<in>
<type id=“a7” name=“” value=“” typeclass=“0” typevalue=“char” typeid=“” />
</in>
<out>
<type id=“b4” name=“” value=“” typeclass=“0” typevalue=“char” typeid=“” />
</out>
</F>

For example, as illustrated above, the input portion of the interface corresponding to the basic function block assignchar includes one level (i.e., Char), and the output portion of the interface corresponding to the basic function block assignchar includes one level (i.e., Char). Thus, as illustrated in FIG. 4Q, in the structural diagram of the storage hierarchy of the interface of the basic function block assignchar, the total number of levels of the input portion is 2 and the total number of levels of the output portion is 1. The input portion currently displays 1 level and the output portion currently displays 1 level. In this case, the input portion illustrates the input data item a7, and the output portion illustrates the output data item b4.

For example, basic data type conversion includes automatic type conversion, basic type conversion to a character string, and forced type conversion. The following Table 4 shows the automatic type conversion, Table 5 shows the basic type conversion to a character string, and Table 6 shows the forced type conversion.

TABLE 4

| | Type | | | | | | |
|---|---|---|---|---|---|---|---|
| Type | char | byte | short | int | long | float | double |

| | | | | | |
|---|---|---|---|---|---|
| char | | convertCI | convertCL | convertCF | convertCD |
| byte | convertBS | convertBI | convertBL | convertBF | convertBD |
| short | | convertSI | convertSL | convertSF | convertSD |
| int | | | convertIL | convertIF | convertID |
| long | | | | convertLF | convertLD |
| float | | | | | convertFD |
| double | | | | | |

TABLE 5

| | Type |
|---|---|
| Type | string |
| char | convertCStr |
| byte | convertBStr |
| short | convertSStr |
| int | convertIStr |
| long | convertLStr |
| float | convertFStr |
| double | convertDStr |

TABLE 6

| | Type | | | | | | |
|---|---|---|---|---|---|---|---|
| Type | char | byte | short | int | long | float | double |

| | | | | | | |
|---|---|---|---|---|---|---|
| char | | convertCB | convertCS | | | |
| byte | convertBC | | convertBS | | | |
| short | convertSC | convertSB | | | | |
| int | convertIC | convertIB | convertIS | | | |
| long | convertLC | convertLB | convertLS | convertLI | | |
| float | convertFC | convertFB | convertFS | convertFI | convertFL | |
| double | convertDC | convertDB | convertDS | convertDI | convertDL | convertDF |

Data items of 10 basic data types correspond to basic function blocks of different types, as illustrated in the following Table 7:

TABLE 7

| | int | long | float | double | char | byte | short | boolean | string | ref |
|---|---|---|---|---|---|---|---|---|---|---|
| Relational | =, >, | =, >, | =, >, | =, >, | =, >, | =, >, | =, >, | | | Equal |
| Expression | <, >=, | <, >=, | <, >=, | <, >=, | <, >=, | <, >=, | <, >=, | | | ref, |
| | <=, != | <=, != | <=, != | <=, != | <=, != | <=, != | <=, != | | | isnull |
| Logical | | | | | | | | &&, | | |
| Expression | | | | | | | | ∥, ! | | |
| Arithmetical | +, −, | +, −, | +, −, | +, −, | | +, −, | +, −, | | | |
| Expression | *, | *, | *, | *, | | *, | *, | | | |
| | /, % | /, % | /, % | /, % | | /, % | /, % | | | |
| Assignment | assign | assign | assign | assign | assig | assig | assign | assign | assign | assign |
| Expression | int | long | float | double | nchar | nbyte | short | boolean | string | ref |

For example, in addition to the basic function blocks of five categories described above, a paradigm basic function block includes getname and addAddress. getname represents acquiring an address of other data item, and the data type attribute of the address data item is the pointer type ref. The type of data that an output data item (of the pointer type) of the getname points to is the same as that of an input data item of the getname. When the type of the input data item is determined, the type of the data item that the output data item points to is determined accordingly. The getname function represents obtaining a physical address during actual running of a storage. An algorithm formed by using a composition technique finally needs to run on a computer. Each data item (real storage) appearing in the algorithm is allocated to a particular hardware carrier during running. The hardware carriers need to be managed during allocation and running. Providing an identifier for each hardware carrier is a precondition of managing hardware resources. The identifier of a hardware resource in which a particular data item resides is acquired by the getname function, which is generally called the physical address. Performing addition and subtraction operations on an address represents that the address of a hardware carrier is ordered and addable. addAddress represents an address addition operation. The axiom of addition defines the ordered concept of natural numbers, and address addition also represents that an address is ordered. The data types of input data items of addAddress are address/pointer and the int type, and the data type of an output data item is address/pointer. addAddress has a constraint for the data class of a data item, as will be described below. getValueFromAddr represents acquiring a data item that an address (of the pointer type) points to.

FIG. 4R is a schematic diagram illustrating a graphical representation of a basic function block representing a getname function provided in some embodiments of the present disclosure; and FIG. 4S is a structural diagram illustrating a storage hierarchy of the interface of the basic function block representing the getname function provided in some embodiments of the present disclosure.

As illustrated in FIG. 4R, the name of the basic function block representing the getname function is getname. The basic function block getname has one input data item idName12 and one output data item idName13. The data type attribute of the input data item idName12 may be any type. The data type attribute of the output data item idName13 is the pointer type ref (if the type of the input data item is uncertain, the output data item is of the generic pointer type, i.e., may point to a data item of any type).

The XML architecture of the basic function block getname is represented as:

```
  <F id=“getname” name=“” >
    <in>
      <type id=“idName12” name=“” value=“” typeclass=“5”
typevalue=“*” typeid=“*”/>
    </in>
    <out>
    <type id=“ idName13” name=“” value=“” typeclass=“4”
typevalue=“ref” typeid=““/>
    </out>
  </F>
```

When compositing using the getname function, the data type of an input data item actually may be the basic data type, the basic composite data type, the array type, or the Exclusive OR type.

The XML description of the data structure of a pointer pointing to a data class of x and a data type of t is as follows:

<type id=“” name=“” value=“” typeclass=“4” typevalue=“&t”
typeid=“ref”>
<type id=“a” name=““ value=“” typeclass=“x” typevalue=“t”
typeid=“t”/>
</type>

where x may be 0, 1, 2, or 3. The specific description of t is determined by the internal data structure of a data item of which id is a, with reference to the subsequent generation rule for typevalue.

For example, as illustrated above, the input portion of the interface corresponding to the basic function block getname includes one level (i.e., data type T), and the output portion of the interface corresponding to the basic function block getname includes one level (i.e., ref). Thus, as illustrated in FIG. 4S, in the structural diagram of the storage hierarchy of the interface of the basic function block getname, the total number of levels of the input portion is 2 and the total number of levels of the output portion is 1. The input portion currently displays 2 levels and the output portion currently displays 1 level. In this case, the input portion illustrates the input data item idName12, and the output portion illustrates the output data item idName13.

It needs to be noted that after the input data item of the basic function block getname is joined by a line, the data type of the input data item is determined.

Line joining expanding is different from graphical viewing expanding. The line joining expanding represents preparatory work for joining internal data items of a data item by a line for the type matching rule. The graphical viewing expanding is intended to allow the user to view the internal components of a data item, and the internal components of the data item would not be subjected to conversion processing. The line joining expanding and the graphical viewing expanding on data items of types such as the basic composite data type, the Exclusive OR type, and the non-generic pointer type have no difference in results, but the line joining expanding and the graphical viewing expanding on a data item of the array type are different. For the data item of the array type, the array logic equivalent transformation rule is applied during line joining expanding, and the data structure of the data item of the array type has changed. The array logic equivalent transformation rule is not applied during graphical viewing expanding, and only the internal structure of the data item of the array type is viewed. For example, when the line joining expanding is performed on data item (intint)[ ], the user will see that the data type attribute of the data item of the first layer of the data item (intint)[ ] is int[ ]int[ ], and the data items of the second layer of the data item (intint)[ ] are two data items of which the data type attributes are int[ ]. When the graphical viewing expanding is performed on data item (intint)[ ], the user will see that the data type attribute of the data item of the first layer of the data item (intint)[ ] is (intint)[ ], and the data item of the second layer of the data item (intint)[ ] is one data item of which the data type attribute is intint, representing that the interior of the data item of the array type is an array formed by a plurality of data items of the intint type. It needs to be noted that to simplify the description here, only the line joining expanding and the graphical viewing expanding corresponding to a data item of the array type are described. It needs to be noted that all expanding actions in the embodiments of the present disclosure are the line joining expanding.

For example, the extensible markup language corresponding to any function block of a plurality of function blocks includes a computation sequence portion, an interface portion, a line joining relationship portion, and an interface and sequence contrast portion.

The computation sequence portion is used for describing interfaces of function blocks included in the any function block. In the computation sequence portion, the interface sequence of the function blocks in the any function block is arranged in sequence. The interface portion is used for describing an interface of the any function block. The line joining relationship portion is used for describing a data transfer relationship and an input merging relationship between the function blocks included in the any function block. The interface and sequence contrast portion is used for describing a contrast relationship between a data item in a function block included in the any function block and a data item in the interface of the any function block and further describing a line joining relationship between input data items joined by an auxiliary merging joining line in the any function block. The contrast relationship is embodied by a first relative path and a second relative path of the data item in the interface of the any function block.

It needs to be noted that when there is no line joining relationship between the data items of the any function block, the line joining relationship portion corresponding to the any function block is null.

For example, if the any function block is a composite function block having the sequential structure, the XML representation corresponding to the complete structure of the any function block is as follows:

```
<PF id=“” name=“”>
<F/PF id=“” name=“”>
<in>
</in>
<out>
</out>
</F/PF>
  ...
<VMS>
    Line joining group 1 Line joining group 2 ...
</VMS>
<in>
</in>
<out>
</out>
<PFVMS>
    Parameter matching group 1 Parameter matching group 2 ...
</PFVMS>
</PF>
```

As illustrated above, the complete structure (sandwiched in <PF></PF>) of the composite function block having the sequential structure is composed of three portions: the paradigm composition area, the large function interface area, and the relationship area of the large function interface type and the small function interface type. The small function block area (i.e., the computation sequence portion) of the paradigm composition area is used for illustrating at least one small function block, and each small function block is sandwiched in <PF></PF> or <F></F>. The interface sequence of the function blocks in the composite function block having the sequential structure is arranged in sequence. The small function block area may include a plurality of <F/PF></F/PF> portions, i.e., include a plurality of small function blocks. The compositing action area of the paradigm composition area includes the line joining relationship portion. The line joining relationship portion (i.e., VMS) of the paradigm composition area is sandwiched in <VMS></VMS> and used for storing the data transfer relationship and the input merging relationship between computation sequences composed of various function blocks. In the large function interface area (i.e., the interface portion), the input portion of the interface is sandwiched in <in></in> and the output portion of the interface is sandwiched in <out></out>. The large function interface area is used for describing the interface of the composite function block having the sequential structure. The input portion and the output portion internally include respective basic data items or composite data items or generic or pointer data items, and each data item is automatically generated from a composite paradigm through a composition rule. Following the description specification of data items, the data items of the interface of the function block are all identified by relative paths, which takes the place of the technical means of identifying data items using variable names in traditional software development. The meanings of the data items and the function block do not rely on the variable names, and data items and an algorithm having specific industry characteristics are not generated. Thus, a pure abstract algorithm is generated, and high abstraction and standardization of the algorithm are realized in essence. The relationship area of the large function interface type and the small function interface type (i.e., the interface and sequence contrast portion, PFVMS) is sandwiched in <PFVMS></PFVMS> and used for describing a contrast relationship between a corresponding data item in a computation sequence composed of various function blocks and a data item in the interface of the composite function block and a line joining relationship between input data items joined by an auxiliary merging joining line in the computation sequence composed of various function blocks.

The JSON representation of the complete structure of the composite function block having the sequential structure is as follows.

```
{
    “type”:”PF”,
    “id”:“”,
    “name”:“”,
    “PFList”:[{
      “type”:“F/PF”,
      “id”:“”,
      “name”:“”,
      “value”:“”,
      “in”:{ },
      “out”:{ }
    }
    ...
    ],
    “VMS”:[{Line joining group 1},{Line joining group 2}...],
    “in”:{ },
    “out”:{ }
    “PFVMS”:[{Parameter matching group 1}, {Parameter matching
group 2}...],
  }
```

where PFList represents the computation sequence portion of the composite function block.

For example, if the any function block is a composite function block having the conditional structure, the XML representation corresponding to the complete structure of the any function block is as follows:

<PF id=“” name=“”>
<exp name=“”>
<F/PF id=“” name=“”
<in>
</in>
<out>
</out>
</F/PF>
</exp>
<do True name=“”>
<F/PF id=“” name=“”>
<in>
</in>
<out>
</out>
</F/PF>
</doTrue>
<doFalse name=“”>
<F/PF id=“” name=“”>
<in>
</in>
<out>
</out>
</F/PF>
</doFalse>
<VMS>
</VMS>
<in>
</in>
<out>
</out>
<PFVMS>
</PFVMS>
</PF>

For example, as illustrated above, the complete structure of the composite function block having the conditional structure is composed of three portions: the paradigm composition area, the large function interface area, and the relationship area of the large function interface type and the small function interface type. The small function block area (i.e., the computation sequence portion) of the paradigm composition area is composed of three portions as follows: a first portion is the judgment condition portion, sandwiched in <exp></exp>. The judgment condition portion includes a function block having an output data item of the boolean data type, and at the judgment condition portion, each small function block is sandwiched in <PF></PF> or <F></F>. A second portion is a branch structure when the condition is true (the first branch portion), sandwiched in <doTrue></doTrue>, and at the first branch portion, each small function block is sandwiched in <PF></PF> or <F></F>. A third portion is a branch structure when the condition is false (the second branch portion), sandwiched in <doFalse></doFalse>, and at the second branch portion, each small function block is sandwiched in <PF></PF> or <F></F>. The line joining relationship portion (i.e., VMS, the compositing action area) of the paradigm composition area is sandwiched in <VMS></VMS> and used for storing the data transfer relationship and the input merging relationship between computation sequences composed of various function blocks. In the large function interface area (i.e., the interface portion), the input portion of the interface is sandwiched in <in></in> and the output portion of the interface is sandwiched in <out></out>. The large function interface area is used for describing the interface of the composite function block having the conditional structure. The relationship area of the large function interface type and the small function interface type (i.e., the interface and sequence contrast portion, PFVMS) is sandwiched in <PFVMS></PFVMS> and used for describing a contrast relationship between a corresponding data item in a computation sequence composed of various function blocks and a data item in the interface of the composite function block and a line joining relationship between input data items joined by an auxiliary merging joining line in the computation sequence composed of various function blocks.

It needs to be noted that in the composite function block having the conditional structure, one branch of the doTrue branch and the doFalse branch may be null.

The JSON representation of the complete structure of the composite function block having the conditional structure is as follows:

```
  {
    “type”:“PF”,
    “id”:“”,
    “name”:“”,
    “exp”:[{
      “type”:“F/PF”,
      “id”:“”,
      “name”:“”,
      “in”:{ },
      “out”:{ }
    }
    ...
    ],
    “doTrue”:[{
      “type”:“F/PF”,
      “id”:“”,
      “name”:“”,
      “in”:{ },
      “out”:{ }
    }
    ...
    ],
    “doFalse”:[{
      “type”:“F/PF”,
      “id”:“”,
      “name”:“”,
      “in”:{ },
      “out”:{ }
    }
    ...
    ],
    “VMS”:[{Line joining group 1},{Line joining group 2}...],
    “in”:{ },
    “out”:{ },
    “PFVMS”:[{Parameter matching group 1}, {Parameter matching
group 2}... ],
  }
```

For example, if the any function block is a composite function block having the loop structure, the XML representation corresponding to the complete structure of the any function block is as follows:

```
<PF id=“” name=“”>
<exp1 name=“”>
<F/PF id=“” name=“”>
<in></in>
<out></out>
</F/PF>
</exp1>
<loopN name=“”>
<IFLoop name=“”>
<exp2 name=“”>
<F/PF id=“” name=“”>
<in></in>
<out></out>
</F/PF>
</exp2>
loop name=“”>
<F/PF id=“” name=“”>
<in></in>
<out></out>
</F/PF>
</loop>
  <exp3 name=“”>
  <F/PF id=“” name=“”>
  <in></in>
  <out></out>
  </F/PF>
  </exp3>
</IFLoop>
</loopN>
<VMS>
</VMS>
<in>
</in>
<out>
</out>
<PFVMS>
  Parameter matching group 1 Parameter matching group 2
</PFVMS>
</PF>
```

For example, as illustrated above, the complete structure of the composite function block having the loop structure is composed of three portions: the paradigm composition area, the large function interface area, and the relationship area of the large function interface type and the small function interface type. The small function block area (i.e., the computation sequence portion) of the paradigm composition area is further divided into two portions: a first portion, namely a portion of a single expression, sandwiched in <exp1></exp1>; and a second portion, namely a portion of a loop body, sandwiched in <loopN></loopN>, where the loop body includes at least one loop portion; <IFloop></IFloop> describes one loop portion, and the internal structure of each loop portion is identical; one loop portion is displayed above by default, and the loop portions may be increased as needed. In each loop portion, the <exp2></exp2> portion represents a conditional expression, the <loop></loop> portion represents an intermediate loop expression, and <exp3></exp3> is an end loop expression portion. The compositing action area of the paradigm composition area includes the line joining relationship portion (i.e., VMS) which is sandwiched in <VMS></VMS> and used for storing the data transfer relationship and the input merging relationship between computation sequences composed of function blocks. The large function interface area includes the input portion sandwiched in <in></in> and the output portion sandwiched in <out></out> and is used for describing the interface of the composite function block having the loop structure. The relationship area of the large function interface type and the small function interface type (i.e., the interface and sequence contrast portion, i.e., PFVMS) is sandwiched in <PFVMS></PFVMS> and used for describing a contrast relationship between a corresponding data item in a computation sequence composed of function blocks and a data item in the interface of the composite function block and a line joining relationship between input data items joined by an auxiliary merging joining line in the computation sequence composed of the function blocks. For example, in the XML corresponding to the composite function block having the loop structure, each small function block is sandwiched in <PF></PF> or <F></F>.

The JSON representation of the complete structure of the composite function block having the loop structure is as follows:

```
  {
    “type”:“PF”,
    “id”:“”,
    “name”:“”,
    “exp1”:[{
      “type”:“F/PF”,
      “id”:“”,
      “name”:“”
      “in”:{ },
      “out”:{ }
    }
    ...
    ],
    “loopN”:[{
      “type”:“IFLoop”
      “name”:“”
      “exp2”:[{
        “type”:“F/PF”,
        “id”:“”,
        “name”:“”,
        “in”:{,
        “out”:{ }
      }
      ...
      ],
      “loop”:[{
        “type”:“F/PF”
        “id”:“”,
        “name”:“”,
        “in”:{ },
        “out”:{ }
      }
      ...
      ],
      “exp3”:[{
        “type”:“F/PF”,
        “id”:“”,
        “name”:“”,
        “in”:{ },
        “out”:{ }
      }
      ...
      ]
    }
    ...
    ],
    “VMS”:[[ Line joining group 1],[ Line joining group 2]...],
    “in”:{ },
    “out”:{ },
    “PFVMS”:[[ Parameter matching group 1],[ Parameter matching
group 2]...],
  }
```

For example, if the any function block is a composite function block having the while loop structure, the XML representation corresponding to the complete structure of the any function block is as follows:

```
<PF id=“” name=“ ”>
<loopN name=“”>
<IFLoop name=“”>
    <exp name=“”>
    <F/PF id=“” name=“”>
      <in></in>
      <out></out>
      </F/PF>
    </exp>
    <loop name=“”>
    <F/PF id=“” name=“”>
      <in></in>
      <out></out>
      </F/PF>
    </loop>
    </IFLoop>
    </loopN>
<VMS>
</VMS>
<in>
</in>
<out>
</out>
<PFVMS>
  Parameter matching group 1 Parameter matching group 2
</PFVMS>
</PF>
```

For example, as illustrated above, the complete structure of the composite function block having the while loop structure is composed of three portions: the paradigm composition area, the large function interface area, and the relationship area of the large function interface type and the small function interface type. The small function block area (i.e., the computation sequence portion) of the paradigm composition area includes: a portion of a while loop body, sandwiched in <loopN></loopN>, where the while loop body includes at least one while loop portion: <IFloop></IFloop> describes one while loop portion, and each while loop portion is sandwiched in <IFLoop></IFLoop>, where the <exp></exp> portion represents a while conditional expression, and the <loop></loop> portion represents a while loop expression. When the small function block area of the paradigm composition area includes a plurality of while loop portions, the internal structures of the plurality of while loop portions are identical. The line joining relationship portion (i.e., VMS) of the paradigm composition area is sandwiched in <VMS></VMS> and used for storing the data transfer relationship and the input merging relationship between computation sequences composed of function blocks. In the large function interface area, the input portion of the interface is sandwiched in <in></in> and the output portion of the interface is sandwiched in <out></out>. The large function interface area is used for describing the interface of the composite function block having the while structure. The relationship area of a large function interface type and a small function interface type (i.e., the interface and sequence contrast portion, i.e., PFVMS) is sandwiched in <PFVMS></PFVMS> and used for describing a contrast relationship between a corresponding data item in a computation sequence composed of function blocks and a data item in the interface of the composite function block and a line joining relationship between input data items joined by an auxiliary merging joining line in the computation sequence composed of the function blocks. For example, in the XML corresponding to the composite function block having the while loop structure, each small function block is sandwiched in <PF></PF> or <F></F>.

For example, in the present disclosure, for any input data item corresponding to any function block of at least two function blocks, the any input data item is extracted as a portion of the interface corresponding to a composite function block. The any input data item corresponds to a first relative path, and the first relative path of the any input data item represents a relative path of the any input data item in the input portion of the interface corresponding to the composite function block. The relative location of a data item describes an output-input relationship of the data item, which does not need to be marked with a name and specifically represented as a path.

For example, in some embodiments, the first relative path of the any input data item is represented in the following form:

in.Path(data_in1) (1)

where in represents the any input data item is in the input portion of the interface corresponding to the composite function block; and Path(data_in1) is the relative path of the any input data item computed by: based on a concatenated structure of the composite function block (i.e., the computation sequence corresponding to the composite function block), between an input data item of an outermost layer corresponding to the any input data item in the input portion of the interface corresponding to the composite function block and the any input data item, acquiring the relative address attribute related to the any input data item layer by layer, and computing the relative path of the any input data item based on the relative address attribute related to the any input data item.

For example, for any output data item corresponding to the any function block, the any output data item is extracted as a portion of the interface corresponding to the composite function block. The any output data item corresponds to a first relative path, and the first relative path of the any output data item represents a relative path of the any output data item in the output portion of the interface corresponding to the composite function block.

For example, in some embodiments, the first relative path of the any output data item is expressed in the following form:

out.Path(data_out1) (2)

where out represents that the any output data item is in the output portion of the interface corresponding to the composite function block; and Path(data_out1) is the relative path of the any output data item computed by: based on a concatenated structure of the composite function block, between an output data item of an outermost layer corresponding to the any output data item in the output portion of the interface corresponding to the composite function block and the any output data item, acquiring the relative address attribute related to the any output data item layer by layer, and computing the relative path of the any output data item based on the relative address attribute related to the any output data item.

For example, in some embodiments, the relative address attribute related to any input data item may be joined using a point symbol (i.e., .) to obtain the relative path of the any input data item. That is, the relative path of an input data item in the input portion of an interface corresponding to a composite function block in which the input data item resides may be obtained by: according to a nested structure, joining the relative address attributes of all input data items (including the input data item of the outermost layer and the input data item) between the input data item of the outermost layer, corresponding to the input data item, of the input portion and the input data item by using the point symbol. Similarly, in some embodiments, the relative address attribute related to any output data item may be joined using a point symbol (i.e., .) to obtain the relative path of the any output data item. That is, the relative path of an output data item in the output portion of an interface corresponding to a composite function block in which the output data item resides may be obtained by: according to a nested structure, joining the relative address attributes of all output data items (including the output data item of the outermost layer and the output data item) between the output data item of the outermost layer, corresponding to the output data item, of the output portion and the output data item by using the point symbol. For the specific computation processes of Path(data_in1) and Path(data_out1), a reference may be made to a data item positioning process described below.

It needs to be noted that in the XML architecture, the first relative path of any data item (an input data item or an output data item) is embodied in the PFVMS corresponding to a composite function block that corresponds to the any data item. The first relative path is computed only for the data item that is extracted as a portion of the interface corresponding to the composite function block.

For example, in some embodiments, in the XML architecture of PFVMS corresponding to a composite function block, the path attribute (see the description on PFVMS) of a source label in a line label may be used for storing the first relative path of any input data item. The path attribute (see the description on PFVMS) of the source label in the line label may be used for storing the first relative path of any output data item.

When joining at least part of input data items and/or at least part of output data items of at least two function blocks, the data type attributes of two data items joined meet the type matching rule or the two data items joined meet the line joining requirement rule. The type matching rule is that the data type attributes of the two data items match.

For example, the line joining requirement rule includes that the data type attribute of one data item of the two data items is the generic type while the data type attribute of the other data item of the two data items is the basic data type, the composite data type, or the generic type, i.e., the other data item of the two data items is of any data type other than the pointer type; alternatively, the line joining requirement rule includes that the data type attribute of one data item of the two data items is the generic pointer type while the data type attribute of the other data item of the two data items is the non-generic pointer type.

For example, the type matching rule includes that the data type attributes of two data items match. The data type attributes of two data items matching may represent that the data type attributes of the two data items are identical. The data type attributes of two data items being identical represents that the data type attributes of the two data items are the same basic data type or the same composite data type or the same pointer type. The data type attributes of two data items matching may also represent that the data type attribute of one data item of the two data items is the generic type while the data type attribute of the other data item of the two data items is other data type than the pointer type. In this case, the two data items meet the type matching rule or the line joining requirement rule.

For example, in the present disclosure, the data type attributes of a data item of the composite data type and a data item of the pointer type may be not null. When the data type attributes are not null, whether two data items meet the type matching rule may be judged directly based on the data type attributes of the two data items. In the case that the values of the data type attributes of the two data items are identical, the two data items are determined as two data items meeting the type matching rule.

For example, in the present disclosure, the data type attributes of a data item of the composite data type and a data item of the pointer type may be null. When the data type attributes of the data item of the composite data type and the data item of the pointer type are null, the steps of judging whether the data type attributes of the two data items match are as follows. Moreover, for a data item of the basic data type and a data item of the generic type, the steps of judging whether the data type attributes of the two data items match are also as follows.

For example, determining two data items meeting the type matching rule includes: for a first data item and a second data item selected from a group including at least part of output data items and/or at least part of input data items: judging whether the data class attribute of the first data item is identical to the data class attribute of the second data item, in response to the data class attribute of the first data item being identical to the data class attribute of the second data item, judging whether the data class attribute of the first data item and the data class attribute of the second data item are the basic data type, the composite data type, the pointer type, or the generic type; in response to both of the data class attribute of the first data item and the data class attribute of the second data item being the basic data type, judging whether the data type attribute of the first data item is identical to the data type attribute of the second data item; and in response to the data type attribute of the first data item being identical to the data type attribute of the second data item, determining that the first data item and the second data item are the two data items meeting the type matching rule.

The composite data type includes the basic composite data type, the Exclusive OR type, and the array type. Determining the two data items meeting the type matching rule further includes: in response to both of the data class attribute of the first data item and the data class attribute of the second data item being the composite data type, judging whether the data class attribute of the first data item and the data class attribute of the second data item are the Exclusive OR type, the basic composite data type, or the array type; in response to both of the data class attribute of the first data item and the data class attribute of the second data item being the Exclusive OR type, circularly performing judgement with respect to the type matching rule on data items at same locations within the first data item and the second data item to obtain a plurality of Exclusive OR judgement results; and in response to each of the plurality of Exclusive OR judgement results indicating meeting the type matching rule, determining that the first data item and the second data item are the two data items meeting the type matching rule.

For example, determining the two data items meeting the type matching rule further includes: in response to both of the data class attribute of the first data item and the data class attribute of the second data item being the array type, circularly judging whether data items at same locations within the first data item and the second data item meet the type matching rule to obtain at least one array judgement result; and in response to each of the at least one array judgement result indicating meeting the type matching rule, determining that the first data item and the second data item are the two data items meeting the type matching rule.

For example, determining the two data items meeting the type matching rule further includes: in response to both of the data class attribute of the first data item and the data class attribute of the second data item being the basic composite data type, circularly judging whether data items at same locations within the first data item and the second data item meet the type matching rule to obtain at least one basic composite judgement result; and in response to each of the at least one basic composite judgement result indicating meeting the type matching rule, determining that the first data item and the second data item are the two data items meeting the type matching rule.

For example, determining the two data items meeting the type matching rule further includes: in response to both of the data class attribute of the first data item and the data class attribute of the second data item being the pointer type, if both of the first data item and the second data item are of the generic pointer type, determining that the first data item and the second data item are the two data items meeting the type matching rule, if both of the first data item and the second data item are of the non-generic pointer type, circularly judging whether data items at same locations within the first data item and the second data item meet the type matching rule to obtain at least one non-generic pointer judgement result; and in response to each of the at least one non-generic pointer judgement result indicating meeting the type matching rule, determining that the first data item and the second data item are the two data items meeting the type matching rule.

For example, determining the two data items meeting the type matching rule further includes: in response to both of the data class attribute of the first data item and the data class attribute of the second data item being the generic type, determining that the first data item and the second data item are the two data items meeting the type matching rule.

The type matching rule is described in detail below by way of example.

In the type matching rule, the data type attributes of two data items being identical may include that basic types are identical, composite types are identical, pointer types are identical, and generic types are identical.

For example, basic types being identical represents that two data items are of the basic data type (i.e., 9 basic data types, byte, short, int, long, float, double, boolean, char, and string), and specific data types are identical. For example, the data types of two data items are basic data types t1 and t2 (each of t1 and t2 is one of the 9 basic data types), respectively. When t1=t2, the two data items meet the requirement of the type matching rule. For example, a plurality of data items of the int type are data items of the same data type.

For example, composite types being identical represents that two data items are of the composite data type, and specific data types are identical. For example, the data types of two data items are composite data types T1 and T2, respectively. When any corresponding data types in T1 and T2 are identical and the typeclass is identical for the any corresponding data types, the two data items meet the requirement of the type matching rule. For example, if T1 represents t1t2 and T2 represents t3t4, when t1 is identical to t3 and t2 is identical to t4, the two data items meet the requirement of the type matching rule.

For example, pointer types being identical represents that two data items are of the generic pointer type, or two data items are of the non-generic pointer type and the data types of specific data items they point to are identical. For example, the data type attributes of two data items are the non-generic pointer type, and the data types of the two data items are represented as &T1 and &T2, respectively. When the data types of any corresponding two internal data items in &T1 and &T2 are identical and the typeclass is also identical for the data types of the any corresponding two internal data items, the two data items meet the requirement of the type matching rule. For example, if T1 represents t1t2 and T2 represents t3t4, when t1 is identical to t3 and t2 is identical to t4, the two data items meet the requirement of the type matching rule.

For any two data items T1 and T2:

Step 1, assuming that the data type attribute of the data item T1 is type1, and the class (typeclass) of the data type of the data item T1 is class1, the data type attribute of the data item T2 is type2, and the class of the data type of the data item T2 is class2.

Step 2, judging whether the class class1 of the data type of the data item T1 and the class class2 of the data type of the data item T2 are identical (i.e., judging that class1=class2); if yes, performing step 3; and if no, performing step 16.

Step 3, judging whether the data item T1 and the data item T2 are data items of the basic data type (i.e., judging whether class1 and class2 are 0); if yes, performing step 4; and if no, performing step 5.

Step 4, performing type matching judgement with respect to the basic data type, which includes the following two steps 4.1 and 4.2:
Step 4.1, judging whether the data type attributes of the two data items T1 and T2 are identical; if yes, performing step 4.2; and if no, performing step 16.
Step 4.2, determining that the data item T1 and the data item T2 meet the type matching rule, and performing step 15.

Step 5, judging whether the class class1 of the data type of the data item T1 and the class class2 of the data type of the data item T2 are the Exclusive OR type; if yes, performing step 6; and if no, performing step 7.

Step 6, performing type matching judgement with respect to the Exclusive OR type, which includes the following five steps 6.1 to 6.5.
Step 6.1, assuming the type value of the data item T1 of the Exclusive OR type to be t1xort2 and the type value of the data item T2 of the Exclusive OR type to be t3xort4;
Step 6.2, performing data type matching judgement on the data item t1 and the data item t3, recursively skipping to step 1, and recording returned result r1;
Step 6.3, performing data type matching judgement on the data item t2 and the data item t4, recursively skipping to step 1, and recording returned result r2;
Step 6.4, judging whether r1 and r2 are both true (r1/r2 being true represents successful matching of the data types of the two data items (data items t1 and t3/data items t2 and t4)); if yes, performing step 6.5; and if no, performing step 16;
Step 6.5, determining the data item T1 and the data item T2 to meet the type matching rule of the Exclusive OR type, and performing step 15.

Step 7, judging whether the class class1 of the data type of the data item T1 and the class class2 of the data type of the data item T2 are the array type; if yes, performing step 8; and if no, performing step 9.

Step 8, performing type matching judgement with respect to the array type, which includes the following four steps 8.1 to 8.4:
Step 8.1, assuming the type value of the internal data item t1 of the data item T1 of the array type to be d1d2d3 . . . , and assuming the type value of the internal data item t2 of the data item T2 of the array type to be d4d5d6 . . . ;
Step 8.2, performing data type matching judgement on the data item t1 and the data item t2, recursively skipping to step 1, and recording returned results;
Step 8.3, judging whether all the returned results in step 8.2 are true; if yes, performing step 8.4; and if no, performing step 16;
Step 8.4, determining the data item T1 and the data item T2 to meet the type matching rule of the array type, and performing step 15.

Step 9, judging whether the class class1 of the data type of the data item T1 and the class class2 of the data type of the data item T2 are the basic composite data type; if yes, performing step 10, and if no, performing step 11.

Step 10, performing type matching judgement with respect to the basic composite data type, which includes the following four steps 10.1 to 10.4:
Step 10.1, assuming the type value of the data item T1 of the composite data type to be h1h2h3 . . . , and assuming the type value of the data item T2 of the composite data type to be h4h5h6 . . . ;
Step 10.2, judging whether the data types of data items at same locations (e.g., h1 in the data item T1 and h4 in the data item T2 are two data items at the same locations) match circularly, recursively skipping to step 1, and recording returned results;
Step 10.3, judging whether all the returned results in step 10.2 are true; if yes, performing step 10.4; and if no, performing step 16;
Step 10.4, determining the data item T1 and the data item T2 to meet the type matching rule of the composite type, and performing step 15.

Step 11, judging whether the class class1 of the data type of the data item T1 and the class class2 of the data type of the data item T2 are the pointer type; if yes, performing step 12; and if no, performing step 13.

Step 12, performing type matching judgement with respect to the pointer type, which includes the following four steps 12.1 to 12.5:
Step 12.1, assuming the type value of the data item T1 of the pointer type to be ref and assuming the type value of the data item T2 of the pointer type to be ref; determining the data item T1 and the data item T2 to meet the type matching rule of the composite type, and performing step 15;
Step 12.2, assuming the type value of the data item T1 of the pointer type to be &h1h2h3 . . . , and assuming the type value of the data item T2 of the pointer type to be &h4h5h6 . . . ;
Step 12.3, judging whether the data types of data items at same locations (e.g., h1 in the data item T1 and h4 in the data item T2 are two data items at the same locations) match circularly, recursively skipping to step 1, and recording returned results;
Step 12.4, determining whether all the returned results in step 12.3 are true; if yes, performing step 12.5; and if no, performing step 16;
Step 12.5, determining the data item T1 and the data item T2 to meet the type matching rule of the pointer type, and performing step 15.

Step 13, judging whether the class class1 of the data type of the data item T1 and the class class2 of the data type of the data item T2 are the generic type; if yes, performing step 14; and if no, performing step 16.

Step 14, performing type matching judgement with respect to the generic type; if the data type attributes of the data items are the generic type, determining the data item T1 and the data item T2 to meet the type matching rule, and performing step 15.

Step 15, determining the data type attributes of the data item T1 and the data item T2 to meet the type matching rule, i.e., the data item T1 and the data item T2 are successfully matched, with a matching result flag=true.

Step 16, determining the data type attributes of the data item T1 and the data item T2 to not meet the type matching rule, i.e., matching of the data item T1 and the data item T2 is failed, with a matching result flag=false.

Step 17, returning to the matching result flag.

For example, if both of the data item T1 and the data item T2 are data items of the basic data type, both of class1 and class2 are 0. If the data type attributes of the two data items are type1 and type2, respectively, when type1 and type2 are identical (e.g., both of type1 and type2 are int), the data type attribute of the data item T1 of the basic data type is identical to the data type attribute of the data item T2 of the basic data type.

For example, if both of the data item T1 and the data item T2 are data items of the composite data type, in the case that both of class 1 and class2 are 3, both of the data item T1 and the data item T2 are data items of the Exclusive OR type. In this case, type matching judgement may be performed with respect to the Exclusive OR type (i.e., the above step 6). For example, if the type value of the data item T1 is t1xort2 and the type value of the data item T2 is t3xort4, in the case that the data type attribute of the data item t1 and the data type attribute of the data item t3 are identical and the data type attribute of the data item t2 and the data type attribute of the data item t4 are identical (e.g., both of the data item t1 and the data item t3 are data items of the int type and both of the data item t2 and the data item t4 are data items of the int types), the data type attribute of the data item T1 of the Exclusive OR type is identical to the data type attribute of the data item T2 of the Exclusive OR type.

For the judgement on two data items of the array type with respect to the type matching rule, it is required to compare whether the data types of data items t1 and t2 included in the two data items of the array type match, where t1 and t2 may be the basic data type, the basic composite data type, the Exclusive OR type, the array type, the pointer type, or the generic type. The comparison on t1 and t2 needs to be recursed to step 1 for comparison. For example, if both of class1 and class2 are 2, both of the data item T1 and the data item T2 are data items of the array type. In this case, type matching judgement may be performed with respect to the array type (i.e., the above step 8). For example, the data item T1 includes the data item t1 and the data item T2 includes the data item t2, and the data type matching judgement is performed on the data item t1 and the data t2 (returning to step 1). For the specific process, see the specific description on each step. For example, in some examples, if both of the data item t1 and the data item t2 are data items of the basic data type, step 4 is performed. Whether the data type attributes of both of the data item t1 and the data item t2 are identical is judged; if yes, the data item t1 and the data item t2 are determined to meet the type matching rule; thus, the data type attribute of the data item T1 of the array type and the data type attribute of the data item T2 of the array type are determined to be identical. In some other examples, if both of the data item t1 and the data item t2 are data items of the basic composite data type, the type value of the data item t1 is d1d2d3 . . . , and the type value of the data item t2 is d4d5d6 . . . , step 10 is performed. For example, the data type attribute of data item d1 is identical to the data type attribute of data item d4, the data type attribute of data item d2 is identical to the data type attribute of data item d5, and the data type attribute of data item d3 is identical to the data type attribute of data item d6. For example, the data type attributes of the data item d1 and the data item d4 are (int2), the data type attributes of the data item d2 and the data item d3 are int, and the data type attributes of the data item d3 and the data item d6 are long. In this case, the data item t1 and the data item t2 meet the type matching rule; thus, the data type attribute of the data item T1 of the array type and the data type attribute of the data item T2 of the array type are determined to be identical, and so on.

If both of class1 and class2 are 1, both of the data item T1 and the data item T2 are data items of the basic composite data type. In this case, type matching judgement may be performed with respect to the basic composite data type (i.e., the above step 10). For example, if the type value of the data item T1 is h1h2h3 and the type value of the data item T2 is h4h5h6, in the case that the data type attribute of data item h1 and the data type attribute of data item h4 are identical, the data type attribute of the data item h2 and the data type attribute of data item h5 are identical, and the data type attribute of the data item h3 and the data type attribute of data item h6 are identical (e.g., both of the data type attributes of the data item h1 and the data item h4 are (int2), both of the data type attributes of the data item h2 and the data item h3 are int, and both of the data type attributes of the data item h3 and the data item h6 are long), the data type attribute of the data item T1 of the composite type is identical to the data type attribute of the data item T2 of the composite type.

For example, if both of class1 and class2 are 4, both of the data item T1 and the data item T2 are data items of the pointer type. In this case, type matching judgement may be performed with respect to the pointer type (i.e., the above step 12). When and only when the data type attribute of a data item (of the basic data type or the composite data type) stored at an address that the data item T1 points to is identical to the data type attribute of a data item (of the basic data type or the composite data type) stored at an address that the data item T2 points to or the data item T1 and the data item T2 do not point to any data item, the data type attributes of the data item T1 and the data item T2 are identical.

For example, if both of class1 and class2 are 5, both of the data item T1 and the data item T2 are data items of the generic type. In this case, type matching judgement may be performed with respect to the generic type (i.e., the above step 14). When both of the data type attributes of the data item T1 and the data item T2 are the generic type, the data item T1 and the data item T2 meet the type matching rule.

For any two data items T1 and T2, the data type attributes of the two data items T1 and T2 meet the type matching rule or the data type attributes of the two data items T1 and T2 meet the line joining requirement rule. For example, a concatenation operation (line joining action) on the two data items T1 and T2 is as follows:

Step I, applying the type matching rule to the two data items T1 and T2. In case of successful matching, performing step VI; and in case of unsuccessful matching, performing step II.

Step II, if the data type attribute of one data item of the two data items T1 and T2 is the generic type and the other data item of the two data items T1 and T2 is of any data type other than the pointer type, determining the two data items to meet the line joining requirement rule, and performing step VI.

Step Ill, if the data type attribute of one data item of the two data items T1 and T2 is the generic pointer type and the other data item of the two data items T1 and T2 is of the non-generic pointer type, determining the two data items to meet the line joining requirement rule, and performing step VI.

Step IV, if type matching between the two data items T1 and T2 is unsuccessful in step I, the two data items T1 and T2 do not meet the line joining requirement rule in steps II and III, and the two data items T1 and T2 are data items of the composite data type, the expanding action may be attempted on the two data items T1 and T2.

Step V, performing step I again for expanded data items and internal data items.

Step VI, if type matching between the two data items T1 and T2 is successful in step I or the two data items meet the line joining requirement rule in steps II and III, the line joining action may be applied to the two data items T1 and T2.

It needs to be noted that in the embodiments of the present disclosure, during the concatenation operation, when two data items meet one of the type matching rule and the line joining requirement rule, the line joining action may be applied to the two data items. That is, if two data items do not meet the type matching rule but meet the line joining requirement rule, the line joining action may be applied to the two data items.

For example, at least part of input data items includes a first part of input data items. In step S11, during the concatenation operation, joining at least part of input data items and/or at least part of output data items of at least two function blocks includes: based on the type matching rule and/or the line joining requirement rule, joining the at least part of output data items and the first part of input data items by a data transfer joining line. A result of the line joining action is equivalent to storage merging, representing that two data items (i.e., storages) joined by a joining line are merged into one data item.

For example, the data type attributes of two data items joined by the data transfer joining line meet the type matching rule or the two data items joined meet the line joining requirement rule. The type matching rule or the line joining requirement rule is a precondition that the line joining operation must follow. The data items joined by the data transfer joining line must meet the type matching rule or the line joining requirement rule so that line joining can be successful.

For example, a data transfer line joining rule must be followed in the processes of organizing function blocks. The data transfer line joining rule includes: if the data type attributes of two data items meet the type matching rule, the two data items may be joined by a line. Moreover, in the process of organizing a function block, in consideration of technical and practical aspects, a practical line joining rule is added. The practical line joining rule includes: if the data type attributes of two input data items meet the type matching rule, the two input data items may be joined by an auxiliary merging joining line.

For example, the data transfer joining line represents a line joining from an output data item to an input data item or an output data item; and the data transfer joining line includes an output-output transfer line used for joining at least two output data items and an output-input transfer line used for joining at least one output data item to at least one input data item. Both of the output-output transfer line and the output-input transfer line are joining lines starting from output data items. The data transfer joining line is a directed joining line. For example, in presentation in the graphical form, an arrowed line may be used for representing the data transfer joining line.

For example, the at least part of output data items includes a first output data item, a second output data item, and a third output data item, and the first part of input data items includes a first input data item.

In the concatenation operation, joining the at least part of output data items and the first part of input data items by a data transfer joining line includes at least one of: joining the second output data item to the first output data item by the output-output transfer line, the second output data item appearing after the first output data item, setting the storage type attribute of the second output data item to the virtual storage while not changing the storage type attribute of the first output data item, and recording a joining relationship between the first output data item and the second output data item, where the computing of the function block in which the second output data item resides follows that of the function block in which the first output data item resides, and the computed value of the second output data item is transferred to the first output data item; joining the third output data item to the first input data item by the output-input transfer line; in response to the third output data item appearing after the first input data item or the third output data item and the first input data item belonging to a same function block, setting the storage type attribute of the third output data item to the virtual storage while not changing the storage type attribute of the first input data item, and recording a joining relationship between the first input data item and the third output data item, where the computing of the function block in which the third output data item resides follows that of the function block in which the first input data item resides, and the computed value of the third output data item is transferred to the first input data item; and in response to the third output data item appearing before the first input data item, setting the storage type attribute of the first input data item to the virtual storage while not changing the storage type attribute of the third output data item, and recording the joining relationship between the first input data item and the third output data item, where the computing of the function block in which the third output data item resides is prior to that of the function block in which the first input data item resides, and the computed value of the third output data item is transferred to the first input data item as input data to the function block in which the first input data item resides. The concatenation and line joining operation is performed by the user. Whether the storage type attribute is set to the virtual storage may be automatically implemented by a visualization tool according to the above rules. The operation steps of the user are simplified.

For example, the first output data item, the second output data item, the third output data item, and the first input data item are positioned in a form of a second relative path; the joining relationship between the first output data item and the second output data item is embodied by the second relative path of the first output data item and the second relative path of the second output data item and recorded in the line joining relationship portion of the selected composite paradigm, and the joining relationship between the first input data item and the third output data item is embodied by the second relative path of the first input data item and the second relative path of the third output data item.

For example, the at least part of input data items further includes a second part of input data items.

For example, in step S11, in the concatenation operation, joining at least part of input data items and/or at least part of output data items of at least two function blocks further includes: based on the type matching rule and/or the line joining requirement rule, joining the second part of input data items by an auxiliary merging joining line.

For example, the second part of input data items, joining the second part of input data items by an auxiliary merging joining line includes: joining the third input data item to the second input data item by the auxiliary merging joining line, setting the storage type attribute of the third input data item to the virtual storage while not changing the storage type attribute of the second input data item, and recording a joining relationship between the second input data item and the third input data item.

For example, the second input data item and the third input data item are positioned in the form of the second relative path; and the joining relationship between the second input data item and the third input data item is embodied by the second relative path of the second input data item and the second relative path of the third input data item and recorded in the interface and sequence contrast portion of the selected composite paradigm.

For example, for any input data item in the interface corresponding to any function block of at least two function blocks, the any input data item corresponds to a second relative path, and the second relative path of the any input data item represents a relative path of the any input data item in a composite function block and is represented in the following form:

Path(PF).in. Path(data_in2) (3)

where Path(PF) is a relative path of the any function block to which the any input data item belongs in the composite function block computed by: based on the concatenated structure of the composite function block (i.e., the computation sequence corresponding to the composite function block, it is specified that the function blocks are encoded in the computation sequence according to sequentially built-in relative addresses, and the encoding rule is 0, 1, 2 . . . ), between a function block of an outermost layer corresponding to the any function block in the composite function block and the any function block, acquiring the relative address attribute related to the any function block layer by layer, and computing the relative path of the any function block based on the relative address attribute related to the any function block; in represents that the any input data item is in the input portion of the interface corresponding to the composite function block; and Path(data_in2) is a relative path of the any input data item in the input portion of the interface corresponding to the any function block computed by: between an input data item of an outermost layer corresponding to the any input data item in the input portion of the interface corresponding to the any function block and the any input data item, obtaining the relative address attribute related to the any input data item layer by layer, and computing the relative path of the any input data item based on the relative address attribute related to the any input data item.

For example, for any output data item in the interface corresponding to any function block, the any output data item corresponds to a second relative path, and the second relative path of the any output data item represents a relative path of the any output data item in the composite function block and is represented in the following form:

Path(PF).out. Path(data_out2) (4)

where Path(PF) represents a relative path of the any function block to which the any output data item belongs in the composite function block; out represents that the any output data item is in the output portion of the interface corresponding to the any function block; and Path(data_out2) is a relative path of the any output data item in the output portion of the interface corresponding to the any function block computed by: between an output data item of an outermost layer corresponding to the any output data item in the output portion of the interface corresponding to the any function block and the any output data item, acquiring the relative address attribute related to the any output data item layer by layer, and computing the relative path of the any output data item based on the relative address attribute related to the any output data item.

For example, in some embodiments, the relative address attribute related to any function block may be joined using a point symbol (i.e., .) to obtain the relative path of the any function block in a composite function block obtained by compositing the any function block. That is, the relative path of a function block in a composite function block composed of the function block may be obtained by: according to a nested structure, joining the relative address attributes of all function blocks (including the function block of the outermost layer and the any function block) between the function block of the outermost layer, corresponding to the any function block, of the composite function block and the any function block by using the point symbol. Similarly, the relative path of an input data item in the input portion of an interface corresponding to a function block in which the input data item resides may be obtained by: according to a nested structure, joining the relative address attributes of all input data items between the input data item of the outermost layer, corresponding to the input data item, of the input portion and the input data item by using the point symbol. The relative path of an output data item in the output portion of an interface corresponding to a function block in which the output data item resides may be obtained by: according to a nested structure, joining the relative address attributes of all output data items (including the output data item of the outermost layer and the output data item) between the output data item of the outermost layer, corresponding to the output data item, of the output portion and the output data item by using the point symbol. For the specific computation processes of Path(data_in2) and Path(data_out2), a reference may be made to the data item positioning process described below.

It needs to be noted that in the XML architecture, the second relative path of any data item (an input data item or an output data item) is embodied in the PFVMS and VMS corresponding to a composite function block that corresponds to the any data item.

For example, in some embodiments, in the XML architecture of PFVMS/VMS corresponding to a composite function block, the path attribute of the destination label in a line label of the PFVMS or the path attribute of the source label or the destination label in a line label of the VMS may be used for storing the second relative path of any input data item or storing the second relative path of any output data item.

For example, after a computation sequence corresponding to at least two function blocks is organized, the internal data items of the at least two function blocks are joined in accordance with the line joining rule, thereby generating the VMS portion corresponding to a composite function block.

For example, in the XML, a data transfer line joining relationship in a computation sequence is stored in the VMS corresponding to a composite function block in the form of a second relative path, and a computation formula for the second relative path of a data item in the computation sequence may be as illustrated in the above formulas (3) and (4). The line joining relationship of an auxiliary merging joining line in a computation sequence is temporarily stored in the VMS in the form of a second relative path, and a computation formula for the second relative path of a data item in the computation sequence may also be as illustrated in the above computation formulas (3) and (4). After an interface is generated, the relationship of the auxiliary merging joining line will be stored in the PFVMS area, and the relationship of the auxiliary merging joining line in the VMS area will be deleted.

For example, in some embodiments, the XML representation of the VMS is as follows:

```
<VMS “>
  <line>
    <source path=“”/>
    <destination path=“” />
  </line>
</VMS>
```

In the above XML of the VMS, the XML of the VMS is used for recording a relationship of a data transfer joining line, i.e., storing directed joining lines starting from output data items. Each joining line is stored using a group of line labels. Each line label is internally composed of source and destination labels, and the path attribute of the source label stores the second relative path of a data item from which a directed line segment starts in a computation sequence, and the path attribute of the destination label stores the second relative path of a data item at which the directed line segment ends in the computation sequence. The memory (not illustrated) attribute represents the storage type attribute of a data item from or at which a line starts or ends. When memory=0, it represents that the storage type attribute of the data item is the virtual storage; and when memory=1, it represents it represents that the storage type attribute of the data item is the real storage. Storage type modification occurs in the memory attributes of data items serving as two endpoints of a directed line segment. It needs to be noted that the storage type attribute of any data item is the real storage by default, which is changed according to the line joining rule (the data transfer line joining rule and the practical line joining rule) during line joining.

The JSON representation of the VMS is as follows:

```
{
  “vms”:[[
    {
      “path”:“”
    },
    {
      “path”:“”
    },
  ],
  ...]
}
```

For example, the undirected attribute is used for distinguishing a type of the line joining relationship. Without no undirected attribute, it represents recording a data transfer joining line, namely storing a directed joining line starting from an output data item. With the undirected attribute, it represents temporarily storing an auxiliary merging joining line, namely storing an undirected joining line between input data items.

For example, the XML representation of the VMS corresponding to the data transfer joining line is as follows:

<VMS>
</VMS>

For example, the XML representation of the VMS corresponding to the auxiliary merging joining line is as follows:

<VMS undirected=“”>
</VMS>

For example, in some examples, recording the joining relationship between the first output data item and the second output data item may include: in the graphical representation, joining the second output data item to the first output data item using an output-output transfer line, with the arrow of the output-output transfer line pointing to the first output data item; and in the representation of the XML of the VMS of a composite function block, storing the second relative path of the second output data item through the path attribute of the source label, and storing the second relative path of the first output data item through the path attribute of the destination label.

For example, in some examples, recording the joining relationship between the first input data item and the third output data item may include: in the graphical representation, joining the third output data item to the first input data item using an output-input transfer line, with the arrow of the output-input transfer line pointing to the first input data item, and in the XML representation of the VMS of a composite function block, storing the second relative path of the third output data item through the path attribute of the source label, and storing the second relative path of the first input data item through the path attribute of the destination label.

For example, in some examples, recording the joining relationship between the second input data item and the third input data item includes: in the graphical representation, joining the second input data item and the third input data item using an auxiliary merging joining line with no arrow. For the relationship of an auxiliary merging joining line, in the organization process of a function block, the relationship of the auxiliary merging joining line is temporarily stored in the VMS area of which the attribute is undirected=“ ” and stored in the PFVMS after an interface is formed, and a portion corresponding to the relationship of the auxiliary merging joining line in the VMS is deleted, i.e., the portion of which the attribute is undirected=“ ”. The joining relationship between the second input data item and the third input data item may be temporarily stored in the XML representation of the VMS of the composite function block. For example, the second relative path of the second input data item is stored through the path attribute of the source label, and the second relative path of the third input data item is stored through the path attribute of the destination label. Alternatively, the second relative path of the third input data item is stored through the path attribute of the source label, and the second relative path of the second input data item is stored through the path attribute of the destination label.

For example, in the graphical representation, setting the storage type attribute of a data item to the virtual storage represents setting the circle representing the data item to a hollow circle, and setting the storage type attribute of a data item to the real storage represents setting the circle representing the data item to a solid circle. In the XML representation of a composite function block, setting the storage type attribute of a data item to the virtual storage represents setting the value of memory of the data item to 0, and setting the storage type attribute of a data item to the real storage represents setting the value of memory of the data item to 1. For example, for the first output data item and the second output data item, setting the storage type attribute of the second output data item to the virtual storage while not changing the storage type attribute of the first output data item includes: in the graphical representation, setting the circle representing the second output data item to a hollow circle and keeping the circle representing the first output data item unchanged; and in the XML representation of a composite function block, setting the value of the storage type attribute memory of the second output data item to 0, and keeping the storage type attribute memory of the first output data item unchanged. In other words, if the circle representing the first output data item is a solid circle in the graphical representation and the value of the storage type attribute memory of the first output data item is 1 in the XML representation of a composite function block, after the first output data item is joined by a line, the circle representing the first output data item is still the solid circle, and the storage type attribute memory of the first output data item is still 1.

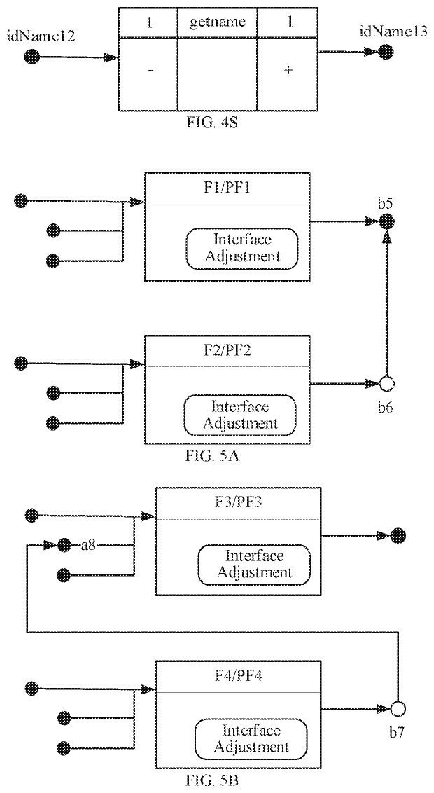

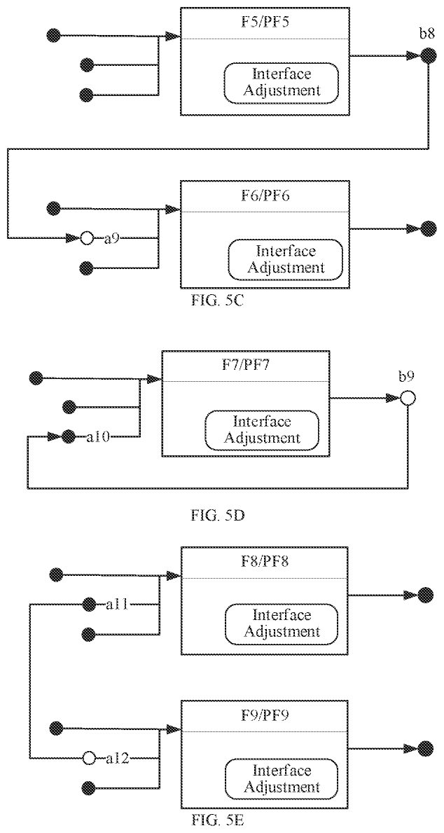

FIG. 5A is a schematic diagram of an output-output transfer line provided in an embodiment of the present disclosure.

For example, as illustrated in FIG. 5A, a composite function block includes function block F1/PF1 and function block F2/PF2. In a computing order, the function block F1/PF1 appears before the function block F2/PF2. The function block F1/PF1 includes output data item b5 (e.g., the above-mentioned first output data item), and the function block F2/PF2 includes output data item b6 (e.g., the above-mentioned second output data item). In the computing order, the output data item b6 appears after the output data item b5, and the output data item b6 may be joined to the output data item b5 by an output-output transfer line. In this case, the storage type attribute of the output data item b6 may be set to the virtual storage, i.e., the circle representing the output data item b6 is set to a hollow circle, and the storage type attribute of the output data item b5 remains unchanged, i.e., the circle representing the output data item b5 is still a solid circle. The XML corresponding to the output-output transfer line illustrated in FIG. 5A is as illustrated below:

```
  <PF id=“” name=“” >
  <PF id=“F1/PF1” name=“”>
  <in>
  <type id=“int2” name=“” value=“” typeclasss=“1” typevalue=“int2”
  typeid=“”>
  <type id=“” name=“” value=“” typeclasss=“0” typevalue=“int”
typeid=“”memory=“1”/>
  <type id=“” name=“” value=“” typeclasss=“0” typevalue=“int”
typeid=“”memory=“1”/>
  </type>
  </in>
  <out>
  <type id=“b5” name=“” value=“” typeclasss=“0” typevalue=“int”
typeid=“”memory=“1”/>
  </out>
  </PF>
  <PF id=“F2/PF2” name=“”>
  <in>
  <type id=“int2” name=“” value=“” typeclasss=“1” typevalue=“int2”
  typeid=“”>
  <type id=“” name=“” value=“” typeclasss=“0” typevalue=“int”
typeid=“”memory=“1”/>
”<type id=“” name=“” value=“” typeclasss=“0” typevalue=“int”
typeid=“”memory=“1”/>
  </type>
  </in>
  <out>
  <type id=“b6” name=“” value=“” typeclasss=“0” typevalue=“int”
typeid=“”memory=“0”/>
  </out>
  </PF>
  </PF>
```

For example, the joining relationship between the output data item b5 and the output data item b6 may be recorded in the VMS portion in the XML architecture of the composite function block, i.e., the output-output transfer line illustrated in FIG. 5A is recorded. In the XML architecture of the composite function block, the VMS corresponding to the output-output transfer line illustrated in FIG. 5A is as illustrated below:

```
<VMS>
  <line>
    <source path=“1.out.0” />
    <destination path=“0.out.0” />
  </line>
</VMS>
```

For example, both of the output data item b5 and the output data item b6 are data items of the int type. The path attribute of the destination label in a line label in the VMS is 0.out.0, which represents the second relative path of the output data item b5; and the path attribute of the source label in the line label in the VMS is 1.out.0, which represents the second relative path of the output data item b6. The memory of the output data item b5 is 1, which represents that the output data item b5 is the real storage, and the memory of the output data item b6 is 0, which represents that the output data item b6 is the virtual storage. The JSON representation corresponding to the output-output transfer line illustrated in FIG. 5A is as follows:

```
{
  “vms”:[[
    {
      “path”:“1.out.0”
    },
    {
      “path”:“0.out.0”
    }
  ]]
}
```

FIG. 5B is a schematic diagram of an output-input transfer line provided in an embodiment of the present disclosure.

For example, as illustrated in FIG. 5B, a composite function block includes function block F3/PF3 and function block F4/PF4. In a computing order, the function block F3/PF3 appears before the function block F4/PF4. The function block F3/PF3 includes input data item a8 (e.g., the above-mentioned first input data item), and the function block F4/PF4 includes output data item b7 (e.g., the above-mentioned third output data item). In the computing order, the output data item b7 appears after the input data item a8, and the output data item b7 and the input data item a8 do not belong to a same function block, and the output data item b7 may be joined to the input data item a8 by an output-input transfer line. In this case, the storage type attribute of the output data item b7 may be set to the virtual storage, i.e., the circle representing the output data item b7 is set to a hollow circle, and the storage type attribute of the input data item a8 remains unchanged, i.e., the circle representing the input data item a8 is still a solid circle. The XML corresponding to the output-input transfer line illustrated in FIG. 5B is as illustrated below:

```
  <PF id=“” name=“” >
  <PF id=“F3/PF3” name=“”>
  <in>
  <type id=“int2” name=“” value=“” typeclasss=“1” typevalue=“int2”
  typeid=“”>
  <type id=“a8” name=“” value=“” typeclasss=“0” typevalue=“int”
typeid=“”memory=“1”/>
  <type id=“” name=“” value=“” typeclasss=“0” typevalue=“int”
typeid=“”memory=“1”/>
  </type>
  </in>
  <out>
  <type id=“ ” name=“” value=“” typeclasss=“0” typevalue=“int”
typeid=“”memory=“1”/>
  </out>
  </PF>
  <PF id=“F4/PF4” name=“”>
  <in>
  <type id=“int2” name=“” value=“” typeclasss=“1” typevalue=“int2”
  typeid=“”>
  <type id=“” name=“” value=“” typeclasss=“0” typevalue=“int”
typeid=“”memory=“1”/>
  <type id=“” name=“” value=“” typeclasss=“0” typevalue=“int”
typeid=“”memory=“1”/>
  </type>
  </in>
  <out>
  <type id=“b7” name=“” value=“” typeclasss=“0” typevalue=“int”
typeid=“”memory=“0”/>
  </out>
  </PF>
  </PF>
```

For example, the joining relationship between the output data item b7 and the input data item a8 may be recorded in the VMS portion in the XML architecture of the composite function block, i.e., the output-input transfer line illustrated in FIG. 5B is recorded. In the XML architecture of the composite function block, the VMS corresponding to the output-input transfer line illustrated in FIG. 5B is as illustrated below:

```
<VMS>
  <line>
    <source path=“1.out.0” />
    <destination path=“0.in.0.0” />
  </line>
</VMS>
```

For example, both of the output data item b7 and the input data item a8 are data items of the int type. The path attribute of the source label in a line label in the VMS is 1.out.0, which represents the second relative path of the output data item b7; and the path attribute of the destination label in the line label in the VMS is 0.in.0.0, which represents the second relative path of the input data item a8. The memory of the output data item b7 is 0, which represents that the output data item b7 is the virtual storage, and the memory of the input data item a8 is 1, which represents that the input data item a8 is the real storage.

FIG. 5C is a schematic diagram of another output-input transfer line provided in an embodiment of the present disclosure.

For example, as illustrated in FIG. 5C, a composite function block includes function block F5/PF5 and function block F6/PF6. In a computing order, the function block F5/PF5 appears before the function block F6/PF6. The function block F5/PF5 includes output data item b8 (e.g., the above-mentioned third output data item), and the function block F6/PF6 includes input data item a9 (e.g., the above-mentioned first input data item). In the computing order, the output data item b8 appears before the input data item a9, and the output data item b8 and the input data item a9 do not belong to a same function block, and the output data item b8 may be joined to the input data item a9 by an output-input transfer line. In this case, the storage type attribute of the input data item a9 may be set to the virtual storage, i.e., the circle representing the input data item a9 is set to a hollow circle, and the storage type attribute of the output data item b8 remains unchanged, i.e., the circle representing the output data item b8 is still a solid circle. The XML corresponding to the output-input transfer line illustrated in FIG. 5C is as illustrated below:

```
  <PF id=“” name=“” >
  <PF id=“F5/PF5” name=“”>
  <in>
  <type id=“int2” name=“” value=“” typeclasss=“1” typevalue=“int2”
  typeid=“”>
  <type id=“ ” name=“” value=“” typeclasss=“0” typevalue=“int”
typeid=“”memory=“1”/>
  <type id=“” name=“” value=“” typeclasss=“0” typevalue=“int”
typeid=“”memory=“1”/>
  </type>
  </in>
  <out>
  <type id=“b8” name=“” value=“” typeclasss=“0” typevalue=“int”
typeid=“”memory=“1”/>
  </out>
  </PF>
  <PF id=“F6/PF6” name=“”>
  <in>
  <type id=“int2” name=“” value=“” typeclasss=“1” typevalue=“int2”
  typeid=“”>
  <type id=“a9” name=“” value=“” typeclasss=“0” typevalue=“int”
typeid=“”memory=“0”/>
  <type id=“” name=“” value=“” typeclasss=“0” typevalue=“int”
typeid=“”memory=“1”/>
  </type>
  </in>
  <out>
  <type id=“” name=“” value=“” typeclasss=“0” typevalue=“int”
typeid=“”memory=“1”/>
  </out>
  </PF>
  </PF>
```

For example, the joining relationship between the output data item b8 and the input data item a9 may be recorded in the VMS portion in the XML architecture of the composite function block, i.e., the output-input transfer line illustrated in FIG. 5C is recorded. In the XML architecture of the composite function block, the VMS corresponding to the output-input transfer line illustrated in FIG. 5C is as illustrated below.

```
<VMS>
  <line>
    <source path=“0.out.0” />
    <destination path=“1.in.0.0” />
  </line>
</VMS>
```

For example, both of the output data item b8 and the input data item a9 are data items of the int type. The path attribute of the source label in a line label in the VMS is 0.out.0, which represents the second relative path of the output data item b8; and the path attribute of the destination label in the line label in the VMS is 1.in.0.0, which represents the second relative path of the input data item a9. The memory of the output data item b8 is 1, which represents that the output data item b8 is the real storage, and the memory of the input data item a9 is 0, which represents that the input data item a9 is the virtual storage.

FIG. 5D is a schematic diagram of further another output-input transfer line provided in an embodiment of the present disclosure.

For example, as illustrated in FIG. 5D, a composite function block includes function block F7/PF7. The function block F5/PF5 includes output data item b9 (e.g., the above-mentioned third output data item) and input data item a10 (e.g., the above-mentioned first input data item). In a computing order, the output data item b9 appears after the input data item a10, and the output data item b9 and the input data item a10 belong to the same function block, and the output data item b9 may be joined to the input data item a10 by an output-input transfer line. In this case, the storage type attribute of the input data item a10 remains unchanged, i.e., the circle representing the input data item a10 is still a solid circle, and the storage type attribute of the output data item b9 may be set to the virtual storage, i.e., the circle representing the output data item b9 is set to a hollow circle. The XML corresponding to the output-input transfer line illustrated in FIG. 5D is as illustrated below.

```
  <PF id=“” name=“” >
  <PF id=“F7/PF7” name=“”>
  <in>
  <type id=“int2” name=“” value=“” typeclasss=“1” typevalue=“int2”
  typeid=“”>
  <type id=“” name=“” value=“” typeclasss=“0” typevalue=“int”
typeid=“”memory=“1”/>
  <type id=“a10” name =“” value=“” typeclasss=“0” typevalue=“int”
typeid=“”memory=“1”/>
  </type>
  </in>
  <out>
  <type id=“b9” name=“” value=“” typeclasss=“0” typevalue=“int”
typeid=“”memory=“0”/>
  </out>
  </PF>
  </PF>
```

For example, the joining relationship between the output data item b9 and the input data item a10 may be recorded in the VMS portion in the XML architecture of the composite function block, i.e., the output-input transfer line illustrated in FIG. 5D is recorded. In the XML architecture of the composite function block, the VMS corresponding to the output-input transfer line illustrated in FIG. 5D is as illustrated below:

```
<VMS>
  <line>
    <source path=“0.out.0” />
    <destination path=“0.in.0.1” />
  </line>
</VMS>
```

For example, both of the output data item b9 and the input data item a10 are data items of the int type. The path attribute of the source label in a line label in the VMS is 0.out.0, which represents the second relative path of the output data item b9; and the path attribute of the destination label in the line label in the VMS is 0.in.0.1, which represents the second relative path of the input data item a10. The memory of the output data item b9 is 0, which represents that the output data item b9 is the virtual storage, and the memory of the input data item a10 is 1, which represents that the input data item a10 is the real storage.

FIG. 5E is a schematic diagram of an auxiliary merging joining line provided in an embodiment of the present disclosure.

For example, as illustrated in FIG. 5E, a composite function block includes function block F8/PF8 and function block F9/PF9. In a computing order, the function block F8/PF8 appears before the function block F9/PF9. The function block F8/PF8 includes input data item a11 (e.g., the above-mentioned second input data item), and the function block F9/PF9 includes input data item a12 (e.g., the above-mentioned third input data item). In the computing order, the input data item a11 appears before the input data item a12, and the input data item a11 and the input data item a12 do not belong to a same function block, and the input data item a11 may be joined to the input data item a12 by an auxiliary merging joining line. In this case, the storage type attribute of the input data item a11 remains unchanged, i.e., the circle representing the input data item a11 is still a solid circle, and the memory type attribute of the input data item a12 may be set to the virtual storage, i.e., the circle representing the input data item a12 is set to a hollow circle. The XML corresponding to the output-input transfer line illustrated in FIG. 5E is as illustrated below:

```
  <PF id=“” name=“” >
  <PF id=“F8/PF8” name=“”
  <in>
  <type id=“int2” name=“” value=“” typeclasss=“1” typevalue=“int2”
  typeid=“”>
  <type id=“a11” name=“” value=“” typeclasss=“0” typevalue=“int”
typeid=“”memory=“1”/>
  <type id=“” name=“” value=“” typeclasss=“0” typevalue=“int”
typeid=“”memory=“1”/>
  </type>
  </in>
  <out>
  <type id=“ ” name=“” value=“” typeclasss=“0” typevalue=“int”
typeid=“”memory=“1”/>
  </out>
  </PF>
  <PF id=“F9/PF9” name=“”>
  <in>
  <type id=“int2” name=“” value=“” typeclasss=“1” typevalue=“int2”
  typeid=“”>
  <type id=“a12” name=“” value=“” typeclasss=“0” typevalue=“int”
typeid=“”memory=“0”/>
  <type id=“” name=“” value=“” typeclasss=“0” typevalue=“int”
typeid=“”memory=“1”/>
  </type>
  </in>
  <out>
  <type id=“” name=“” value=“” typeclasss=“0” typevalue=“int”
typeid=“”memory=“1”/>
  </out>
  </PF>
  </PF>
```

For example, the joining relationship between the input data item a11 and the input data item a12 may be recorded in the VMS portion in the XML architecture of the composite function block, i.e., the auxiliary merging joining line illustrated in FIG. 5E is recorded. The attribute of the VMS portion is undirected=“ ”. After the interface is formed, the joining relationship is updated in the PFVMS portion, and the related content in the VMS portion is deleted.

In the XML architecture of the composite function block, the VMS corresponding to the auxiliary merging joining line illustrated in FIG. 5E is as illustrated below:

```
<VMS undirected=“”>
  <line>
    <source path=“0.in.0.0” />
    <destination path=“1.in.0.0” />
  </line>
</VMS>
```

For example, both of the input data item all and the input data item a12 are data items of the int type. The path attribute of the source label in a line label in the VMS is 0.in.0.0, which represents the second relative path of the input data item a11; and the path attribute of the destination label in the line label in the VMS is 1.in.0.0, which represents the second relative path of the input data item a12. The memory of the input data item a11 is 1, which represents that the input data item a11 is the real storage, and the memory of the input data item a12 is 0, which represents that the input data item a12 is the virtual storage.

For example, as illustrated in FIG. 1, the interface corresponding to each function block of the plurality of function blocks includes the input portion and the output portion. In step S13, encapsulating the at least two function blocks into a composite function block and generating an interface corresponding to the composite function block include: compositing and encapsulating at least one input data item corresponding to the composite function block and extracted as an interface to obtain the input portion of the interface corresponding to the composite function block; and compositing and encapsulating at least one output data item corresponding to the composite function block and extracted as an interface to obtain the output portion of the interface corresponding to the composite function block.

For example, the interface corresponding to the composite function block is stored in the interface portion of the selected composite paradigm.

The input portions of all the function blocks (i.e., the at least two function blocks for forming the composite function block) in a computation sequence are sequentially merged to determine the input portion of the interface corresponding to the composite function block, and the output portions of all the function blocks in the computation sequence are sequentially merged to determine the output portion of the interface corresponding to the composite function block. For example, in some examples, input data items extracted as an interface may be sequentially composited into one or more input data items that serve as the input portion of the interface. For example, the one or more input data items may include a data item of the composite data type other than the Exclusive OR type, or may include a data item of the basic data type or a data item of the pointer type or the generic type. Output data items extracted as an interface may be sequentially composited into one or more output data items that serve as the output portion of the interface. For example, the one or more output data items may include a data item of the composite data type, or may include a data item of the basic data type or a data item of the pointer type or the generic type.

For example, in step S13, encapsulating the at least two function blocks into a composite function block and generating an interface corresponding to the composite function block further include at least one of: for any function block of the at least two function blocks, when the data type attribute of any input data item or output data item corresponding to the any function block is the composite data type, in the case that a particular data item with the any input data item or output data item is not extracted as a portion of the interface corresponding to the composite function block, breaking apart the any input data item or output data item, not extracting the particular data item, and recompositing the remaining data items of the any input data item or output data item as a portion of the interface corresponding to the composite function block; for any function block of the at least two function blocks, when any input data item or output data item corresponding to the any function block is a data item of the pointer type and the any input data item or output data item of the pointer type is extracted as a portion of the interface corresponding to the composite function block, not breaking apart the data structure of the any input data item or output data item of the pointer type: for any function block of the at least two function blocks, when any input data item or output data item corresponding to the any function block is a constant data item, not extracting the any constant input data item or constant output data item as a portion of the interface corresponding to the composite function block; for input data items corresponding to the at least two function blocks, not extracting an input data item whose the storage type attribute is the virtual storage as a portion of the interface corresponding to the composite function block; for any output data item corresponding to the at least two function blocks, in response to the any output data item being directly or indirectly joined to at least one output data item by the data transfer joining line, acquiring an output data item first appearing among the any output data item and the at least one output data item as an output data item to be extracted; when the output data item to be extracted is joined to any input data item, in the case that the output data item to be extracted appears before the any input data item, not extracting the output data item to be extracted as a portion of the interface corresponding to the composite function block; and in the case that the output data item to be extracted appears after the any input data item or the output data item to be extracted and the any input data item belong to a same function block, extracting the output data item to be extracted as a portion of the interface corresponding to the composite function block, and extracting, as needed, part data items, not extracted as an interface, of output data items corresponding to the at least two function blocks as the interface; and for the output data items corresponding to the at least two function blocks, extracting all the output data items corresponding to the at least two function blocks as the interface corresponding to the composite function block.

For example, if the data type of a data item extracted as the interface is the pointer type, the internal data structure of the data item of the pointer type is not broken apart. The input portions and the output portions of all function blocks in a computation sequence are sequentially merged, respectively. If the composite structure of a same function block includes a data item not extracted as the interface, other data items than the data item are recomposited and extracted as a portion of the interface, and the data item is not involved in recompositing and does not serve as a portion of the interface.

For example, for input data items corresponding to at least two function blocks, an input data item of which the storage type attribute is the real storage is extracted as a portion of the interface corresponding to a composite function block, and an input data item of which the storage type attribute is the virtual storage is not extracted as a portion of the interface corresponding to the composite function block, and an input data item of the constant type is not extracted as a portion of the interface corresponding to the composite function block.

For example, for output data items corresponding to the at least two function blocks, the output data items may be extracted in the following three ways. First, all the output data items are extracted as a portion of the interface corresponding to the composite function block. Second, the user may select whether to extract an output data item as a portion of the interface corresponding to the composite function block. Third, for any output data item corresponding to the at least two function blocks, whether the any output data item has at least one output data item in a direct line joining relationship and an indirect line joining relationship is determined first. If yes, an output data item first appearing among the any output data item and the at least one output data item is acquired as an output data item to be extracted. In the case that the output data item to be extracted is joined to any input data item, if the output data item to be extracted appears before the any input data item, the output data item to be extracted is not extracted as a portion of the interface corresponding to the composite function block. If the output data item to be extracted appears after the any input data item or the output data item to be extracted and the any input data item belong to a same function block, the output data item to be extracted is extracted as a portion of the interface corresponding to the composite function block. Finally, for an output data item, not extracted to the interface corresponding to the composite function block, in the at least two function blocks, the user may select whether to extract it as a portion of the interface corresponding to the composite function block. For example, the user selection process may be carried out at any time after the completion of interface extraction, e.g., when output data items are found to be insufficient during the use of the PF. For example, other output data items than the output data item to be extracted among the any output data item and the at least one output data item are not extracted as a portion of the interface corresponding to the composite function block.

It needs to be noted that in the case that the output data item to be extracted appears after the any input data item or the output data item to be extracted and the any input data item belong to a same function block, and the output data item to be extracted is extracted as a portion of the interface corresponding to the composite function block, when the composite function block is used, the line joining relationship between the output data item to be extracted and the any input data item needs to be represented on the interface corresponding to the composite function block.

For example, in a same function block in the computation sequence, if there is a data item not extracted as the interface corresponding to the composite function block in a composite data item (i.e., of which the data type attribute is the composite data type, and which may be an input data item or an output data item), when an interface is extracted, the composite structure of the composite data item is broken apart, and the data items in the composite data items are recomposited. All outer-layer composite types of the composite data item are removed to expose the remaining data items, extracted as the interface, in the composite data item, and then these data items are recomposited according to a composition rule.

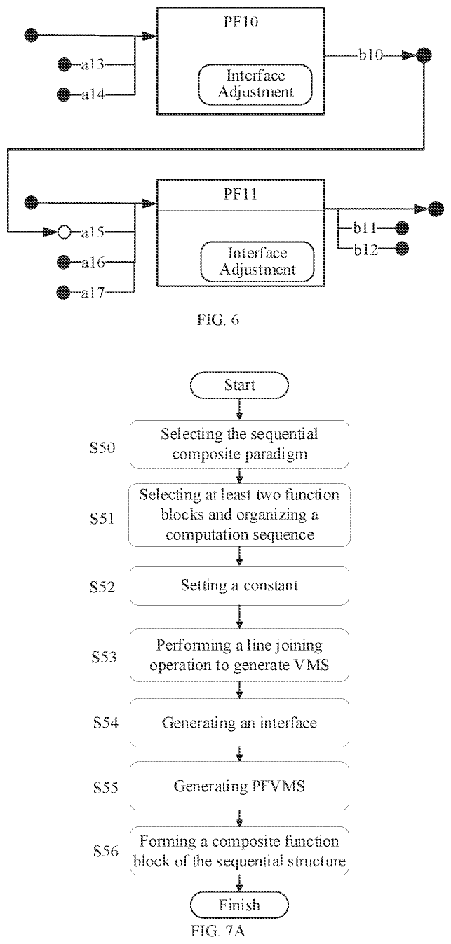

FIG. 6 is a schematic diagram of a composite function block provided in some embodiments of the present disclosure.

For example, as illustrated in FIG. 6, the composite function block includes function block PF10 and function block PF11. The function block PF10 has two input data items a13 and a14 and one output data item b10, and the function block PF11 has three input data items a15, a16, and a17, and two output data items b11 and b12.

For example, the XML representation of the computation sequence portion in the XML architecture of the composite function block is as follows:

```
  <PF id=“PF10” name=“”>
  <in>
  <type id=“” name=“” value=“” typeclass=“1” typevalue=“int2”
typeid=“int2” memory=“1”>
  <type id=“a13” name=“” value=“” typeclass=“0” typevalue=“int”
typeid=“int”memory=“1”/>
  <type id=“a14” name=“” value=“” typeclass=“0” typevalue=“int”
typeid=“int”memory=“1”/>
  </type>
  </in>
  <out>
  <type id=“b10” name=“” value=“” typeclass=“0” typevalue=“int”
typeid=“int”memory=“1”/>
  </out>
  </PF>
  <PF id=“PF11” name=“”>
  <in>
  <type id=“” name=“” value=“” typeclass=“1” typevalue=“intintint”
typeid=“ intintint” memory=“1”>
  <type id=“a15” name=“” value=“” typeclass=“0” typevalue=“int”
typeid=“int”memory=“1”/>
  <type id=“a16” name=“” value=“” typeclass=“0” typevalue=“int”
typeid=“int”memory=“1”/>
  <type id=“a17” name=“” value=“” typeclass=“0” typevalue=“int”
typeid=“int”memory=“1”/>
  </type>
  </in>
  <out>
  <type id=“” name=“” value=“” typeclass=“1” typevalue=“int2”
typeid=“int2” memory=“1”>
  <type id=“b11” name=“” value=“” typeclass=“0” typevalue=“int”
typeid=“int” memory=“1”/>
  <type id=“b12” name=“” value=“” typeclass=“0” typevalue=“int”
typeid=“int” memory=“1”/>
  </type>
  </out>
  </PF>
```

For example, there is a line joining relationship between a first input pin, namely the input data item a15, in the function block PF11 and a first output pin, namely the output data item b10, in the function block PF10, i.e., the output data item b10 is joined to the input data item a15 by an output-to-input transfer line. In this case, the input data item a15 is not extracted as the interface. Thus, when the interface corresponding to the composite function block is generated, the input data item of the composite data type in the input portion of the interface corresponding to the function block PF11 is broken apart, i.e., the outer-layer composite structure of the input portion is removed to expose the remaining data items (i.e., the input data item a16 and the input data item a17) in the composite structure, and the remaining data items are recomposited and extracted as a portion of the interface corresponding to the composite function block. Subsequently, according to a composition rule, the data items are recomposited, i.e., the input data item (the composite data item formed by compositing the input data items a13 and a14) in the interface corresponding to the function block PF10 and the input data item a16 and the input data item a17 in the interface corresponding to the function block PF11 are recomposited to obtain the input portion of the interface corresponding to the composite function block.

The output data item b11 and the output data item b12 in the output portion of the interface corresponding to the function block PF11 are composited to obtain the output portion of the interface corresponding to the composite function block.

For example, because the composite input data formed by compositing the input data items a13 and a14 corresponding to the function block PF10 is not broken apart, the composite structure of the composite input data item remains unchanged.

For example, the input data item a15 corresponding to the function block PF11 is not extracted as a portion of the interface corresponding to the composite function block, the composite input data item formed by compositing the input data items a15, a16, and a17 corresponding to the function block PF11 is broken apart, and the input data items a16 and a17 and the composite input data item corresponding to the function block PF10 are recomposited to obtain an input data item of the composite function block.

For example, the XML representation of the interface portion in the XML architecture of the composite function block is as follows:

```
  <PF id=“user-defined Pf title” name=“algorithm naming”>
    <in>
      <type name=“” typeclass=“1” typevalue=“int2intint”
      typeid=“int2(intint)”>
        <type id=“” name=“” value=“” typeclass=“1” typevalue=“int2”
typeid=“int2”>
            <type id=“a13” name=“” value=“” typeclass=“0”
typevalue=“int” typeid=“int” />
            <type id=“a14” name=“” value=“” typeclass=“0”
typevalue=“int” typeid=“int” />
        </type>
        <type id=“” name=“” value=“” typeclass=“1” typevalue=“intint”
typeid=“ intint”>
            <type id=“a16” name=“” value=“” typeclass=“0”
typevalue=“int” typeid=“int” />
            <type id=“a17” name=“” value=“” typeclass=“0”
typevalue=“int” typeid=“int” />
        </type>
    </in>
    <out>
        <type id=“” name=“” value=“” typeclass=“1” typevalue=“int2”
typeid=“int2” memory=“1”/>
          <type id=“b11” name=“” value=“” typeclass=“0”
typevalue=“int” typeid=“int” memory=“1”/>
          <type id=“b12” name=“” value=“” typeclass=“0”
typevalue=“int” typeid=“int” memory=“1”/>
        </type>
    </out>
  </PF>
```

As can be seen from the above XML of the interface portion, the data type attributes of the input data items in the input portion of the interface corresponding to the composite function block are int2(intint). The input portion includes a three-layer structure. A first layer of the input portion includes input data item int2(intint) of the composite data type. In the first layer of the input portion, the relative address attribute of the input data item int2(intint) is 0. A second layer of the input portion includes composite input data item int2 (the data type attribute is the composite data type, e.g., int2, namely a13 and a14) and composite input data item intint (the data type attribute is the composite data type, e.g., intint, namely a16 and a17). In the second layer of the input portion, the relative address attribute of the composite input data item int2 is 0, and the relative address attribute of the composite input data item intint is 1. A third layer of the input portion includes the input data item a13 (the data type attribute is the basic data type, e.g., int) and the input data item a14 (the data type attribute is the basic data type, e.g., int) in the composite input data item int2, and further includes the input data item a16 (the data type attribute is the basic data type, e.g., int) and the input data item a17 (the data type attribute is the basic data type, e.g., int) in the composite input data item intint. In the third layer of the input portion, the relative address attribute of the input data item a13 is 0, the relative address attribute of the input data item a14 is 1, the relative address attribute of the input data item a16 is 0, and the relative address attribute of the input data item a17 is 1.

It needs to be noted that the memory attribute is visually and automatically set, and by default, memory=1.

The data type attributes of the output data items in the output portion of the interface corresponding to the composite function block are int2. The output portion includes a two-layer structure. A first layer of the output portion includes output data item int2 of the composite data type. In the first layer of the output portion, the relative address attribute of the output data item int2 is 0. A second layer of the output portion includes the output data item b11 (the data type attribute is the basic data type, e.g., int) and the output data item b12 (the data type attribute is the basic data type, e.g., int). In the second layer of the output portion, the relative address attribute of the output data item b11 is 0, and the relative address attribute of the output data item b12 is 1.

For example, as illustrated in FIG. 6, the circles representing the input data item a13, the input data item a14, the input data item a16, the input data item a17, the output data item b10, the output data item b11, and the output data item b12 are all solid circles, i.e., the storage type attributes of the input data item a13, the input data item a14, the input data item a16, the input data item a17, the output data item b10, the output data item b11, and the output data item b12 are all the real storages. The circle representing the input data item a15 is a hollow circle, i.e., the storage type attribute of the input data item a15 is the virtual storage. The input data item a15 and the output data item b10 are joined by a data transfer joining line (a line with an arrow pointing to the input data item a15).

For example, in some embodiments, the method provided in the present disclosure further includes: selecting at least one basic function block representing the assignment expression and at least one basic function block representing the relational expression from the basic function blocks as the at least two function blocks. For example, in some other embodiments, the basic function block representing the arithmetical expression includes a basic function block representing integer addition and a basic function block representing integer subtraction. The method provided in the present disclosure further includes: selecting at least one basic function block representing integer addition and/or at least one basic function block representing integer subtraction and at least one basic function block representing the relational expression from the basic function blocks as the at least two function blocks. In this case, compositing the at least two function blocks according to at least one composite paradigm of a plurality of composite paradigms includes: selecting at least one of the sequential composite paradigm, the conditional composite paradigm, the looping composite paradigm, and the while looping composite paradigm as the at least one composite paradigm; and compositing the at least two function blocks according to the at least one composite paradigm.

The following describes processes of compositing at least two function blocks based on different composite paradigms and performing the concatenation operation to finally obtain composite function blocks.

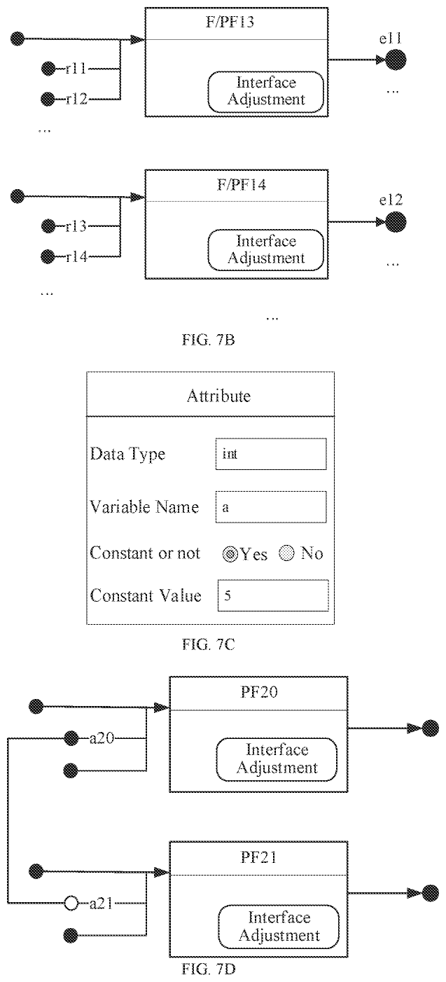

FIG. 7A is a schematic diagram of a method for compositing function blocks based on a sequential composite paradigm provided in some embodiments of the present disclosure; FIG. 7B is a schematic diagram illustrating graphical representations of at least two function blocks provided in some embodiments of the present disclosure; and FIG. 7C is a schematic diagram illustrating a graphical representation of a constant data item provided in some embodiments of the present disclosure.

For example, in the process of organizing a composite function block having the sequential structure, at least one function block is utilized to gradually fill a structure template of the sequential composite paradigm.

For example, as illustrated in FIG. 7A, the method for compositing function blocks based on the sequential composite paradigm includes steps S50 to S56.

For example, step S50 includes: selecting the sequential composite paradigm.

For example, step S51 includes: selecting at least two function blocks and organizing a computation sequence.

For example, the at least two function blocks (basic function blocks and/or composite function blocks) may be selected from a function block library, and are arranged based on the sequential composite paradigm and an arrangement operation to form the corresponding computation sequence. In the sequential composite paradigm, the at least two function blocks may be sequentially composited. The id values of data items in the at least two function blocks may be specified, i.e., the id values of the data items may be modified as needed, causing the computation sequence more comprehensible.

For example, as illustrated in FIG. 7B, in some embodiments, the number of the at least two function blocks is 2. That is, two function blocks F/PF13 and F/PF14 are selected from the function block library. FIG. 7B illustrates the graphical representations of the two function blocks F/PF13 and F/PF14. For example, the function block F/PF13 includes input data items r11 and r12, etc., and further includes output data item e11, etc.; and the function block F/PF14 includes input data items r13 and r14, etc., and further includes output data item e12, etc. The function blocks F/PF13 and F/PF14 may be basic function blocks, or may be composite function blocks. It needs to be noted that the present disclosure is not limited thereto, and the number of the at least two function blocks may also be 3, 5, or more or less.

For example, the XML representation of the computation sequence formed by the two function blocks F/PF13 and F/PF14 is as follows:

<F/PF id=“F/PF13” name=“system number”>
<in>
<type id=“” name=“” value=“” typeclass=“” typevalue=“T” typeid=“”>
<type id=“r11” name=“” value=“” typeclass=“” typevalue=“T1”
typeid=“” />
<type id=“r12” name=“” value=“” typeclass=“” typevalue=“T2”
typeid=“” />
...
</type>
</in>
<out>
<type id=“e11” name=“” value=“” typeclass=“” typevalue=“T3”
typeid=“” />
</out>
</F/PF>
<F/PF id=“ F/PF14” name=“ system number”>
<in>
<type id=“” name=“” value=“” typeclass=“” typevalue=“T” typeid=“”>
<type id=“r13” name=“” value=“” typeclass=“” typevalue=“T4”
typeid=“” />
<type id=“r14” name=“” value=“” typeclass=“” typevalue=“T5”
typeid=“” />
...
</type>
</in>
<out>
<type id=“e12” name=“” value=“” typeclass=“” typevalue=“T6”
typeid=“” />
</out>
</F/PF>

For example, the name attribute of the function block F/PF13 represents the global address (i.e., a system number) of the function block F/PF13 in the function block library and remains unchanged. Similarly, the name attribute of the function block F/PF14 represents the global address (i.e., a system number) of the function block PF12 in the function block library and remains unchanged.

For example, when the function block F/PF13 or the function block F/PF14 is a basic function block, the XML of the function block F/PF13 or the function block F/PF14 is included between <F> and </F>. When the function block F/PF13 or the function block F/PF14 is a composite function block, the XML of the function block F/PF13 or the function block F/PF14 is included between <PF> and </PF>.

For example, after the computation sequence is formed, attribute setting may be performed on the data items. Step S52 includes: setting a constant. The attribute setting includes: selecting a data item. The attribute value of the data item may be initialized in an attribute area. For example, the attribute setting may include constant setting. For example, if one data item in the computation sequence is a constant data item, the constant attribute of the constant data item is modified, as illustrated in FIG. 7C. For example, data item a of the int type is a constant data item, and the value of the data item a is set to 5.

For example, the user may modify the id of an input/output data item in the computation sequence as needed. In the graphical representation illustrated in FIG. 7C, “variable name” is the id of the data item. For example, in the example illustrated in FIG. 7C, the id of the data item may be set to a. The data item a is selected as a constant and set to have a constant value of 5.

The value of the constant data item is directly stored in the value attribute of the data item.

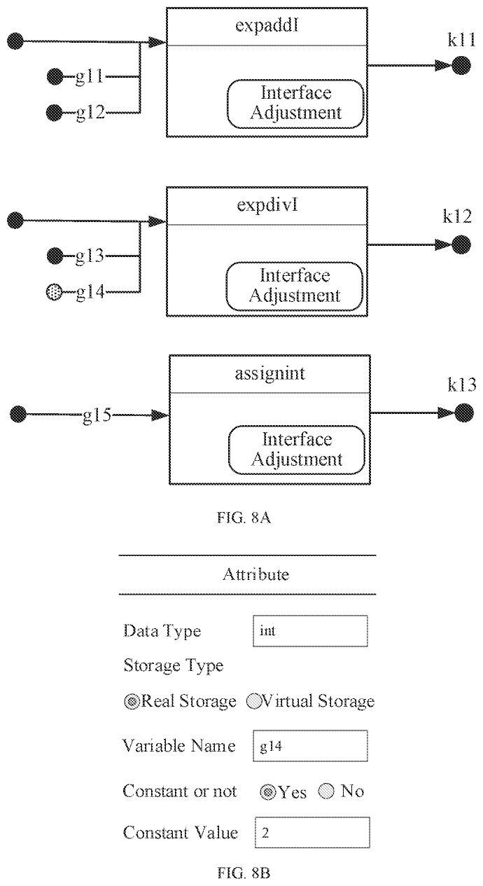

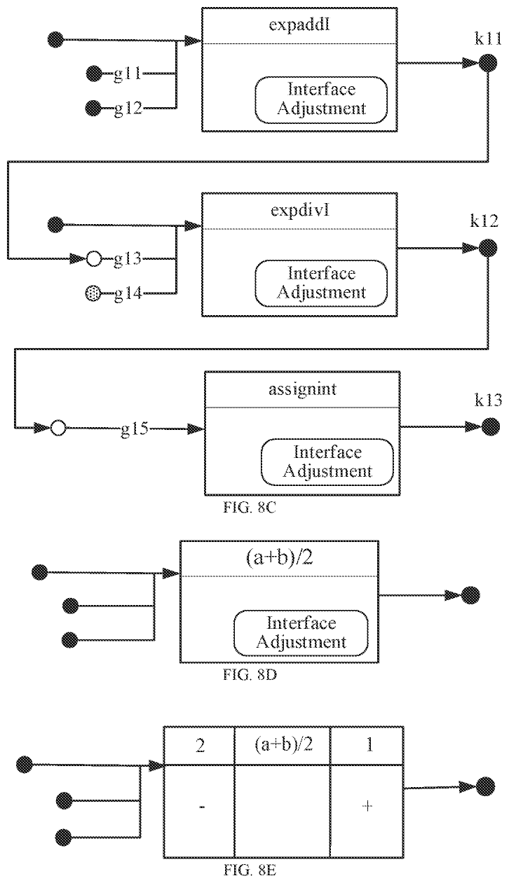

FIG. 8A is a schematic diagram illustrating a graphical representation of a computation sequence provided in some embodiments of the present disclosure; FIG. 8B is a schematic diagram illustrating a graphical representation of the constant data item illustrated in FIG. 8A; and FIG. 8C is a schematic diagram illustrating a graphical representation of the computation sequence illustrated in FIG. 8A after joining by a line.

For example, in one example, there is a need to construct a composite function block to realize the computing functionality of averaging two pieces of data of the int type. For example, the mathematical function expression corresponding to the computing functionality is as follows: y=(a+b)/2. As can be seen based on the analysis on the mathematical function corresponding to the computing functionality, an addition function block (for realizing the adding computing functionality), a division function block (for realizing the dividing computing functionality), and an assignment function block (for realizing the assigning functionality) may be selected to realize the computing functionality.

Firstly, as illustrated in FIG. 8A, three function blocks are selected from the function block library, which are addition function block expaddI, division function block expdivI, and assignment function block assignint. The three function blocks are arranged based on the sequential composite paradigm and the arrangement operation to obtain the corresponding computation sequence. The graphical representation of the computation sequence composed of the three function blocks is as illustrated in FIG. 8A. As illustrated in FIG. 8A, the addition function block expaddI includes two input data items g11 and g12 and one output data item k11. The division function block expdivI includes two input data items g13 and g14 and one output data item k12. The assignment function block assignint includes one input data item g15 and one output data item k13.

For example, as illustrated in FIG. 8A, the input data item g14 corresponding to a second input pin of the division function block expdivI is a constant data item, and the value of the constant data item g14 may be 2. For example, as illustrated in FIG. 8B, the value of the constant data item g14 is set to 2; the variable name corresponding to the constant data item g14 is g14; the data type attribute of the constant data item g14 is the int type; and the storage type attribute corresponding to the constant data item g14 is the real storage.

For example, the XML representation of the computation sequence composed of the three function blocks is as follows:

```
  <F id=“expaddI” name=“” >
  <in>
  <type id=“” name=“” value=“” typeclass=“1” typevalue=“int2” typeid=“”>
  <type id=“g11” name=“” value=“” typeclass=“0” typevalue=“int” typeid=“”
memory=“1”/>
  <type id=“g12” name=“” value=“” typeclass=“0” typevalue=“int” typeid=“”
memory=“1”/>
  </type>
  </in>
  <out>
  <type id=“k11” name=“” value=“” typeclass=“0” typevalue=“int”
typeid=“”memory=“1” />
  </out>
  </F>
  <F id=“expdiv1” name=“”>
  <in>
  <type id=“” name=“” value=“” typeclass=“1” typevalue=“int2” typeid=“”>
  <type id=“g13” name=“” value=“” typeclass=“0” typevalue=“int” typeid=“”
memory=“1”/>
  <type id=“g14” name=“” value=“” typeclass=“0” typevalue=“int” typeid=“”
memory=“1” />
  </type>
  </in>
  <out>
  <type id=“k12” name=“” value=“” typeclass=“0” typevalue=“int”
typeid=“”memory=“1” />
  </out>
  </F>
  <F id=“assignint” name=“” >
  <in>
  <type id=“g15” name=“” value=“” typeclass=“0” typevalue=“int” typeid=“”
memory=“1” />
  </in>
  <out>
  <type id=“k13” name=“” value=“” typeclass=“0” typevalue=“int” typeid=“”
memory=“1”/>
  </out>
  </F>
```

For example, in the above XML of the computation sequence, because the addition function block expaddI, the division function block expdivI, and the assignment function block assignint are all basic function blocks, the XML of each of the addition function block expaddI, the division function block expdivI, and the assignment function block assignint is included between <F> and </F>.

Because the division function block expdivI includes the input data item g14 of the constant type and the value of the input data item g14 of the constant type is 2, the value attribute of the input data item g14 is set to 2.

```
  <F id=“expdivI” name=“”>
  <in>
  <type id=“” name=“” value=“” typeclass=“1” typevalue=“int2” typeid=“”>
  <type id=“g13” name=“” value=“” typeclass=“0” typevalue=“int” typeid=“”
memory=“1”/>
  <type id=“g14” name=“” value=“2” typeclass=“0” typevalue=“int” typeid=“”
memory=“1”/>
  </type>
  </in>
  <out>
  <type id=“k12” name=“” value=“” typeclass=“0” typevalue=“int” typeid=“”
memory=“1”/>
  </out>
  </F>
```

For example, the storage type attributes of data items (input data items and output data items) are set to 1 by default, i.e., memory=“1”. However, the present disclosure is not limited thereto. The storage type attributes of the data items may be set to null, i.e., no any value is set, and memory=“ ”.

For example, as illustrated in FIG. 7A, step S53 includes performing a line joining operation to generate VMS, i.e., performing the operations of a data transfer joining line and an auxiliary merging joining line. In step S53, according to the computation sequence, which data items (input data items and/or output data items) in the at least two function blocks may be joined by a data transfer joining line and/or an auxiliary merging joining line is determined. That is, after the computation sequence is obtained, the internal data items of the composite function block may be joined in accordance with line joining rules to generate the VMS corresponding to the composite function block.

For example, for two data items of which the data type attributes match and the data class attributes are identical, they may be joined by the data transfer joining line and/or the auxiliary merging joining line.

If a data item is of the basic composite data type, i.e., typeclass=1, the expanding action may be performed on the data item. The expanding action has no influence on the data type attributes and the data class attributes of the data item and the data items included therein. After expanding with respect to the composite data type, type matching judgement may be performed on the data items included therein. After type matching is successful, the line joining action may be performed on the data items included therein. If a data item included in a composite data item is also a data item of the composite data type, the expanding action may be continuously applied to the data item included therein until the type of the data item meets the type matching rule or the data item is of the basic data type, the generic pointer type, or the generic type.

In some embodiments, when an output data item and an input data item meet the type matching rule, the output data item is joined to the input data item by an output-input transfer line of the data transfer joining line. If the output data item appears before the input data item, the storage type attribute of the input data item is the virtual storage, the storage type attribute of the output data item is not changed, and the joining relationship between the output data item and the input data item is recorded. In this case, the output-input transfer line is graphically embodied as: joining the output data item to the input data item using a joining line with an arrow pointing to the input data item, where the graphic (e.g., a circle) representing the input data item is changed to a hollow graphic while the graphic representing the output data item is not changed. The output-input transfer line is embodied in the XML of the VMS portion as: in the XML of the VMS portion, a second relative path of the input data item is stored in the path attribute of the end-point destination label of a directed line segment joining the input data item, and a second relative path of the output data item is stored in the path attribute of the start-point destination label of a directed line segment joining the output data item. The value of memory of the input data item is set to 0, and the value of memory of the output data item remains unchanged.

In some other embodiments, when an output data item and an input data item meet the type matching rule, the output data item is joined to the input data item by an output-input transfer line of the data transfer joining line. If the output data item appears after the input data item, or if the output data item and the input data item belong to a same function block, the storage type attribute of the output data item is set to the virtual storage, the storage type attribute of the input data item is not changed, and the joining relationship between the output data item and the input data item is recorded. In this case, the output-input transfer line is graphically embodied as: joining the output data item to the input data item using a joining line with an arrow pointing to the input data item, where a graphic (e.g., a circle) representing the output data item is changed to a hollow graphic while the graphic representing the input data item is not changed. The output-input transfer line is embodied in the XML of the VMS portion as follows: in the XML of the VMS portion, a second relative path of the input data item is stored in the path attribute of the end-point destination label of a directed line segment joining the input data item, and a second relative path of the output data item is stored in the path attribute of the start-point source label of a directed line segment joining the output data item. The value of memory of the output data item is set to 0, and the value of memory of the input data item remains unchanged.

For example, as illustrated in FIG. 8C, the output data item kl 1 corresponding to an output pin of the addition function block expaddI and the input data item g13 corresponding to the first input pin of the division function block expdivI are joined by an output-input transfer line, and the output data item k12 corresponding to the output pin of the division function block expdivI and the input data item g15 corresponding to an input pin of the assignment function block assignint are joined by an output-input transfer line. It needs to be noted that in FIG. 8C, an arrowed line represents an output-input transfer line, with the arrow representing a data flow direction of the output-input transfer line.

For example, as illustrated in FIG. 8C, in the graphical representation, after data items are joined by a line, the output data item k11 is joined to the input data item g13 by an arrowed output-input transfer line, and the output data item k11 is transferred to the input data item g13. The output data item k12 is joined to the input data item g15 by an arrowed output-input transfer line, and the output data item k12 is transferred to the input data item g15. The storage type attributes of the input data item g13 of the division function block expdivI and the input data item g15 of the assignment function block assignint are both modified to the virtual storage, which is embodied in FIG. 8C as: the solid circle representing the input data item g13 of the division function block expdivI is changed to a hollow circle, and the solid circle representing the input data item g15 of the assignment function block assignint is changed to a hollow circle.

For example, in the XML representation of the VMS portion, the relative address attribute of the output data item kl 1 of the addition function block expaddI is the second relative path of the output data item k11 of the addition function block expaddI, i.e., 0.out.0; the relative address attribute of the input data item g13 of the division function block expdivI is the second relative path of the input data item g13 of the division function block expdivI, i.e., 1.in.0.0; the relative address attribute of the output data item k12 of the division function block expdivI is the second relative path of the output data item k12 of the division function block expdivI, i.e., 1.out.0; and the relative address attribute of the input data item g15 of the assignment function block assignint is the second relative path of the input data item g15 of the assignment function block assignint, i.e., 2.in.0. The storage type attributes of the input data item g13 of the division function block expdivI and the input data item g15 of the assignment function block assignint are both modified to the virtual storage, i.e., both of the memory corresponding to the input data item g13 of the division function block expdivI and the memory corresponding to the input data item g15 of the assignment function block assignint are set to 0.

For example, the XML representation of the VMS corresponding to the line joining relationship illustrated in FIG. 8C is as follows:

```
<VMS>
<line>
    <source path=“0.out.0” />
    <destination path=“1.in.0.0” />
</line>
<line>
    <source path=“1.out.0” />
    <destination path=“2.in.0” />
  </line>
</VMS>
```

In some embodiments, when two output data items meet the type matching rule, the two output data items are joined by an output-output transfer line of the data transfer joining line. It is defined that the output data item appearing earlier is expressed as Out1 and the output data item appearing later is expressed as Out2. The output data item Out2 is joined to the output data item Out1 by the output-output transfer line. In this case, the storage type attribute of the output data item Out2 is set to the virtual storage, the storage type attribute of the output data item Out1 is not changed, and the joining relationship between the output data item Out1 and the output data item Out2 is recorded. In this case, the output-output transfer line is graphically embodied as: joining the output data item Out2 to the input data item Out1 using a joining line with an arrow pointing to the output data item Out1, where the graphic (e.g., a circle) representing the output data item Out2 is changed to a hollow graphic while the graphic representing the output data item Out1 is not changed. The output-output transfer line is embodied in the XML of the VMS portion as follows: in the XML of the VMS portion, a second relative path of the output data item Out1 is stored in the path of the destination label, and a second relative path of the output data item Out2 is stored in the path of source. The value of memory of the output data item Out2 is set to 0, and the value of memory of the output data item Out1 remains unchanged.

There are no output-output transfer line and auxiliary merging joining line in the example illustrated in FIG. 8C.

For data item D1 of the generic type, after a joining line (a data transfer joining line and/or an auxiliary merging joining line) is established between the data item of the generic type and another data item D2 of any type other than the pointer type, there are also the following rules related to the generic type:

First, if D2 is of the generic type, the data class attributes and the data type attributes of D1 and D2 remain unchanged.

Second, if D2 is a data item of any other type than the pointer type and the generic type, the value of the data class attribute of D1 is changed to be identical to the value of the data class attribute of D2, and the value of the data type attribute of D1 is changed to be identical to the value of the data type attribute of D2.

For data items of the pointer type, a joining line (a data transfer joining line and/or an auxiliary merging joining line) is established between two data items of the pointer type, there are also the following rules related to the pointer type:

First, when data item REF1 of the generic pointer type is joined to data item REF2 of the pointer type with a pointing type (the data item REF2 points to a particular data item of a specific data type, and the pointing type represents the type of the data item to which the data item REF2 of the pointer type points) by a line, the data item REF1 gets the pointing type, and the pointing type of the data item REF1 is consistent with the pointing type of the data item REF2.

Second, for one or more data items REFk of the pointer type joined to the data item REF1 by data transfer joining line(s) and/or auxiliary merging joining line(s), where k is any positive integer, and k>0, if the data item REFk is of the generic pointer type, the data item REFk also gets the pointing type of the data item REF2.

Third, for data item REFm on the other side of the assignment function assignref to which the data item REFk belongs, if the data item REFk gets the pointing type of the data item REF2, the data item REFm also gets the pointing type of the data item REF2 such that the data type of an input data item and the data type of an output data item of the assignment function assignref are identical. In the assignment function assignref, if the data item REFk is an input data item, the data item REFm is an output data item; and if the data item REFk is an output data item, the data item REFm is an input data item, and m>0.

Fourth, for data item REFn on the other side of addAddress function block to which the data item REFk belongs, if the data item REFk gets the pointing type of the data item REF2, the data item REFm also gets the pointing type of the data item REF2 such that a data type to which an input pointer type data item of the addAddress function block points and a data type to which an output pointer type data item points are identical. In the addAddress, if the data item REFk is an input data item, the data item REFn is an output data item, and if the data item REFk is an output data item, the data item REFn is an input data item, and n>0.

Fifth, for function block getName, in the case that an input data item of the function block getName is of the generic type (any data type) and an output data item of the function block getName is of the generic pointer type, when the input data item is joined to data item T with a specific data type attribute (the basic data type/composite data type) by a line, the input data item gets the data type attribute of the data item T, i.e., the data type attribute of the input data item and the data type attribute of the data item T are identical. The output data item of the pointer type gets a pointing type, and the pointing type of the output data item is identical to the data type attribute of the data item T, and the first to third rules described above are applied continuously.

Sixth, for a data item joined to the data item REFm by a data transfer joining line and/or an auxiliary merging joining line (e.g., the data type of the data item is identical to the pointing type of the data item REF2), the first to third rules described above are applied continuously.

To sum up, for a first pointer data item and a second pointer data item in at least part of input data items and/or at least part of output data items, the data type attribute of the first pointer data item is the generic pointer type, and that of the second pointer data item is the non-generic pointer type, i.e., the second pointer data item points to a data item. In response to the first pointer data item and the second pointer data item being joined by a data transfer joining line and/or an auxiliary merging joining line, the data item to which the first pointer data item points is identical to the data item to which the second pointer data item points.

After the pointing type of a data item of the generic pointer type is determined, the determined type format of a data item to which the pointer type points is recorded in the generic pointer data item. For example, a pointer data item of which id is r internally includes a type description of data item d to which it points, and the XML representation of the pointer portion is as follows:

```
<type id=“r” name=“” value=“” typeclass=“4” typevalue=“ &T1” typeid=“”>
  <type id=“d” name=“” value=“” typeclass=“” typevalue=“T1” typeid=“” />
  </type>
```

If a data item is of the non-generic pointer type, the expanding action may be performed on the data item. The expanding action has no influence on the data type attributes and the data class attributes of the data item and the data items included therein. After expanding with respect to the pointer type, type matching judgement may be performed on the data items included therein. After type matching is successful, the line joining action may be performed on the data items included therein. If a data item included in a pointer data item is also of the composite data type (the basic composite data type, the Exclusive OR type, the array type, or the non-generic pointer type), the expanding action may be continuously applied to the data item included therein until the type of the data item meets the type matching rule or the data item is of the basic data type, the generic pointer type, or the generic type.

For example, as illustrated in FIG. 7A, step S54 includes: generating an interface.

For example, the XML representation of the interface portion corresponding to each composite function block is as follows:

<PF id=“” name=“” >
<in>
Input portion
</in>
<out>
Output portion
</out>
</PF>

The interface portion of the composite function block is composed of a composite function block name, an input portion, and an output portion. The composite function block name may include: a user defined name represented by id; and a system defined name, represented by name, and an encoding rule thereof is the same with a basic function block. The input portion of the composite function block is represented by <in></in> structure, and the output portion of the composite function block is represented by <out></out> structure. A specific input data item is sandwiched between <in> and </in>, and a specific output data item is sandwiched between <out> and </out>.

In the XML of the interface portion, a data item (an input data item and an output data item) is represented as:
<type id=“ ” name=“ ” value=“ ” typeclass=“type class” typevalue=“type label” typeid=“user defined type title“memory=””/>, where typevalue represents the data type attribute of the data item, i.e., the type label of a composite data item follows a type naming rule; id represents an annotation for the data item, which may be specifically named by the user; name represents the physical address of the data item (i.e., represents the physical address of the data item when an algorithm runs), value may represent the value of the data item; when the data value is not null, it represents that the data item is a constant data item which, in the graphical representation, is represented by a yellow solid circle, typeclass represents the data class attribute of the data item, which is determined by the used composite paradigm; typeid represents the name of the user defined data type attribute, such as linknode and treenode; memory represents the storage type attribute of the data item, when the value of memory is 0, it represents the virtual storage, which is graphically represented by a hollow circle; and when the value of memory is 1, it represents the real storage, which is graphically represented by a solid circle. For example, typeclass may be represented using a numeral; when typeclass is 0, it represents the basic data type; when typeclass is 1, it represents the basic composite data type; when typeclass is 2, it represents that the data structure is the array structure; when typeclass is 3, it represents a one-out-of-two structure type; when typeclass is 4, it represents the pointer type; and when typeclass is 5, it represents the generic type.

For example, when the at least one composite paradigm is the sequential composite paradigm and the composite function block is a composite function block having the sequential structure, in the compositing process of encapsulating the at least two function blocks into a composite function block and generating an interface corresponding to the composite function block, data items in the interface corresponding to the composite function block are generated sequentially by the data items in the interfaces corresponding to the at least two function blocks according to the computation sequence. A data item may be extracted according to an interface extraction rule from each function block of the at least two function blocks after the line joining action is completed (in other words, all input data items extractable as the interface in the function block are extracted as one data item, and all output data items extractable as the interface in the function block are extracted as one data item), or no data item is extracted. The data class attributes of the data items in the interface corresponding to the composite function block are the basic composite data type.

For the sequential composite paradigm, assuming that n data items d1, d2, . . . , dn are extracted from the computation sequence when the input portion or the output portion of the interface of the composite function block having the sequential structure is formed, with the data classes of the n data items being tc1, tc2, . . . , tcn and the data types being t1, t2, . . . , tn, where n>1, the formed interface data item (i.e., the data item of the interface) is a data item of the basic composite data type, and the interface data item internally includes the descriptions of the n data items d1, d2, . . . , dn. The XML description of the interface data item is as follows:

<type id=“” name=“” value=“” typeclass=“1” typevalue=“” typeid=“”>
<type id=“” name=“” value=“” typeclass=“tc1” typevalue=“t1” typeid=“”/>
<type id=“” name=“” value=“” typeclass=“tc2” typevalue=“t2” typeid=“”/>
......
<type id=“” name=“” value=“” typeclass=“tcn” typevalue=“tn” typeid=“”/>
</type>

For the sequential composite paradigm, assuming that one data item d1 is extracted from the computation sequence when the input portion or the output portion of the interface of the composite function block having the sequential structure is formed, with the data class of the data item being tc1 and the data type being t1, the basic composite data type previously applied to the formed interface data item may be omitted, and the data item d1 may be directly used as the interface data item. The XML description of the interface data item is as follows:
<type id=“ ” name=“ ” value=“ ” typeclass=“tc1” typevalue=“t1” typeid=“ ”/>

FIG. 8D is a schematic diagram illustrating a graphical representation of an interface corresponding to a composite function block determined based on the line joining relationship illustrated in FIG. 8C; and FIG. 8E is a structural diagram illustrating a storage hierarchy of the interface illustrated in FIG. 8D.

For example, FIG. 8D illustrates the graphical representation of the interface corresponding to the composite function block, where (a+b)/2 may be the name of the composite function block, which is defined by the user. The input portion of the interface includes two input data items, and the output portion of the interface includes one output data item. As illustrated in FIG. 8E, in the structural diagram of the storage hierarchy of the interface corresponding to the composite function block, the total number of levels of the input portion is 2 and the total number of levels of the output portion is 1. The input portion currently displays 2 levels and the output portion currently displays 1 level. In this case, the input portion shows two input data items, and the output portion shows one output data item.

It needs to be noted that regarding the extraction rule for the interface of the composite function block having the sequential structure, a reference may be made to the above related description on extracting the interface, which will not be redundantly described here.

For example, the XML representation of the interface illustrated in FIG. 8D is as follows:

```
  <PF id=“(a+b)/2” name=“”>
  <in>
  <type id=“int2” name=“” value=“” typeclass=“1” typevalue=“int2” typeid=“”
memory=“1”>
  <type id=“g11” name=“” value=“” typeclass=“0” typevalue=“int”
typeid=“”memory=“1”/>
  <type id=“g12” name=“” value=“” typeclass=“0” typevalue=“int”
typeid=“”memory=“1”/>
  </type>
  </in>
  <out>
  <type id=“k13” name=“” value=“” typeclass=“0” typevalue=“int”
typeid=“”memory=“1”/>
  </out>
  </PF>
```

For example, as illustrated in FIG. 7A, step S55 includes: generating PFVMS. After the interface corresponding to the composite function block is generated, the XML of the PFVMS portion corresponding to the composite function block may be generated. The PFVMS portion is used for describing a contrast relationship between a corresponding data item in the computation sequence composed of function blocks and a data item in the interface of the composite function block, and also describing the relationship of an auxiliary merging joining line between input data items. After the PFVMS is generated, part of contents with the undirected attribute in the VMS is deleted. It needs to be noted that in the PFVMS, the relationship of the auxiliary merging joining line between input data items is represented as: a VMS relationship between one data item in the interface and a plurality of input data items joined by the auxiliary merging joining lines in a small function block. For example, input data items a, b, and c in a small function block are joined by auxiliary merging joining lines, and the input data items a, b, and c are extracted as data item m of the interface. Accordingly, information of three lines (m,a), (m,b), and (m,c) is finally formed in the PFVMS.

The XML representation of the PFVMS portion is as follows:

```
<PFVMS>>
  <line>
    <source path=“ ” />
    <destination path=“” />
  </line>
</PFVMS>
```

In the above XML of the PFVMS portion, a group of line labels represents the contrast relationship of a data item; the path attribute of the source label represents the first relative path of a data item in the large function interface area, and the path attribute of the destination label represents the second relative path of the corresponding data item in the computation sequence.

The JSON representation of the PFVMS portion is as follows:

```
{
  “PFVMS”:[[
    {
      “path”:“”
    },
    {
      “path”:“”
    }
  ]]
}
```

The XML representation of the PFVMS portion corresponding to the interface illustrated in FIG. 8D is as follows:

```
<PFVMS>
<line>
    <source path=“in.0” />
    <destination path=“0.in.0” />
  </line>
<line>
    <source path=“out.0” />
    <destination path=“2.out.0” />
  </line>
</PFVMS>
```

FIG. 7D is a schematic diagram illustrating graphical representations of two function blocks provided in some embodiments of the present disclosure.

For example, the description on the relationship of an auxiliary merging joining line is represented as: a first input data item of a set of data items storing the auxiliary merging joining lines is extracted as the interface, and apart from the first input data item, a correspondence is created between each of other input data items and the first input data item. For example, FIG. 7D illustrates function block PF20 and function block PF21. The function block PF20 and the function block PF21 are organized to obtain a composite function block. The function block PF20 includes one input data item a20, and the function block PF21 includes one input data item a21. The input data item a20 and the input data item a21 are joined by an auxiliary merging joining line. In this case, the relationship of the auxiliary merging joining line is stored in the VMS portion with the undirected attribute of the composite function block. The VMS portion is as illustrated below:

```
<VMS undirected=“”>
<line>
  <source path=“0.in.0.0” />
  <destination path=“1.in.0.0” />
</line>
</VMS>
```

After the input data item a20 (i.e., first input data item) in the function block PF20 is extracted as the interface, the PFVMS portion of the composite function block is updated, and a correspondence is created between the input data item a21 having the auxiliary merging line joining relationship with the input data item a20 and the input data item a20. For example, the interface portion corresponding to the composite function block is represented as:

```
  <in>
  <type id=“” name=“” value=“” typevalue=“int2int” typeclass=“1” typeid=“”>
  <type id=“” name=“” value=“” typevalue=“int2” typeclass=“1” typeid=“”
memory=“1”>
  <type id=“” name=“” value=“” typevalue=“int” typeclass=“0” typeid=“”
memory=“1”/>
  <type id=“” name=“” value=“” typevalue=“int” typeclass=“0” typeid=“”
memory=“1”/>
  </type>
  <type id=“” name=“” value=“” typevalue=“int” typeclass=“0” typeid=“”
memory=“1” />
  </type>
  </in>
  <out>
  <type id=“” name=“” value=“” typevalue=“intint” typeclass=“1” typeid=“”>
  <type id=“” name=“” value=“” typevalue=“int” typeclass=“0” typeid=“”
memory=“1”/>
  <type id=“” name=“” value=“” typevalue=“int” typeclass=“0” typeid=“”
memory=“1”/>
  </type>
  </out>
```

The PFVMS portion corresponding to the composite function block is as follows:

```
<PFVMS>
......
<line>
  <source path=“in.0.0” />
  <destination path=“0.in.0” />
</line>
<line>
  <source path=“in.0.0.0” />
  <destination path=“1.in.0.0” />
</line>
<line>
  <source path=“in.0.1” />
  <destination path=“1.in.0.1” />
</line>
<line>
  <source path=“out.0” />
  <destination path=“2.out.0” />
</line>
</PFVMS>
```

It needs to be noted that after the PFVMS portion corresponding to the composite function block is updated, the VMS portion with the undirected attribute needs to be deleted.

For example, as illustrated in FIG. 7A, step S56 includes: forming a composite function block having the sequential structure. Thus, by steps S50 to S56, the organization of the composite function block having the sequential structure is completed, and the complete structure of the composite function block having the sequential structure is generated.

For example, the complete XML representation corresponding to composite function block (a+b)/2 is as follows:

```
  <PF id=“(a+b)/2” name=“” >
  <F id=“expaddI” name=“ ”>
  <in>
  <type id=“int2” name=“” value=“” typeclass=“1” typevalue=“int2” typeid=“”>
  <type id=“g11” name=“” value=“” typeclass=“0” typevalue=“int” typeid=“”
memory=“1”/>
  <type id=“g12” name=“” value=“” typeclass=“0” typevalue=“int” typeid=“”
memory=“1” />
  </type>
  </in>
  <out>
  <type id=“k11” name=“” value=“” typeclass=“0” typevalue=“int” typeid=“”
memory=“1” />
  </out>
  </F>
  <F id=“expdivI” name=“ ”>
  <in>
  <type id=“int2” name=“” value=“” typeclass=“1” typevalue=“int2” typeid=“”>
  <type id=“g13” name=“” value=“” typeclass=“0” typevalue=“int” typeid=“”
memory=“0”/>
  <type id=“g14” name=“” value=“2” typeclass=“0” typevalue=“int” typeid=“”
memory=“1”/>
  </type>
  </in>
  <out>
  <type id=“k12” name=“” value=“” typeclass=“0” typevalue=“int” typeid=“”
memory=“1”/>
  </out>
  </F>
  <F id=“assignint” name=“ ”>
  <in>
  <type id=“g15” name=“” value=“” typeclass=“0” typevalue=“int” typeid=“”
memory=“0”/>
  </in>
  <out>
  <type id=“k13” name=“” value=“” typeclass=“0” typevalue=“int” typeid=“”
memory=“1”/>
  </out>
  </F>
  <VMS>
  <line>
    <source path=“0.out.0” />
    <destination path=“1.in.0.0” />
  </line>
  <line>
    <source path=“1.out.0” />
    <destination path=“2.in.0” />
  </line>
  </VMS>
  <in>
  <type id=“int2” name=“” value=“” typeclass=“1” typevalue=“int2” typeid=“”
memory=“1”>
  <type id=“g11” name=“” value=“” typeclass=“0” typevalue=“int” typeid=“”
memory=“1” />
  <type id=“g12” name=“” value=“” typeclass=“0” typevalue=“int” typeid=“”
memory=“1” />
  </type>
  </in>
  <out>
  <type id=“k13” name=“” value=“” typeclass=“0” typevalue=“int” typeid=“”
memory=“1” />
  </out>
  <PFVMS>
  <line>
    <source path=“in.0” />
    <destination path=“0.in.0” />
  </line>
  <line>
    <source path=“out.0” />
    <destination path=“2.out.0” />
  </line>
  </PFVMS>
  </PF>
```

FIG. 9A is a schematic diagram of a composite function block having an if structure provided in some embodiments of the present disclosure; FIG. 9B is a schematic diagram of a method for compositing function blocks based on an if composite paradigm provided in some embodiments of the present disclosure; and FIG. 9C is a schematic diagram illustrating a graphical representation of a composite function block having an if structure provided in some embodiments of the present disclosure.

For example, at least two function blocks are composited based on the if composite paradigm to obtain a composite function block having the if structure. As illustrated in FIG. 9A, the conditional composite paradigm includes judgment condition portion exp, first branch portion doTrue, and second branch portion doFalse. The first branch portion doTrue represents a branch when the result of the judgment condition of the judgment condition portion exp is true, and the second branch portion doFalse represents a branch when the result of the judgment condition of the judgment condition portion exp is false. The judgment condition portion exp includes at least one function block, the first branch portion doTrue includes at least one function block, and the second branch portion doFalse also includes at least one function block. It needs to be noted that in the composite function block having the conditional structure, one branch of the first branch portion doTrue and the second branch portion doFalse may be null, i.e., the first branch portion doTrue or the second branch portion doFalse may include no any function block.

For example, in the process of organizing a composite function block having the if structure, at least one function block is utilized to gradually fill a structure template of the if composite paradigm.

The XML representation of the computation sequence portion corresponding to any composite function block having the if structure is as follows:

<exp name=“”>
<F/PF id=“” name=“”>
<in>
</in>
<out>
</out>
</ F/PF>
</exp>
<doTrue name=“”>
< F/PF id=“” name=“”>
<in>
</in>
<out>
</out>
</ F/PF>
</doTrue>
<doFalse name=“”>
< F/PF id=“” name=“”>
<in>
</in>
<out>
</out>
</ F/PF>
</doFalse>

For example, the computation sequence portion corresponding to the composite function block having the if structure includes: the judgment condition portion exp, represented by <exp></exp> structure: a branch structure when the condition is true, i.e., the first branch portion doTrue, represented by <doTrue></doTrue> structure; and a branch structure when the condition is false, i.e., the second branch portion doFalse, represented by <doFalse></doFalse> structure. As illustrated in FIG. 9A, the exp portion is joined to the first branch portion doTrue and the second branch portion doFalse through a one-out-of-two module. When the output of the exp portion is 1, the doTrue branch is executed; and when the output of the exp portion is 0, doFalse is executed.

For example, based on an encoding rule, the relative addresses of the judgment condition portion exp, the first branch portion doTrue, and the second branch portion doFalse are 0, 1, and 2, respectively. The relative address of a function block in each portion is encoded according to serial numbers 0, 1, . . . . The relative address and the encoding rule are used for assisting in describing the positioning of a data item in the first relative path and the second relative path. In an actual operation, the relative address attribute may not exist and be not set, and the construction of a structural body itself represents a nested path where the data item resides, which may be automatically computed by an algorithm according to the encoding rule. For example, an output data item of a function block of the judgment condition portion exp is a data item of the boolean type. When both of the doTrue portion and the doFalse portion exist, the doTrue portion includes at least one function block, and the doFalse portion includes at least one function block. For example, the doTrue portion or the doFalse portion may be null, i.e., include no any function block.

For example, as illustrated in FIG. 9B, the method for compositing function blocks based on the if composite paradigm includes steps S60 to S66. For example, as illustrated in FIG. 9B, step S60 includes: selecting the if composite paradigm.

For example, step S61 includes: selecting at least two function blocks and organizing a computation sequence.

For example, for three portions (the judgment condition portion exp, the first branch portion doTrue, and the second branch portion doFalse) of the if structure, at least one function block is selected for each portion from the function block library as needed (in the embodiments of the present disclosure, taking for example that each portion includes one function block), and the selected function blocks are arranged based on the if composite paradigm to form the corresponding computation sequence. The id values of data items in the computation sequence composed of the selected function blocks may be specified, i.e., the id values of the data items may be modified as needed, causing the computation sequence more comprehensible.

For example, after the computation sequence is formed, attribute setting may be performed on the data items. Step S62 includes: setting a constant. After the computation sequence is organized, a constant may be set for a data item as needed, and the constant is set in the value attribute of the data item.

For example, in some embodiments, a functionality needs to be realized is as follows: comparing two data items (i.e., a first data item and a second data item) of the int type; performing subtraction if the first data item is greater than the second data item; and performing addition if the first data item is less than the second data item. Based on this functionality, three function blocks are selected from the function block library: function block lessint representing a less-than relational expression (for realizing less-than comparison), addition function block expaddI, and subtraction function block expsubI. As illustrated in FIG. 9C, based on the if composite paradigm, the function block lessint is set in the judgment condition portion exp in the if structure; the addition function block expaddI is set in the first branch portion doTrue when the condition in the if structure is true; and the subtraction function block expsubI is set in the second branch portion doFalse when the condition is false.

For example, the XML representation of the computation sequence formed by the three function blocks illustrated in FIG. 9C is as follows:

```
  <exp name=“”>
  <F id=“lessint” name=“ ”>
  <in>
  <type id=“int2” name=“” value=“” typeclass=“1” typevalue=“int2”
  typeid=“”>
  <type id=“int1” name=“” value=“” typeclass=“0” typevalue=“int”
typeid=“” memory=“1”/>
  <type id=“int2” name=“” value=“” typeclass=“0” typevalue=“int”
typeid=“” memory=“1”/>
  </type>
  </in>
  <out>
  <type id=“boolean” name=“” value=“” typeclass=“0”
typevalue=“boolean” typeid=“” memory=“1”/>
  </out>
  </F>
  </exp>
  <doTrue name=“”>
  <F id=“expaddI” name=“ ”>
  <in>
  <type id=“ ” name=“” value=“” typeclass=“1” typevalue=“int2”
  typeid=“”>
  <type id=“int3” name=“” value=“” typeclass=“0” typevalue=“int”
typeid=“” memory=“1”/>
  <type id=“int4” name=“” value=“” typeclass=“0” typevalue=“int”
typeid=“” memory=“1”/>
  </type>
  </in>
  <out>
  <type id=“int5” name=“” value=“” typeclass=“0” typevalue=“int”
typeid=“” memory=“1”/>
  </out>
  </F>
  </doTrue>
  <doFalse name=“”>
  <F id=“expsubI” name=“ ”>
  <in>
  <type id=“ ” name=“” value=“” typeclass=“1” typevalue=“int2”
  typeid=“”>
  <type id=“int3” name=“” value=“” typeclass=“0” typevalue=“int”
typeid=“” memory=“1”/>
  <type id=“int4” name=“” value=“” typeclass=“0” typevalue=“int”
typeid=“” memory=“1”/>
  </type>
  </in>
  <out>
  <type id=“int6” name=“” value=“” typeclass=“0” typevalue=“int”
typeid=“” memory=“1”/>
  </out>
  </F>
  </doFalse>
```

For example, as illustrated in FIG. 9B, step S63 includes: performing a line joining operation to generate VMS. In step S61, according to the computation sequence, which data items (input data items and/or output data items) in the three function blocks may be joined by a data transfer joining line and/or an auxiliary merging joining line is determined. That is, after the computation sequence is obtained, the internal data items of the composite function block having the if structure may be joined in accordance with line joining rules to generate the VMS corresponding to the composite function block having the if structure. For example, for the if composite paradigm, in the process of organizing the function block, there are an auxiliary merging joining line and a data transfer joining line that joins an output data item to an output data item. Because the output portion of the function block in the judgment condition portion exp is subjected to the judgment operation and not involved in the line joining operation, the output data items of the doTrue and doFalse branches do not exist simultaneously, and the output data items of a same type may be joined by a data transfer joining line.

For example, in the example illustrated in FIG. 9C, the line joining relationship between the data items is merely the auxiliary merging line joining relationship. The present disclosure is not limited thereto. In the if structure, the line joining relationship between data items may include a data transfer line joining relationship and/or an auxiliary merging line joining relationship. It needs to be noted that for the specific line joining rule of the line joining operation, a reference may be made to the above related description on the line joining rules, which will not be redundantly described here.

FIG. 9D is a schematic diagram illustrating a graphical representation after joining data items in the composite function block in FIG. 9C by a line.

For example, as illustrated in FIG. 9D, in the graphical representation, the input data items int3 and int4 of the addition function block expaddI in the doTrue branch are joined to the input data items int3 and int4 of the subtraction function block expsubI in the dofalse branch by auxiliary merging joining lines, respectively, and the circles corresponding to the input data items of the subtraction function block expsubI in the dofalse branch are changed to hollow circles.

For example, the XML representation of the VMS corresponding to the line joining relationship illustrated in FIG. 9D is as follows:

```
<VMS undirected=””>
<line>
  <source path=″1.0.in.0.0″ />
  < destination path=″2.0.in.0.0″ />
</line>
<line>
  <source path=″1.0.in.0.1″ />
  < destination path=″2.0.in.0.1″ />
</line>
</VMS>
```

For example, in the XML representation of the VMS portion, the source paths of the input data items int3 and int4 of the addition function block expaddI in the doTrue branch are the second relative paths of the input data items int3 and int4, respectively, i.e., 1.0.in.0.0 and 1.0.in.0.1. The memory is 1 for both of the input data items int3 and int4 of the addition function block expaddI in the doTrue branch, i.e., the input data items int3 and int4 of the addition function block expaddI in the doTrue branch are the real storages. The destination paths of the input data items int3 and int4 of the subtraction function block expsubI in the doFalse branch are the second relative paths of the input data items int3 and int4, respectively, i.e., 2.0.in.0.0 and 2.0.in.0.1. The memory is 0 for both of the input data items int3 and int4 of the subtraction function block expsubI in the doFalse branch, i.e., the input data items int3 and int4 of the subtraction function block expsubI in the doFalse branch are the virtual storages.

For example, as illustrated in FIG. 9B, step S64 includes: generating an interface. For a rule used when generating the interface, a reference may be made to the related description of encapsulating the at least two function blocks into a composite function block and generating an interface corresponding to the composite function block in step S13 described above.

For example, the composite function block having the conditional structure may include a data item of the Exclusive OR type. The Exclusive OR type is the composite data type generated according to the interface extraction rule when the output interface of the composite function block having the if structure is formed.

Each of the doTrue branch structure and the doFalse branch structure internally includes a small function area of a sequential paradigm (a computation sequence). After the concatenation operation is completed, it is assumed that n output data items d1, d2, . . . , dn are extracted according to an extraction rule from the output of the doTrue branch, with the data classes of the n data items being tc1, tc2, . . . , tcn and the data types being t1, t2, . . . , tn, where n>1, and data item d of the basic composite data type is formed. It is assumed that m output data items s1, s2, . . . , sm are extracted according to the extraction rule from the output of the doFalse branch, with the data classes of the m data items being tcf1, tcf2, . . . , tcfm and the data types being tf1, tf2, . . . , tfm, where m>1, and data item s of the basic composite data type is formed. The data item d and the data item s are then composite in the Exclusive OR manner to form a composite data item of the Exclusive OR type. The typeclass of the data item is 3; typevalue is formed by joining the typevalue of the data item d and the typevalue of the data item s using symbol xor. The data item internally includes the data item d and the data item s, and the XML description of the composite data item of the Exclusive OR type is as follows:

```
  <type id=“” name=“” value=“” typeclass=“3”
typevalue=“t1t2...tnxortf1tf2...tfm” typeid=“”>
  <type id=“d” name=“” value=“” typeclass=“1” typevalue=“t1t2...tn”
  typeid=“”>
  <type id=“” name=“” value=“” typeclass=“tc1” typevalue=“t1”
  typeid=“”/>
  <type id=“” name=“” value=“” typeclass=“tc2” typevalue=“t2”
  typeid=“”/>
    ......
  <type id=“” name=“” value=“” typeclass=“tcn” typevalue=“tn”
  typeid=“”/>
  </type>
  <type id=“s” name=“” value=“” typeclass=“1” typevalue=“tf1tf2...tfm”
  typeid=“”>
  <type id=“” name=“” value=“” typeclass=“tcf1” typevalue=“tf1”
  typeid=“”/>
  <type id=“” name=“” value=“” typeclass=“tcf2” typevalue=“tf2”
  typeid=“”/>
    ......
  <type id=“” name=“” value=“” typeclass=“tcfm” typevalue=“tfm”
  typeid=“”/>
  </type>
  </type>
```

The graphical representation of a data item of the Exclusive OR type may be a solid circle (e.g., blue) with symbol ‘+’ therein. The XML representation of the data item of the Exclusive OR type is as follows:

```
<type id=“” name=“” value=“” typeclass=“3” typevalue=“T1xorT2”
typeid=“”>
  <type id=“” name=“” value=“” typeclass=“” typevalue=“T1” typeid=“”
  />
  <type id=“” name=“” value=“” typeclass=“” typevalue=“T2” typeid=“”
  />
</type>
```

The naming rule for the typevalue of the data item of the Exclusive OR type is that the data type attributes of two data items in the Exclusive OR structure are joined by symbol xor. For example, T1xorT2 represents that data types T1 and T2 are in the Exclusive OR relationship. The typeclass value of the data item of the Exclusive OR type is 3.

The JSON representation of the data item of the Exclusive OR type is as follows:

```
{
“id”: “”,
“name”: “”,
“value”: “”,
“typeclass”: “3”,
“typevalue”: “T1xorT2”,
“typeid”: “”,
“memory”: “”,
“children”: [{
“id”: “”,
“name”: “”,
“value”: “”,
“typeclass”: “”,
“typevalue”: “T1”,
“typeid”: “”,
“memory”: “”
  }, {
“id”: “”,
“name”: “”,
“value”: “”,
“typeclass”: “”,
“typevalue”: “T2”,
“typeid”: “”,
“memory”: “”
  }]
}
```

In the process of organizing the composite function block having the if structure, when the output portion of the interface is finally formed, data items are extracted according to an Exclusive OR interface extraction rule.

The generation rule for the interface of the composite function block having the conditional structure further includes the following special extraction rule (including an Exclusive OR structure extraction rule). For example, for the composite function block having the conditional structure, in step S13, encapsulating the at least two function blocks into a composite function block and generating an interface corresponding to the composite function block further include: not extracting an output data item of a function block belonging to the judgment condition portion in the composite function block having the condition structure as a portion of the interface corresponding to the composite function block having the conditional structure; in response to the composite function of the conditional structure including at least two input data items, extracting an input data item of an interface corresponding to a function block belonging to the judgment condition portion, an input data item of an interface corresponding to a function block belonging to the first branch portion, and an input data item of an interface corresponding to a function block belonging to the second branch portion as the input portion of the composite function block having the conditional structure, thereby forming an input interface of the basic composite data type, where the data class attribute of the input portion of the interface corresponding to the composite function block having the conditional structure is the basic composite data type; and in response to the composite function of the conditional structure including at least two output data items that have the Exclusive OR structure and include a first output Exclusive OR portion belonging to the function block of the first branch portion and a second output Exclusive OR portion belonging to the function block of the second branch portion, in the case that part data items in any output data item of at least two output data items is joined by a data transfer joining line, extracting the part data items in the any output data item as a common output portion of the composite function block having the conditional structure, and in the case that all output data items of the first output Exclusive OR portion of the at least two output data items are extracted as the common output portion, not taking all the output data items of the first output Exclusive OR portion as a portion of the Exclusive OR structure, and taking other output data items than output data items extracted as the common output portion in the second output Exclusive OR portion separately as a portion of the Exclusive OR structure.

For example, at least two output data items having the Exclusive OR structure represents that the at least two output data items form a data item of the Exclusive OR type.

It needs to be noted that for the composite function block having the conditional structure, when the output portion of the interface is extracted, the output data item of the function block of the condition portion is not extracted, and only the output data item of the function block of the first branch portion or the second branch portion is extracted.

FIG. 9E is a schematic diagram of a composite function block having a conditional structure provided in some embodiments of the present disclosure. The Exclusive OR structure extraction rule is described below with reference to FIG. 9E.

As illustrated in FIG. 9E, the composite function block having the conditional structure includes function block PF15, function block PF16, and function block PF17. The function block PF15 is located in the judgment condition portion exp, the function block PF16 is located in the first branch portion doTrue, and the function block PF17 is located in the second branch portion doFalse.

The XML representation of the computation sequence formed by three function blocks illustrated in FIG. 9E is as follows:

```
  <exp name=“”>
  <PF id=“PF15” name=“”>
  <in>
  <type id=“T0” name=“” value=“” typeclass=“” typevalue=“t0”
typeid=“” memory=“1”/>
  </in>
  <out>
  <type id=“” name=“” value=“” typeclass=“” typevalue=“boolean”
typeid=“” memory=“1” />
  </out>
  </PF>
  </exp>
  <doTrue name=“”>
  <PF id=“PF16” name=“”>
  <in>
  <type id=“T11” name=“” value=“” typeclass=“” typevalue=“t11”
typeid=“” memory=“1” />
  </in>
  <out>
  <type id=“T12” name=“” value=“” typeclass=“” typevalue=“t12”
typeid=“” memory=“1”/>
  </out>
  </PF>
  </doTrue>
  <doFalse name=“”>
  <PF id=“PF17” name=“”>
  <in>
  <type id=“T21” name=“” value=“” typeclass=“” typevalue=“t21”
typeid=“” memory=“1”/>
  </in>
  <out>
  <type id=“T22” name=“” value=“” typeclass=“” typevalue=“t22”
typeid=“” memory=“1”/>
  </out>
  </PF>
  </doFalse>
```

For example, when extracting the interface, input data item T0 of the function block PF15 of the judgment condition portion exp, input data item T11 of the function block PF16, and input data item T21 of the function block PF17 are all extracted as an input portion of the interface corresponding to the composite function block, thereby forming a basic composite data item. The typeclass value of the basic composite data item is 1. If the data type of the input data item T0 is t0, the data type of the input data item T11 is t11, and the data type of the input data item T21 is t21, the data type of the basic composite data item is expressed as t0t11t21. Output data item T12 of the function block PF16 and output data item T22 of the function block PF17 have the Exclusive OR structure, i.e., form a composite data item of the Exclusive OR structure, and the output data item T12 serves as the first output Exclusive OR portion and the output data item T22 serves as the second output Exclusive OR portion. If the data type of the output data item T12 is t12 and the data type of the input data item T22 is t22, the data type of the composite data item of the Exclusive OR structure is expressed as t12xort22.

The XML representation of the interface portion of the composite function block finally obtained by composition of the conditional structure is as follows:

```
  <PF id=“IF” name=“”>
  <in>
  <type id=“” name=“” value=“” typeclass=“1” typevalue=“ t0t11t21”
  typeid=“”>
  <type id=“T0” name=“” value=“” typeclass=“” typevalue=“t0”
typeid=“” memory=“1”/>
  <type id=“T11” name=“” value=“” typeclass=“” typevalue=“t11”
typeid=“” memory=“1”/>
  <type id=“T21” name=“” value=“” typeclass=“” typevalue=“t21”
typeid=“” memory=“1” />
  </type>
  </in>
  <out>
  <type id=“” name=“” value=“” typeclass=“3” typevalue=“t12xort22”
  typeid=“”>
  <type id=“T12” name=“” value=“” typeclass=“” typevalue=“t12”
typeid=“” memory=“1”/>
  <type id=“T22” name=“” value=“” typeclass=“” typevalue=“t22”
typeid=“” memory=“1” />
  </type>
  </out>
  </PF>
```

If there is a data transfer joining line between the first output Exclusive OR portion and the second output Exclusive OR portion of an output data item, the output data item is extracted as a portion of the common output portion. The common output portion is composited with the Exclusive OR portions to form a data item of the basic composite data type.

If data items of one Exclusive OR portion of a data item of the Exclusive OR structure are all extracted as the data items of the common output portion, and the remaining data items of the other Exclusive OR portion maintain the Exclusive OR structure. That is, other data items than the data item extracted as the common output portion among the original data items of the other Exclusive OR portion is regarded as a portion of the Exclusive OR structure, and the typeclass is the basic composite data type. For example, the data type of a data item in the first Exclusive OR portion of a data item with the Exclusive OR structure is t1, and the data type of a data item in the second Exclusive OR portion is t1t2, where when there is a data transfer joining line between two data items of which the data types are t1, the data items of the data type t1 are extracted as the common output portion. There is no remaining data item in the first Exclusive OR portion, and the remaining data item of the second Exclusive OR portion is data item c of which the data type is t2. The data item c separately forms Exclusive OR portion data item b, and the typevalue of the data item b is xort2 and the typeclass is 3. The data item b and the common output portion are composited to form an output data item in a format as follows:

```
  <type id=“” name=“” value=“” typeclass=“1” typevalue=“t1(xort2)”
  typeid=“”>
  <type id=“a” name=“” value=“” typeclass=“” typevalue=“t1” typeid=“”
memory=“1”/>
  <type id=“b” name=“” value=“” typeclass=“3” typevalue=“xort2”
  typeid=“”>
  <type id=“c” name=“” value=“” typeclass==“” typevalue=“t2”
typeid=“” memory=“1” />
  </type>
  </type>
```

If an Exclusive OR portion of the Exclusive OR structure has only a constant data item, a data item of the other Exclusive OR portion is used as an output interface, and the Exclusive OR structure is not retained.

It needs to be noted that when generating the interface of the composite function block having the if structure, if the above-mentioned extraction rule for generating the interface (i.e., the related rule for generating the interface in step S13) conflicts with the special rule corresponding to the if structure described here, the special rule corresponding to the if structure is preferred.

For example, after the line joining operation is completed, the interface may be generated.

The XML format of the interface of the composite function block having the conditional structure is identical to the interface format of the composite function block having the sequential structure, which will not be redundantly described here.

FIG. 9F is a schematic diagram illustrating a graphical representation of an interface corresponding to the composite function block having the if structure illustrated in FIG. 9E. As illustrated in FIG. 9F, Ifelse is the name of the composite function block having the if structure, which is defined by the user. The input portion of the interface includes input data item int2int2. The input data item int2int2 includes a first input data item int2 and a second input data item int2. The first input data item int2 includes input data item int1 and input data item int2, and the second input data item int2 includes input data item int3 and input data item int4. The output portion of the interface includes output data item intxorint. The output data item intxorint includes output data item int5 and output data item int6.

For example, the XML representation of the interface illustrated in FIG. 9F is as follows.

```
  <PF id=“ifelse” name=“” >
  <in>
  <type typevalue=“int2int2” typeclass=“1” typeid=“” id=“” name=“”>
  <type id=“” name=“” value=“” typeclass=“1” typevalue=“int2”
  typeid=“”>
  <type id=“int1” name=“” value=“” typeclass=“0” typevalue=“int”
typeid=“” memory=“1”/>
  <type id=“int2” name=“” value=“” typeclass=“0” typevalue=“int”
typeid=“” memory=“1”/>
  </type>
  <type id=“” name=“” value=“” typeclass=“1” typevalue=“int2”
  typeid=“”>
  <type id=“int3” name=“” value=“” typeclass=“0” typevalue=“int”
typeid=“” memory=“1”/>
  <type id=“int4” name=“” value=“” typeclass=“0” typevalue=“int”
typeid=“” memory=“1”/>
  </type>
  </type>
  </in>
  <out>
  <type id=“” name=“” value=“” typeclass=“3” typevalue=“intxorint”
  typeid=“”>
  <type id=“int5” name=“” value=“” typeclass=“0” typevalue=“int”
typeid=“” memory=“1”/>
  <type id=“int6” name=“” value=“” typeclass=“0” typevalue=“int”
typeid=“” memory=“1”/>
  </type>
  </out>
  </PF>
```

For example, as illustrated in FIG. 9B, step S65 includes: generating PFVMS. After the interface corresponding to the composite function block is generated, the XML of the PFVMS portion corresponding to the composite function block having the if structure may be generated. The PFVMS portion in the XML architecture corresponding to the composite function block having the if structure illustrated in FIG. 9C is represented as:

<PFVMS>
<line>
<source path=“ in.0.0” />
<destination path=“0.0.in.0” /
</line>
<line>
<source path=“in.0.1” />
<destination path=“1.0.in.0” />
</line>
<line>
<source path=“in.0.1” />
<destination path=“2.0.in.0” />
</line>
<line>
<source path=“out.0.0” />
<destination path=“1.0.out.0” />
</line>
<line>
<source path=“out.0.1” />
<destination path=“2.0.out.0” />
</line>
</PFVMS>

For example, as illustrated in FIG. 9B, step S66 includes: forming a composite function block having the if structure. Thus, by steps S60 to S66, the organization of the composite function block having the if structure is completed, and the complete structure of the composite function block having the if structure is generated.

For example, the complete XML representation corresponding to composite function block ifelse is as follows:

```
  <PF id=“ifelse” name=“”>
  <exp name=“”>
  <F id=“lessint” name=“ ”>
  <in>
  <type id=“int2” name=“” value=“” typeclass=“1” typevalue=“int2”
  typeid=“”>
  <type id=“int1” name=“” value=“” typeclass=“0” typevalue=“int”
typeid=“” memory=“1”/>
  <type id=“int2” name=“” value=“” typeclass=“0” typevalue=“int”
typeid=“” memory=“1”/>
  </type>
  </in>
  <out>
  <type id=“boolean” name=“” value=“” typeclass=“0”
typevalue=“boolean” typeid=“” memory=“1”/>
  </out>
  </F>
  </exp>
  <doTrue name=“”>
  <F id=“expaddI” name=“ ”>
  <in>
  <type id=“ ” name=“” value=“” typeclass=“1” typevalue=“int2”
  typeid=“”>
  <type id=“int3” name=“” value=“” typeclass=“0” typevalue=“int”
typeid=“” memory=“1”/>
  <type id=“int4” name=“” value=“” typeclass=“0” typevalue=“int”
typeid=“” memory=“1”/>
  </type>
  </in>
  <out>
  <type id=“int5” name=“” value=“” typeclass=“0” typevalue=“int”
typeid=“” memory=“1”/>
  </out>
  </F>
  </doTrue>
  <doFalse name=“”>
  <F id=“expsubI” name=“ ”>
  <in>
  <type id=“ ” name=“” value=“” typeclass=“1” typevalue=“int2”
  typeid=“”>
  <type id=“int3” name=“” value=“” typeclass=“0” typevalue=“int”
typeid=“” memory=“0”/>
  <type id=“int4” name=“” value=“” typeclass=“0” typevalue=“int”
typeid=“” memory=“0”/>
  </type>
  </in>
  <out>
  <type id=“int6” name=“” value=“” typeclass=“0” typevalue=“int”
typeid=“” memory=“1”/>
  </out>
  </F>
  </doFalse>
  <in>
  <type typevalue=“int2int2” typeclass=“1” typeid=“” id=“” name=“”>
  <type id=“” name=“” value=“” typeclass=“1” typevalue=“int2”
  typeid=“”>
  <type id=“int1” name=“” value=“” typeclass=“0” typevalue=“int”
typeid=“” memory=“1”/>
  <type id=“int2” name=“” value=“” typeclass=“0” typevalue=“int”
typeid=“” memory=“1”/>
  </type>
  <type id=“” name=“” value=“” typeclass=“1” typevalue=“int2”
  typeid=“”>
  <type id=“int3” name=“” value=“” typeclass=“0” typevalue=“int”
typeid=“” memory=“1”/>
  <type id=“int4” name=“” value=“” typeclass=“0” typevalue=“int”
typeid=“” memory=“1”/>
  </type>
  </type>
  </in>
  <out>
  <type id=“” name=“” value=“” typeclass=“3” typevalue=“intxorint”
  typeid=“”>
  <type id=“int5” name=“” value=“” typeclass=“0” typevalue=“int”
typeid=“” memory=“1”/>
  <type id=“int6” name=“” value=“” typeclass=“0” typevalue=“int”
typeid=“” memory=“1”/>
  </type>
  </out>
  <PFVMS>
  <line>
  <source path=“ in.0.0” />
  <destination path=“0.0.in.0” /
  </line>
  <line>
  <source path=“in.0.1” />
  <destination path=“1.0.in.0” />
  </line>
  <line>
  <source path=“in.0.1” />
  <destination path=“2.0.in.0” />
  </line>
  <line>
  <source path=“out.0.0” />
  <destination path=“1.0.out.0” />
  </line>
  <line>
  <source path=“out.0.1” />
  <destination path=“2.0.out.0” />
  </line>
  </PFVMS>
  </PF>
```

For example, when two data items of the Exclusive OR type are joined by a line, the two data items of the Exclusive OR type meet an Exclusive OR type matching rule. The Exclusive OR type matching rule includes: the Exclusive OR type is identical, which follows an identical composite type rule of identical type rules; t1 and t2 form data item t1xort2 of the Exclusive OR structure; if the types of data items of each sequential Exclusive OR branch of two data items T1 and T2 of the Exclusive OR type are identical, the data types of the two data items of the Exclusive OR type are identical. For example, if the data item T1 of the Exclusive OR type is represented as t1xort2 and the data item T2 of the Exclusive OR type is represented as t3xort4, when the data type of data item t1 and the data type of data item t3 are identical and the data type of data item t2 and the data type of data item t4 are identical, the data item T1 and the data item T2 meet that the Exclusive OR type is identical. It needs to be noted that the data type of the data item t1 and the data type of the data item t2 may be identical, and may also be different, and the data type of the data item t3 and the data type of the data item t4 may be identical, and may also be different. For example, if the data type of the data item t1 is int and the data type of the data item t2 is int, the data type of the data item T1 is intxorint.

For a composite data item of the Exclusive OR type, i.e., typeclass=3, the expanding action may be performed on the composite data item. The expanding action has no influence on the data type attributes and the data class attributes of the composite data item and the data items included therein. After the composite data of the Exclusive OR type is expanded, type matching judgement may be performed on the data items included therein. After type matching is successful, the line joining action may be performed on the data items included therein. If a data item included in a composite data item of the Exclusive OR type is also a data item of the composite data type, the expanding action may be continuously applied to the data item of the composite data type included therein until the type of the data item meets the type matching rule or the data item is of the basic data type, the generic pointer type, or the generic type. For example, if a data item of the Exclusive OR type is XOR1 and the data item XOR1 is an output data item, the function block in which the data item XOR1 resides is PF. If joining lines are created between all sub-structures of the data item XOR1 and a data item before a function block PF in the computation sequence in which the function block PF resides, a joining line may be created between a single sub-structure of the data item XOR1 and a data item after the function block PF in the computation sequence in which the function block PF resides. For example, if the data item T1 of the Exclusive OR type is located in function block PF2 and is an output data item in the function block PF2 and the computation sequence in which the function block PF2 resides includes function block PF1, the function block PF2, function block PF3, and function block PF4 arranged sequentially, for the data item T1 of the Exclusive OR type, a data item before it is a data item in the function block PF1, and data items after it are data items in the function block PF3 and the function block PF4. If no joining line is created between a sub-structure of the data item XOR1 and the data item before the function block PF in the computation sequence in which the function block PF resides and a joining line is created between another sub-structure of the data item XOR1 and the data item after the function block PF in the computation sequence in which the function block PF resides, the data item XOR1 of the Exclusive OR type must be joined as an integral structure to the data item after the function block PF in the computation sequence in which the function block PF resides by a line. For example, the data item T1 of the Exclusive OR type is expressed as t1xort2 and located in the function block PF2 and is an output data item in the function block PF2. If no joining line is created between data item t5 and a data item before the function block PF2 in the computation sequence in which the function block PF2 resides and a joining line is created between data item t6 and the data item before the function block PF2 in the computation sequence in which the function block PF2 resides, in subsequent use, the data item T1 of the Exclusive OR type must be integrally subjected to the line joining operation.

FIG. 10A is a schematic diagram of a composite function block having a for structure provided in some embodiments of the present disclosure; FIG. 10B is a schematic diagram of a method for compositing function blocks based on a for composite paradigm provided in some embodiments of the present disclosure; and FIG. 10C is a schematic diagram illustrating a graphical representation of a composite function block having a for structure provided in some embodiments of the present disclosure.

For example, at least two function blocks are composited based on the for composite paradigm to obtain a composite function block having the for structure. As illustrated in FIG. 10A, the for composite paradigm includes single expression exp1 and at least one layer of loop bodies LoopN. In loopN, there is a layer of loop portions IFloops by default. Each IFloop includes a conditional expression, an intermediate loop expression, and an end loop expression. When one layer of IFloops is insufficient to describe the whole computation organization process, the IFloops may be added as needed until the whole computation meaning can be completely described. FIG. 10A shows the for composite paradigm with two layers of IFloops, with the internal structure of each layer of IFloops being identical. In each layer of IFloops, exp2 represents the conditional expression, loop represents the intermediate loop expression, and exp3 represents the end loop expression. The single expression represents control on a loop. The single expression exp1 includes at least one function block. The conditional expression exp2 in one layer of IFloops includes at least one function block. The intermediate loop expression loop includes at least one function block. The end loop expression exp3 includes at least one function block.

It needs to be noted that in one layer of IFloops, the conditional expression exp2 and the intermediate loop expression loop have the if structure, and the intermediate loop expression loop is the first branch portion doTrue in the if structure. In the looping paradigm and the while looping paradigm, for the simplicity of expression, the form of the extracted output data item of the if structure included in IFloop is of the Exclusive OR type is omitted, i.e., in the looping paradigm and the while looping paradigm, the Exclusive OR type is not generated when extracting the interface.

For example, in the process of organizing a composite function block having the for structure, at least one function block is utilized to gradually fill a structure template of the if composite paradigm.

The XML representation of the computation sequence portion corresponding to any composite function block having the for structure is as follows:

<exp1 name=“”>
<F/PF id=“” name=“”>
<in></in>
<out></out>
</F/PF>
</exp1>
<loopN name=“”>
<IFLoop name=“”>
<exp2 name=“”>
<F/PF id=“” name=“”>
<in></in>
<out></out>
</F/PF>
</exp2>
<loop name=“”>
<F/PF id=“” name=“”>
<in></in>
<out></out>
</F/PF>
</loop>
<exp3 name=“”>
<F/PF id=“” name=“”>
<in></in>
<out></out>
</F/PF>
</exp3>
</IFLoop>
</loopN>

For example, the computation sequence portion corresponding to the composite function block having the for structure includes: single expression exp1, represented by <exp1></exp1> structure; and loop body loopN, represented by <loopN></loopN>, where each layer of IFloops includes conditional expression exp2, represented by <exp2></exp2> structure, intermediate loop expression loop, represented by <loop></loop>, and end loop expression exp3, represented by <exp3></exp3> structure.

For example, in the for structure, the conditional expression exp2 of each layer of IFloops is joined to the loop expression loop of the current layer of loops through a one-out-of-two module. When the output of the conditional expression exp2 is 1, the function block in the first intermediate loop expression loop of the for structure is executed; and when the output of the conditional expression exp2 is 0, it is to jump out of the loop.

For example, in the for structure, the relative address values of the exp1 portion and the loopN portion are 0 and 1, respectively, and each layer of IFLoops is sequentially and automatically encoded (according to 0, 1, 2). The relative address values of exp2, loop, and exp3 in IFLoop relative to their parent structure are 0, 1, and 2, respectively. The relative address of a function block in each portion is encoded according to serial numbers 0, 1, . . . . The relative address and the encoding rule are used for assisting in describing the positioning of a data item in the first relative path and the second relative path. In an actual operation, the relative address attribute may not exist and be not set, and the construction of a structural body itself represents a nested path where the data item resides, which may be automatically computed by an algorithm according to the encoding rule.

For example, four portions exp1, exp2, exp3, and loop in the computation sequence of the for composite paradigm each have a function block.

For example, as illustrated in FIG. 10B, the method for compositing function blocks based on the for composite paradigm includes steps S70 to S76.

Step S70 includes: selecting the for composite paradigm.

Step S71 includes: selecting at least two function blocks and organizing a computation sequence.

For example, for the four portions exp1, exp2, exp3, and loop of the for structure, at least one function block is selected from the function block library for each portion as needed (in the embodiments of the present disclosure, taking for example that each portion includes one function block), and the selected function blocks are arranged based on the for composite paradigm to form the corresponding computation sequence. For example, an output data item of a function block of the exp2 portion must be a data item of the boolean type. The id values of data items in the selected function blocks may be specified, i.e., the id values of the data items may be modified as needed, causing the computation sequence more comprehensible.

For example, in some embodiments, a functionality needs to be realized is as follows: summing a set of data of the int type. Based on this functionality, four function blocks are selected from the function block library: assignment function block assignint, function block lessint representing the less-than relational expression, addition function block addint, and addition function block addint. As illustrated in FIG. 10C, based on the for composite paradigm, the assignment function block assignint is set in the single expression exp1 of the for structure; the function block lessint representing the less-than relational expression is set in the exp2 portion of each layer of IFLoops of the for structure; and the addition function block addint is set in each of the end loop expression exp3 portion of each layer of IFLoops and the loop expression loop portion of each layer of IFLoops in the for structure. Two layers of IFLoops are sufficient to express the organization process of the whole loop structure, and only one layer of IFLoops is added in the basic for composite paradigm.

For example, the XML representation of the computation sequence formed by the function blocks illustrated in FIG. 10C is as follows:

```
  <PF id=“PF_For” name=“” >
  <exp1 name=“”>
  <F id=“assignint” name=“” >
  <in>
  <type id=“0” name=“” value=“” typeclass=“0” typevalue=“int”
typeid=“” memory=“1”/>
  </in>
  <out>
  <type id=“i” name=“” value=“” typeclass=“0” typevalue=“int”
typeid=“” memory=“1”/>
  </out>
  </F>
  </exp1>
  <loopN name=“”>
  <IFLoop name=“”>
  <exp2 name=“”>
  <F id=“lessint” name=“”>
  <in>
  <type id=“int2” name=“” value=“” typeclass=“1” typevalue=“int2”
  typeid=“”>
  <type id=“i” name=“” value=“” typeclass=“0” typevalue=“int”
typeid=“” memory=“1”/>
  <type id=“n” name=“” value=“” typeclass=“0” typevalue=“int”
typeid=“” memory=“1”/>
  </type>
  </in>
  <out>
  <type id=“boolean” name=“” value=“” typeclass=“0”
typevalue=“boolean” typeid=“” memory=“1” />
  </out>
  </F>
  </exp2>
  <loop name=“”>
  <PF id=“addint” name=“”>
  <in>
  <type id=“int2” name=“” value=“” typeclass=“1” typevalue=“int2”
  typeid=“”>
  <type id=“sum1” name=“” value=“” typeclass=“0” typevalue=“int”
typeid=“” memory=“1”/>
  <type id=“a” name=“” value=“” typeclass=“0” typevalue=“int”
typeid=“” memory=“1” />
  </type>
  </in>
  <out>
  <type id=“sum2” name=“” value=“” typeclass=“0” typevalue=“int”
typeid=“” memory=“1”/>
  </out>
  </PF>
  </loop>
  <exp3 name=“”>
  <PF id=“addint” name=“”>
  <in>
  <type id=“int2” name=“” value=“” typeclass=“1” typevalue=“int2”
  typeid=“”>
  <type id=“i” name=“” value=“” typeclass=“0” typevalue=“int”
typeid=“” memory=“1”/>
  <type id=“1” name=“” value=“” typeclass=“0” typevalue=“int”
typeid=“” memory=“1”/>
  </type>
  </in>
  <out>
  <type id=“i” name=“” value=“” typeclass=“0” typevalue=“int”
typeid=“” memory=“1” />
  </out>
  </PF>
  </exp3>
  </IFLoop>
  <IFLoop name=“”>
  <exp2 name=“”>
  <F id=“lessint” name=“”>
  <in>
  <type id=“int2” name=“” value=“” typeclass=“1” typevalue=“int2”
  typeid=“”>
  <type id=“i” name=“” value=“” typeclass=“0” typevalue=“int”
typeid=“” memory=“1” />
  <type id=“n” name=“” value=“” typeclass=“0” typevalue=“int”
typeid=“”memory=“1” />
  </type>
  </in>
  <out>
  <type id=“boolean” name=“” value=“” typeclass=“0”
typevalue=“boolean” typeid=“” memory=“1” />
  </out>
  </F>
  </exp2>
  <loop name=“”>
  <PF id=“addint” name=“”>
  <in>
  <type id=“int2” name=“” value=“” typeclass=“1” typevalue=“int2”
  typeid=“”>
  <type id=“sum1” name=“” value=“” typeclass=“0” typevalue=“int”
typeid=“” memory=“1”/>
  <type id=“a” name=“” value=“” typeclass=“0” typevalue=“int”
typeid=“” memory=“1” />
  </type>
  </in>
  <out>
  <type id=“sum2” name=“” value=“” typeclass=“0” typevalue=“int”
typeid=“” memory=“1” />
  </out>
  </PF>
  </loop>
  <exp3 name=“”>
  <PF id=“addint” name=“”>
  <in>
  <type id=“int2” name=“” value=“” typeclass=“1” typevalue=“int2”
  typeid=“”>
  <type id=“i” name=“” value=“” typeclass=“0” typevalue=“int”
typeid=“” memory=“1”/>
  <type id=“1” name=“” value=“” typeclass=“0” typevalue=“int”
typeid=“” memory=“1” />
  </type>
  </in>
  <out>
  <type id=“i” name=“” value=“” typeclass=“0” typevalue=“int”
typeid=“” memory=“1” />
  </out>
  </PF>
  </exp3>
  </IFloop>
  </loopN>
  </PF>
```

For example, after the computation sequence is formed, attribute setting may be performed on the data items. As illustrated in FIG. 10B, step S72 includes: setting a constant. After the computation sequence is organized, a constant may be set for a data item and recorded in the value attribute of the data item. In the computation sequence illustrated in FIG. 10C, the input data item of the assignment function block assignint in the single expression exp1 is a constant data item, and the value thereof is 0. The second input data item of the addition function block addint in the end loop expression exp3 of each layer of IFloops is a constant data item, and the value thereof is 1. If the constant setting appears in the loop portion IFLoop, it represents that a same constant is set for the corresponding data item of each IFLoop. For example, for constant data item 1 in the end loop expression exp3 in FIG. 10C, the constant data item 1 is set at a same location of the end loop expression exp3 of each IFLoop. The XML description is as follows:

```
  <exp1 name=“”>
  <F id=“assignint” name=“”>
  <in>
  <type id=“0” name=“” value=“0” typeclass=“0” typevalue=“int” typeid=“”
memory=“1” />
  </in>
  <out>
  <type id=“i” name=“” value=“” typeclass=“0” typevalue=“int” typeid=“”
memory=“1”/>
  </out>
  </F>
  </exp1>
  <exp3 name=“”>
  <PF id=“addint” name=“”>
  <in>
  <type id=“int2” name=“” value=“” typeclass=“1” typevalue=“int2” typeid=“”>
  <type id=“i” name=“” value=“” typeclass=“0” typevalue=“int” typeid=“”
memory=“1”/>
  <type id=“1” name=“” value=“1” typeclass=“0” typevalue=“int” typeid=“”
memory=“1” />
  </type>
  </in>
  <out>
  <type id=“i” name=“” value=“” typeclass=“0” typevalue=“int” typeid=“”
memory=“1”/>
  </out>
  </PF>
  </exp3>
```

For example, as illustrated in FIG. 10B, step S73 includes performing a line joining operation. In step S74, according to the computation sequence, which data items (input data items and/or output data items) in the function blocks in the for structure may be joined by a data transfer joining line and/or an auxiliary merging joining line is determined. That is, after the computation sequence is obtained, the internal data items of the composite function block having the for structure may be joined in accordance with line joining rules to generate the VMS corresponding to the composite function block having the for structure.

It needs to be noted that in the for composite paradigm, there are a data transfer joining line that joins an output data item to an input data item, a data transfer joining line that joins an output data item to an output data item, and an auxiliary merging joining line that joins an input data item to an input data item. Because the output data item of the function block in the exp2 portion of each layer of IFloops is used for realizing the judgement operation, the output data item of the exp2 portion of each layer of IFloops is not involved in the line joining operation.

For example, in the for structure, for two layers of IFloops, levels of the two layers of IFloops are the kth layer of IFloops and the mth layer of IFloops. Joining data item d1 in the kth layer of IFloops and data item d2 in the mth layer of IFloops by a line represents: automatically joining the data items d1 corresponding to k+n layers of IFloops and the data items d2 corresponding to m+n layers of IFloops by lines, where k+n>0, and k+n<=the total number of layers of IFloops; m+n>0, and m+n<=the total number of layers of IFloops; and k and m may be identical or different. For example, in some examples, when k and m are identical, the data item d1 and the data item d2 are in the same IFloop, and joining the data item d1 and the data item d2 by a line represents automatically joining the data item d1 and the data item d2 in each IFloop by a line. For example, in some other examples, when k and m are different, the data item d1 and the data item d2 are joined by a line across IFloop loops, i.e., between different IFloop layers, or across one layer of IFloops or a plurality of layers of IFloops. That is, the absolute value of k−m may be equal to 1, or may be greater than 1. When the absolute value of k−m is greater than 1, the data item d1 and the data item d2 are joined by a line across layers (assumed to be across c layers, i.e., k−m=c). The data item d1 of each layer of IFloop after the kth layer of IFloops is joined to the data items d2 of IFloops across c layers by lines.

FIG. 10D is a schematic diagram illustrating a graphical representation of a computation sequence illustrated in FIG. 10C after joining by a line; FIG. 10E is a schematic diagram illustrating another graphical representation of the computation sequence illustrated in FIG. 10C after joining by a line; and FIG. 10F is a schematic diagram illustrating further another graphical representation of the computation sequence illustrated in FIG. 10C after joining by a line.

For example, as illustrated in FIG. 10D, firstly, a data item (data item i) for realizing loop control in the for structure is joined by a line. For example, the output data item i of the function block assignint of the exp1 portion and the first input data item i of the function block lessint of the exp2 portion in the first layer of IFloops of the loop body loopN are joined by a data transfer joining line, and the output data item i of the function block assignint of the exp1 portion and the input data item i of the function block addint of the exp3 portion in the first layer of IFloops of the loop body loopN are joined by a data transfer joining line. The output data item i of the function block addint of the exp3 portion in the first layer of IFloops of the loop body loopN is joined to the first input data item i of the function block lessint of the exp2 portion in the second layer of IFloops of the loop body loopN and the first input data item i of the function block addint of the exp3 portion in the second layer of IFloops of the loop body loopN by data transfer joining lines. As illustrated in FIG. 10D, after line joining, the circles corresponding to the first input data item i of the function block lessint of the exp2 portion and the input data item i of the function block addint of the exp3 portion in each layer of IFloops are changed to hollow circles, representing that these data items are the virtual storages.

In this case, the VMS corresponding to the line joining relationship illustrated in FIG. 10D is represented as.

```
<VMS>
  <line>
    <source path=“0.0.out.0” />
    <destination path=“1.0.0.0.in.0.0”/>
  </line>
  <line>
    <source path=“0.0.out.0” />
    <destination path=“1.0.2.0.in.0.0” />
  </line>
  <line>
    <source path=“1.0.2.0.out.0” />
    <destination path=“1.1.0.0.in.0.0” />
  </line>
  <line>
    <source path=“1.0.2.0.out.0”/>
    <destination path=“1.1.2.0.in.0.0” />
  </line>
</VMS>
```

For example, as illustrated in FIG. 10E, two layers of IFLoops are then joined by a data transfer joining line which is saved in the VMS. For example, the output data item sum2 of the function block addint of the loop portion in the first layer of IFLoops is joined to the first input data item sum1 of the function block addint of the loop portion in the second layer of IFLoops. That is, the output data item sum2 of the function block addint of the loop portion in the first layer of IFLoops is joined to the first input data item sum1 of the function block addint of the loop portion in the second layer of IFLoops by a data transfer joining line. As illustrated in FIG. 10E, after line joining, the circle corresponding to the first input data item sum1 of the function block addint of the loop portion in the second layer of IFLoops is changed to a hollow circle, representing that the first input data item sum1 of the function block addint of the loop portion in the second layer of IFLoops is the virtual storage.

In this case, the VMS corresponding to the line joining relationship (including a joining line related to the data item i) illustrated in FIG. 10E is represented as:

```
<VMS>
  <line>
    <source path=“0.0.out.0” />
    <destination path=“1.0.0.0.in.0.0” />
  </line>
  <line>
    <source path=“0.0.out.0” />
    <destination path=“1.0.2.0.in.0.0” />
  </line>
  <line>
    <source path=“1.0.2.0.out.0” />
    <destination path=“1.1.0.0.in.0.0” />
  </line>
  <line>
    <source path=“1.0.2.0.out.0” />
    <destination path=“1.1.2.0.in.0.0” />
  </line>
  <line>
    <source path=“1.0.1.0.out.0” />
    <destination path=“1.1.1.0.in.0.0” />
  </line>
</VMS>
```

For example, as illustrated in FIG. 10F, in consideration of the practicability in the function organizing process, the input data items of two layers of IFLoops may be joined by an auxiliary merging joining line. For example, the second input data item n of the function block lessint of the exp2 portion in the first layer of IFloops is joined to the second input data item n of the function block lessint of the exp2 portion in the second layer of IFloops by an auxiliary merging joining line, and the line joining relationship is recorded in the VMS with the attribute undirected. As illustrated in FIG. 10F, after line joining, the circle corresponding to the second input data item n of the function block lessint of the exp2 portion in the second layer of IFloops is changed to a hollow circle, representing that the second input data item n of the function block lessint of the exp2 portion in the IFloop is the virtual storage.

In this case, the VMS corresponding to the auxiliary merging joining line illustrated in FIG. 10F is represented as:

```
<VMS undirected =“”>
  <line>
    <source path=“1.0.0.0.in.0.1” />
    <destination path=“1.1.0.0.in.0.1” />
  </line>
</VMS>
```

For example, in the above XML representation of the VMS, the second relative path of the output data item i of the function block assignint in the exp1 portion is 0.0.out.0, the second relative path of the first input data item i of the function block lessint in the exp2 portion of the first layer of IFLoops is 1.0.0.0.in.0.0; the second relative path of the first input data item i of the function block addint in the exp3 portion of the first layer of IFLoops is 1.0.2.0.in.0.0; the second relative path of the output data item i of the function block addint in the exp3 portion of the first layer of IFLoops is 1.0.2.0.out.0; the second relative path of the first input data item i of the function block lessint in the exp2 portion of the second layer of IFLoops is 1.1.0.0.in.0.0: the second relative path of the first input data item i of the function block addint in the exp3 portion of the second layer of IFLoops is 1.1.2.0.in.0.0; the second relative path of the output data item sum2 of the function block addint in the loop portion of the first layer of IFLoops is 1.0.1.0.out.0; the second relative path of the first input data item sum1 of the function block addint in the loop portion of the second layer of IFLoops is 1.1.1.0.in.0.0; the second relative path of the second input data item n of the function block lessint in the exp2 portion of the first layer of IFLoops is 1.0.0.0.in.0.1; and the second relative path of the second input data item n of the function block lessint in the exp2 portion of the second layer of IFLoops is 1.1.0.0.in.0.1.

For example, as illustrated in FIG. 10B, step S74 includes: generating an interface.

The generation rule for the interface of the composite function block having the loop structure further includes the following N-ization extraction rule:

When the at least one composite paradigm includes the looping composite paradigm and each loop body loopN includes a plurality of loop portions, the N-ization condition is that data items at same locations among the plurality of loop portions IFloops are not joined by lines. When the at least one composite paradigm includes the while looping composite paradigm and a while loop body includes a plurality of while loop portions, the N-ization condition is that data items at same locations among the plurality of while loop portions are not joined by lines.

After the completion of line joining of data items, according to the N-ization extraction rule, data items to be N-ized may be automatically determined according to the preset N-ization condition.

N-ization extraction is performed on data item D. Assuming that the type attribute of the data item D is T, array data item a will be generated, where a is a data structure formed by logically and sequentially arranging a plurality of data items having the same data type and the same data class attribute with the data item D; the data type attribute of a is T[ ], and the data class attribute is 2.

The array data item a internally includes n data items of T type, where n may be any constant, or may be a variable. The n data items of T type are represented in a simplified way and the description may be made only on one data item. The XML representation of the array data item of T[ ] type is as follows:

```
  <type id=“a” name=“” value=“” typeclass=“2” typevalue=“T[ ]” typeid=“”>
  <type id=“d” name=“” value=“” typeclass=“0, 1, 2, 3, 4 or 5” typevalue=“T”
typeid=“”/>
  </type>
```

The N-ized data item is extracted as a component of the interface. A line joining relationship between data item d and data item D is created in the PFVMS, where the data item d is an internal data item of the N-ized data a in the large function interface, and the data item D is an N-ized original data item in the small function composition area.

For example, because the structure of each layer of IFloops is identical, the input data item and the output data item of each layer of IFloops are identical. As illustrated in FIG. 10C, the first layer of IFloops has two input data items i, input data item n, input data item sum1, input data item a, and input data item 1 of the constant type, and the first layer of IFloops has output data item boolean, output data item sum2, and output data item i. Similarly, the second layer of IFloops also has two input data items i, input data item n, input data item sum1, input data item a, and input data item 1 of the constant type, and the second layer of IFloops has output data item boolean, output data item sum2, and output data item i.

The generation rule for the interface of the composite function block having the loop structure further includes the following N-ization extraction rule:

For example, in the N-ization extraction rule, for any input data item in the composite function block having the loop structure, if the any input data items in some IFloops of a plurality of layers of IFloops are joined by joining lines and the any input data items in another IFloops of the plurality of layers of IFloops are not joined by lines, an interface corresponding to an input data item of which the storage attribute is the real storage among a plurality of any input data items corresponding to the plurality of layers of IFloops is provided. In other words, when extracting the interface, only the input data item of which the storage attribute is the real storage is extracted, and the input data item is not subjected to N-ization extraction.

For example, in the N-ization extraction rule, for any output data item in the composite function block having the loop structure, if the any output data items in some IFloops of a plurality of layers of IFloops are joined by joining lines and the any output data items in another IFloops of the plurality of layers of IFloops are not joined by lines, only an interface corresponding to the any output data item in the first layer of IFloops of the plurality of layers of IFloops is provided or N-ization extraction is performed on a plurality of any output data items in the plurality of layers of IFloops. In other words, when extracting the interface, it may be selected to only extract the output data item in the first IFloop as the interface while not extracting the output data item in other IFloop, or to perform N-ization extraction on the output data item.

If the above-mentioned extraction rule for generating the interface (i.e., the related rule for generating the interface in step S13) conflicts with the special extraction rule described here, the special rule described here is preferred.

The generation rule for the interface of the composite function block having the loop structure further includes the following special extraction rule: for the composite function block having the loop structure, in step S13, encapsulating the at least two function blocks into a composite function block and generating an interface corresponding to the composite function block further include: not providing interfaces corresponding to output data items of function blocks located in the single expression and the conditional expression and the end loop expression of each layer of IFloops in the composite function block having the loop structure; and not extracting a constant data item as a portion of the interface. For example, for the composite function block having the loop structure, when extracting the interface, the N-ization extraction rule is regarded as a rule with a high priority, and the interface extraction rule corresponding to the sequential composite paradigm is regarded as a rule with a low priority.

A data item of an N-ized structure does not exist in the computation sequence and only exist in the large function interface area of the for composite paradigm. For example, the generation rule for the interface of the composite function block having the loop structure further includes the following special extraction rule: when any data item d (e.g., an input data item or an output data item) at a same location of each IFloop in the looping composite paradigm is not joined by a joining line (a data transfer joining line or an auxiliary merging joining line), for a plurality of layers of IFloops, there are a plurality of identical data items d. When the plurality of data items d are extracted as the interface of the composite function block obtained by composition, an N-ized array d[ ] formed by a plurality of data items d is formed on the interface. In this case, the N-ized array d[ ] corresponds to the plurality of data items d in the plurality of layers of IFloops in the looping composite paradigm. The N-ized array d[ ] is an array data item of the array type.

An input data item extracted from the single expression and an input data item extracted from the loop body loopN are composited to form the input portion of the for composite paradigm. The data class of the data item is 1, namely the basic composite data type. A data item of the input portion may internally include a data item of the array type. In particular cases, if no data item is extracted from the single expression and only one data item of the array type is extracted from the loop body loopN, the data item of the array type serves as the finally formed input portion of the for composite paradigm and does not need to be composited into the basic composite data. In this case, the data class attribute of the data item of the input portion is 2, i.e., the array type.

The output portion of the for composite paradigm is formed by compositing output data extracted from the portion of the loop body loopN, and the data class of the finally formed data item is 1, namely the basic composite data type. A data item of the output portion may internally include a data item of the array type. In particular cases, if only one data item of the array type is extracted from the loop body, the data item of the array type serves as the finally formed output portion of the for composite paradigm and does not need to be composited into the basic composite data. In this case, the data class attribute of the data item of the output portion is 2, i.e., the array type.

It needs to be noted that when generating the interface of the composite function block having the for structure, if the above-mentioned extraction rule for generating the interface (i.e., the related rule for generating the interface in step S13) conflicts with the special rule corresponding to the for structure described here, the special rule corresponding to the for structure is preferred. In addition, when generating the interface of the composite function block having the for structure, it may be freely selected to extract an output data item as a portion of the interface corresponding to the composite function block having the for structure.

FIG. 10G is a schematic diagram illustrating a graphical representation of an interface corresponding to the composite function block having the for structure illustrated in FIG. 10F.

As illustrated in FIG. 10G, PF_For is the name of the composite function block, which is defined by the user. The input portion of the interface includes input data items n and intint[ ] (array data items), and the output portion of the interface includes output data item sum2[ ] (array data item). The input data item intint[ ] includes data item sum1 and array data item a[ ]. The data item a[ ] is an N-ized data item extracted from data item a according to the interface extraction rule, and the data item sum2[ ] is obtained by performing N-ization extraction on the output data item sum2 according to the interface extraction rule.

For example, the XML representation of the interface illustrated in FIG. 10G is as follows.

```
  <PF id=“PF_for” name=“”>
  <in>
  <type id=“” name=“” value=“” typeclass=“1” typevalue=“int(intint[ ])” typeid=“”>
  <type id=“n” name=“” value=“” typeclass=“0” typevalue=“int”
typeid=“”memory=“1”/>
  <type id=“intint[ ]” name=“” value=“” typeclass=“1” typevalue=“intint[ ]” typeid=“”
memory=“1”>
  <type id=“sum1” name=“” value=“” typeclass=“0” typevalue=“int”
typeid=“”memory=“1”/>
  <type id=“a[ ]” name=“” value=“” typeclass=“2” typevalue=“int[ ]”
typeid=“”memory=“1”>
  <type id=“a” name=## value=## typeclass=“0” typevalue=“int”
typeid=“”memory=“1”/>
  </type>
  </type>
  </type>
  </in>
  <out>
  <type id=“sum2[]” name=“” value=“” typeclass=“2” typevalue=“int[]”
typeid=“”memory=“1”>
  <type id=“sum2” name=“” value=“” typeclass=“0” typevalue=“int”
typeid=“”memory=“1”/>
  </type>
  </out>
  </PF>
```

For example, in the above XML of the interface, the typevalue of the array data item a[ ] is int[ ], and the typeclass of the array data item a[ ] is 2. The typevalue of the array data item sum2[ ] is int[ ], and the typeclass of the array data item sum2[ ] is 2.

For example, in the organization process of the composite function block having the for structure, if N-ization interface extraction is performed on a data item, the data item corresponding to the interface that corresponds to the composite function block having the for structure, when extracted to the interface, is changed to a data item of the array structure.

For example, the array type may be obtained by performing N-ization extraction on a data item of the basic data type, or may be obtained by performing N-ization extraction on a data item of the composite data type. The array type is one of composite data types. For example, a data item of the array type may be referred to as an array data item.

For example, the typevalue of the data item of the array type is represented in the following form: type+[ ]. The XML representation of the data item of the array type is as follows.

<type id=“” name=“” value=“”typeclass=“2” typevalue=“T[ ]” typeid=“T[ ]”>
<type id=“” name=“” value=“”typeclass=“”typevalue=“T” typeid=“” />
</type>

For example, the typevalue of the array data item is expressed as T[ ], and T is the data type attribute. For example, T may be int, int2, or the like, and the typeclass of the data item of the array type is 2.

For example, the XML representation of the array structure of an array data item of the int e is as follows:

<type id=“” name=“” value=“”typeclass=“2” typevalue=“int[ ]” typeid=“int[ ]”>
<type id=“” name=“” value=“”typeclass=“0”typevalue=“int” typeid=“int” />
</type>

For example, the XML representation of the array structure of an array data item of the int 2 type is as follows:

<type id=“” name=“” value=“”typeclass=“2”typevalue=“int2[ ]” typeid=“int2[ ]”>
<type id=“” name=“” value=“”typeclass=“1”typevalue=“int2” typeid=“int2”>
<type id=“” name=“” value=“”typeclass=“0”typevalue=“int” typeid=“int” />
<type id=“” name=“” value=“”typeclass=“0” typevalue=“int” typeid=“int” />
</type>
</type>

For example, each data item in the array data item of the int 2 type includes two data items of the int type.

When the getname function is used, assuming that an input data item is a data item of the array type with the type attribute of T[ ], an output data item is a pointer pointing to an array data item of T type, and the pointer points to a first data item of the array data item:

```
  <F id=“getname” name=“”>
  <in>
  <type id=“” name=“” value=“” typeclass=“2” typevalue=“T[ ]” typeid=“T[ ]”>
  <type id=“” name=“” value=“” typeclass=“0, 1, 2, 3, 4 or 5” typevalue=“T”
typeid=“T”/>
  </type>
  </in>
  <out>
  <type id=“” name=“” value=“” typeclass=“4” typevalue=“& T[ ]” typeid=“ref”>
  <type id=“” name=“” value=“” typeclass=“2” typevalue=“T[ ]” typeid=“T[ ]”>
  <type id=“” name=“” value=“” typeclass=“0, 1, 2, 3, 4 or 5” typevalue=“T”
typeid=“T”/>
  </type>
  </type>
  </out>
  </F>
```

When the addAddress function is used, the types of two input data items are the pointer type pointing to an array and the int type, and an output data item has an identical data type with an input pointer data item. Using the addAddress function represents that the pointer of the input data item points to the address of a data item in an array data item.

The addAddress function has two constraints. Constraint 1: an input pointer data item points to a data item in an array data item; a first source of the pointer data item is obtaining an output of the address of a first data item from an array data item by getname, and a second source of the same is an output of the addAddress function; each data item in the array data item is logically and sequentially arranged, meeting address additivity. Constraint 2: each data item in the array data item has the same data class attribute and the data type attribute. Because each data item has the same type attribute, it guarantees that the storage size of each data item is logically regular and consistent, i.e., a logical gap between adjacent data items in the array data item is equal, meeting the address additivity. Assuming that a first input data item of the addAddress function is a pointer data item pointing to array t[ ] and a second input data item is constant 1, the addAddress function represents acquiring an address pointer of a data item after the data item to which the current input pointer data item points, and the type of the data item is also t, implicitly constraining that the current pointer and one data item after it belong to a same array data item range. Assuming that the first input data item of the addAddress function is a pointer data item pointing to array t[ ] and the second input data item is data item n of the int type, the addAddress function represents obtaining an address pointer of the nth data item after the data item to which the current input pointer data item points, and the type of the data item is also t, implicitly constraining that the current pointer and n data items after it belong to a same array data item range.

Joining a data item of the array type by a line need to meet an array type matching rule and the line joining requirement rule.

The expanding action is allowed to be performed on a data item of the composite data type array, and the expanding action has influence on the data type attributes and the data class attributes of the data item and the data items included therein. The operation process of the expanding action following the following array logic equivalent transformation rule: if an array data item included in an expanded data item is also an array of the composite data type, the expanding action may be continuously applied to the array of the composite data type included therein until the type of the data item meets the type matching rule or the data item is an array of the basic data type or an array of the pointer type or an array of the generic type.

Assuming that there is data item T[ ] of the array type, the data class attribute of the data item of the array type is 2 and the data type attribute is T[ ]. If T is the composite data type with k data items being included therein and the data types of the k data items being t1, t2, . . . , tk, respectively, the data class attribute of T may be 1 or 3 (apart from the basic data type), and the data type attribute of T is t1t2 . . . tk. The expanding action is performed on the data item T[ ] of the array type. N-ization is performed on the k data items to form k array data items t1[ ], t2[ ], . . . , tk[ ]. The data class attribute of each array data item of the k array data items is 2. Meanwhile, following a composition rule of data types, array data item T[ ] turns into composite data item D formed by compositing t1[ ], t2[ ], . . . , tk[ ], i.e., N-ization of T[ ] is canceled. The data class attribute of D is identical to the data class attribute (which may be 1 or 3) of T, and the data type attribute of D is t1[ ]t2[ ] . . . tk[ ]. If there is the composite data type among t1, t2, . . . , and tk, the expanding action may be continuously and recursively applied to the array of the composite data type, and the expanding operation is terminated until the following two conditions are met: first, the data item at this time is an array of a basic type and cannot be expanded; second, when the line joining operation requirement of the user is met, the expanding operation may be chosen not to be performed.

Assuming that there is array data item T[ ], the data class attribute of array data item T[ ] is 2 and the data type attribute of array data item T[ ] is T[ ]. If T is an array of the composite data type, i.e., T itself is an array that internally includes m data items t1, t2, . . . , tm, the data type attribute of T is (t1t2 . . . tm)[ ], the data class attribute of T is 2, and the data type attribute of array data item T[ ] is ((t1t2 . . . tm)[ ])[ ]. When performing the expanding action on array data item T[ ], T needs to be expanded first. That is, data item (t1t2 . . . tm)[ ] is expanded first by the expanding action as described above. Thus, (t1t2 . . . tm)[ ] is expanded into t1[ ]t2[ ] . . . tm[ ]. At this time, the data type attribute of array data item T[ ] is (t1[ ]t2[ ] . . . tm[ ])[ ] and the data class attribute thereof is 2. If there is also an array of the composite data type among t1, t2, . . . , and tm, the array of the composite data type among t1, t2, . . . , and tm is expanded first, and then the expanding action is performed on an array of an upper layer.

For example, for an array logic equivalent rule, the specific operation is represented as follows: an expanding rule for an array structure is that for a function block in which a data item of the array type resides, a logic equivalent expanding operation may be performed on the data item of the array type, and when the expanding operation is performed, the operation may be performed according to the following description: assuming that an output data item of the current layer of the function block is a data item of the array type, the data class attribute of the data item of the array type is 2 and the data type attribute is ((t1t2)t3)[ ]. The data item of the array type is an array of the composite data type and internally includes data item D1 of the composite data type (of which the data type attribute is t1t2) and data item D2 of the basic data type (of which the data type attribute is t3). The composite data type is ((t1t2)t3) and the data class attribute is 1. When expanding the data item of the array type, data items D1 and D2 included in the data item are logically N-ized into the array form of each data item, thereby forming two array data items of which the data type attributes are (t1t2)[ ] and t3[ ], with the data type attribute of the array data item being 2. Meanwhile, an N-ization canceling operation is performed on original data item T[ ], and according to a generation rule for typevalue, a data item having the data type attribute of (t1t2)[ ]t3[ ] and the data class attribute of 1 is generated. For the expanded array data item having the data type attribute of (t1t2)[ ], whether to continue expanding may be selected according to the willingness of the user. For a data item of which the data type attribute is t3[ ], because it is an array of the basic data type and does not meet an expanding condition, the data item of which the data type attribute is t3[ ] cannot be expanded continuously. For an input data item, a reference may be made to the above related description on an output data item. After an array data item is expanded, the expanded array data items may be merged according to reverse actions of the above steps till a first level of data items.

FIG. 3 (1) A illustrates a function block with an array data item of the basic composite data type. As illustrated in FIG. 3 (1) A, the array data item of the basic composite data type is represented as (int(intstring))[ ]. FIG. 3 (1) B illustrates a form after the line joining expanding action is performed on the array data item. As illustrated in FIG. 3 (1) B, after the line joining expanding on the array data item (int(intstring))[ ], array data item int[ ] and array data item (intstring)[ ] may be formed. FIG. 3 (1) A illustrates a form after merging of the array data item in FIG. 3 (1) B.

FIG. 3 (1) C illustrates a function block with an array data item of the Exclusive OR composite data type. As illustrated in FIG. 3 (1) C, the array data item of the Exclusive OR composite data type is represented as (intxorfloat)[ ], which is an output data item. FIG. 3 (1) D illustrates a form after the line joining expanding action is performed on the array data item. As illustrated in FIG. 3 (1) D, after the line joining expanding on the array data item (intxorfloat)[ ], array data item int[ ] and array data item float[ ] may be formed. FIG. 3 (1) C illustrates a form after merging of the array data item in FIG. 3 (1) D.

FIG. 3 (1) E illustrates a function block internally including a data item of the array type. As illustrated in FIG. 3 (1) E, the array data item internally including the data item of the array type is represented as (int[ ]string)[ ]. FIG. 3 (1) F illustrates a form after the expanding action is performed on the array. As illustrated in FIG. 3 (1) F, after the line joining expanding on the array data item (int[ ]string)[ ], array data item int[ ][ ] and array data item string [ ] may be formed. FIG. 3 (1) E illustrates a form after merging of the array in FIG. 3 (1) F.

For example, the XML representation of an array data item having the data type attribute of ((t1t2)t3)[ ] is as follows:

```
  <type id=“” name=“” value=“ typeclass=“2” typevalue=“((t1t2)t3)[ ]” typeid=“”>
  <type id=“” name=“” value=“” typeclass=“1” typevalue=“((t1t2)t3)” typeid=“”>
  <type id=“” name=“” value=“” typeclass=“1” typevalue=“t1t2” typeid=“”>
  <type id=“” name=“” value=“” typeclass=“0, 1, 2, 3, 4 [symbol]   5” typevalue=“t1”
typeid=“” />
  <type id=“” name=“” value=“” typeclass=“0, 1, 2, 3, 4 or 5” typevalue=“t2”
typeid=“” />
  </type>
  <type id=“” name=“” value=“” typeclass=“0, 1, 2, 3, 4 or 5” typevalue=“t3”
typeid=“” />
  </type>
  </type>
```

FIG. 10H illustrates a structural diagram illustrating a storage hierarchy of an interface of a function block including the data item of the array type; FIG. 10I is a structural diagram illustrating a storage hierarchy when performing line joining expanding on the data item of the array type at a first layer; and FIG. 10J is a structural diagram illustrating a storage hierarchy when performing line joining expanding on the data item of the array type at a second layer.

As illustrated in FIG. 10H, in the rectangular box, the total number of levels of the input portion of the function block PF is 1, and the currently displayed level of the input portion is 1. The total numbers of levels of the output portion of the function block PF is 3, and the currently displayed level of the output portion is 1. As illustrated in FIG. 10I, the operation of performing line joining expanding on the output data item of the function block at the first layer is as follows: an internal type of the first layer of the output data item is logically modified to (t1t2)[ ]t3[ ], and the XML representation is as follows:

```
  <type id=“” name=“” value=“” typeclass=“1” typevalue=“(t1t2)[ ]t3[ ]” typeid=“”>
  <type id=“” name=“” value=“” typeclass=“2” typevalue=“(t1t2)[ ]” typeid=“”>
  <type id=“” name=“” value=“” typeclass=“1” typevalue=“t1t2” typeid=“”>
  <type id=“” name=“” value=“” typeclass=“0, 1, 2, 3, 4 or 5” typevalue=“t1”
typeid=“” />
  <type id=“” name=“” value=“” typeclass=“0, 1, 2, 3, 4 or 5” typevalue=“t2”
typeid=“” />
  </type>
  </type>
  <type id=“” name=“” value=“” typeclass=“2” typevalue=“t3[ ]” typeid=“”>
  <type id=“” name=“” value=“” typeclass=“0, 1, 2, 3, 4 or 5” typevalue=“t3”
typeid=“”>
  </type>
  </type>
```

As illustrated in FIG. 10J, the operation of performing line joining expanding on the output data item of the function block at the second layer is as follows: an internal type of the second layer of the output data item is logically modified to (t1[ ]t2[ ]) t3[ ], and the XML representation is as follows:

```
  <type id=“” name=“” value=“” typeclass=“1” typevalue=“(t1[ ]t2[ ])t3[ ]” typeid=“”>
  <type id=“” name=“” value=“” typeclass=“1” typevalue=“t1[ ]t2[ ]” typeid=“”>
  <type id=“” name=“” value=“” typeclass=“2” typevalue=“t1[ ]” typeid=“”>
  <type id=“” name=“” value=“” typeclass=“0, 1, 2, 3, 4 or 5” typevalue=“t1”
typeid=“”>
  </type>
  <type id=“” name=“” value=“” typeclass= “2” typevalue=“t2[ ]” typeid=“”>
  <type id=“” name=“” value=“” typeclass=“0, 1, 2, 3, 4 or 5” typevalue=“t2”
typeid=“”>
  </type>
  </type>
  <type id=“” name=“” value=“” typeclass=“2” typevalue=“t3[ ]” typeid=“”>
  <type id=“” name=“” value=“” typeclass=“0, 1, 2, 3, 4 or 5” typevalue=“t3”
typeid=“”>
  </type>
  </type>
```

A line joining relationship is then created for data item t1[ ], data item t2[ ], and data item t3[ ] according to the type matching rule or the line joining requirement rule.

For example, as illustrated in FIG. JOB, step S75 includes: generating PFVMS. After the interface corresponding to the composite function block is generated, a contrast relationship between the data item extracted as the interface and a data item in the computation sequence and a contrast relationship between the data item extracted as the interface and a data item of an auxiliary merging joining line or a data transfer joining line are created to generate the PFVMS. For example, the XML of the PFVMS portion corresponding to the composite function block having the for structure may be generated. The PFVMS portion in the XML architecture corresponding to the composite function block having the for structure illustrated in FIG. 10G is represented as:

```
<PFVMS>
<line>
  <source path= “in.0.0”/>
  <destination path=“1.0.0.0.in.0.1” />
</line>
<line>
  <source path= “in.0.0” />
  <destination path=“1.1.0.0.in.0.1” />
</line>
<line>
  <source path= “in.0.1.0” />
  <destination path=“1.0.1.0.in.0.0” />
</line>
<line>
  <source path= “in.0.1.1.0” />
  <destination path=“1.0.1.0.in.0.1” />
</line>
<line>
  <source path= “out.0.0” />
  <destination path=“1.0.1.0.out.0” />
</line>
</PFVMS
```

For example, as illustrated in FIG. 10B, step S76 includes: forming a composite function block having the for structure. Thus, by steps S70 to S76, the organization of the composite function block having the for structure is completed, and the complete structure of the composite function block having the for structure is generated.

For example, the complete XML representation corresponding to composite function block PF_For is as follows:

```
  <PF id=“PF_For” name=“”>
  <exp1 name=“”>
  <F id=“assignint” name=“”>
  <in>
  <type id=“0” name=“” value=“0” typeclass=“0” typevalue=“int” typeid=“”
memory=“1” />
  </in>
  <out>
  <type id=“i” name=“” value=“” typeclass=“0” typevalue=“int” typeid=“”
memory=“1” />
  </out>
  </F>
  </exp1>
  <loopN name=“”>
  <IFLoop name=“”>
  <exp2 name=“”>
  <F id=“lessint” name=“” >
  <in>
  <type id=“int2” name=“” value=“” typeclass=“1” typevalue=“int2” typeid=“”>
  <type id=“i” name=“” value=“” typeclass=“0” typevalue=“int” typeid=“”
memory=“0”/>
  <type id=“n” name=“” value=“” typeclass=“0” typevalue=“int” typeid=“”
memory=“1”/>
  </type>
  </in>
  <out>
  <type id=“boolean” name=“” value=“” typeclass=“0” typevalue=“boolean”
typeid=“” memory=“1”/>
  </out>
  </F>
  </exp2>
  <loop name=“”>
  <PF id=“addint” name=“”>
  <in>
  <type id=“int2” name=“” value=“” typeclass=“1” typevalue=“int2” typeid=“”>
  <type id=“sum1” name=“” value=“” typeclass=“0” typevalue=“int” typeid=“”
memory=“1”/>
  <type id=“a” name=“” value=“” typeclass=“0” typevalue=“int” typeid=“”
memory=“1” />
  </type>
  </in>
  <out>
  <type id=“sum2” name=“” value=“” typeclass=“0” typevalue=“int” typeid=“”
memory=“1”/>
  </out>
  </PF>
  </loop>
  <exp3 name=“”>
  <PF id=“addint” name=“” >
  <in>
  <type id=“int2” name=“” value=“” typeclass=“1” typevalue=“int2” typeid=“”>
  <type id=“i” name=“” value=“” typeclass=“0” typevalue=“int” typeid=“”
memory=“0”/>
  <type id=“1” name=“” value=“1” typeclass=“0” typevalue=“int” typeid=“”
memory=“1” />
  </type>
  </in>
  <out>
  <type id=“i” name=“” value=“” typeclass=“0” typevalue=“int” typeid=“”
memory=“1” />
  </out>
  </PF>
  </exp3>
  </IFLoop>
  <IFLoop name=“”>
  <exp2 name=“”>
  <F id=“lessint” name=“”>
  <in>
  <type id=“int2” name=“” value=“” typeclass=“1” typevalue=“int2” typeid=“”>
  <type id=“i” name=“” value=“” typeclass=“0” typevalue=“int” typeid=“”
memory=“0”/>
  <type id=“n” name=“” value=“” typeclass=“0” typevalue=“int” typeid=“”
memory=“0”/>
  </type>
  </in>
  <out>
  <type id=“boolean” name=“” value=“” typeclass=“0” typevalue=“boolean”
typeid=“” memory=“1”/>
  </out>
  </F>
  </exp2>
  <loop name=“”>
  <PF id=“addint” name=“”>
  <in>
  <type id=“int2” name=“” value=“” typeclass=“1” typevalue=“int2” typeid=“”>
  <type id=“sum1” name=“” value=“” typeclass=“0” typevalue=“int” typeid=“”
memory=“0”/>
  <type id=“a” name=“” value=“” typeclass=“0” typevalue=“int” typeid=“”
memory=“1” />
  </type>
  </in>
  <out>
  <type id=“sum2” name=“” value=“” typeclass=“0” typevalue=“int” typeid=“”
memory=“1” />
  </out>
  </PF>
  </loop>
  <exp3 name=“”>
  <PF id=“addint” name=“”>
  <in>
  <type id=“int2” name=“” value=“” typeclass=“1” typevalue=“int2” typeid=“”>
  <type id=“i” name=“” value=“” typeclass=“0” typevalue=“int” typeid=“”
memory=“0”/>
  <type id=“1” name=“” value=“1” typeclass=“0” typevalue=“int” typeid=“”
memory=“1”/>
  </type>
  </in>
  <out>
  <type id=“i” name=“” value=“” typeclass=“0” typevalue=“int” typeid=“”
memory=“1” />
  </out>
  </PF>
  </exp3>
  </IFloop>
  </loopN>
  <VMS>
  <line>
  <source path=“0.0.out.0” />
  <destination path=“1.0.0.0.in.0.0” />
  </line>
  <line>
  <source path=“0.0.out.0”/>
  <destination path=“1.0.2.0.in.0.0” />
  </line>
  <line>
  <source path=“1.0.2.0.out.0” />
  <destination path=“1.1.0.0.in.0.0” />
  </line>
  <line>
  <source path=“1.0.2.0.out.0” />
  <destination path=“1.1.2.0.in.0.0” />
  </line>
  <line>
  <source path=“1.0.1.0.out.0” />
  <destination path=“1.1.1.0.in.0.0” />
  </line>
  </VMS>
  <in>
  <type id=“” name=“” value=“” typeclass=“1” typevalue=“int(intint[ ])” typeid=“”>
  <type id=“n” name=“” value=“” typeclass=“0” typevalue=“int” typeid=“”
memory=“1” />
  <type id=“intint[ ]” name=“” value=“” typeclass=“1” typevalue=“intint[ ]” typeid=“”
memory=“1”>
  <type id=“sum1” name=“” value=“” typeclass=“0” typevalue=“int” typeid=“”
memory=“1” />
  <type id=“a[ ]” name=“” value=“” typeclass=“2” typevalue=“int[ ]” typeid=“”
memory=“1” >
  <type id=“a” name=“” value=“” typeclass=“0” typevalue=“int”
typeid=“”memory=“1”/>
  </type>
  </type>
  </type>
  </in>
  <out>
  <type id=“sum2[ ]” name=“” value=“” typeclass=“2” typevalue=“int[ ]”
typeid=“”memory=“1”>
  <type id=“sum2” name=“” value=“” typeclass=“0” typevalue=“int”
typeid=“”memory=“1”/>
  </type>
  </out>
  <PFVMS>
  <line>
  <source path= “in.0.0” />
  <destination path=“1.0.0.0.in.0.1” />
  </line>
  <line>
  <source path= “in.0.0” />
  <destination path=“1.1.0.0.in.0.1” />
  </line>
  <line>
  <source path= “in.0.1.0” />
  <destination path=“1.0.1.0.in.0.0” />
  </line>
  <line>
  <source path= “in.0.1.1.0” />
  <destination path=“1.0.1.0.in.0.1” />
  </line>
  <line>
  <source path= “out.0.0” />
  <destination path=“1.0.1.0.out.0” />
  </line>
  </PFVMS>
  </PF>
```

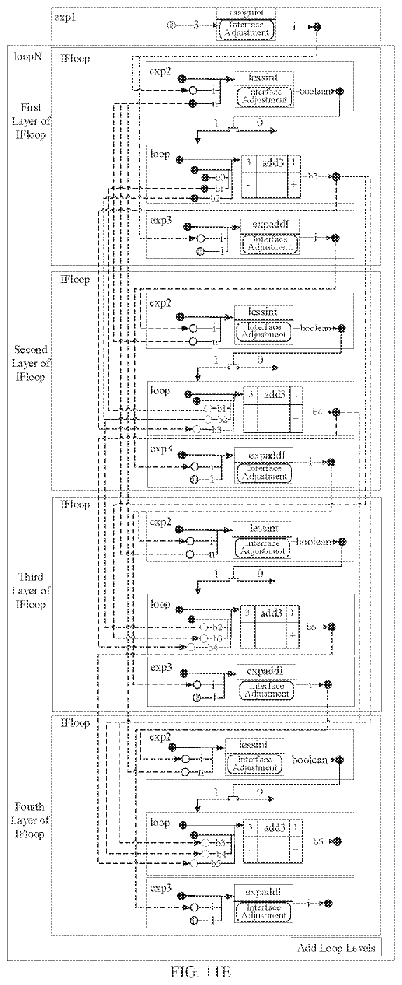

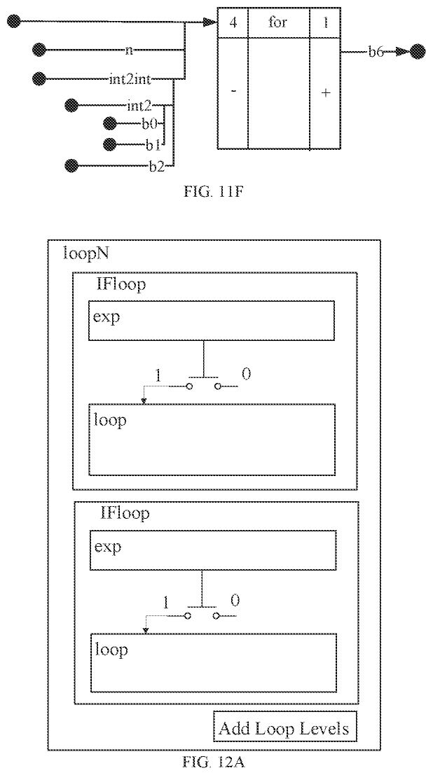

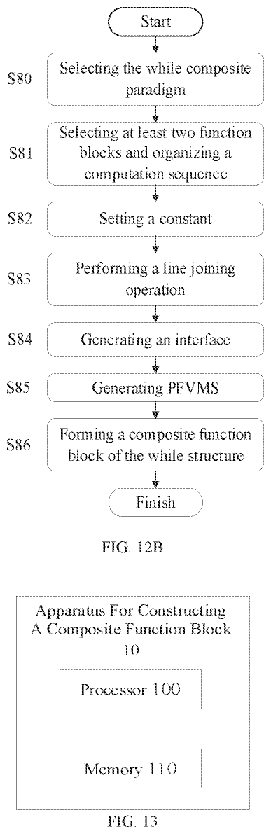

FIG. 11A is a schematic diagram of a computation function provided in some embodiments of the present disclosure; and FIG. 11B is a schematic diagram illustrating a graphical representation of another composite function block having a for structure provided in some embodiments of the present disclosure. For example, the composite function block having the for structure illustrated in FIG. 11B is configured to realize the computation function illustrated in FIG. 11A.

For example, in some other embodiments, at least two function blocks may be composited based on the for composite paradigm to obtain a composite function block having the for structure, thus realizing the computation function illustrated in FIG. 11A.

For example, as illustrated in FIG. 11A, the computation function includes four layers of loops: loop1, loop2, loop3, and loop4. The first layer of loops loop1 is used for computing b3, where b3=b2+b1+b0. The second layer of loops loop2 is used for computing b4, where b4=b3+b2+b1. The third layer of loops loop3 is used for computing b5, where b5=b4+b3+b2. The fourth layer of loops loop4 is used for computing b6, where b6=b5+b4+b3. For example, b0 may be assigned pf1, b1 may be assigned pf2, and b2 may be assigned pf3.

For example, as illustrated in FIG. 11B, based on the computation function illustrated in FIG. 11A, four function blocks may be selected from the function block library. The selected four function blocks are arranged based on the for composite paradigm to form the corresponding computation sequence. The selected four function blocks are assignment function block assignint, function block lessint representing the less-than relational expression, first addition function block add3, and second addition function block expaddI. The first addition function block add3 has three input data items and is used for perform an addition operation on the three input data items, and the second addition function block expaddI has two input data items and is used for performing an addition operation on the two input data items. Because the computation function illustrated in FIG. 11A has four layers of loops, as illustrated in FIG. 11B, four layers of IFloops may be set in the for structure: a first layer of IFloops (corresponding to loop1 in FIG. 11A), a second layer of IFloops (corresponding to loop2 in FIG. 11A), a third layer of IFloops (corresponding to loop3 in FIG. 1 IA), and a fourth layer of IFloops (corresponding to loop4 in FIG. 11A). Based on the for composite paradigm, the assignment function block assignint is set in the single expression exp1 portion in the for structure, the function block lessint representing the less-than relational expression is set in the exp2 portion of each layer of IFloops in the for structure, the first addition function block add3 is set in the loop expression loop portion of each layer of IFloops in the for structure, and the second addition function block expaddI is set in the end loop expression exp3 portion of each layer of IFloops.

For example, the XML representation of the computation sequence formed by the function blocks illustrated in FIG. 11B is as follows:

```
  <PF id=“for” name=“”>
  <exp1 name=“”>
  <F id=“assignint” name=“” >
  <in>
  <type id=“3” name=“” value=“” typeclasss=“0” typevalue=“int” typeid=“”
memory=“1” />
  </in>
  <out>
  <“type id=“i” name=“” value=“” typeclasss=“0” typevalue=“int” typeid=“”
memory=“1” />
  </out>
  </F>
  </exp1>
  <loopN name=“” >
  <IFLoop id=“” name=“” >
  <exp2 name=“”>
  <F id=“lessint” name=“” >
  <in>
  <type id=“int2” name=“” value=“” typeclasss=“1” typevalue=“int2” typeid=“”>
  <type id=“i” name=“” value=“” typeclasss=“0” typevalue=“int” typeid=“”
memory=“1” />
  <type id=“n” name=“” value=“” typeclasss=“0” typevalue=“int” typeid=“”
memory=“1” />
  </type>
  </in>
  <out>
  <“type id=“boolean” name=“” value=“” typeclasss=“0” typevalue=“boolean”
typeid=“” memory=“1”/>
  </out>
  </F>
  </exp2>
  <loop name=“”>
  <PF id=“add3” name=“”>
  <in>
  <type id=“” name=“” value=“” typeclasss=“1” typevalue=“int2int” typeid=“”>
  <type id=“int2” name=“” value=“” typeclasss=“1” typevalue=“int2” typeid=“”>
  <“type id=“b0” name=“” value=“” typeclasss=“0” typevalue=“int” typeid=“”
memory=“1” />
  <type id=“b1” name=“” value=“” typeclasss=“0” typevalue=“int” typeid=“”
memory=“1”/>
  </type>
  <type id=“b2” name=“” value=“” typeclasss=“0” typevalue=“int” typeid=“”
memory=“1”/>
  </type>
  </in>
  <out>
  <type id=“b3” name=“” value=“” typeclasss=“0” typevalue=“int” typeid=“”
memory=“1” />
  </out>
  </PF>
  </loop>
  <exp3 name=“”>
  <F id=“expaddI” name=“”>
  <in>
  <type id=“” name=“” value=“” typeclasss=“1” typevalue=“int2” typeid=“”>
  <type id=“i” name=“” value=“” typeclasss=“0” typevalue=“int” typeid=“”
memory=“1”/>
  <type id=“1” name=“” value=“” typeclasss=“0” typevalue=“int” typeid=“”
memory=“1”/>
  </type>
  </in>
  <out>
  <type id=“i” name=“” value=“” typeclasss=“0” typevalue=“int” typeid=“”
memory=“1” />
  </out>
  </F>
  </exp3>
  </IFloop>
  <IFLoop id=“” name=“”>
  <exp2 name=“”>
  <F id=“lessint” name=“” >
  <in>
  <type id=“int2” name=“” value=“” typeclasss=“1” typevalue=“int2” typeid=“”>
  <type id=“i” name=“” value=“” typeclasss=“0” typevalue=“int” typeid=“”
memory=“1” />
  <type id=“n” name=“” value=“” typeclasss=“0” typevalue=“int” typeid=“”
memory=“1”/>
  </type>
  </in>
  <out>
  <type id=“boolean” name=“” value=“” typeclasss=“0” typevalue=“boolean”
typeid=“” memory=“1”/>
  </out>
  </F>
  </exp2>
  <loop name=“”>
  <PF id=“add3” name=“”>
  <in>
  <type id=“” name=“” value=“” typeclasss=“1” typevalue=“int2int” typeid=“”>
  <type id=“int2” name=“” value=“” typeclasss=“1” typevalue=“int2” typeid=“”>
  <type id=“b1” name=“” value=“” typeclasss=“0” typevalue=“int” typeid=“”
memory=“1” />
  <“type id=“b2” name=“” value=“” typeclasss=“0” typevalue=“int” typeid=“”
memory=“1” />
  </type>
  <type id=“b3” name=“” value=“” typeclasss=“0” typevalue=“int” typeid=“”
memory=“1”/>
  </type>
  </in>
  <out>
  <type id=“b4” name=“” value=“” typeclasss=“0” typevalue=“int” typeid=“”
memory=“1” />
  </out>
  </PF>
  </loop>
  <exp3 name=“”>
  <F id=“expaddI” name=“ ” >
  <in>
  <type id=“” name=“” value=“” typeclass=“1” typevalue=“int2” typeid=“”>
  <type id=“i” name=“” value=“” typeclasss=“0” typevalue=“int” typeid=“”
memory=“1”/>
  <type id=“1” name=“” value=“” typeclasss=“0” typevalue=“int” typeid=“”
memory=“1”/>
  </type>
  </in>
  <out>
  <type id=“i” name=“” value=“” typeclasss=“0” typevalue=“int” typeid=“”
memory=“1”/>
  </out>
  </F>
  </exp3>
  </IFloop>
  <IFLoop id=“” name=“”>
  <exp2 name=“”>
  <F id=“lessint” name=“ ”>
  <in>
  <type id=“int2” name=“” value=“” typeclasss=“1” typevalue=“int2” typeid=“”>
  <type id=“i” name=“” value=“” typeclasss=“0” typevalue=“int” typeid=“”
memory=“1”/>
  <type id=“n” name=“” value=“” typeclasss=“0” typevalue=“int” typeid=“”
memory=“1”/>
  </type>
  </in>
  <out>
  <type id=“boolean” name=“” value=“” typeclasss=“0” typevalue=“boolean”
typeid=“” memory=“1”/>
  </out>
  </F>
  </exp2>
  <loop name=“”>
  <PF id=“add3” name=“”>
  <in>
  <type id=“” name=“” value=“” typeclasss=“1” typevalue=“int2int” typeid=“”>
  <type id=“int2” name=“” value=“” typeclasss=“1” typevalue=“int2” typeid=“”>
  <type id=“b2” name=“” value=“” typeclasss=“0” typevalue=“int” typeid=“”
memory=“1”/>
  <type id=“b3” name=“” value=“” typeclasss=“0” typevalue=“int” typeid=“”
memory=“1”/>
  </type>
  <type id=“b4” name=“” value=“” typeclasss=“0” typevalue=“int” typeid=“”
memory=“1”/>
  </type>
  </in>
  <out>
  <type id=“b5” name=“” value=“” typeclasss=“0” typevalue=“int” typeid=“”
memory=“1”/>
  </out>
  </PF>
  </loop>
  <exp3 name=“”>
  <F id=“expaddI” name=“” >
  <in>
  <type id=“” name=“” value=“” typeclasss=“1” typevalue=“int2” typeid=“”>
  <type id=“i” name=“” value=“” typeclasss=“0” typevalue=“int” typeid=“”
memory=“1”/>
  <type id=“1” name=“” value=“” typeclasss=“0” typevalue=“int” typeid=“”
memory=“1”/>
  </type>
  </in>
  <out>
  <type id=“i” name=“” value=“” typeclasss=“0” typevalue=“int” typeid=“”
memory=“1” />
  </out>
  </F>
  </exp3>
  </IFloop>
  <IFLoop id=“” name=“” >
  <exp2 name=“”>
  <F id=“lessint” name=“ ”>
  <in>
  <type id=“int2” name=“” value=“” typeclasss=“1” typevalue=“int2” typeid=“”>
  <type id=“i” name=“” value=“” typeclasss=“0” typevalue=“int” typeid=“”
memory=“1”/>
  <type id=“n” name=“” value=“” typeclasss=“0” typevalue=“int” typeid=“”
memory=“1” />
  </type>
  </in>
  <out>
  <type id=“boolean” name=“” value=“” typeclasss=“0” typevalue=“boolean”
typeid=“” memory=“1”/>
  </out>
  </F>
  </exp2>
  <loop name=“”>
  <PF id=“add3” name=“”>
  <in>
  <type id=“” name=“” value=“” typeclasss=“1” typevalue=“int2int” typeid=“”>
  <type id=“int2” name=“” value=“” typeclasss=“1” typevalue=“int2” typeid=“”>
  <type id=“b3” name=“” value=“” typeclasss=“0” typevalue=“int” typeid=“”
memory=“1”/>
  <type id=“b4” name=“” value=“” typeclasss=“0” typevalue=“int” typeid=“”
memory=“1”/>
  </type>
  <type id=“b5” name=“” value=“” typeclasss=“0” typevalue=“int” typeid=“”
memory=“1”/>
  </type>
  </in>
  <out>
  <type id=“b6” name=“” value=“” typeclasss=“0” typevalue=“int” typeid =“”
memory=“1”/>
  </out>
  </PF>
  </loop>
  <exp3 name=“”>
  <F id=“expaddI” name=“ ” >
  <in>
  <type id=“” name=“” value=“” typeclasss=“1” typevalue=“int2” typeid=“”>
  <type id=“i” name=“” value=“” typeclasss=“0” typevalue=“int” typeid=“”
memory=“1” />
  <type id=“1” name=“” value=“” typeclasss=“0” typevalue=“int” typeid=“”
memory=“1”/>
  </type>
  </in>
  <out>
  <type id=“i” name=“” value=“” typeclasss=“0” typevalue=“int” typeid=“”
memory=“1”/>
  </out>
  </F>
  </exp3>
  </IFloop>
  </loopN>
  </PF>
```

For example, in the above XML of the computation sequence, the memory of a data item represents the memory before the line joining operation has been performed. The memory of each data item after the line joining operation has been performed is determined according to the line joining operation.

For example, after the computation sequence is formed, attribute setting may be performed on the data items. The attribute setting includes: setting a constant. After the computation sequence is organized, a constant may be set for a data item and recorded in the value attribute of the data item. As illustrated in FIG. 11B, the input data item of the assignment function block assignint is a constant data item, and the value of the constant data item is 3. An input data item of the second addition function block expaddI is a constant data item, and the value of the constant data item is 1. In graphics, a constant data item is represented by a patterned circle, and a non-constant data item is represented by a solid circle.

For example, in the for structure, after the computation sequence is organized, according to the computation sequence, which data items (input data items and/or output data items) in the function blocks in the for structure may be joined by a data transfer joining line and/or an auxiliary merging joining line is determined. That is, after the computation sequence is obtained, the internal data items of the composite function block having the for structure may be joined in accordance with line joining rules to generate the VMS corresponding to the composite function block having the for structure.

For example, in the for structure, there are a data transfer joining line that joins an output data item to an input data item, a data transfer joining line that joins an output data item to an output data item, and an auxiliary merging joining line that joins an input data item to an input data item. Because the output data item of the function block in the exp2 portion of each layer of IFloops is used for realizing the judgement operation, the output data item of the exp2 portion of each layer of IFloops is not involved in the line joining operation.

FIG. 11C is another schematic diagram of a computation function provided in some embodiments of the present disclosure.

For example, as illustrated in FIG. 11C, an arrowed dotted line represents: for a line joining relationship created between a first output data item (i.e., a first output storage) of the first layer of loops (loop1) and a first input data item of the second layer of loops (loop2), a joining line is created automatically between data items at same locations between loop2 and loop3, and a joining line is created automatically between data items at same locations between loop3 and loop4. The arrowed dotted line represents a joining line between adjacent loop layers. For example, b3 in loop1 is joined to b3 in loop2, and b4 in loop2 is joined to b4 in loop3. The line joining operation between the adjacent loop layers is repeated automatically.

For example, as illustrated in FIG. 11C, an arrowed solid line represents: for a line joining relationship created between the first output data item of the first layer of loops (loop1) and a second input data item of the third layer of loops (loop3), a joining line is created automatically between data items at same locations between loop2 and loop4. The arrowed solid line represents a joining line across layers. For example, b3 in loop1 is joined to b3 in loop3, and b4 in loop2 is joined to b4 in loop4. The line joining operation across layers is repeated automatically.

FIG. 11D is a schematic diagram illustrating a graphical representation of a computation sequence illustrated in FIG. 11B after joining by a line.

For example, as illustrated in FIG. 11D, firstly, a data item (data item i) for realizing loop control in the for structure is joined by a line. For example, the output data item i of the function block assignint of the exp1 portion and the first input data item i of the function block lessint of the exp2 portion in the first layer of IFloops are joined by a data transfer joining line, and the output data item i of the function block assignint of the exp1 portion and the input data item i of the function block expaddI of the exp3 portion in the first layer of IFloops are joined by a data transfer joining line. The output data item i of the function block expaddI of the exp3 portion in the first layer of IFloops is joined to the first input data item i of the function block lessint of the exp2 portion in the second layer of IFloops by a data transfer joining line, and the output data item i of the function block expaddI of the exp3 portion in the first layer of IFloops is joined to the first input data item i of the function block expaddI of the exp3 portion in the second layer of IFloops by a data transfer joining line. When the first layer of IFloops is joined to the second IFloop by a line, a joining line is created automatically between data items i at same locations between the second layer of IFloops and the third layer of IFloops, and a joining line is created automatically between data items i at same locations between the third layer of IFloops and the fourth layer of IFloops. For example, the output data item i of the function block expaddI of the exp3 portion in the second layer of IFloops is joined to the first input data item i of the function block lessint of the exp2 portion in the third layer of IFloops by a data transfer joining line, and the output data item i of the function block expaddI of the exp3 portion in the second layer of IFloops is joined to the first input data item i of the function block expaddI of the exp3 portion in the third layer of IFloops by a data transfer joining line.

For example, as illustrated in FIG. 11D, after line joining, the circles corresponding to the first input data item i of the function block lessint of the exp2 portion in each layer of IFloops and the input data item i of the function block expaddI of the exp3 portion in each layer of IFloops are changed to hollow circles, representing that these data items are the virtual storages.

In this case, the VMS corresponding to the line joining relationship illustrated in FIG. 11D is represented as.

```
<VMS>
<line>
  <source path=“0.0.out.0” />
  <destination path=“1.0.0.0.in.0.0”/>
</line>
<line>
  <source path=“0.0.out.0” />
  <destination path=“1.0.2.0.in.0.0”/>
</line>
<line>
  <source path=“1.0.2.0.out.0” />
  <destination path=“1.1.0.0.in.0.0”/>
</line>
<line>
  <source path=“1.0.2.0.out.0” />
  <destination path=“1.1.2.0.in.0.0”/>
</line>
<line>
  <source path=“1.1.2.0.out.0” />
  <destination path=“1.2.0.0.in.0.0”/>
</line>
<line>
  <source path=“1.1.2.0.out.0” />
  <destination path=“1.2.2.0.in.0.0”/>
</line>
<line>
  <source path=“1.2.2.0.out.0” />
  <destination path=“1.3.0.0.in.0.0”/>
</line>
<line>
  <source path=“1.2.2.0.out.0” />
  <destination path=“1.3.2.0.in.0.0”/>
</line>
</VMS>
```

FIG. 11E is a schematic diagram illustrating another graphical representation of the computation sequence illustrated in FIG. 11C after joining by a line.

For example, as illustrated in FIG. 11E, each IFLoop is joined by a data transfer joining line which is saved in the VMS. For example, the output data item b3 of the function block add3 of the loop portion in the first layer of IFLoops is joined to the input data item b3 of the function block add3 of the loop portion in the second layer of IFLoops by a data transfer joining line, the input data item b2 of the function block add3 of the loop portion in the first layer of IFLoops is joined to the input data item b2 of the function block add3 of the loop portion in the second layer of IFLoops by an auxiliary merging joining line, and the input data item b1 of the function block add3 of the loop portion in the first layer of IFLoops is joined to the input data item b1 of the function block add3 of the loop portion in the second layer of IFLoops by an auxiliary merging joining line. The input data item n of the function block lessint of the exp2 portion in the first layer of IFLoops is joined to the input data item n of the function block lessint of the exp2 portion in the second layer of IFLoops by an auxiliary merging joining line. As illustrated in FIG. 11E, after line joining, the circles corresponding to the input data items b1-b3 of the function block add3 of the loop portion in the second layer of IFLoops are changed to hollow circles, representing that the input data items b1-b3 of the function block add3 of the loop portion in the second layer of IFLoops are the virtual storages. The circle corresponding to the input data item n of the function block lessint of the exp2 portion in the second layer of IFloops is changed to a hollow circle, representing that the input data item n of the function block lessint of the exp2 portion in the second layer of IFloops is the virtual storage.

It needs to be noted that for the line joining operation between the second layer of IFLoops and the third layer of IFLoops and the line joining operation between the third layer of IFLoops and the fourth layer of IFLoops, a reference may be made to the description on the line joining operation between the first layer of IFLoops and the second layer of IFLoops, which will not be described here redundantly.

The relationship between the data items joined by the auxiliary merging joining line illustrated in FIG. 11E is recorded in the VMS with the attribute undirected, which is represented as:

```
<VMS>
<line>
  <source path=“0.0.out.0” />
  <destination path=“1.0.0.0.in.0.0”/>
</line>
<line>
  <source path=“0.0.out.0” />
  <destination path=“1.0.2.0.in.0.0”/>
</line>
<line>
  <source path=“1.0.2.0.out.0” />
  <destination path=“1.1.0.0.in.0.0”/>
</line>
<line>
  <source path=“1.0.2.0.out.0” />
  <destination path=“1.1.2.0.in.0.0”/>
</line>
<line>
  <source path=“1.1.2.0.out.0” />
  <destination path=“1.2.0.0.in.0.0”/>
</line>
<line>
  <source path=“1.1.2.0.out.0” />
  <destination path=“1.2.2.0.in.0.0”/>
</line>
<line>
  <source path=“1.2.2.0.out.0” />
  <destination path=“1.3.0.0.in.0.0”/>
</line>
<line>
  <source path=“1.2.2.0.out.0” />
  <destination path=“1.3.2.0.in.0.0”/>
</line>
<line>
  <source path=“1.0.1.0.out.0” />
  <destination path=“1.1.1.0.in.0.1”/>
</line>
<line>
  <source path=“1.0.1.0.out.0” />
  <destination path=“1.2.1.0.in.0.0.1”/>
</line>
<line>
  <source path=“1.0.1.0.out.0” />
  <destination path=“1.3.1.0.in.0.0.0”/>
</line>
<line>
  <source path=“1.1.1.0.out.0” />
  <destination path=“1.2.1.0.in.0.1”/>
</line>
<line>
  <source path=“1.1.1.0.out.0” />
  <destination path=“1.3.1.0.in.0.0.1”/>
</line>
<line>
  <source path=“1.2.1.0.out.0” />
  <destination path=“1.3.1.0.in.0.1”/>
</line>
</VMS>
<VMS undirected=“”>
<line>
  <source path=“1.0.1.0.in.0.0.1” />
  <destination path=“1.1.1.0.in.0.0.0”/>
</line>
<line>
  <source path=“1.0.1.0.in.0.1” />
  <destination path=“1.1.1.0.in.0.0.1”/>
</line>
<line>
  <source path=“1.0.1.0.in.0.1” />
  <destination path=“1.2.1.0.in.0.0.0”/>
</line>
<line>
  <source path=“1.0.0.0.in.0.1” />
  <destination path=“1.1.0.0.in.0.1”/>
</line>
<line>
  <source path=“1.0.0.0.in.0.1” />
  <destination path=“1.2.0.0.in.0.1”/>
</line>
<line>
  <source path=“1.0.0.0.in.0.1” />
  <destination path=“1.3.0.0.in.0.1”/>
</line>
</VMS>
```

For example, after the line joining operation is completed, the interface may be generated.

The XML format of the interface of the composite function block having the for structure is identical to the interface format of the composite function block having the sequential structure, which will not be redundantly described here.

FIG. 11F is a schematic diagram illustrating a graphical representation of an interface corresponding to the composite function block having the for structure illustrated in FIG. 11E.

As illustrated in FIG. 11F, for is the name of the composite function block, which is defined by the user. The input portion of the interface includes input data item n and input data item int2int, and the output portion of the interface includes output data item b6. The data type attribute of b6 is a data item of the int array type. The output data item is selected by the user from the output data items of the add3 function block in each layer of IFloops as a final output data item. That is, output data items b3, b4, b5, and b6 are formed by N-ization extraction. The input data item int2int includes input data item int2 and input data item b2, and the input data item int2 includes input data item b0 and input data item b1.

For example, the XML representation of the interface illustrated in FIG. 11F is as follows:

```
  <PF id=“for” name=“”>
  <in>
  <type id=“ name=“” value=“” typeclasss=“1” typevalue=“int(int2int)” typeid=“” >
  <type id=“n” name=“” value=“” typeclasss=“0” typevalue=“int” typeid=“”
memory=“1”/>
  <type id=“” name=“” value=“” typeclasss=“1” typevalue=“int2int” typeid=“”
memory=“1”>
  <type id=“” name=“” value=“” typeclasss=“1” typevalue=“int2” typeid=“”
memory=“1”>
  <type id=“b0” name=“” value=“” typeclasss=“0” typevalue=“int” typeid=“”
memory=“1”/>
  <type id=“bl” name=“” value=“” typeclasss=“0” typevalue=“int” typeid=“”
memory=“1”/>
  </type>
  <type id=“b2” name=“” value=“” typeclasss=“0” typevalue=“int” typeid=“”
memory=“1”/>
  </type>
  </type>
  </in>
  <out>
  <type id=“b6” name=“” value=“” typeclasss=“2” typevalue=“int[ ]” typeid=“”
memory=“1”>
<type id=“b” name=“” value=“” typeclasss=“0” typevalue=“int” typeid=“”
memory=“1”/>
  </type>
  </out>
  </PF>
```

For example, after the interface corresponding to the composite function block is generated, a contrast relationship between the data item extracted as the interface and a data item in the computation sequence and a contrast relationship between the data item extracted as the interface and a data item of an auxiliary merging joining line or a data transfer joining line are created to generate the PFVMS.

For example, the XML of the PFVMS portion corresponding to the composite function block having the for structure may be generated. The PFVMS portion in the XML architecture corresponding to the composite function block having the for structure illustrated in FIG. 11E is represented as:

<PFVMS>
<line>
<source path=“in.0.0” />
<destination path=“1.0.0.0.in.0.1”/>
</line>
<line>
<source path=“in.0.0” />
<destination path=“1.1.0.0.in.0.1”/>
</line>
<line>
<source path=“in.0.0” />
<destination path=“1.2.0.0.in.0.1”/>
</line>
<line>
<source path=“in.0.0” />
<destination path=“1.3.0.0.in.0.1”>
</line>
<line>
<source path=“in.0.1.0.0” />
<destination path=“1.0.1.0.in.0.0.0”/>
</line>
<line>
<source path=“in.0.1.0.1” />
<destination path=“1.0.1.0.in.0.0.1”/>
</line>
<line>
<source path=“in.0.1.0.1” />
<destination path=“1.1.1.0.in.0.0.0”/>
</line>
<line>
<source path=“in.0.1.1” />
<destination path=“1.0.1.0.in.0.1”/>
</line>
<line>
<source path=“in.0.1.1” />
<destination path=“1.1.1.0.in.0.0.1”/>
</line>
<line>
<source path=“in.0.1.1” />
<destination path=“1.2.1.0.in.0.0.0”/>
</line>
<line>
<source path=“out. 0.0” />
<destination path=“1.0.1.0.out.0”/>
</line>
</PFVMS>

For example, the complete XML representation corresponding to the composite function block for in this instance is as follows:

FIG. 12A is a schematic diagram of a composite function block having a while structure provided in some embodiments of the present disclosure; and FIG. 12B is a schematic diagram of a method for compositing function blocks based on a while composite paradigm provided in some embodiments of the present disclosure.

For example, the while composite paradigm includes at least one layer of while loop bodies loopN; each while loop body includes at least one while loop portion IFloop, and each while loop portion includes a while conditional expression exp and a while loop expression. At least two function blocks are composited based on the while composite paradigm to obtain a composite function block having the while structure. As illustrated in FIG. 12A, in some examples, the while composite paradigm includes a first while loop portion IFloop and a second while loop portion IFloop. The first while loop portion IFloop includes a first while conditional expression exp and a first while loop expression loop, and the second while loop portion IFloop includes a second while conditional expression exp and a second while loop expression loop. The structure of the first while loop portion IFloop is identical to the structure of the second while loop portion IFloop. In other words, the structures of the first while conditional expression exp and the second while conditional expression exp are identical, and the structures of the first while loop expression loop and the second while loop expression loop are identical. The first while conditional expression exp in the first while loop portion IFloop includes at least one function block, and the first while loop expression loop in the first while loop portion IFloop includes at least one function block. The second while conditional expression exp in the second while loop portion IFloop includes at least one function block, and the second while loop expression loop in the second while loop portion IFloop includes at least one function block. The while composite paradigm has one layer of while loop portions by default. When one layer of while loop portions is insufficient to describe the whole computation organization process, loop levels may be added as needed until the whole computation meaning can be completely described. The structure of each layer of loop portions is identical. In other words, the while composite paradigm may include a plurality of layers of while loop portions IFloop.

It needs to be noted that in the first while loop portion IFloop, the first while conditional expression exp and the first while loop expression loop have the if structure, and the first while loop expression loop is the first branch portion doTrue in the if structure. Similarly, in the second while loop portion IFloop, the second while conditional expression exp and the second while loop expression loop have the if structure, and the second while loop expression loop is the first branch portion doTrue in the if structure.

The XML representation of the computation sequence portion corresponding to any composite function block having the while structure is as follows:

```
<IFLoop name=“”>
<exp name=“”>
<F/PF id=“” name=“”>
  <in></in>
  <out></out>
  </F/PF>
</exp>
<loopN name=“”>
<IFLoop name=“”>
<exp name=“”>
<F/PF id=“” name=“”>
<in></in>
<out></out>
</F/PF>
</exp>
<loop name=“”>
<F/PF id=“” name=“”>
  <in></in>
  <out></out>
  </F/PF>
</loop>
</IFLoop>
<IFLoop name=“” >
<exp name=“”>
<F/PF id=“” name=“”>
  <in></in>
  <out></out>
  </F/PF>
</exp>
<loop name=“”>
<F/PF id=“” name=“”>
  <in></in>
  <out></out>
  </F/PF>
</loop>
</IFLoop>
</loopN>
```

For example, the computation sequence portion corresponding to the composite function block having the while structure includes: a while loop body, represented by <loopN></loopN>, each while loop portion in the while loop body being represented by <IFLoop></IFLoop>, where each while loop portion IFloop includes the first while conditional expression exp, represented by <exp></exp> structure and representing a control condition for the loop, and the while loop expression loop, represented by <loop></loop> structure. Each while loop portion has a relative address, and the relative addresses of a plurality of layers of while loop portions are encoded in a sequentially increasing way.

For example, in the while structure, the relative address values of the exp portion and the loop portion are 0 and 1, respectively. The relative address of a function block in each portion is encoded according to serial numbers 0, 1, . . .

For example, in the composite function block having the while structure, each of the first while conditional expression exp/the second while conditional expression exp and the first while loop expression loop/the second while loop expression loop includes at least one function block.

The output data item of the function block of the exp portion must be a data item of the boolean type.

For example, as illustrated in FIG. 12B, the method for compositing function blocks based on the while composite paradigm includes steps S80 to S86.

Step S80 includes: selecting the while composite paradigm; step S81 includes: selecting at least two function blocks and organizing a computation sequence; step S82 includes: setting a constant; step S83 includes: performing a line joining operation; step S84 includes: generating an interface; step S85 includes: generating PFVMS; and step S86 includes: forming a composite function block having the while structure. By steps S80 to S86, the organization of the composite function block having the while structure is completed, and the complete structure of the composite function block having the while structure is generated.

It needs to be noted that the construction process of the composite function block having the while structure and related rules are similar to the construction process of the composite function block having the for structure and related rules, which will not be described here redundantly.

The generation rule for the interface of the composite function block having the while loop structure further includes the following special extraction rule. For example, for the composite function block having the while loop structure, in step S13, encapsulating the at least two function blocks into a composite function block and generating an interface corresponding to the composite function block further include: not providing an interface corresponding to the output data item of the function block located in the while conditional expression in the composite function block having the while loop structure; and not extracting a constant data item as a portion of the interface.

The generation rule for the interface of the composite function block having the while loop structure further includes the following N-ization extraction rule:

For example, each while loop body includes a plurality of while loop portions. In the N-ization extraction rule, for any input data item in the composite function block having the while loop structure, if the any input data items in some while loop portions of the plurality of while loop portions are joined by a joining line and the any input data items in another while loop portions of the plurality of while loop portions are not joined by a line, an interface corresponding to an input data item of which the storage attribute is the real storage among a plurality of any input data items corresponding to the plurality of while loop portions is provided.

For example, in the N-ization extraction rule, for any output data item in the composite function block having the while loop structure, if the any output data items in some while loop portions of the plurality of while loop portions are joined by a joining line and the any output data items in another while loop portions of the plurality of while loop portions are not joined by a line, only the any output data item in a first while loop portion of the plurality of while loop portions is provided as a corresponding interface or N-ization extraction is performed on a plurality of any output data items in the plurality of while loop portions.

A data item of an N-ized structure is not present in the computation sequence and only present in the large function interface area of the while composite paradigm. For example, the generation rule for the interface of the composite function block having the while loop structure further includes the following special extraction rule: when any data item d (e.g., an input data item or an output data item) at a same location of each while loop portion in the while looping composite paradigm is not joined by a joining line (a data transfer joining line or an auxiliary merging joining line), for a plurality of layers of while loop portions, there are a plurality of identical data items d. When the plurality of data items d are extracted as the interface of the composite function block obtained by composition, an N-ized array d[ ] formed by a plurality of data items d is formed on the interface. In this case, the N-ized array d[ ] corresponds to the plurality of data items d in the plurality of layers of while loop portions in the while composite paradigm. The N-ized array d[ ] is an array data item of the array type.

For example, in the organization process of the composite function block having the while structure, if N-ization extraction is performed on a data item, the data item corresponding to the interface that corresponds to the composite function block having the while structure includes a data item of the array structure.

It needs to be noted that the data class attribute of a data item in the interface corresponding to the composite function block having the loop structure or the while loop structure is the array type.

It needs to be noted that when generating the interface of the composite function block having the while structure, if the above-mentioned extraction rule for generating the interface (i.e., the related rule for generating the interface in step S13) conflicts with the special rule corresponding to the while structure described here, the special rule corresponding to the while structure is preferred.

The line joining rule and N-ization extraction for the while composite paradigm are identical to those of the for composite paradigm.

Some embodiments of the present disclosure further provide a composite function block that is obtained by compositing by the method according to any above embodiment.

For example, the composite function block may include one or more function blocks, where the one or more function blocks are joined by a data transfer joining line and/or an auxiliary merging joining line.

It needs to be noted that for the compositing process of the composite function block, the data transfer joining line, the auxiliary merging joining line, and the like, a reference may be made to the above related description, which will not be described here redundantly.

FIG. 13 illustrates an apparatus for constructing a composite function block provided in some embodiments of the present disclosure. For example, as illustrated in FIG. 13, the apparatus 10 for constructing a composite function block includes processor 100 and memory 110. The processor 100 and the memory 110 communicate with each other through a communication bus. Components such as the processor 100 and the memory 10 may also communicate through a network connection. The present disclosure has no limitations on the type and functionality of the network.

For example, the memory 110 is configured to non-transiently store computer-readable instructions. The processor 100 is configured to run the computer-readable instructions which, when run by the processor 100, cause implementing the method for constructing a composite function block according to any above embodiment. For the specific implementation of each step of the method for constructing a composite function block and related explanatory contents, a reference may be made for the embodiments of the method for constructing a composite function block, which will not be redundantly described here.

For example, the implementation way that the processor 100 executes a program stored on the memory 110 to implement the method provided in the above embodiments is the same as the implementation way mentioned in the foregoing embodiments of the method, which will not be redundantly described here too.

For example, the communication bus may be a peripheral component interconnect (PCI) bus, an extended industry standard architecture (EISA) bus, or the like. The communication can be divided into address bus, data bus and control bus, etc. For ease of representation, only one thick line is used to represent the system bus in the figure, but this does not mean that there is only one bus or only one type of bus.

For example, the processor 100 and the memory 110 may be set at a server side (or cloud).

The processor 100 may control other components in the apparatus to perform desired functionalities. The processor 100 may be a central processing unit (CPU), a network processor (NP), or the like; or may be a digital signal processor (DSP), an application-specific integrated circuit (ASIC), a field-programmable gate array (FPGA), another programmable logic device, a discrete gate or transistor logic device, or a discrete hardware component. The CPU may be an X86 or ARM architecture or the like.

For example, the memory 110 may include any combination of one or more computer program products. The computer program products may include computer readable storage mediums in various forms, e.g., a volatile memory and/or a nonvolatile memory. The volatile memory may include, for example, a random access memory (RAM) and/or a cache, etc. The nonvolatile memory may include, for example, a read only memory (ROM), a hard disk, an erasable programmable read-only memory (EPROM), a compact disk read-only memory (CD-ROM) a USB memory, a flash memory, etc. One or more computer-readable instructions may be stored on the computer-readable storage medium, and the processor 100 may run the computer-readable instructions to implement various functionalities of the apparatus 10 for constructing a composite function block. Various application programs and various kinds of data may also be stored on the storage medium.

For example, for the detailed description of the process that the apparatus 10 for constructing a composite function block performs the construction of the composite function block, a reference may be made to the related description in the embodiments of the method for constructing a composite function block, which will not be described here redundantly.

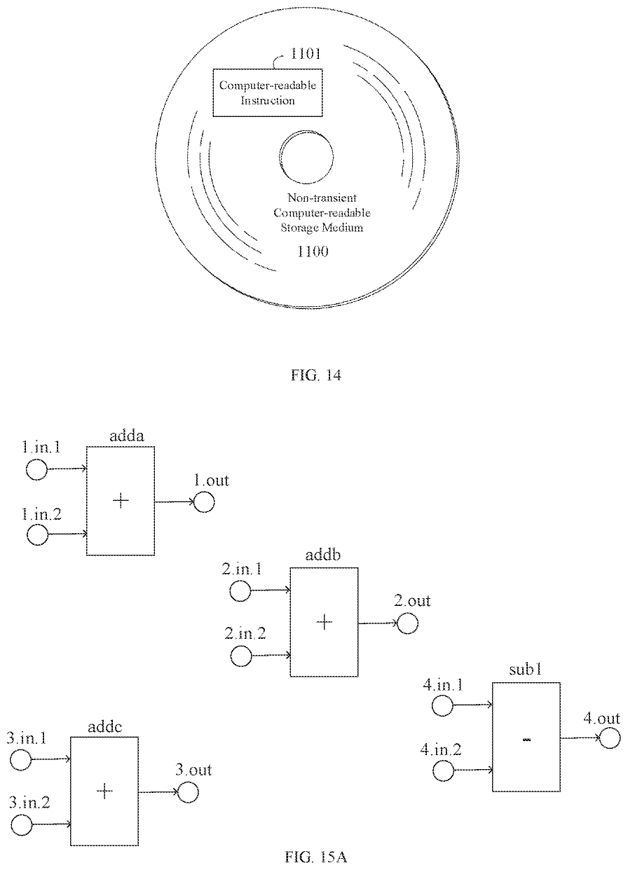

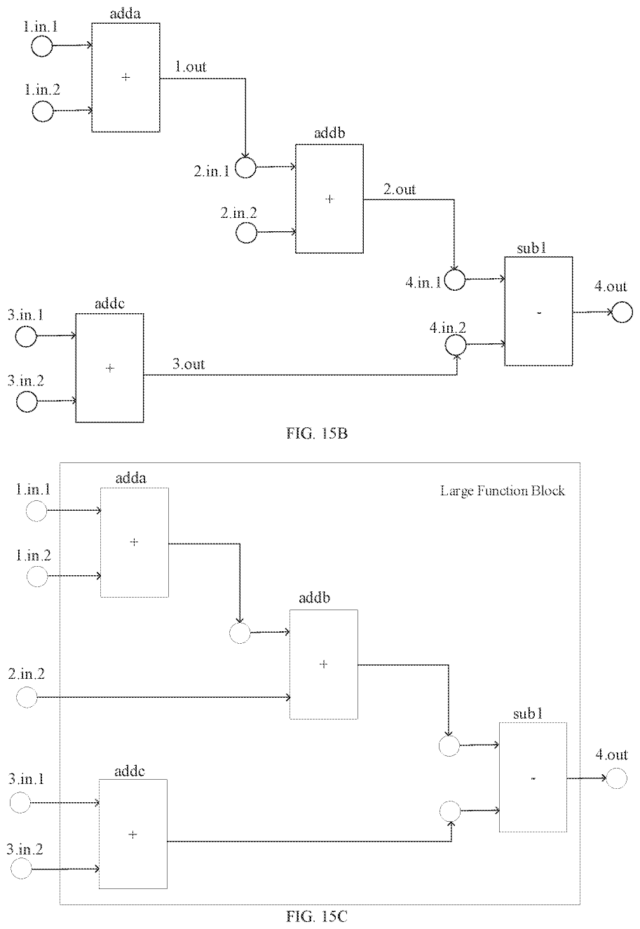

FIG. 14 is a schematic diagram of a non-transient computer-readable storage medium provided in at least one embodiment of the present disclosure. For example, as illustrated in FIG. 14, one or more computer-readable instructions 1101 may be non-transiently stored on the non-transient computer-readable storage medium 1100. For example, when the computer-readable instructions 1101 are executed by a processor, one or more steps of the method for constructing a composite function block described above may be performed.

For example, the non-transient computer-readable storage medium 1100 may be applied to the apparatus 10 for constructing a composite function block. For example, the non-transient computer-readable storage medium 1100 may include the memory 110 of the apparatus 10 for constructing a composite function block.

For example, the description regarding the non-transient computer-readable storage medium 1100 may be known with reference to the related description of the memory 110 in the embodiment of the apparatus 10 for constructing a composite function block, which will not be described here redundantly.

A major way for precisely representing a computation in the prior art is by a computer high-level language (C, C++, Java, python, or the like), also referred to as high-level language for short. Basic concepts for the high-level language to represent a computation are variable, function, and statement. A variable is used for representing a computing (computed) object, a function is used for organizing a computation, and by a statement, the variable is cited to represent the computation on the computing object. The function also needs to be called by a statement to implement a computation on the computing object. When a function is used to organize a computation, variables need to be defined first, such as a global variable, a class variable, a function parameter variable, and a local variable, and then the variables are cited by a statement to organize the computation.

All programming manuals require variable names to have meanings to improve the readability of a code. For different application fields, different functionalities will yield different name systems. Although different enterprises are in the same application field, different name systems will be yielded because code names between the enterprises can be hardly harmonized. Different name systems attach application meanings to codes. The inseparability of an application and a computation will cause an increase in code quantity and increase the development and maintenance costs. A computation cannot be precisely expressed independently, which will affect the formation and sharing of computational common knowledge. The mixed use of codes of different name systems will destroy the readability of codes and make code sharing difficult.

An application and a computation and the mixed representation thereof (i.e., the inseparability of the application and the computation) are derived from the syntactic representation rule (variables and citation of the variables by statements) of the existing high-level language and cannot be eliminated by a design method.

Componentized software design is a design idea pursued in the software industry. The componentized design idea is to regard software as being composed of components. Small components are composited into a large component, and large components are composited into a larger component, thereby forming software. The complete componentization of software implies that there are (ideally, a finite number of) basic components, and the basic components are repeatedly composited to form components and software of various sizes. At present, the major way of software production is still encoding.

The technical characteristics of existing high-level language computing are as follows: a variable needs to be declared first and then the variable is cited by a statement to implement a computation, with the variable representing a storage; therefore, in the high-level language, the storage and the computation are separated, and the storage may be defined separately; organizing a computation by a function requires a parameter of the function to be represented first so that the parameter can be cited by a statement, and therefore, representing a computation in the high-level language is top-down.

The present disclosure provides a computation-storage integrated bottom-up computation representation way and organization way, by which complete modularization of a computation can be realized. The computation and the application are separated. Meanwhile, simple and intuitional visualized operation on computation organization is realized.

The basic design idea of the present disclosure is described below by way of an example.

A segment of code of the existing high-level language is illustrated as below:

Int addsub(int a, int b, int c, int d, int e)

```
{
  x1 = a + b;
  x2 = x + c;
  x3 = d + e;
  y = x2 − x3;
  return y
}
```

“+” and “−” are regarded as function blocks, where “+” function block (i.e., add function block) is represented as: (int) add(int, int); and “−” function block (i.e., sub function block) is represented as: (int) sub(int, int).

Regarding the “−” function block, from left to right, a first parameter of the input of the “−” function block is a minuend, and a second parameter is a subtrahend. The parameter of the function block does not use a parameter variable and only represents a type of the parameter and a parameter position. For example, the input type in of the add function block is (int,int). The input type in includes two int sub-types. The output type out of the add function block is int. Thus, based on the idea of the present disclosure, the above computation is represented as:

| (int) addsub((int,int), int, (int,int)) // Step 3 | |
|---|---|
| { | |
| { | // Step 1 |

| | (int) add(int,int) |
|---|---|
| | (int) add(int,int) |
| | (int) add(int,int) |
| | (int) sub(int,int) |
| } | |
| { | // Step 2 |
| | (1.out, 2.in.1) |
| | (2.out, 4.in.1) |
| | (3.out, 4.in.2) |
| } | |
| { | // Step 4 |
| | (0.in.1, 1.in) |
| | (0.in.2, 2.in.2) |
| | (0.in.3, 3.in) |
| | (0.out, 4.out) |

}

}

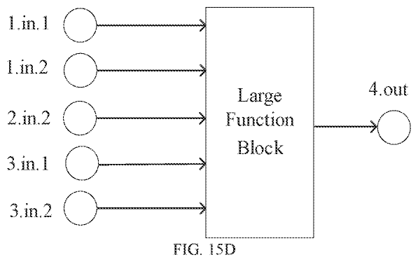

FIG. 15A is a schematic diagram of a plurality of function blocks for compositing provided in some embodiments of the present disclosure; FIG. 15B is a schematic diagram of performing a line joining operation on the plurality of function blocks illustrated in FIG. 15A; FIG. 15C is a schematic diagram of an interface of a large function block generated based on compositing of the plurality of function blocks illustrated in FIG. 15A; and FIG. 15D is a schematic diagram of a large function block generated based on compositing of the plurality of function blocks illustrated in FIG. 15A.

The implementation steps are as follows.

Step 1, listing at least one function block needing to be used. A function block needing to be executed first is placed first. As illustrated above, in this example, the function block includes three add function blocks, namely (int) add(int, int), and one sub function block, namely (int) sub(int, int). As illustrated in FIG. 15A, three add function blocks and one sub function blocks, the three add function blocks are function block adda, function block addb, and function block addc. The one sub function block is function block sub1, and the three add function blocks and the one sub function blocks are arranged in a certain order.

For example, as illustrated in FIG. 15A, the function block adda includes first input parameter 1.in.1 and second input parameter 1.in.2, and output parameter 1.out. The function block addb includes first input parameter 2.in.1 and second input parameter 2.in.2, and output parameter 2.out. The function block addc includes first input parameter 3.in.1 and second input parameter 3.in.2, and output parameter 3.out. The function block sub1 includes first input parameter 4.in.1 and second input parameter 4.in.2, and output parameter 4.out.

Step 2, representing an output and input relationship between the function blocks by using serial numbers of the function blocks and serial numbers of the parameters of the function blocks in step 1. As illustrated in FIG. 15B, the input parameters and the output parameters of the function blocks are joined. For example, the output parameter 1.out of the function block adda is joined to the first input parameter 2.in.1 of the function block addb by, for example, a data transfer joining line; the output parameter 2.out of the function block addb is joined to the first input parameter 4.in.1 of the function block sub1 by, for example, a data transfer joining line; and the output parameter 3.out of the function block addc is joined to the second input parameter 4.in.2 of the function block sub1 by, for example, a data transfer joining line.

Step 3, generating designed interfaces of the function blocks. The input parameters of some function blocks in step 1 have been provided with specific values based on the joining operation in step 2, such as the first input parameter 2.in.1 of the function block addb, the first input parameter 4.in.1 of the function block sub1, and the second input parameter 4.in.2 of the function block sub1. Besides, the remaining parameters need to be provided with value externally and thus need to become input parameters of a generated large function block, such as 1.in (i.e., two input parameters of the function block adda), 2.in.2 (i.e., the second input parameters of the function block addb), and 3.in (i.e., two input parameters of the function block addc). An output parameter of the large function block is certainly included among the output parameters of the function blocks in step 1. A strategy for determining the output parameter of the large function block includes: a, selecting all the output parameters in step 1 as the output parameters of the large function block and then specifically selecting one when the large function block is used in further compositing; and b, selecting 4.out as the output parameter of the large function block (i.e., the output parameter of the function block sub1) in the process of generating the large function block.

Step 4, generating a relationship between a function block and an interface needed to composite interfaces and function blocks according to the interfaces in step 3.

As illustrated in FIG. 15C, the input portion of the interface of the generated large function block includes five input parameters, namely the two input parameters 1.in.1 and 1.in.2 of the function block adda, the second input parameter 2.in.2 of the function block addb, and the two input parameters 3.in.1 and 3.in.2 of the function block addc. The output portion of the interface of the generated large function block includes one output parameter, and the output parameter is the output parameter 4.out of the function block sub1. As illustrated in FIG. 15D, finally, the generated large function block may be encapsulated to simplify the representation. That is, the small function blocks and the joining relationships thereof in the large function block are not represented, and only the input parameter and the output parameter of the interface of the large function block are represented.

Step 1 and step 2 are selected independently. For example, in step 3, if strategy a is selected, step 3 and step 4 may be generated according to the selection fixation rule in step 1 and step 2. For example, in step 3, if strategy b is selected, the input parameter of the interface of the large function block may be generated automatically, and the output parameter of the interface of the large function block may be selected and generated simply. The relationship between the function block and the interface in step 4 may be generated automatically.

In the present disclosure, the symbolic representation of the formation way of a function block is more complicated than high-level language representation, but the present disclosure provides a simple and intuitional illustration. If the method provided in the present disclosure is operated visually, the method becomes simple and intuitional. As illustrated in FIG. 15A to FIG. 15D, a designer only needs to select 4 functions and 3 joining lines, or simply output selection, and others may be generated automatically according to rules. The determination of a composite function has been completed by steps 1 and 2, and the composite function is represented in a standard form by steps 3 and 4, thereby facilitating further involvement in subsequent composition. Storages are set on the input parameters (i.e., the above-mentioned input data items) and the output parameters (i.e., the above-mentioned output data items) of the function blocks. The joining lines between the function blocks may be regarded as storage merging and data transfer, and joining may also be referred to as data transfer line joining. Forming a standard interface may be regarded as extracting the storages of small function blocks onto the input parameter and the output parameter of the large function block. A storage has a type. For example, the types of the storages in FIG. 15A to FIG. 15D are all int. Storages exist on the input parameter and the output parameter of the large function block and the joining lines between the input parameters and the output parameters of the small function blocks in the large function block. The storages (input data items and output data items) of the input parameter and the output parameter of the large function block may regarded as compositions of storages of the input parameters and the output parameters of the small function blocks.

Because the main steps needing to be performed by the designer are to select small function blocks and join the small function blocks, the method for constructing a composite function block provided in the present disclosure is referred to as a compositing design method. Because the interface of the large function block is generated, the method for constructing a composite function block provided in the present disclosure is a bottom-up design way rather than a way of designing an interface first and then implementing a computation. The method for constructing a composite function block provided in the present disclosure does not use a variable to represent storage, and the represented computations are pure computations.

The way of forming the large function block from the small function blocks illustrated in FIG. 15A to FIG. 15D is a sequential way, also referred to as a sequential paradigm (i.e., the above-mentioned sequential composite paradigm). In addition to the sequential composite paradigm, the present disclosure further includes providing the if composite paradigm, the for composite paradigm, the while composite paradigm, etc.

Any function is composed of smaller functions, implying that a group of minimum functions is used as a start of composition. The minimum function may be selected as a theoretical minimum function at Turing basic operation level, may be selected as a minimum function at hardware instruction set level, or may be selected as a minimum function at high-level language basic computation statement level. The minimum function is referred to as a basic function. In the description of the present disclosure, the basic function at high-level language basic computation statement level is selected.

There are also the following points to be made with respect to the present disclosure:

(1) The accompanying drawings of embodiments of the present disclosure relate only to structures involved with embodiments of the present disclosure, and reference may be made to the usual design for other structures.

(2) For the sake of clarity, in the accompanying drawings used to describe the embodiments of the present disclosure, the thicknesses and dimensions of the layers or structures are enlarged. It is to be understood that when an element such as a layer, film, region or substrate is said to be disposed “on” or “under” another element, the element may be disposed “directly” “on” or “under” the other element, or there may be an intermediate element.

(3) Without conflict, embodiments and features in embodiments of the present disclosure may be combined with each other to obtain new embodiments.

The foregoing are only specific embodiments of the present disclosure, but the scope of protection of the present disclosure is not limited thereto, and the scope of protection of the present disclosure shall be subject to the scope of protection of the stated claims.

1. A method for constructing a composite function block by nested use of composite paradigms, applied to a function block library comprising a plurality of function blocks, wherein the method comprises:
selecting at least one composite paradigm from a plurality of composite paradigms;
acquiring an arrangement operation for at least two function blocks of the plurality of function blocks to obtain a computation sequence;
based on the computation sequence, performing a concatenation operation to determine a joining relationship between the at least two function blocks; and
based on an interface of each function block of the at least two function blocks and the joining relationship between the at least two function blocks, encapsulating the at least two function blocks into a composite function block and generating an interface corresponding to the composite function block,
wherein each function block of the plurality of function blocks comprises at least one input data item and at least one output data item that correspond to an interface corresponding to the function block, and the at least one input data item and the at least one output data item exist in a form of storage in the function block; and
the concatenation operation comprises joining at least part of input data items and/or at least part of output data items of the at least two function blocks.

2. The method according to claim 1, wherein the plurality of function blocks comprise a plurality of basic function blocks and a plurality of composite function blocks, and each of the plurality of composite function blocks is composed of at least one basic function block and/or at least one composite function block;
the plurality of basic function blocks represent a minimum unit composing any composite function block;
each basic function block of the plurality of basic function blocks has a corresponding computing functionality thereof;
a computing functionality of each of the plurality of composite function blocks is determined based on a computing functionality and a joining relationship of the at least one basic function block and/or the at least one composite function block;
a variable name does not need to be designated for the at least one input data item and the at least one output data item; and
the method further comprises:
storing the composite function block in the function block library as a function block to expand the function block library.

3. The method according to claim 2, wherein
the concatenation operation is performed in a following order of steps:
compositing the at least two function blocks according to at least one composite paradigm of the plurality of composite paradigms; and joining at least part of input data items and/or at least part of output data items of the at least two function blocks after compositing;
or,
joining at least part of input data items and/or at least part of output data items of the at least two function blocks; and according to at least one composite paradigm of the plurality of composite paradigms, compositing the at least two function blocks after joining data items.

4. (canceled)

5. The method according to claim 3, wherein
the plurality of composite paradigms comprise a sequential composite paradigm, a conditional composite paradigm, a looping composite paradigm, and a while looping composite paradigm;
the conditional composite paradigm comprises a judgment condition portion, a first branch portion, and a second branch portion;
the looping composite paradigm comprises a single expression and at least one layer of loop bodies; each loop body comprises at least one loop portion, and each loop portion comprises a conditional expression, an intermediate loop expression, and an end loop expression;
the while looping composite paradigm comprises at least one layer of while loop bodies; each while loop body comprises at least one while loop portion, and each while loop portion comprises a while conditional expression and a while loop expression;
the plurality of basic function blocks comprise a basic function block representing a relational expression, a basic function block representing a logical expression, a basic function block representing an arithmetical expression, a basic function block representing an assignment expression, a basic function block representing a data type conversion functionality, and a paradigm basic function block,
wherein the paradigm basic function block comprises a basic function block for performing an operation on a pointer; and
the paradigm basic function block comprises a basic function block for acquiring an address of a data item, a basic function block for acquiring a data type value of a data item, and a basic function block for performing an array operation.

6. (canceled)

7. The method according to claim 5, wherein for each function block of the plurality of function blocks, an interface corresponding to each function block of the plurality of function blocks comprises an input portion and an output portion; the input portion of the interface corresponding to each function block of the plurality of function blocks corresponds to at least one input data item of each function block of the plurality of function blocks, and the output portion of the interface corresponding to each function block of the plurality of function blocks corresponds to at least one output data item of each function block of the plurality of function blocks;
each data item of a group comprising the at least one input data item and the at least one output data item comprises a data type attribute, a data class attribute, a storage type attribute, a value attribute, a name attribute, a physical address attribute, and a relative address attribute;
the data class attribute comprises a basic data type, a composite data type, a pointer type, and a generic type, and the pointer type comprises a generic pointer type and a non-generic pointer type;
the data type attribute refers to a type of a data item;
the storage type attribute comprises a virtual storage and a real storage;
the relative address attribute is used for representing a sequentially encoded value of a data item;
for a data item whose data class attribute is the composite data type, the data item comprises a plurality of data items whose data class attribute is the basic data type, or the data item comprises a plurality of data items whose data class attribute is the composite data type, or the data item comprises a plurality of data items whose data class attribute is the pointer type, or the data item comprises a plurality of data items whose data class attribute is the generic type, or data class attributes of data items comprised in the data item are at least two of following data class attributes: the basic data type, the composite data type, the pointer type, and the generic type;
structure formats of a data item whose data class attribute is the basic data type, a data item whose data class attribute is the composite data type, a data item whose data class attribute is the pointer type, and a data item whose data class attribute is the generic type are identical and normative; a structure of the data item whose data class attribute is the composite data type is a nested structure, and structure formats of data items of each layer of the nested structure are identical;
wherein when the at least one composite paradigm comprises at least one of the looping composite paradigm and the while looping composite paradigm,
when the at least one composite paradigm comprises the looping composite paradigm and each loop body comprises a plurality of loop portions, a N-ization condition is that data items at same locations among the plurality of loop portions are not joined by lines; and
when the at least one composite paradigm comprises the while looping composite paradigm and each while loop body comprises a plurality of while loop portions, the N-ization condition is that data items at same locations among the plurality of while loop portions are not joined by lines.

8. The method according to claim 7, wherein the concatenation operation comprises a type matching rule and a line joining requirement rule;
when joining at least part of input data items and/or at least part of output data items of the at least two function blocks, data type attributes of two data items joined meet the type matching rule or the two data items joined meet the line joining requirement rule; the type matching rule is that the data type attributes of the two data items match; and the line joining requirement rule comprises that a data type attribute of one data item of the two data items is the generic type and a data type attribute of other data item of the two data items is the basic data type, the composite data type, or the generic type, or comprises that the data type attribute of the one data item of the two data items is the generic pointer type and the data type attribute of the other data item of the two data items is the non-generic pointer type;
wherein determining the two data items meeting the type matching rule comprises:
for a first data item and a second data item selected from a group comprising the at least part of output data items and/or the at least part of input data items:
determining whether a data class attribute of the first data item is identical to a data class attribute of the second data item; in response to the data class attribute of the first data item being identical to the data class attribute of the second data item, determining whether the data class attribute of the first data item and the data class attribute of the second data item are the basic data type, the composite data type, the pointer type, or the generic type;
in response to both of the data class attribute of the first data item and the data class attribute of the second data item being the basic data type, determining whether a data type attribute of the first data item is identical to a data type attribute of the second data item; and in response to the data type attribute of the first data item being identical to the data type attribute of the second data item, determining that the first data item and the second data item are the two data items meeting the type matching rule.

9. The method according to claim 8, wherein the composite data type comprises a basic composite data type, an Exclusive OR type, and an array type; and
the determining the two data items meeting the type matching rule further comprises:
in response to both of the data class attribute of the first data item and the data class attribute of the second data item being the composite data type, determining whether the data class attribute of the first data item and the data class attribute of the second data item are the Exclusive OR type, the basic composite data type, or the array type;
in response to both of the data class attribute of the first data item and the data class attribute of the second data item being the Exclusive OR type, circularly performing judgement with respect to the type matching rule on data items at same locations within the first data item and the second data item to obtain a plurality of Exclusive OR judgement results; and
in response to each of the plurality of Exclusive OR judgement results indicating meeting the type matching rule, determining that the first data item and the second data item are the two data items meeting the type matching rule;
or,
in response to both of the data class attribute of the first data item and the data class attribute of the second data item being the array type, circularly judging whether data items at same locations within the first data item and the second data item meet the type matching rule to obtain at least one array judgement result; and in response to each of the at least one array judgement result indicating meeting the type matching rule, determining that the first data item and the second data item are the two data items meeting the type matching rule;
or,
in response to both of the data class attribute of the first data item and the data class attribute of the second data item being the basic composite data type, circularly judging whether data items at same locations within the first data item and the second data item meet the type matching rule to obtain at least one basic composite judgement result; and
in response to each of the at least one basic composite judgement result indicating meeting the type matching rule, determining that the first data item and the second data item are the two data items meeting the type matching rule;
or,
in response to both of the data class attribute of the first data item and the data class attribute of the second data item being the pointer type, in a case that both of the first data item and the second data item are of the generic pointer type, determining that the first data item and the second data item are the two data items meeting the type matching rule; in a case that both of the first data item and the second data item are of the non-generic pointer type, circularly judging whether data items at same locations within the first data item and the second data item meet the type matching rule to obtain at least one non-generic pointer judgement result; and in response to each of the at least one non-generic pointer judgement result indicating meeting the type matching rule, determining that the first data item and the second data item are the two data items meeting the type matching rule; and
in response to both of the data class attribute of the first data item and the data class attribute of the second data item being the generic type, determining that the first data item and the second data item are the two data items meeting the type matching rule.

10. (canceled)

11. (canceled)

12. (canceled)

13. The method according to claim 8, wherein the at least part of input data items comprises a first part of input data items; and
the joining at least part of input data items and/or at least part of output data items of the at least two function blocks comprises:
based on the type matching rule and/or the line joining requirement rule, joining the at least part of output data items and the first part of input data items by a data transfer joining line,
wherein the data transfer joining line represents a line joining from an output data item to an input data item or an output data item; and the data transfer joining line comprises an output-output transfer line used for joining at least two output data items and an output-input transfer line used for joining at least one output data item to at least one input data item.

14. The method according to claim 13, wherein the at least part of output data items comprises a first output data item, a second output data item, and a third output data item, and the first part of input data items comprises a first input data item;
the joining the at least part of output data items and the first part of input data items by a data transfer joining line comprises at least one of:
joining the second output data item to the first output data item by the output-output transfer line, the second output data item appearing after the first output data item, setting a storage type attribute of the second output data item to the virtual storage, not changing a storage type attribute of the first output data item, and recording a joining relationship between the first output data item and the second output data item;
joining the third output data item to the first input data item by the output-input transfer line;
in response to the third output data item appearing after the first input data item or the third output data item and the first input data item belonging to a same function block, setting a storage type attribute of the third output data item to the virtual storage, not changing a storage type attribute of the first input data item, and recording a joining relationship between the first input data item and the third output data item; and
in response to the third output data item appearing before the first input data item, setting the storage type attribute of the first input data item to the virtual storage, not changing the storage type attribute of the third output data item, and recording the joining relationship between the first input data item and the third output data item,
wherein the first output data item, the second output data item, the third output data item, and the first input data item are positioned in a form of a second relative path;
the joining relationship between the first output data item and the second output data item is embodied by a second relative path of the first output data item and a second relative path of the second output data item and recorded in a line joining relationship portion of a selected composite paradigm; and
the joining relationship between the first input data item and the third output data item is embodied by a second relative path of the first input data item and a second relative path of the third output data item.

15. The method according to claim 13, wherein the at least part of input data items further comprises a second part of input data items;
the joining at least part of input data items and/or at least part of output data items of the at least two function blocks further comprises:
based on the type matching rule and/or the line joining requirement rule, joining the second part of input data items by an auxiliary merging joining line;
the second part of input data items comprises a second input data item and a third input data item; and
the joining the second part of input data items by an auxiliary merging joining line comprises:
joining the third input data item to the second input data item by the auxiliary merging joining line, setting a storage type attribute of the third input data item to the virtual storage, not changing a storage type attribute of the second input data item, and recording a joining relationship between the second input data item and the third input data item,
wherein the second input data item and the third input data item are positioned in a form of a second relative path; and the joining relationship between the second input data item and the third input data item is embodied by a second relative path of the second input data item and a second relative path of the third input data item and recorded in an interface and sequence contrast portion of a selected composite paradigm;
wherein for a first pointer data item and a second pointer data item in the at least part of input data items and/or the at least part of output data items, a data type attribute of the first pointer data item is the generic pointer type, and a data type attribute of the second pointer data item is the non-generic pointer type; and
in response to the first pointer data item and the second pointer data item being joined by the data transfer joining line or the auxiliary merging joining line, the data type attribute of the first pointer data item is set to a data type attribute of a data item pointed to by the second pointer data item.

16. (canceled)

17. (canceled)

18. The method according to claim 8, wherein the interface corresponding to each function block of the plurality of function blocks comprises the input portion and the output portion;
the encapsulating the at least two function blocks into a composite function block and generating an interface corresponding to the composite function block comprise:
compositing and encapsulating at least one input data item corresponding to the composite function block and extracted as an interface to obtain an input portion of the interface corresponding to the composite function block; and
compositing and encapsulating at least one output data item corresponding to the composite function block and extracted as an interface to obtain an output portion of the interface corresponding to the composite function block; and
storing the interface corresponding to the composite function block in an interface portion of a selected composite paradigm;
wherein the encapsulating the at least two function blocks into a composite function block and generating an interface corresponding to the composite function block further comprise at least one of:
for any function block of the at least two function blocks, when a data type attribute of any input data item or output data item corresponding to the any function block is the composite data type, in a case that a particular data item of the any input data item or output data item with the composite data type is not extracted as a portion of the interface corresponding to the composite function block, breaking apart the any input data item or output data item, not extracting the particular data item, and re-compositing remaining data items of the any input data item or output data item as a portion of the interface corresponding to the composite function block;
for any function block of the at least two function blocks, when any input data item corresponding to the any function block is a constant data item, not extracting the any input data item as a portion of the interface corresponding to the composite function block;
for input data items corresponding to the at least two function blocks, not extracting an input data item whose storage type attribute is the virtual storage as a portion of the interface corresponding to the composite function block;
for any output data item corresponding to the at least two function blocks, in response to the any output data item being directly or indirectly joined to at least one output data item by the data transfer joining line, acquiring an output data item first appearing among the any output data item and the at least one output data item as an output data item to be extracted; when the output data item to be extracted is joined to any input data item, in a case that the output data item to be extracted appears before the any input data item, not extracting the output data item to be extracted as a portion of the interface corresponding to the composite function block; and in a case that the output data item to be extracted appears after the any input data item or the output data item to be extracted and the any input data item belong to a same function block, extracting the output data item to be extracted as a portion of the interface corresponding to the composite function block, and extracting, as needed, part data items, not extracted as an interface, of output data items corresponding to the at least two function blocks as the interface; and
for the output data items corresponding to the at least two function blocks, extracting all the output data items corresponding to the at least two function blocks as the interface corresponding to the composite function block.

19. (canceled)

20. The method according to claim 18, wherein when the at least one composite paradigm is the sequential composite paradigm and the composite function block is a composite function block having a sequential structure, in a compositing process of encapsulating the at least two function blocks into a composite function block and generating an interface corresponding to the composite function block, data items in the interface corresponding to the composite function block are generated sequentially by data items in interfaces corresponding to the at least two function blocks, and data class attributes of the data items in the interface corresponding to the composite function block are the basic composite data type;
wherein when the at least one composite paradigm is the conditional composite paradigm, the composite function block is a composite function block having a conditional structure;
for the composite function block having the conditional structure, the encapsulating the at least two function blocks into a composite function block and generating an interface corresponding to the composite function block further comprise:
not extracting an output data item of a function block belonging to the judgment condition portion in the composite function block having the conditional structure as a portion of an interface corresponding to the composite function block having the conditional structure;
in response to the composite function block having the conditional structure comprising at least two input data items, extracting an input data item of an interface corresponding to the function block belonging to the judgment condition portion, an input data item of an interface corresponding to a function block belonging to the first branch portion, and an input data item of an interface corresponding to a function block belonging to the second branch portion as an input portion of the interface corresponding to the composite function block having the conditional structure, a data class attribute of the input portion of the interface corresponding to the composite function block having the conditional structure being the basic composite data type;
in response to the composite function block having the conditional structure comprising at least two output data items, the at least two output data items having an Exclusive OR structure, and the at least two output data items comprising a first output Exclusive OR portion belonging to a function block of the first branch portion and a second output Exclusive OR portion belonging to a function block of the second branch portion;
in a case that part of data items of any output data item of the at least two output data items are joined by the data transfer joining line, extracting part of data items of the any output data item as a common output portion of the composite function block having the conditional structure; and
in a case that all output data items of the first output Exclusive OR portion of the at least two output data items are extracted as the common output portion, not taking all the output data items of the first output Exclusive OR portion as a portion of the Exclusive OR structure, and taking other output data items than output data items extracted as the common output portion in the second output Exclusive OR portion separately as a portion of the Exclusive OR structure.

21. (canceled)

22. The method according to claim 20, wherein when the at least one composite paradigm is the looping composite paradigm, the composite function block is a composite function block having a loop structure, and each loop body comprises a plurality of loop portions,
for the composite function block having the loop structure, the encapsulating the at least two function blocks into a composite function block and generating an interface corresponding to the composite function block further comprise:
not providing interfaces corresponding to output data items of function blocks located in the single expression and the conditional expression and the end loop expression of each loop portion in the composite function block having the loop structure;
for any input data item in the composite function block having the loop structure, in a case that the any input data items in some loop portions of the plurality of loop portions are joined by a joining line and the any input data items in other loop portions of the plurality of loop portions are not joined by a line, providing an interface corresponding to an input data item whose storage attribute is the real storage among a plurality of any input data items corresponding to the plurality of loop portions; and
for any output data item in the composite function block having the loop structure, in a case that the any output data items in some loop portions of the plurality of loop portions are joined by a joining line and the any output data items in other loop portions of the plurality of loop portions are not joined by a line, providing only the any output data item in a first loop portion of the plurality of loop portions as a corresponding interface or performing N-ization extraction on a plurality of any output data items in the plurality of loop portions;
when the at least one composite paradigm is the while looping composite paradigm, the composite function block is a composite function block having a while loop structure, and each while loop body comprises a plurality of while loop portions,
for the composite function block having the while loop structure, the encapsulating the at least two function blocks into a composite function block and generating an interface corresponding to the composite function block further comprise:
not providing an interface corresponding to an output data item of a function block located in the while conditional expression in the composite function block having the while loop structure;
for any input data item in the composite function block having the while loop structure, in a case that the any input data items in some while loop portions of the plurality of while loop portions are joined by a joining line and the any input data items in other while loop portions of the plurality of while loop portions are not joined by a line, providing an interface corresponding to an input data item whose storage attribute is the real storage among a plurality of any input data items corresponding to the plurality of while loop portions; and
for any output data item in the composite function block having the while loop structure, in a case that the any output data items in some while loop portions of the plurality of while loop portions are joined by a joining line and the any output data items in other while loop portions of the plurality of while loop portions are not joined by a line, providing only the any output data item in a first while loop portion of the plurality of while loop portions as a corresponding interface or performing N-ization extraction on a plurality of any output data items in the plurality of while loop portions; and
a data class attribute of a data item in the interface corresponding to the composite function block having the loop structure or the while loop structure is the array type.

23. The method according to claim 7, wherein each function block of the plurality of function blocks is presented in a form of graphic, the graphic corresponds to a symbolic language, and the symbolic language comprises an extensible markup language;
an extensible markup language corresponding to any function block of the plurality of function blocks comprises a computation sequence portion, an interface portion, a line joining relationship portion, and an interface and sequence contrast portion;
the computation sequence portion is used for describing interfaces of function blocks comprised in the any function block;
the interface portion is used for describing an interface of the any function block;
the line joining relationship portion is used for describing a data transfer relationship and an input merging relationship between the function blocks comprised in the any function block;
the interface and sequence contrast portion is used for describing a contrast relationship between a data item in a function block comprised in the any function block and a data item in the interface of the any function block and further describing a line joining relationship between input data items joined by an auxiliary merging joining line in the any function block; and
the contrast relationship is embodied by a first relative path and a second relative path of the data item in the interface of the any function block.

24. (canceled)

25. The method according to claim 23,
wherein for any input data item corresponding to any function block of the at least two function blocks, the any input data item is extracted as a portion of the interface corresponding to the composite function block;
the any input data item corresponds to a first relative path, and the first relative path of the any input data item represents a relative path of the any input data item in an input portion of the interface corresponding to the composite function block;
the first relative path of the any input data item is represented as follows:
in.Path(data_in1)
wherein in represents that the any input data item is in the input portion of the interface corresponding to the composite function block; and
Path(data_in1) is the relative path of the any input data item computed by: based on a concatenation structure of the composite function block, between an input data item of an outermost layer corresponding to the any input data item in the input portion of the interface corresponding to the composite function block and the any input data item, acquiring a relative address attribute related to the any input data item layer by layer, and computing the relative path of the any input data item based on the relative address attribute related to the any input data item;
wherein for any output data item corresponding to the any function block, the any output data item is extracted as a portion of the interface corresponding to the composite function block;
the any output data item corresponds to a first relative path, and the first relative path of the any output data item represents a relative path of the any output data item in an output portion of the interface corresponding to the composite function block;
the first relative path of the any output data item is represented as follows:
out.Path(data_out1)
wherein out represents that the any output data item is in the output portion of the interface corresponding to the composite function block; and
Path(data_out1) is the relative path of the any output data item computed by: based on a concatenation structure of the composite function block, between an output data item of an outermost layer corresponding to the any output data item in the output portion of the interface corresponding to the composite function block and the any output data item, acquiring a relative address attribute related to the any output data item layer by layer, and computing the relative path of the any output data item based on the relative address attribute related to the any output data item.

26. The method according to claim 14,
wherein for any input data item in an interface corresponding to any function block of the at least two function blocks, the any input data item corresponds to a second relative path, the second relative path of the any input data item represents a relative path of the any input data item in the composite function block and the second relative path of the any input data item is represented as follows:
Path(PF).in. Path(data_in2)
wherein Path(PF) is a relative path of the any function block in the composite function block computed by: based on a concatenation structure of the composite function block, between a function block of an outermost layer corresponding to the any function block in the composite function block and the any function block, acquiring a relative address attribute related to the any function block layer by layer, and computing the relative path of the any function block based on the relative address attribute related to the any function block;
in represents that the any input data item is in an input portion of the interface corresponding to the any function block; and
Path(data_in2) is a relative path of the any input data item in the input portion of the interface corresponding to the any function block computed by: between an input data item of an outermost layer corresponding to the any input data item in the input portion of the interface corresponding to the any function block and the any input data item, acquiring a relative address attribute related to the any input data item layer by layer, and computing the relative path of the any input data item based on the relative address attribute related to the any input data item;
wherein for any output data item in the interface corresponding to the any function block, the any output data item corresponds to a second relative path, the second relative path of the any output data item represents a relative path of the any output data item in the composite function block and the second relative path of the any output data item is represented as follows:
Path(PF).out. Path(data_out2)
wherein out represents that the any output data item is in an output portion of the interface corresponding to the any function block; and
Path(data_out2) is a relative path of the any output data item in the output portion of the interface corresponding to the any function block computed by: between an output data item of an outermost layer corresponding to the any output data item in the output portion of the interface corresponding to the any function block and the any output data item, acquiring a relative address attribute related to the any output data item layer by layer, and computing the relative path of the any output data item based on the relative address attribute related to the any output data item.

27. (canceled)

28. The method according to claim 5, further comprising:
selecting at least one basic function block representing the assignment expression and at least one basic function block representing the relational expression from the basic function blocks as the at least two function blocks,
wherein the compositing the at least two function blocks according to at least one composite paradigm of the plurality of composite paradigms comprises:
selecting at least one of the sequential composite paradigm, the conditional composite paradigm, and the while looping composite paradigm as the at least one composite paradigm; and
compositing the at least two function blocks according to the at least one composite paradigm;
wherein in a case that an extensible markup language corresponding to each basic function block is compiled as a high-level language, a name attribute is compiled as a variable name in the high-level language.

29. (canceled)

30. A composite function block obtained by the method according to claim 1, comprising one or more function blocks, wherein the one or more function blocks are joined by a data transfer joining line and/or an auxiliary merging joining line.

31. An apparatus for constructing a composite function block, comprising:
a memory, configured to non-transiently store computer-readable instructions; and
a processor, configured to run the computer-readable instructions, wherein the computer-readable instructions upon being run by the processor, implement the method according to claim 1.

32. A non-transient computer-readable storage medium, storing computer-readable instructions, wherein the computer-readable instructions upon being executed by a processor, implement the method according to claim 1.
